(19) United States
(12) Patent Application Publication
(10) Pub. No.: US 2026/0023457 A1
(43) Pub. Date: Jan. 22, 2026

(54) DEVICES, METHODS, AND GRAPHICAL USER INTERFACES FOR DISPLAYING VIRTUAL REPRESENTATIONS OF USERS OF A COMMUNICATION SESSION

(71) Applicant: Apple Inc., Cupertino, CA (US)

(72) Inventors: Jesse CHAND, Lodi, NJ (US); Shih-Sang CHIU, San Francisco, CA (US); Jason D. RICKWALD, Santa Cruz, CA (US); Rupert BURTON, San Francisco, CA (US)

(21) Appl. No.: 19/226,943

(22) Filed: Jun. 3, 2025

Related U.S. Application Data
(60) Provisional application No. 63/657,917, filed on Jun. 9, 2024.

(51) Int. Cl. G06F 3/04815; G02B 27/00; G02B 27/01; G06F 3/01

(52) U.S. Cl. CPC G06F 3/04815; G02B 27/0093; G02B 27/0172; G06F 3/013; G06F 3/017

(57) ABSTRACT

In some embodiments, a computer system moves one or more virtual representations in a three-dimensional environment in response to changes of participation of one or more users in a communication session. In some embodiments, a computer system updates a spatial setting status of one or more representations of one or more users in a three-dimensional environment. In some embodiments, a first computer system displays a representation of the user of the first computer system in a three-dimensional environment while in a communication session. In some embodiments, a computer system displays a representation of a second user within a three-dimensional environment during a communication session with a second computer system of the second user.

### CROSS REFERENCE TO RELATED APPLICATIONS

This application claims the benefit of U.S. Provisional Application No. 63/657,917, filed Jun. 9, 2024, the content of which is herein incorporated by reference in its entirety for all purposes.

### TECHNICAL FIELD

The present disclosure relates generally to computer systems that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a first computer system moves one or more virtual representations in a three-dimensional environment in response to changes of participation of one or more users in a communication session. In some embodiments, while in a communication session with a plurality of computer systems other than the first computer system, wherein the first computer system is associated with a first user and the plurality of computer systems are associated with a plurality of users, the first computer system displays, via the display generation component, a plurality of representations of the plurality of users in a three-dimensional environment from a current viewpoint of the first user, the plurality of representations including a first representation of a second user of the plurality of users displayed at a first distance from the current viewpoint of the first user. In some embodiments, the first computer system detects an indication corresponding to a change of participation of the second user in the communication session. In some embodiments, in response to detecting the indication of the change of participation of the second user in the communication session, in accordance with the determination that the change of participation of the second user satisfies first one or more criteria, the first computer system moves the first representation of the second user to a second distance, different from the first distance, from the current viewpoint of the first user in the three-dimensional environment.

In some embodiments, while a three-dimensional environment is visible via the display generation component from a viewpoint of a first user of a first computer system, and while the first computer system is in a communication session with a second computer system, different from the first computer system, of a second user, different from the first user, the computer system displays a non-spatial representation of the second user in the three-dimensional environment relative to the viewpoint of the first user. In some embodiments, the first computer system detects, via the one or more input devices, a first input corresponding to a request to include a spatial representation of the first user in the communication session with the second user. In some embodiments, in response to the first computer system detecting the first input and in accordance with a determination that one or more criteria are satisfied, the first computer system ceases displaying, via the display generation component, of the non-spatial representation of the second user. In some embodiments, the first computer system displays, via the display generation component, a spatial representation of the second user in the three-dimensional environment. In some embodiments, in accordance with a determination that the one or more criteria are not satisfied, the first computer system maintains displaying, via the display generation component, of the non-spatial representation of the second user in the-three-dimensional environment.

In some embodiments, while a three-dimensional environment is visible via the display generation component from a viewpoint of a first user of a first computer system, and while the first user of the first computer system is in a real-time communication session with a second computer system, different from the first computer system, associated with a second user, different from the first user, the first computer system displays, via the display generation component, a non-spatial representation of the second user in the three-dimensional environment, and displays a communication session controls interface in the three-dimensional environment, wherein the communication session controls interface includes a first selectable option. In some embodiments, while the first computer system displays the non-spatial representation of the second user and the communication session controls interface, including the first selectable option, in the three-dimensional environment, the first computer system detects, via the one or more input devices, a first input directed to the first selectable option. In some embodiments, in response to detecting the first input, the first computer system displays, via the display generation component, a user interface including a non-spatial representation of the first user, wherein the user interface is displayed in a first position in the three-dimensional environment that is closer to the viewpoint of the first user than a second position of the communication session controls interface and a third position of the non-spatial representation of the second user in the three-dimensional environment.

In some embodiments, a first computer system is in communication with one or more display generation components and one or more input devices. In some embodiments, a first three-dimensional environment is visible via the one or more display generation components from a viewpoint of a first user of the first computer system, and the first computer system is in a communication session with a second computer system, different from the first computer system, of a second user, different from the first user. In some embodiments, the first computer system displays, via the one or more display generation components, a representation of the second user with a respective background. In some embodiments, in accordance with a determination that a system environment of the second computer system is a first system environment, the respective background is a first background corresponding to the first system environment. In some embodiments, in accordance with a determination that the system environment of the second computer system is a second system environment, different from the first system environment, the respective background is a second background corresponding to the second system environment, different from the first background.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7K illustrate examples of a computer system moving one or more virtual representations in a three-dimensional environment in response to changes of participation of one or more users in a communication session, in accordance with some embodiments.

FIG. 8 is a flowchart illustrating an exemplary method of moving one or more virtual representations in a three-dimensional environment in response to changes of participation of one or more users in a communication session, in accordance with some embodiments.

FIGS. 9A-1 to 9A-2, 9B-1 to 9B-2, 9C-1 to 9C-2, 9D-1 to 9D-3, 9E-1 to 9E-2, 9F, 9G-1 to 9G-2, 9H, 9I-1 to 9I-2, 9J-1 to 9J-2, and 9K-9M illustrate examples of a computer system updating a spatial setting status of one or more representations of one or more users in a three-dimensional environment in response to detecting one or more spatial setting status requests from one or more users in a communication session, in accordance with some embodiments.

FIG. 10 is a flow diagram illustrating an exemplary method of updating a spatial setting status of one or more representations of one or more users in a three-dimensional environment in response to detecting one or more spatial setting status requests from one or more users in a communication session, in accordance with some embodiments.

FIGS. 11A-11K illustrate examples of a first computer system displaying a representation of a user of the first computer system in a three-dimensional environment while in a communication session, in accordance with some embodiments.

FIG. 12 is a flow diagram illustrating an example method of a first computer system displaying a representation of a user of the first computer system in a three-dimensional environment while in a communication session, in accordance with some embodiments.

FIGS. 13A-13P illustrate examples of a computer system displaying a representation of a second user of a second computer system within a three-dimensional environment during a communication session with the second computer system of the second user, in accordance with some embodiments.

FIG. 14 is a flowchart illustrating an example method of a computer system displaying a representation of a second user within a three-dimensional environment during a communication session with a second computer system of the second user, in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a first computer system moves one or more virtual representations in a three-dimensional environment in response to changes of participation of one or more users in a communication session. In some embodiments, while in a communication session with a plurality of computer systems other than the first computer system, wherein the first computer system is associated with a first user and the plurality of computer systems are associated with a plurality of users, the first computer system displays, via the display generation component, a plurality of representations of the plurality of users in a three-dimensional environment from a current viewpoint of the first user, the plurality of representations including a first representation of a second user of the plurality of users displayed at a first distance from the current viewpoint of the first user. In some embodiments, the first computer system detects an indication corresponding to a change of participation of the second user in the communication session. In some embodiments, in response to detecting the indication of the change of participation of the second user in the communication session, in accordance with the determination that the change of participation of the second user satisfies first one or more criteria, the first computer system moves the first representation of the second user to a second distance, different from the first distance, from the current viewpoint of the first user in the three-dimensional environment.

In some embodiments, while a three-dimensional environment is visible via the display generation component from a viewpoint of a first user of a first computer system, and while the first computer system is in a communication session with a second computer system, different from the first computer system, of a second user, different from the first user, the computer system displays a non-spatial representation of the second user in the three-dimensional environment relative to the viewpoint of the first user. In some embodiments, the first computer system detects, via the one or more input devices, a first input corresponding to a request to include a spatial representation of the first user in the communication session with the second user. In some embodiments, in response to the first computer system detecting the first input and in accordance with a determination that one or more criteria are satisfied, the first computer system ceases displaying, via the display generation component, of the non-spatial representation of the second user. In some embodiments, the first computer system displays, via the display generation component, a spatial representation of the second user in the three-dimensional environment. In some embodiments, in accordance with a determination that the one or more criteria are not satisfied, the first computer system maintains displaying, via the display generation component, of the non-spatial representation of the second user in the-three-dimensional environment.

In some embodiments, while a three-dimensional environment is visible via the display generation component from a viewpoint of a first user of a first computer system, and while the first user of the first computer system is in a real-time communication session with a second computer system, different from the first computer system, associated with a second user, different from the first user, the first computer system displays, via the display generation component, a non-spatial representation of the second user in the three-dimensional environment, and displays a communication session controls interface in the three-dimensional environment, wherein the communication session controls interface includes a first selectable option. In some embodiments, while the first computer system displays the non-spatial representation of the second user and the communication session controls interface, including the first selectable option, in the three-dimensional environment, the first computer system detects, via the one or more input devices, a first input directed to the first selectable option. In some embodiments, in response to detecting the first input, the first computer system displays, via the display generation component, a user interface including a non-spatial representation of the first user, wherein the user interface is displayed in a first position in the three-dimensional environment that is closer to the viewpoint of the first user than a second position of the communication session controls interface and a third position of the non-spatial representation of the second user in the three-dimensional environment.

In some embodiments, a first computer system is in communication with one or more display generation components and one or more input devices. In some embodiments, a first three-dimensional environment is visible via the one or more display generation components from a viewpoint of a first user of the first computer system, and the first computer system is in a communication session with a second computer system, different from the first computer system, of a second user, different from the first user. In some embodiments, the first computer system displays, via the one or more display generation components, a representation of the second user with a respective background. In some embodiments, in accordance with a determination that a system environment of the second computer system is a first system environment, the respective background is a first background corresponding to the first system environment. In some embodiments, in accordance with a determination that the system environment of the second computer system is a second system environment, different from the first system environment, the respective background is a second background corresponding to the second system environment, different from the first background.

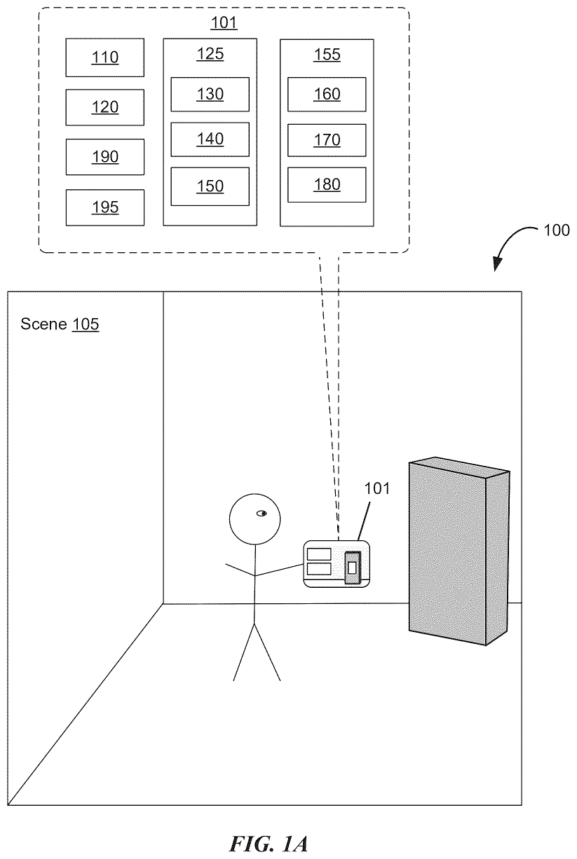

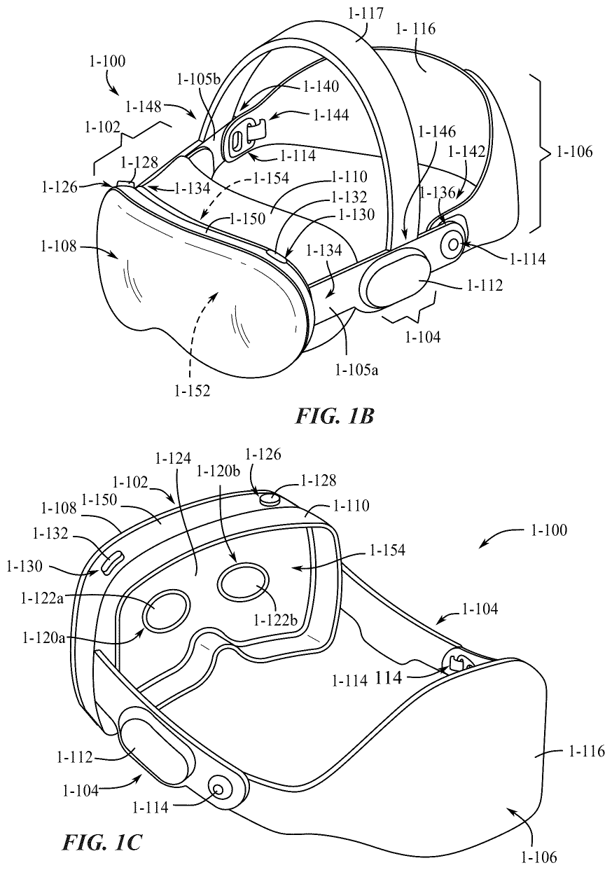

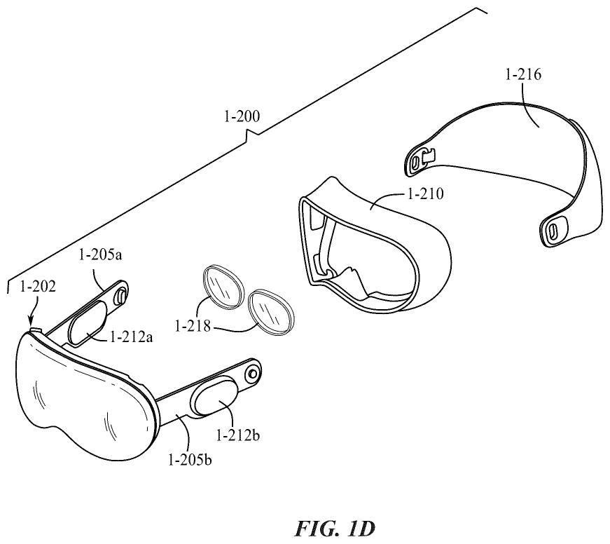

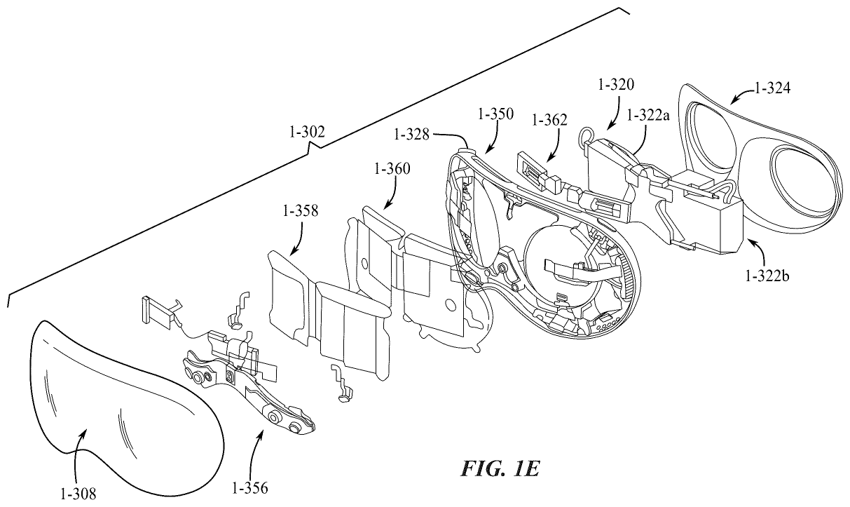

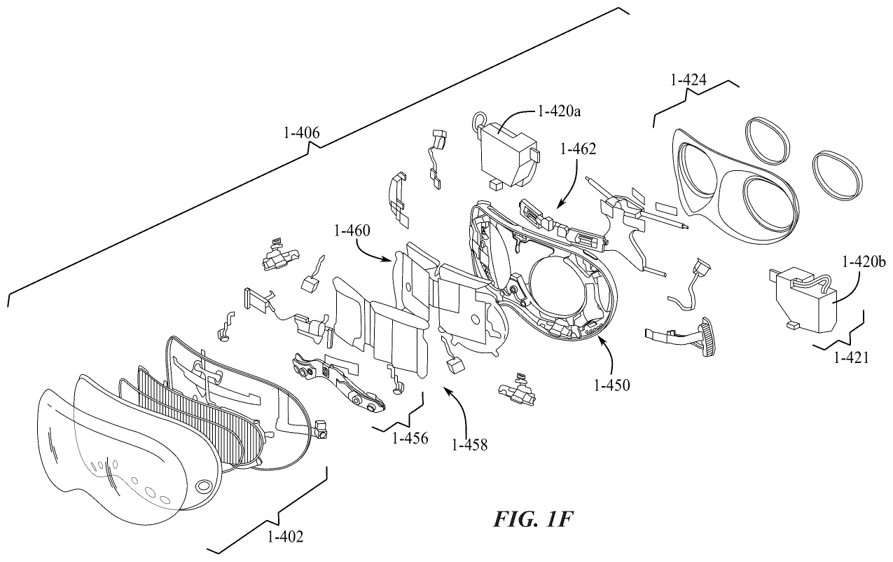

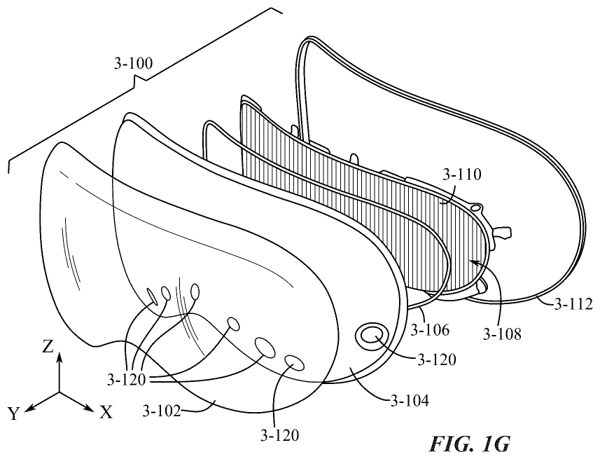

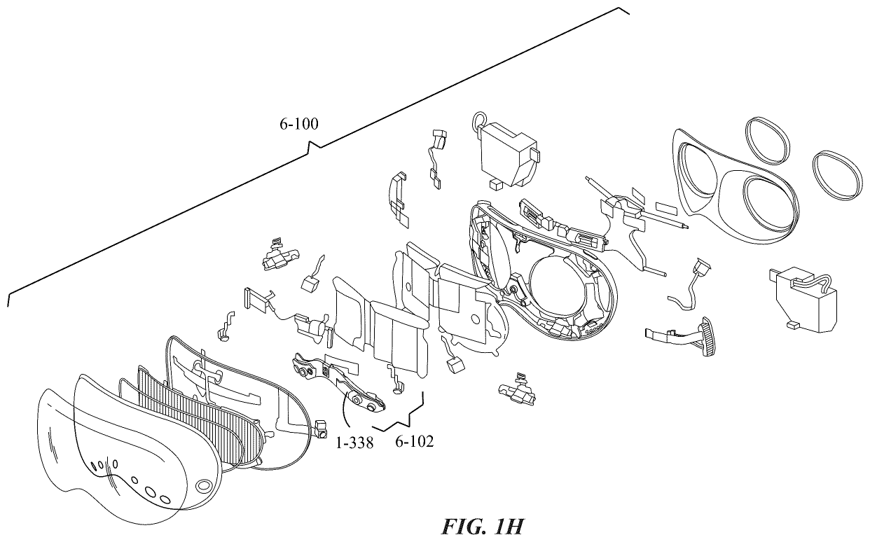

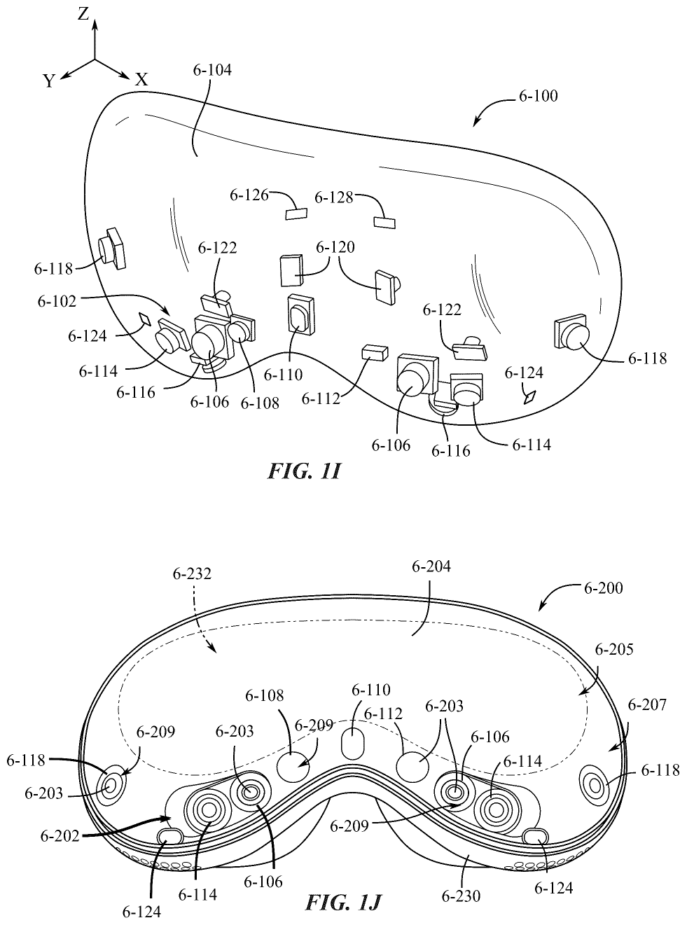

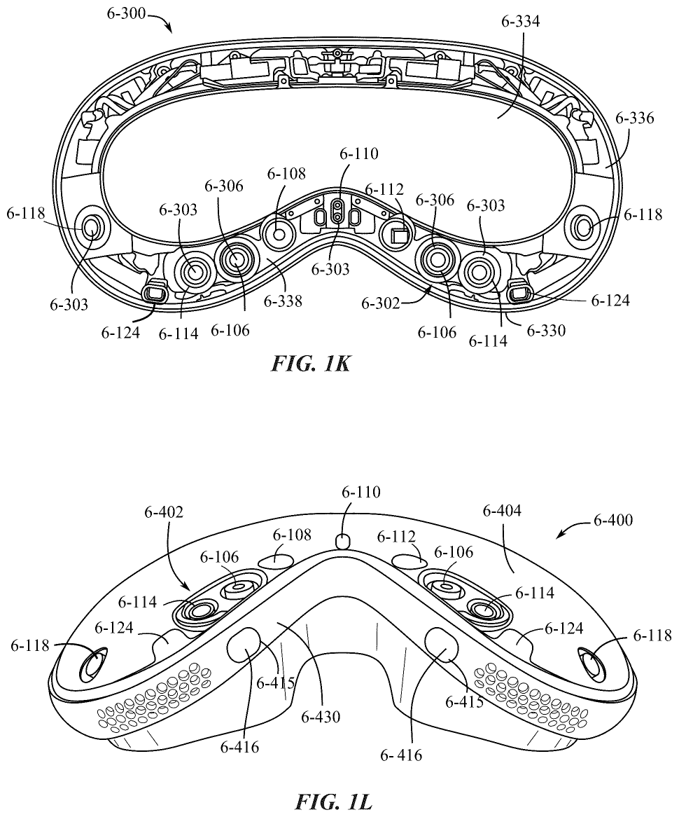

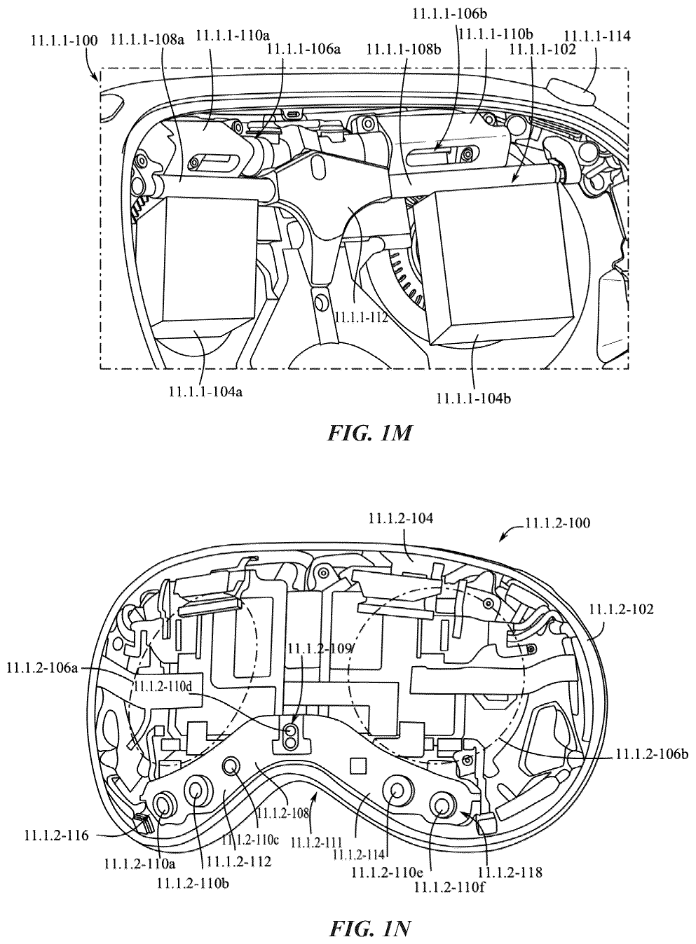

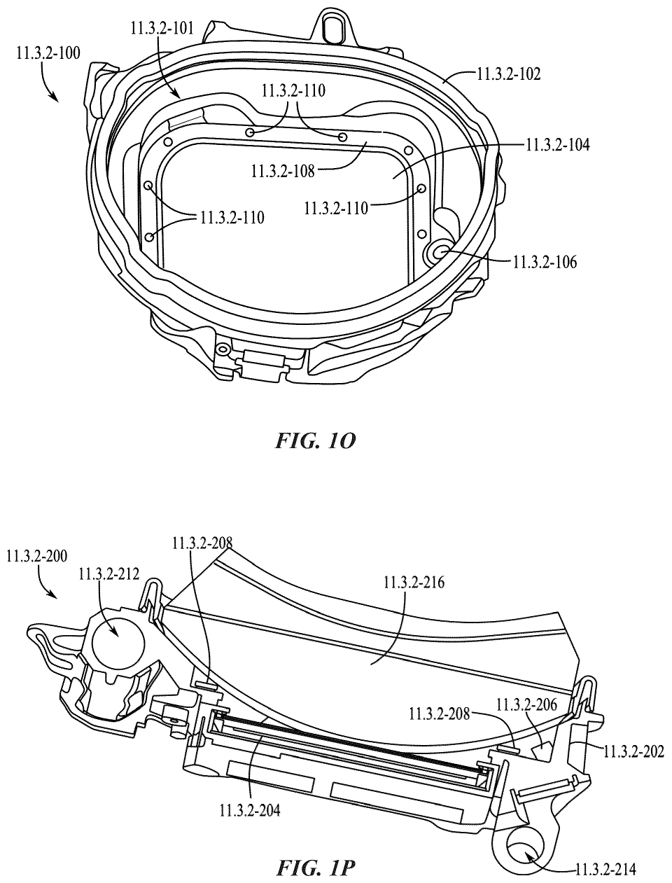

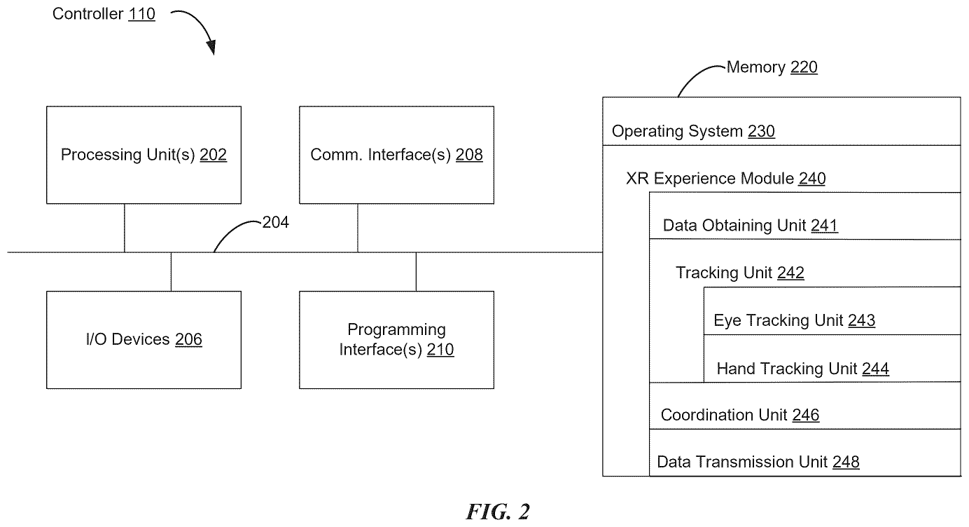

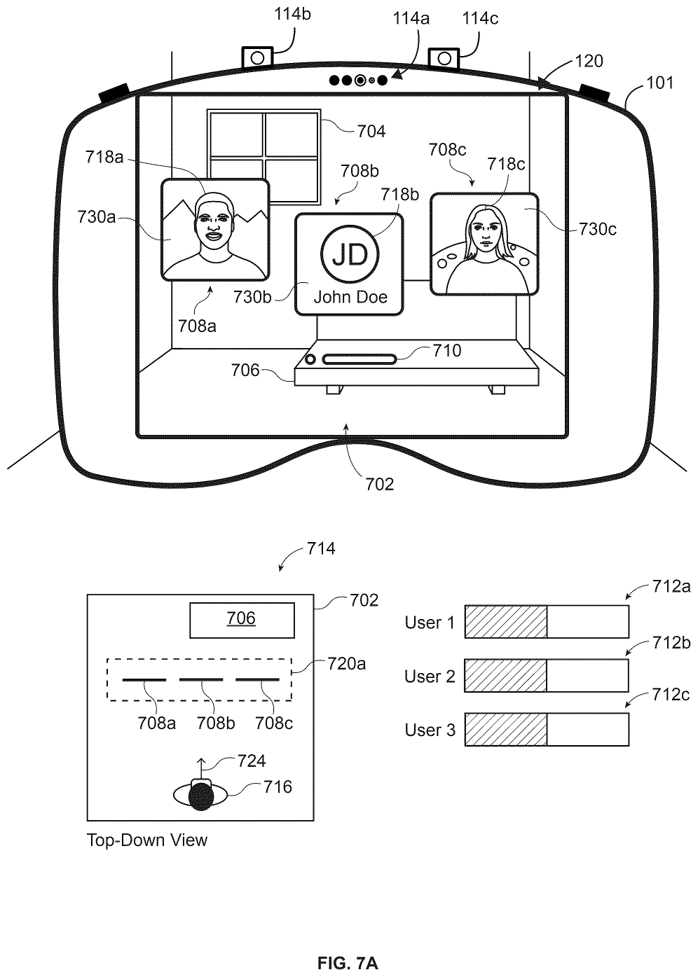

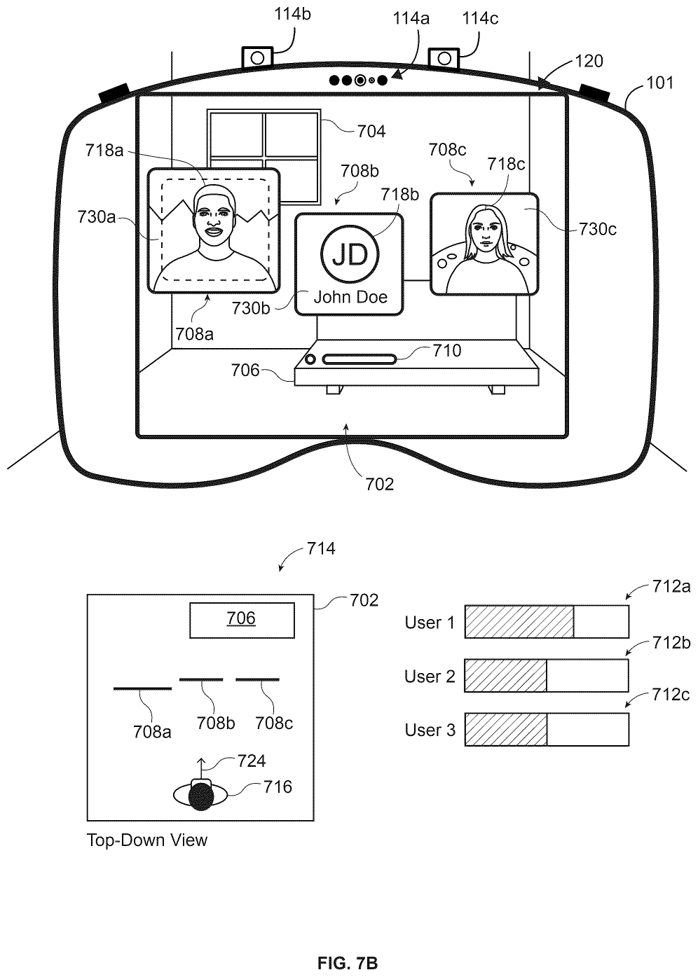

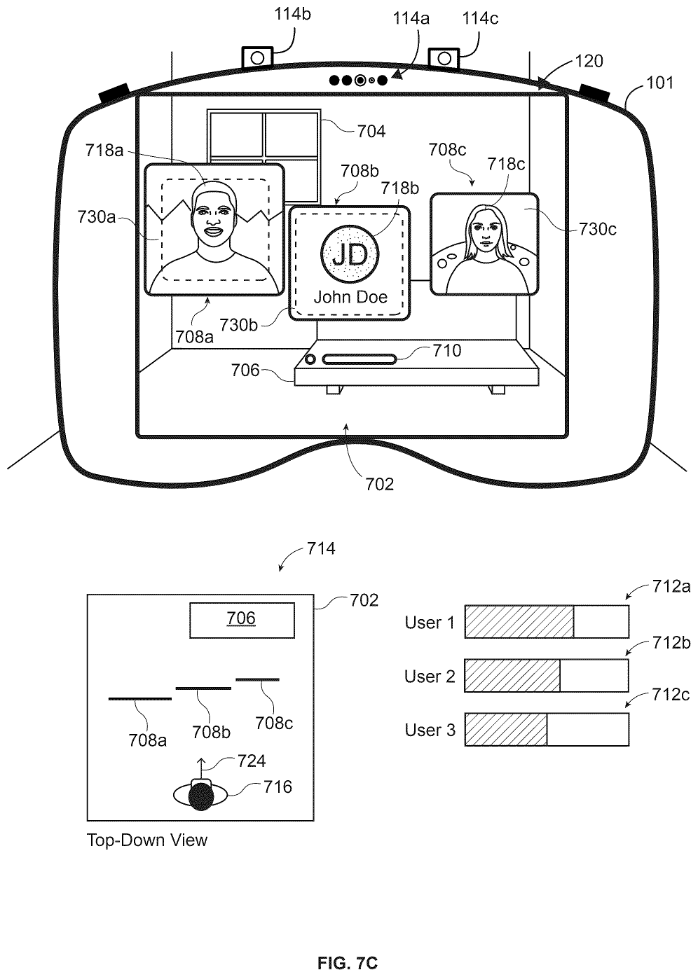

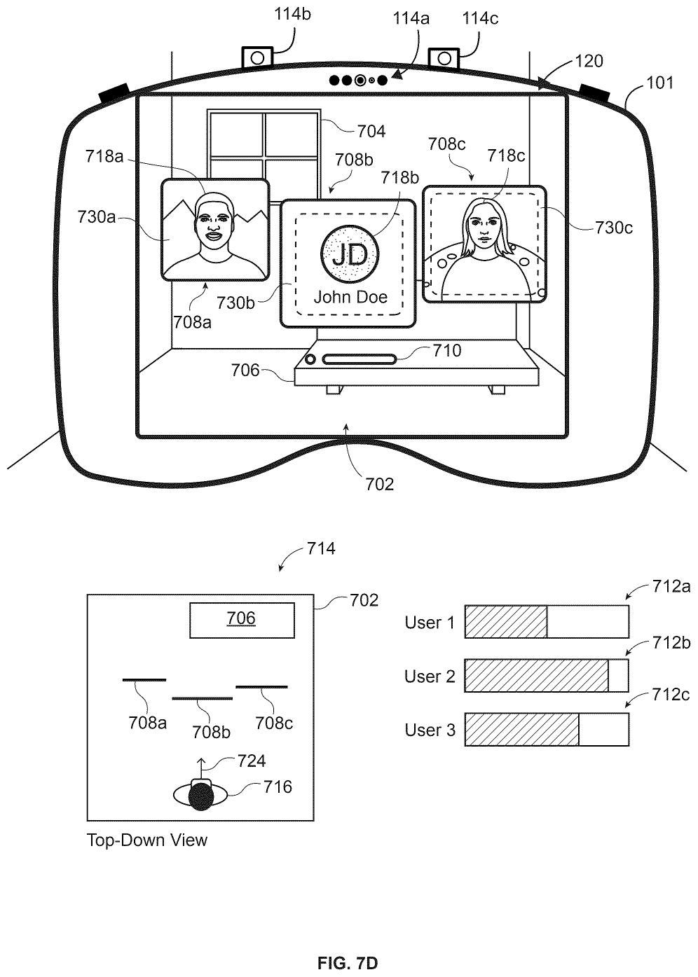

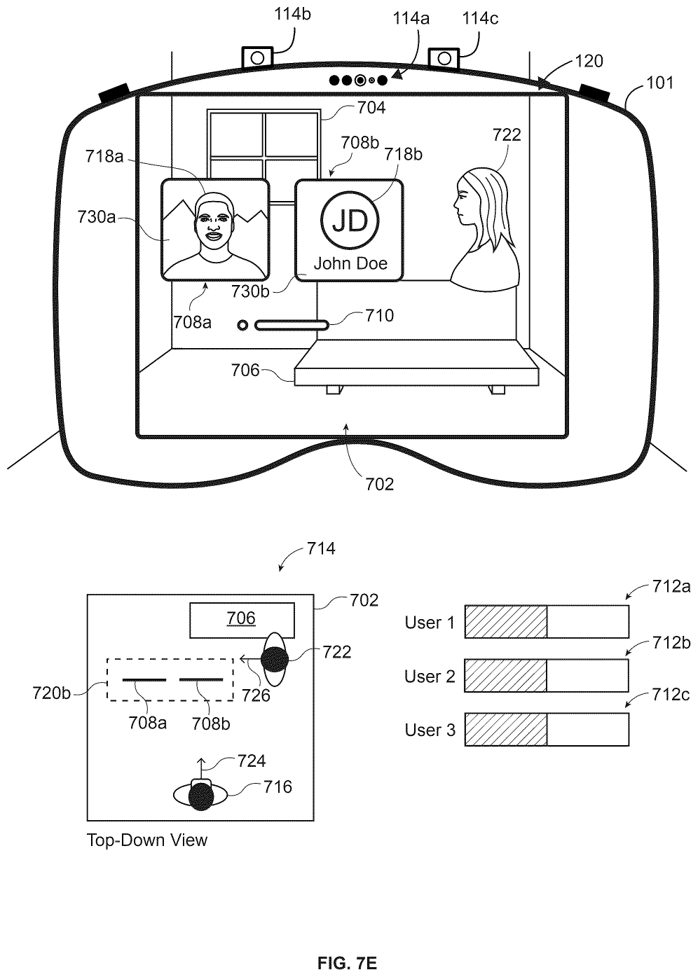

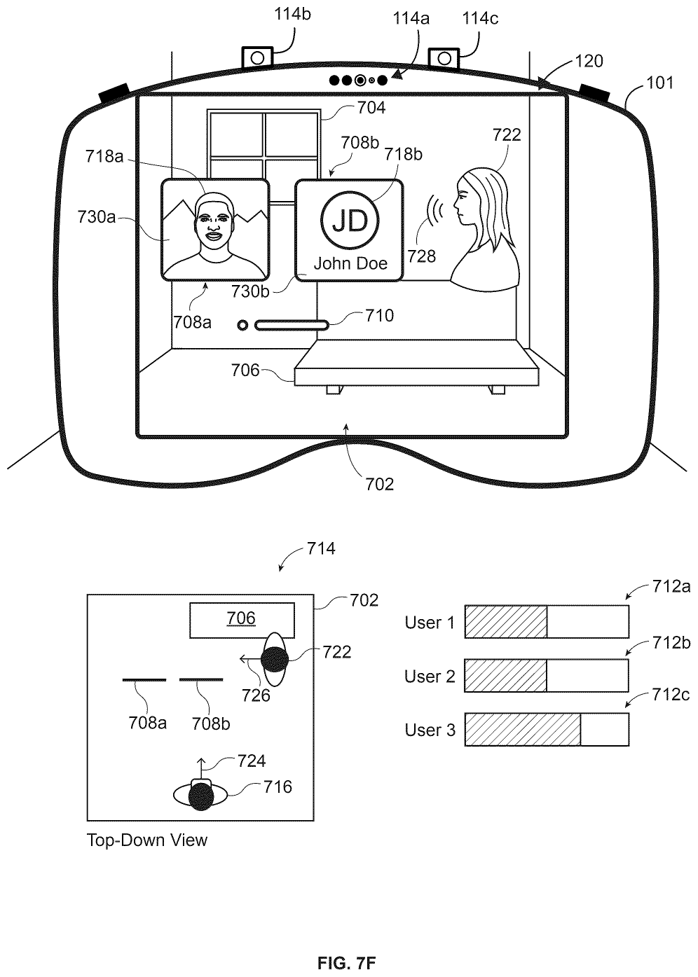

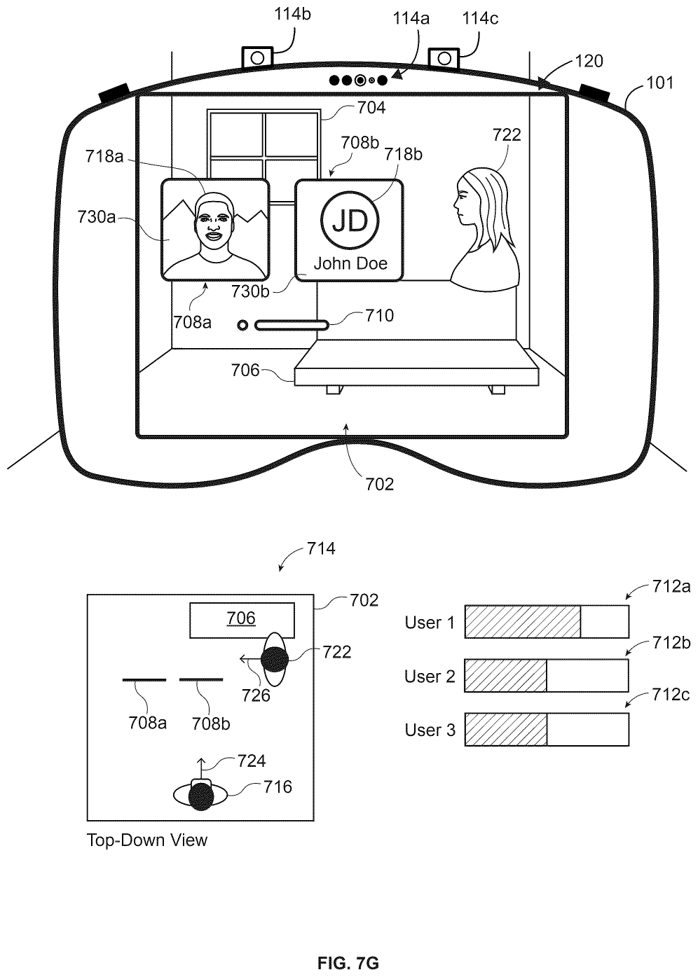

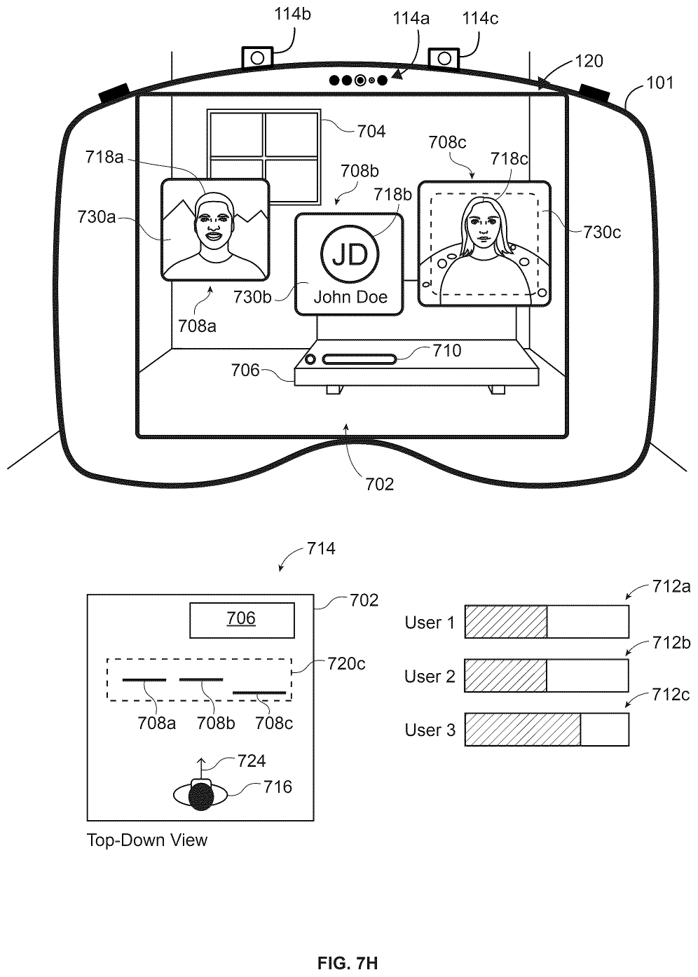

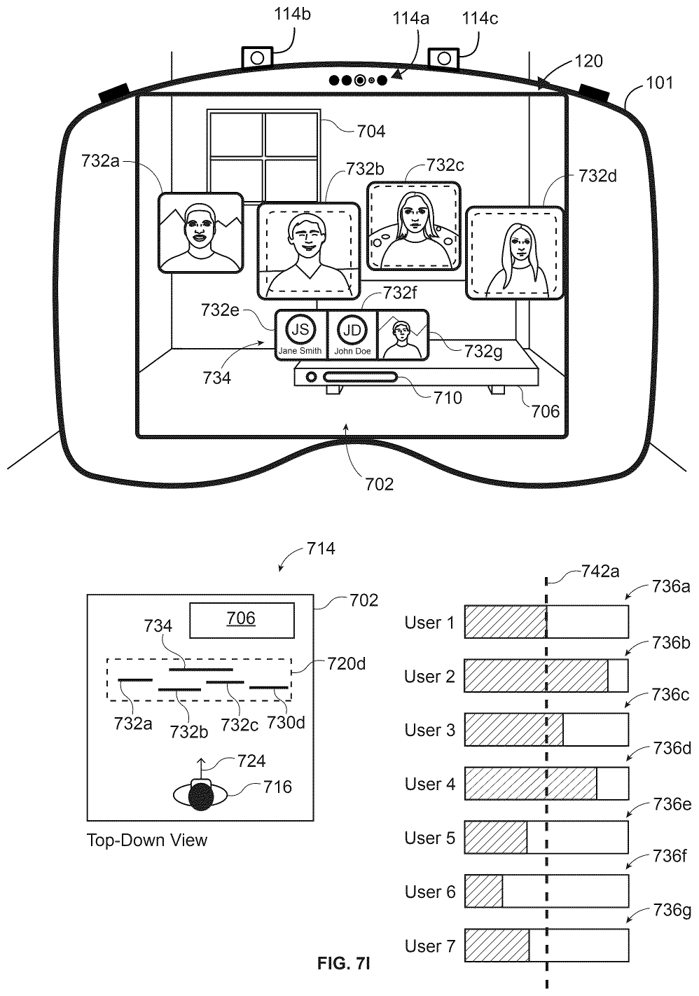

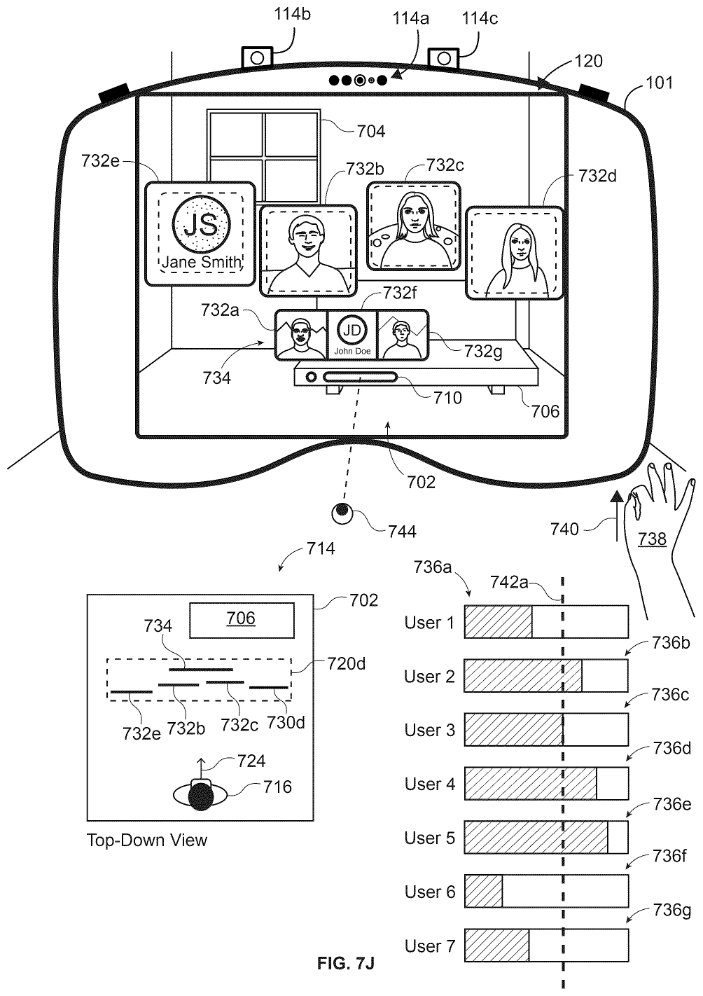

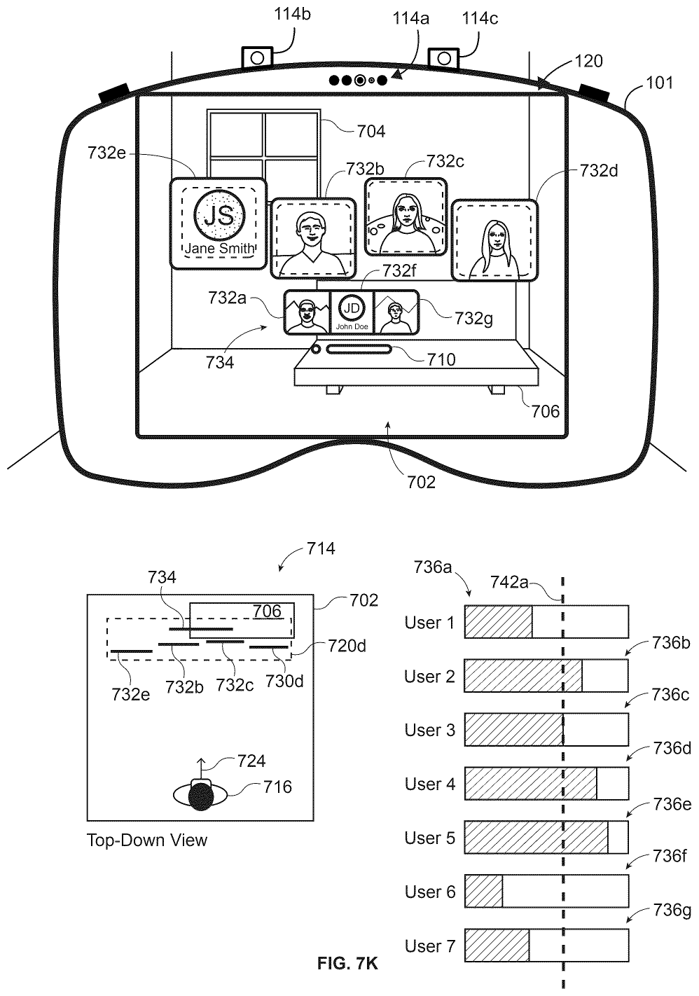

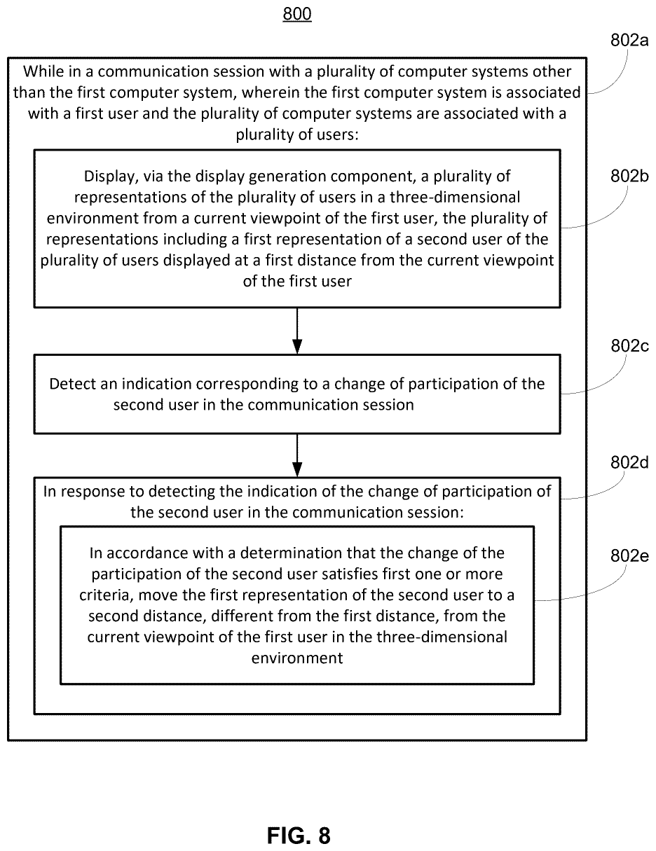

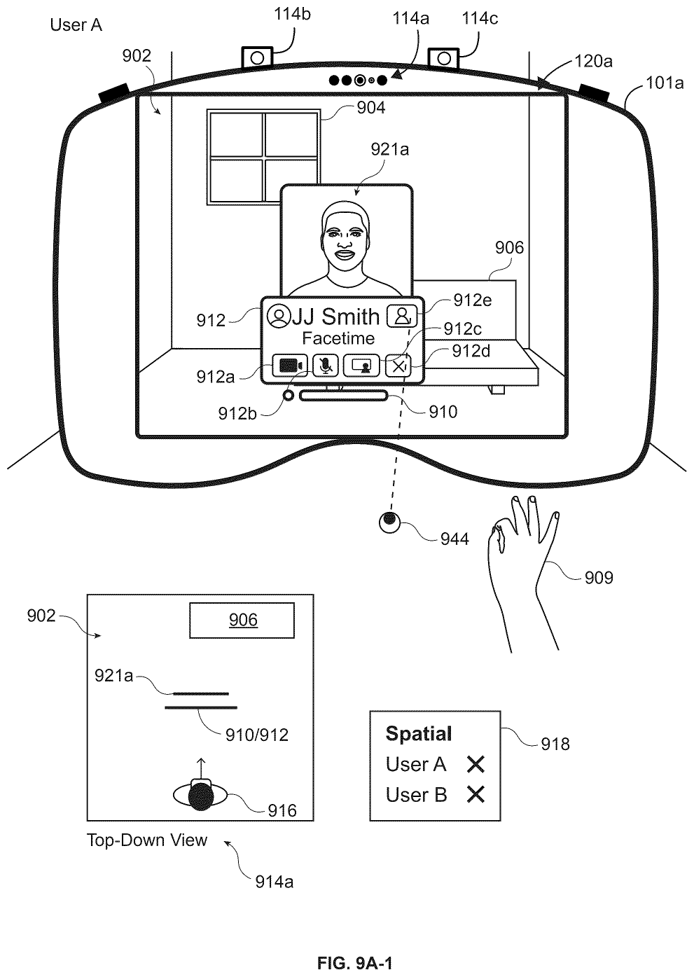

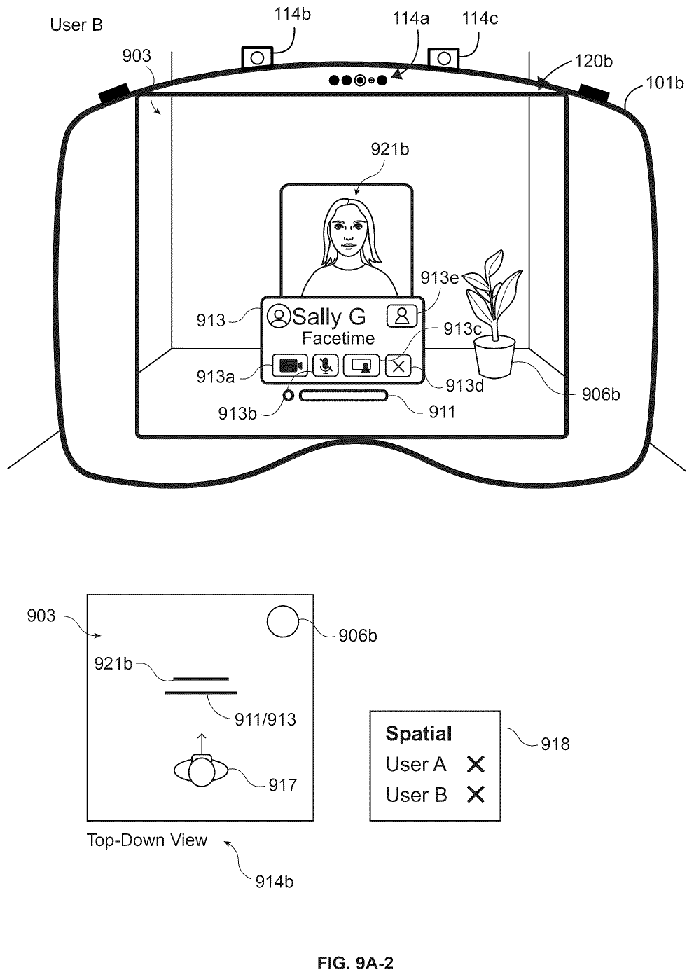

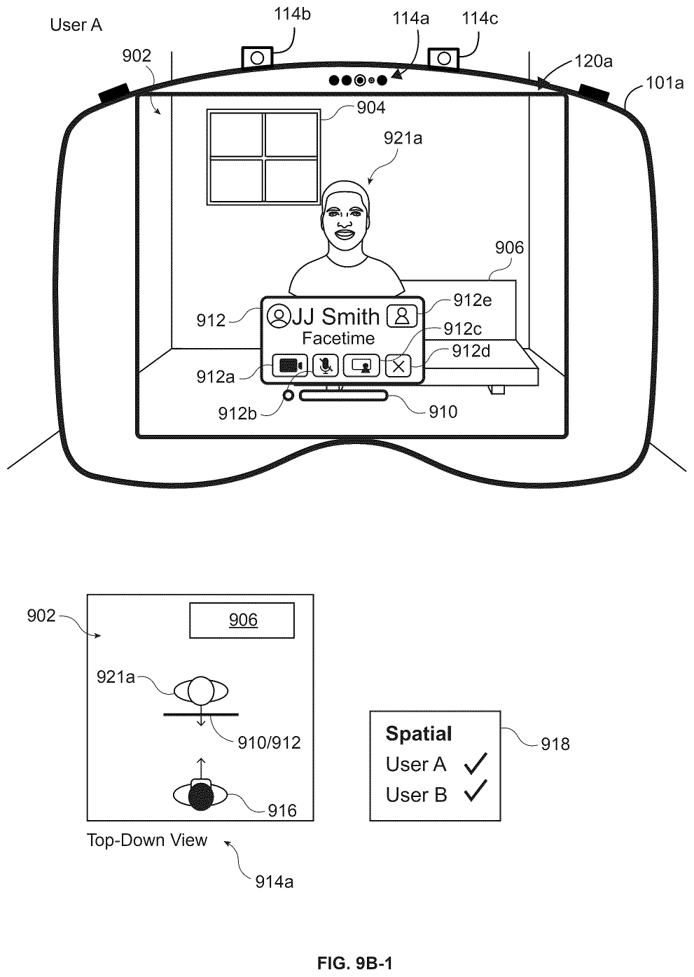

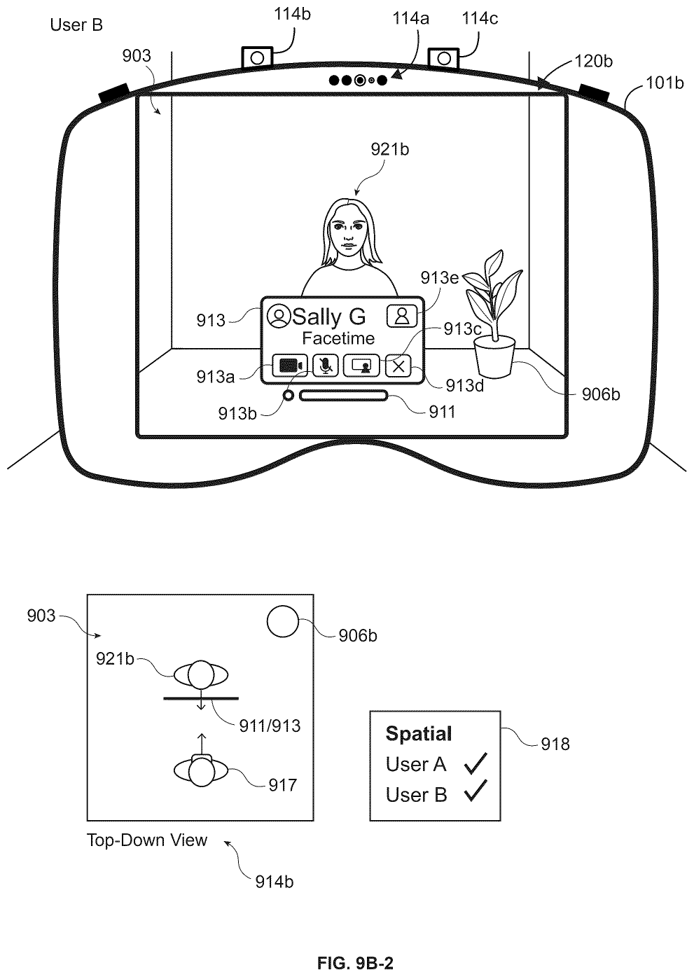

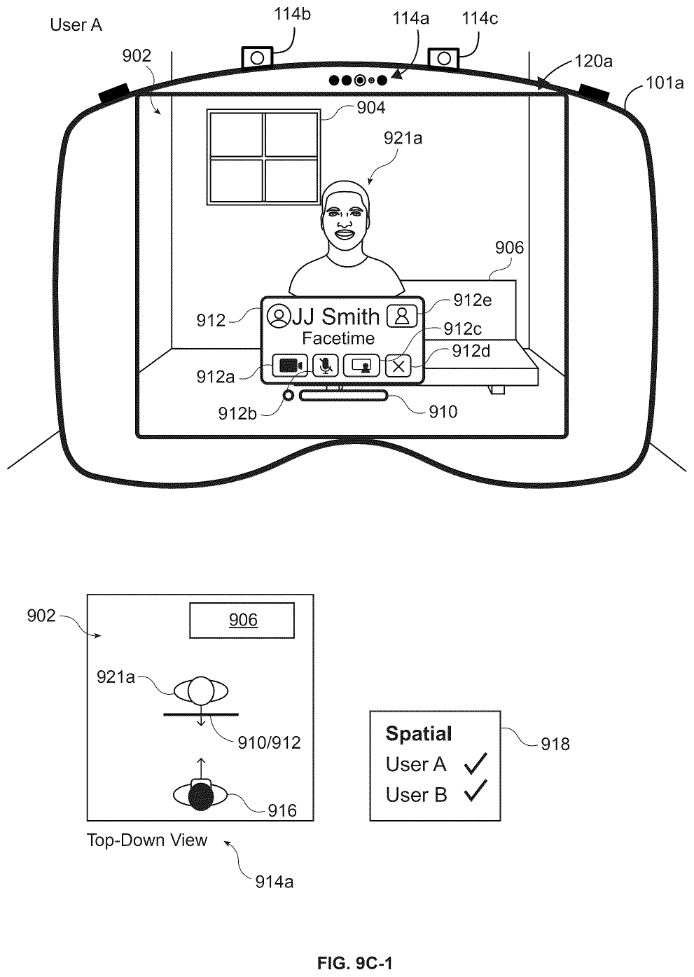

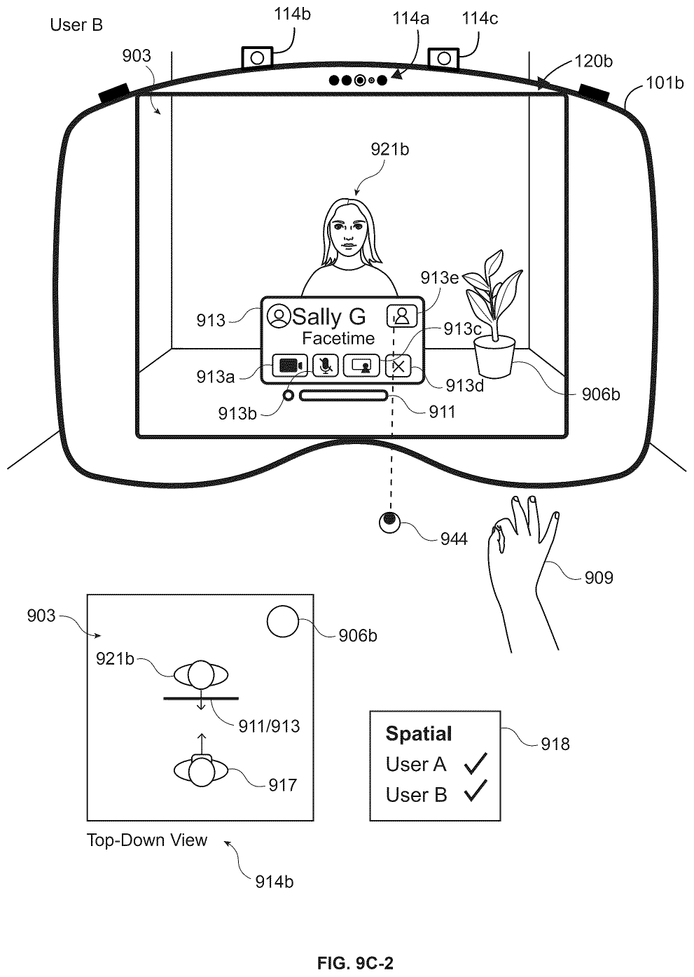

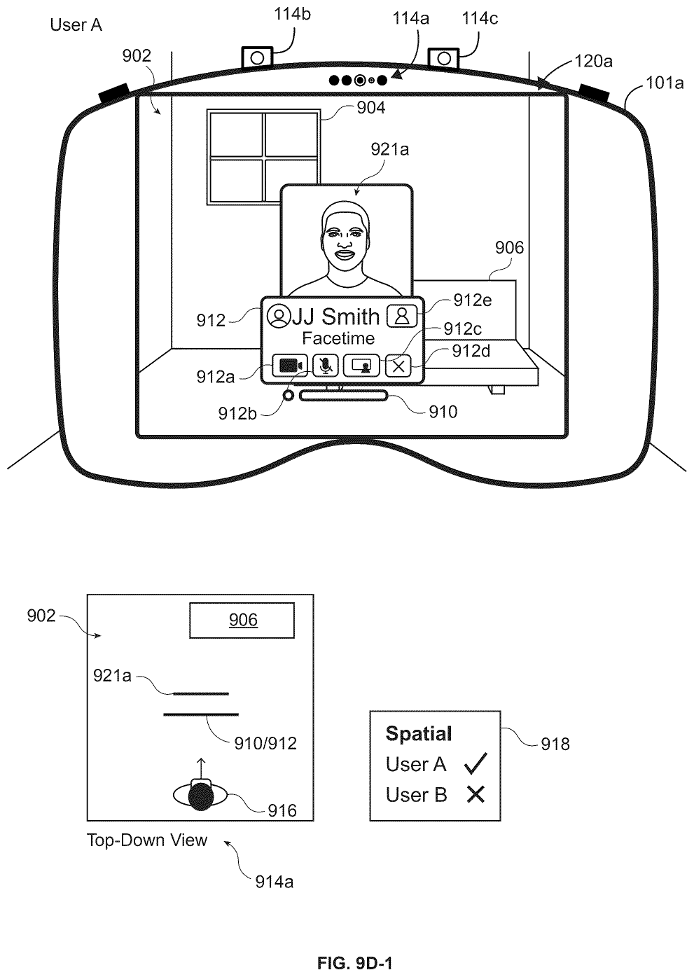

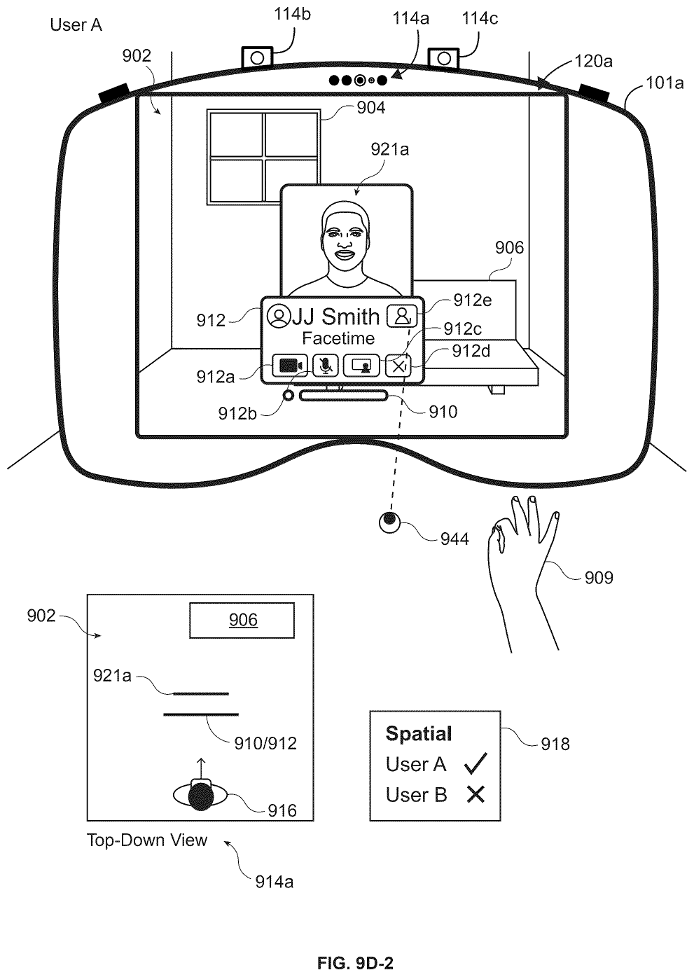

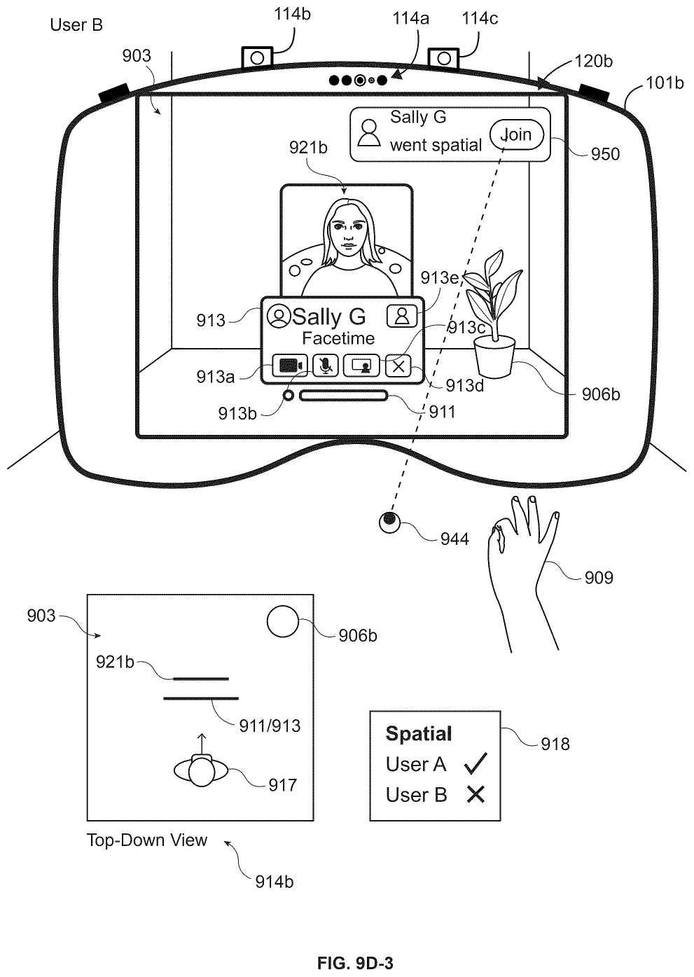

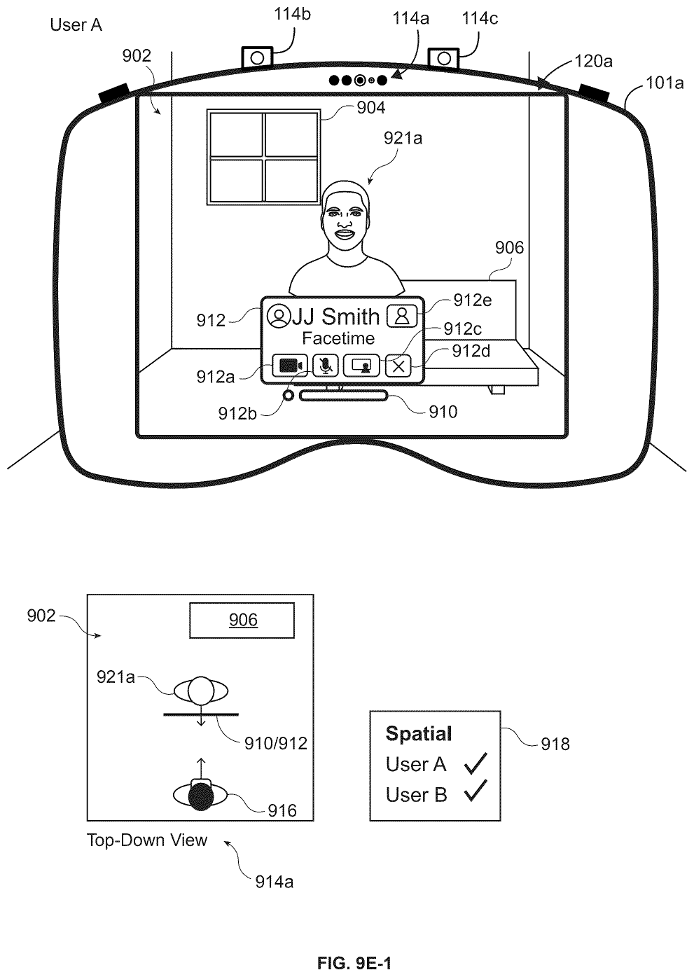

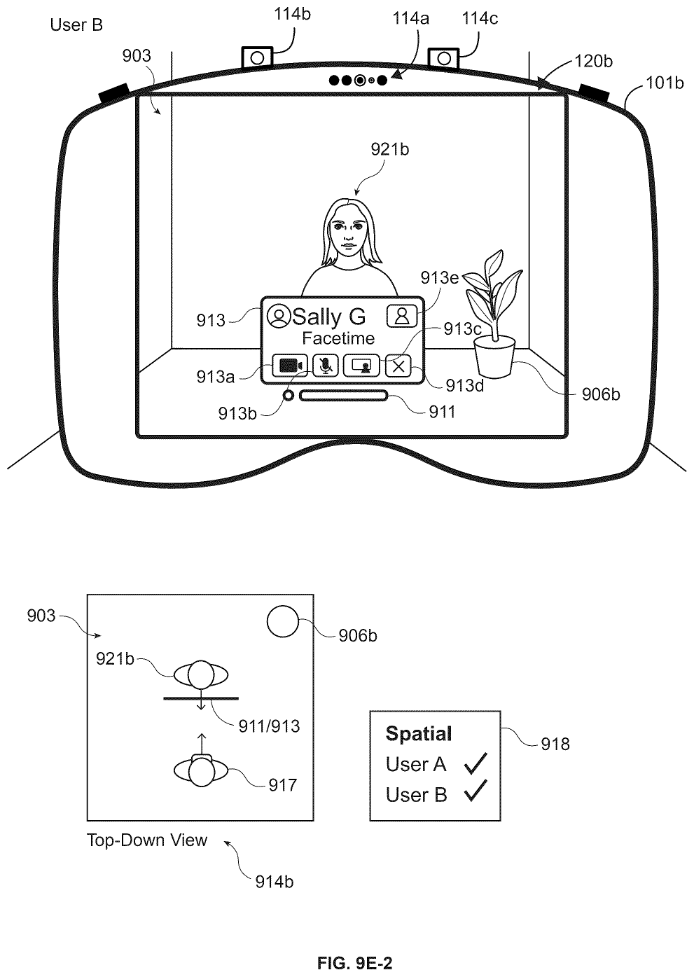

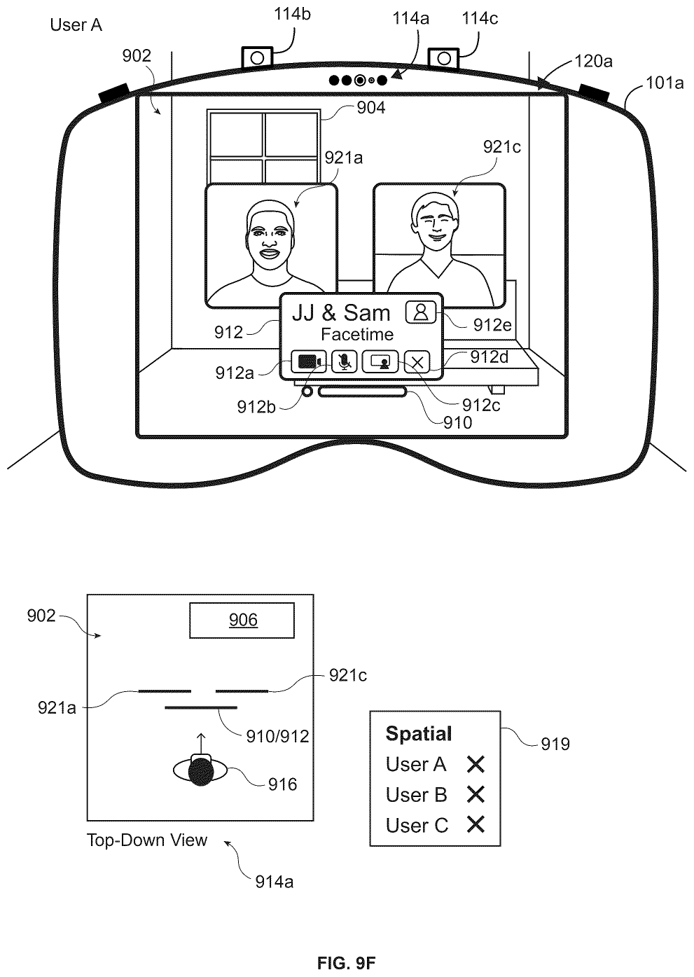

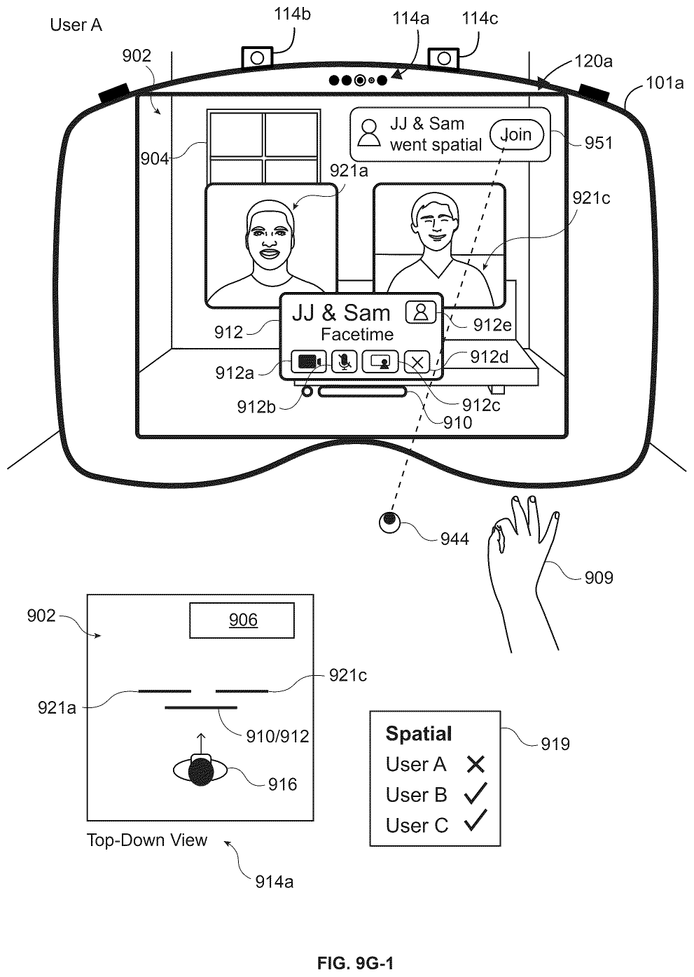

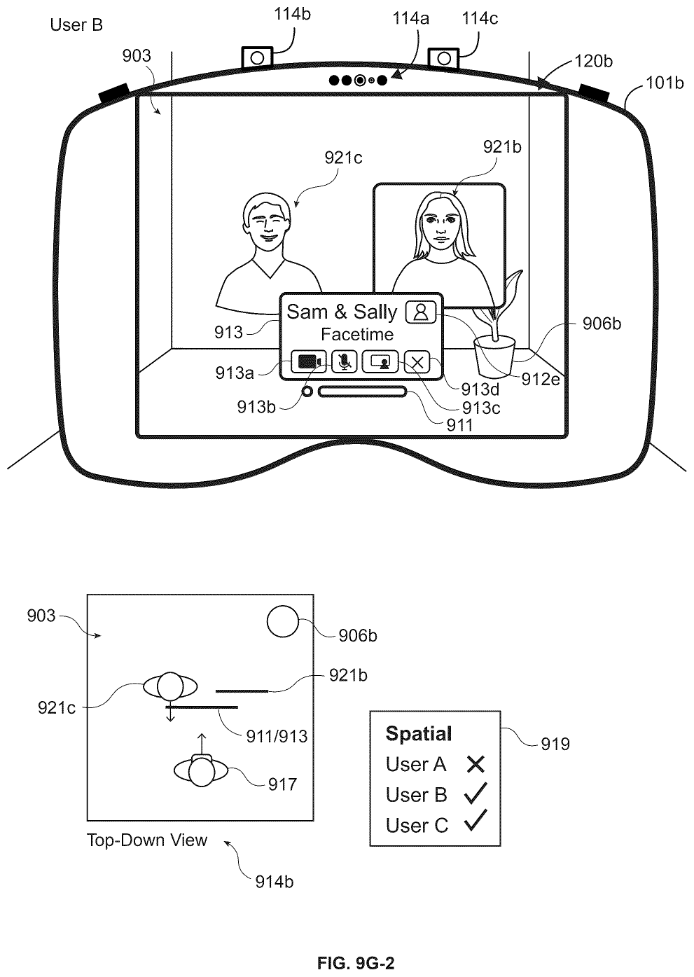

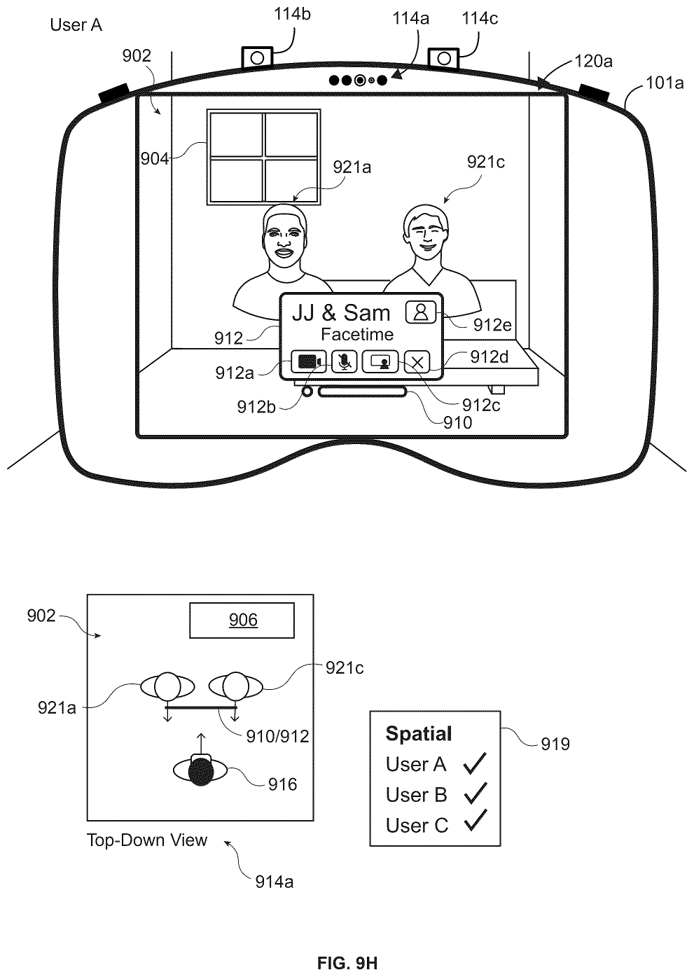

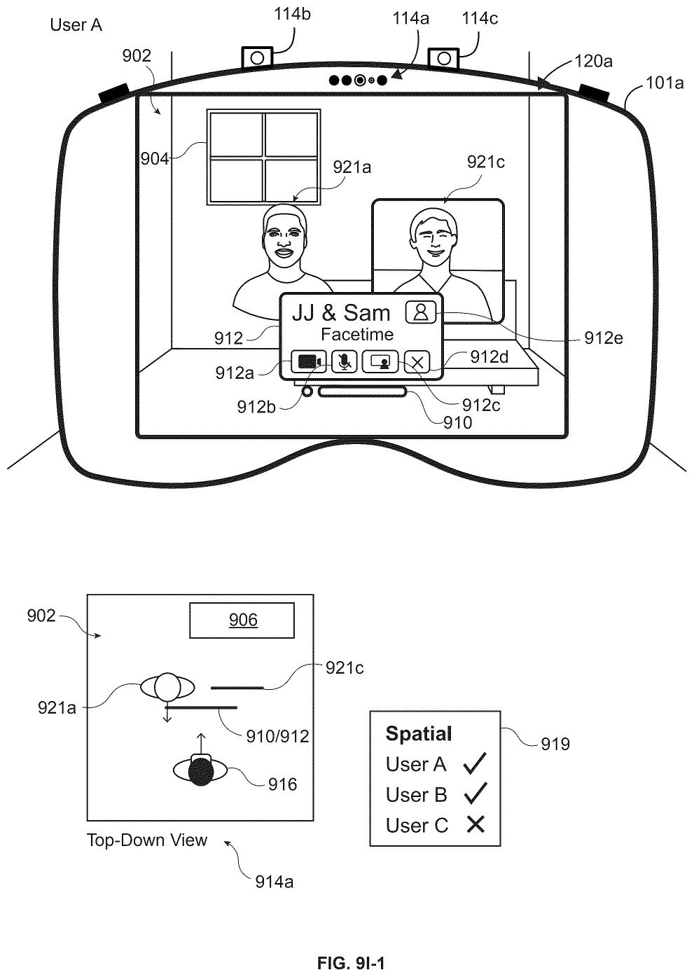

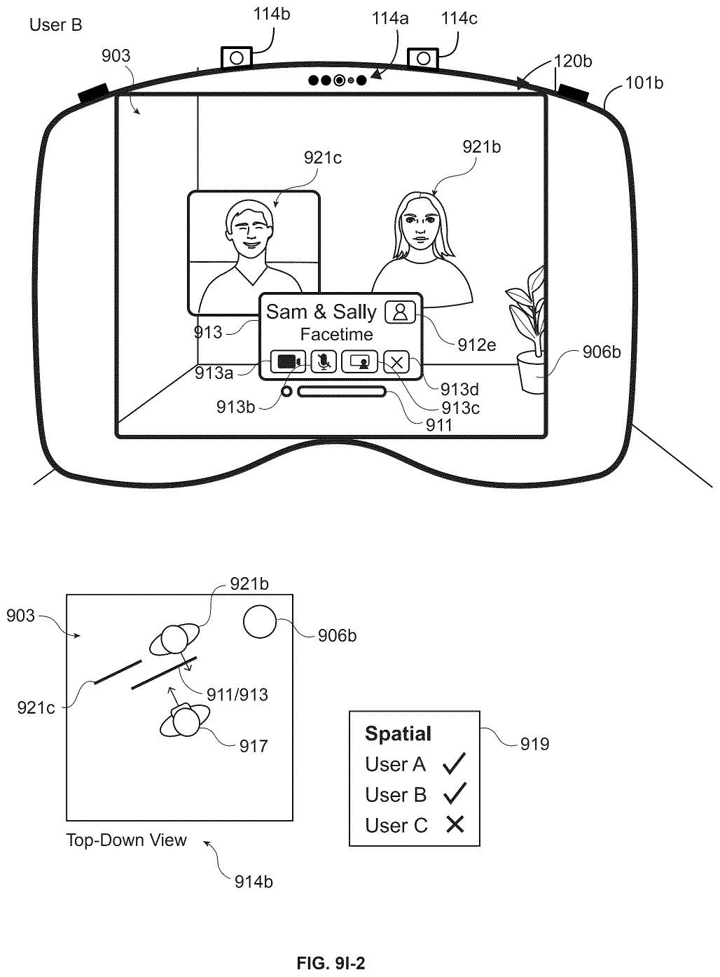

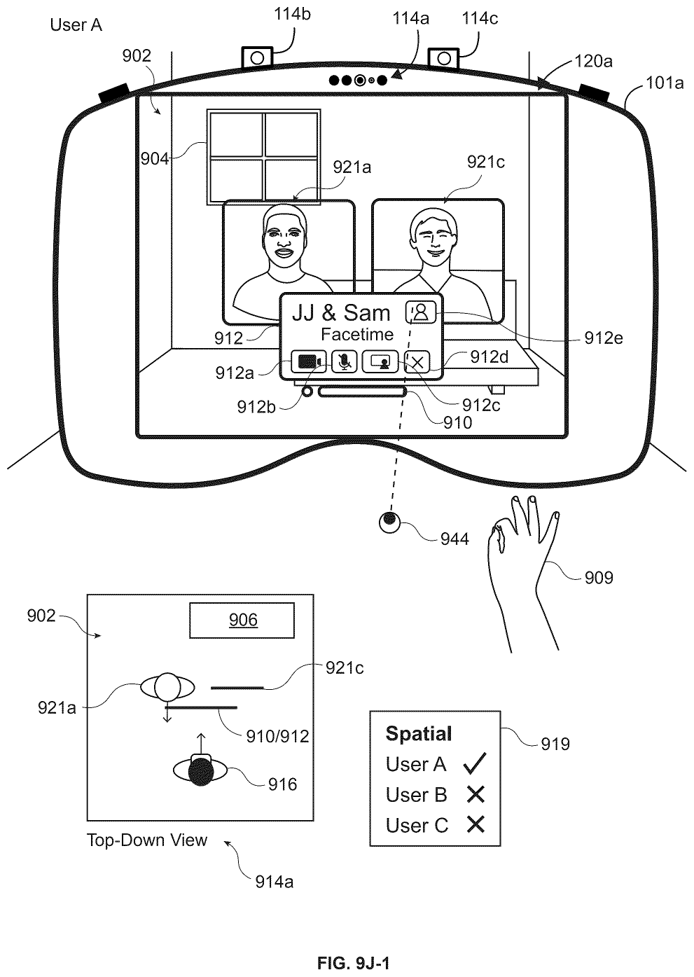

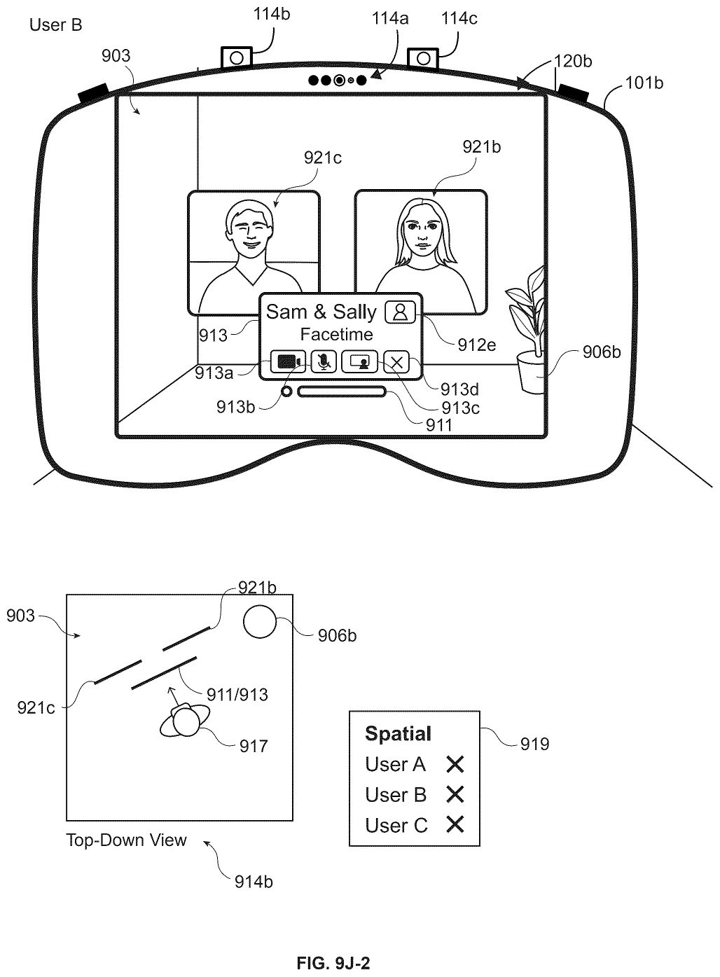

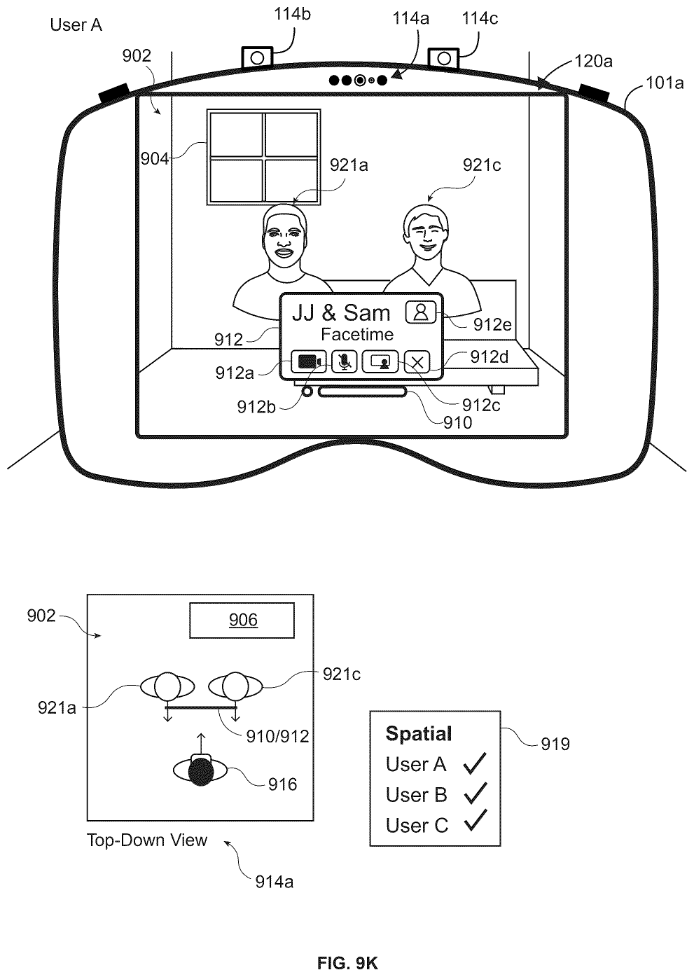

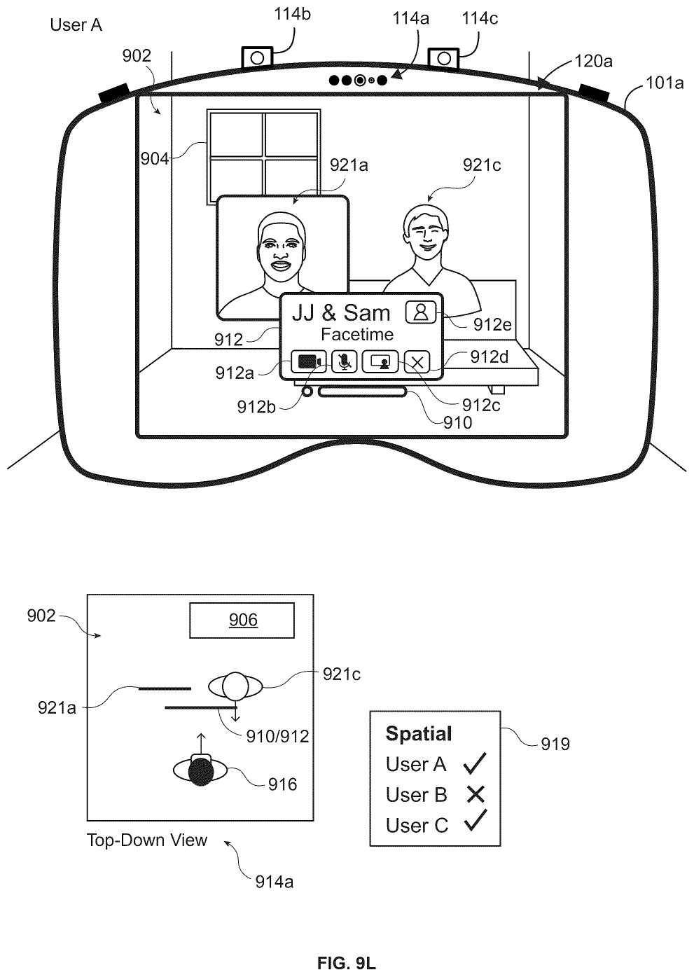

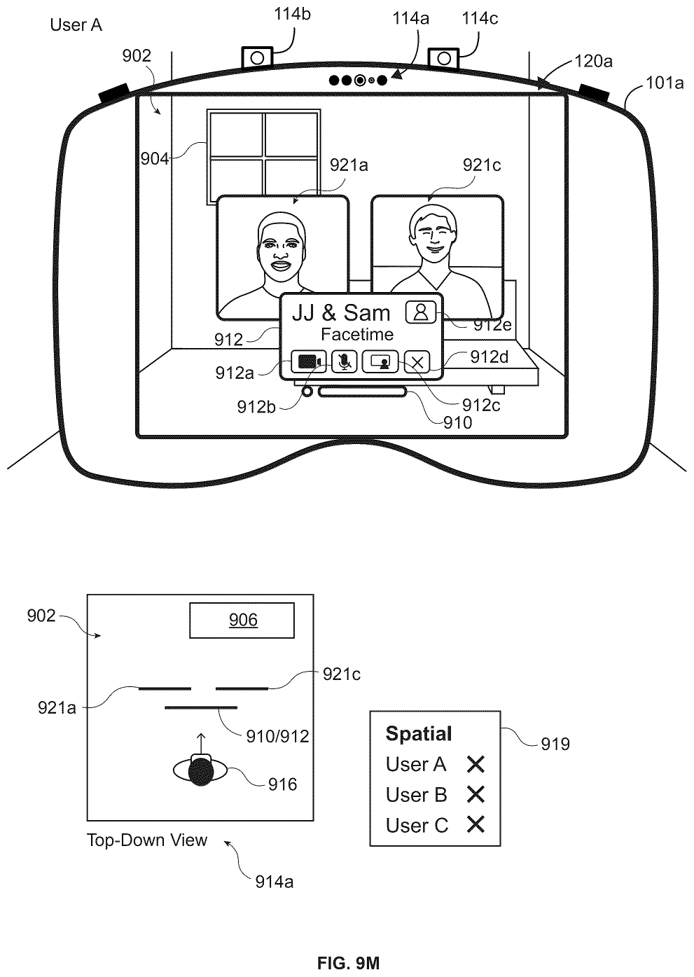

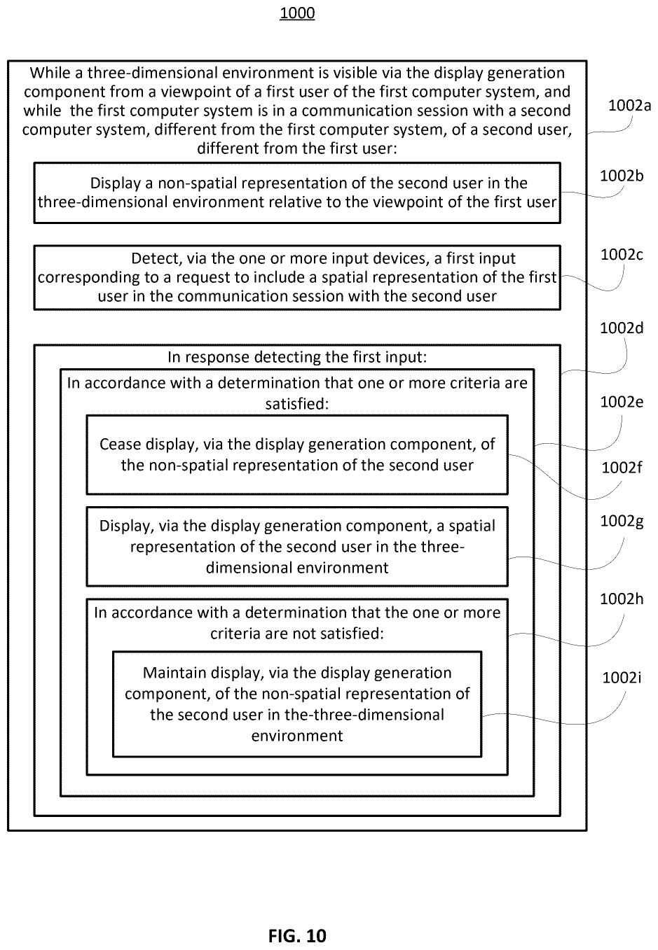

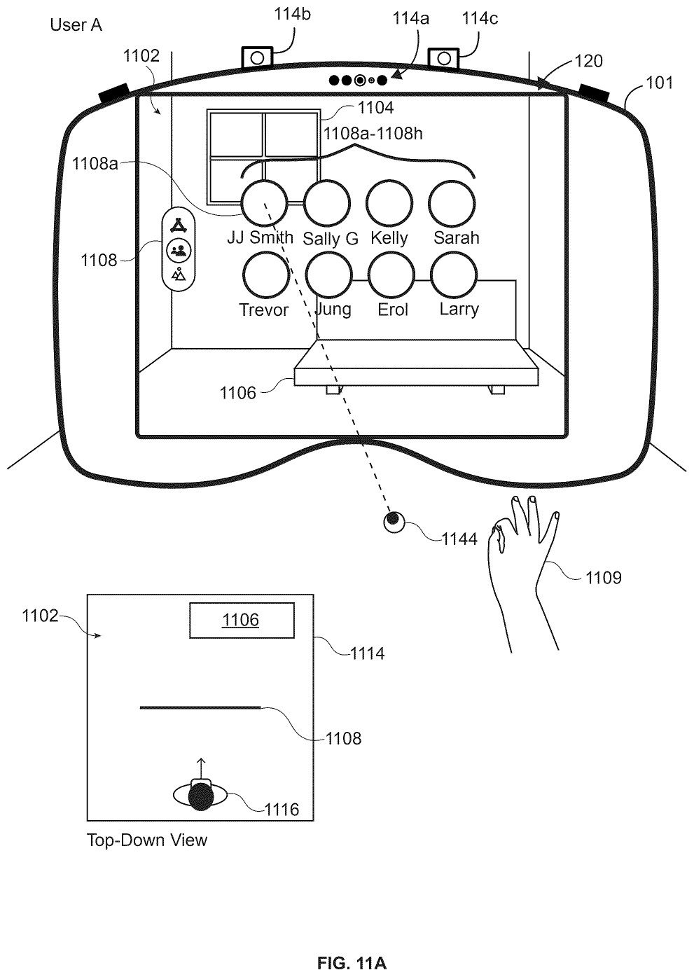

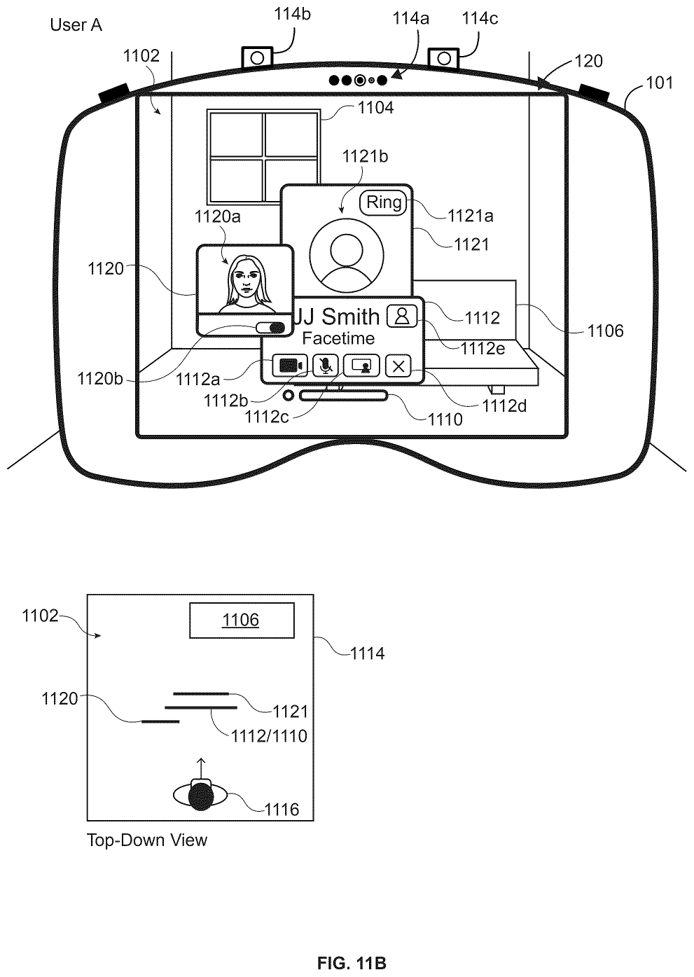

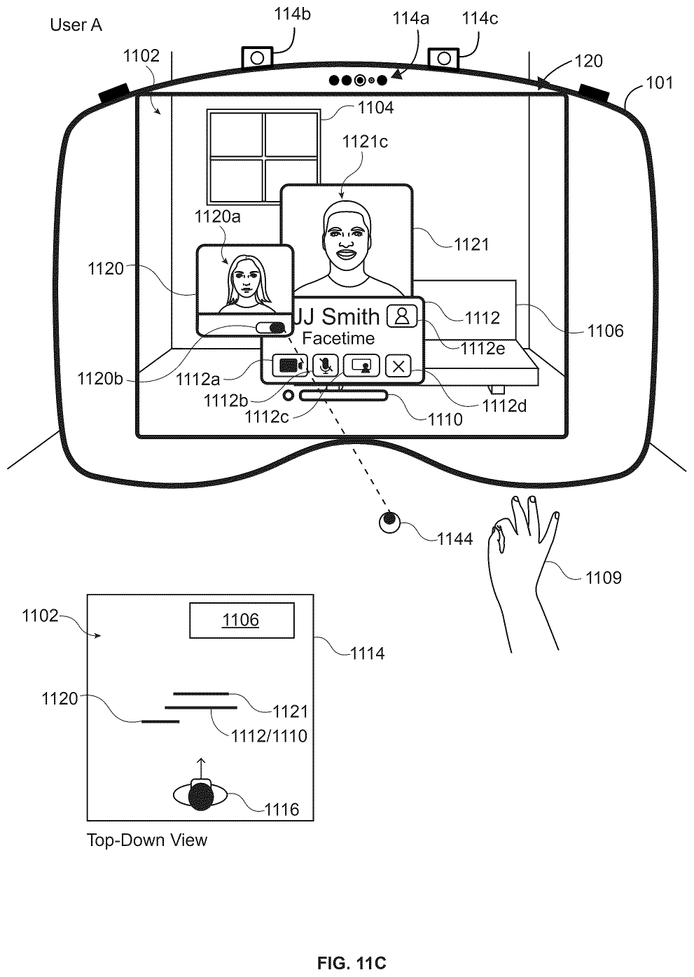

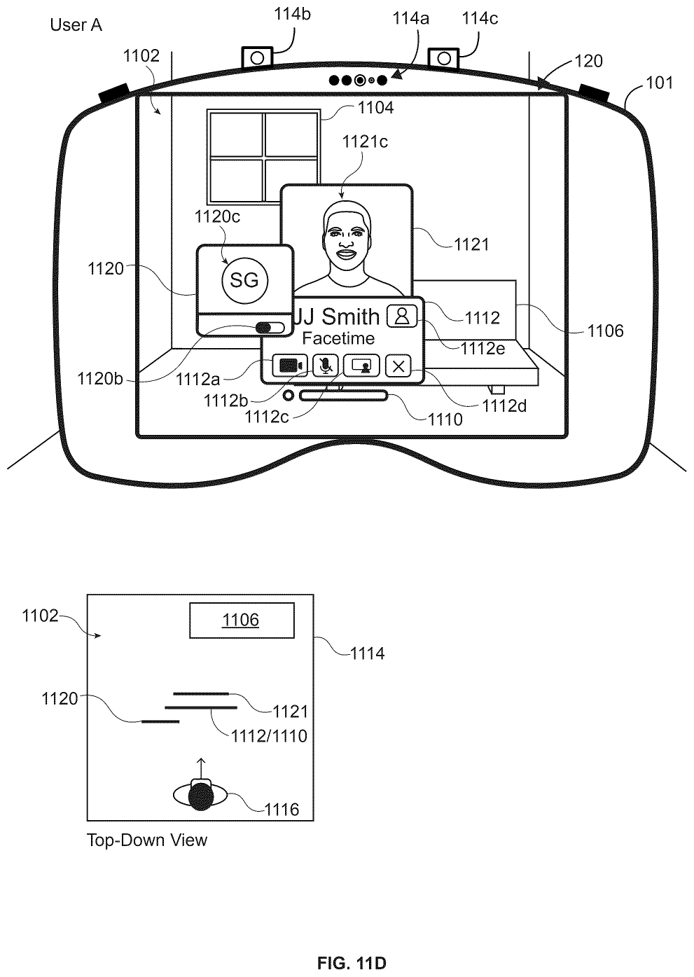

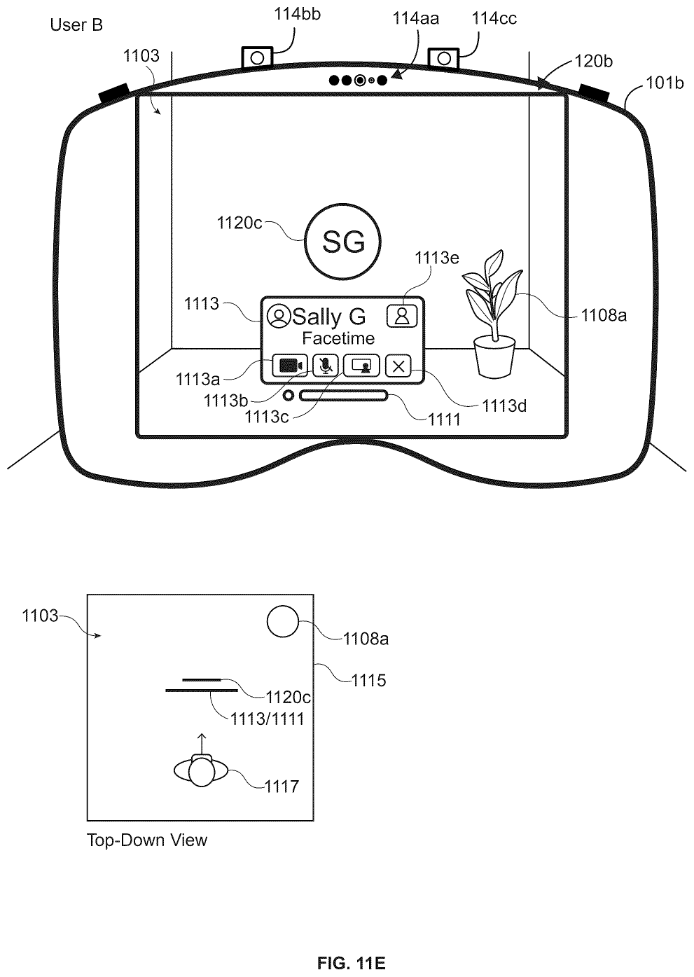

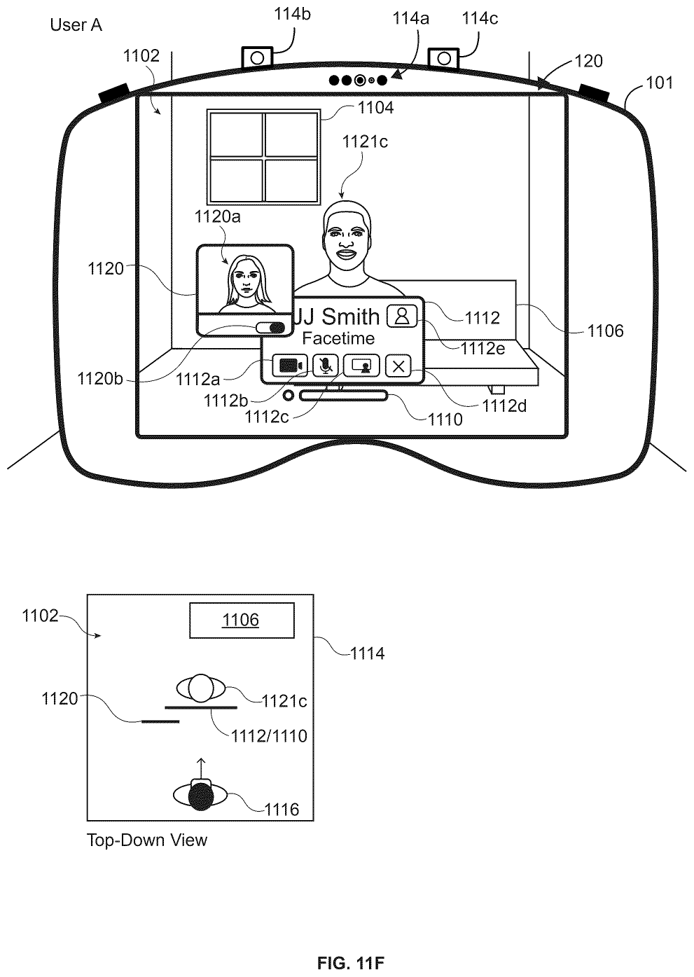

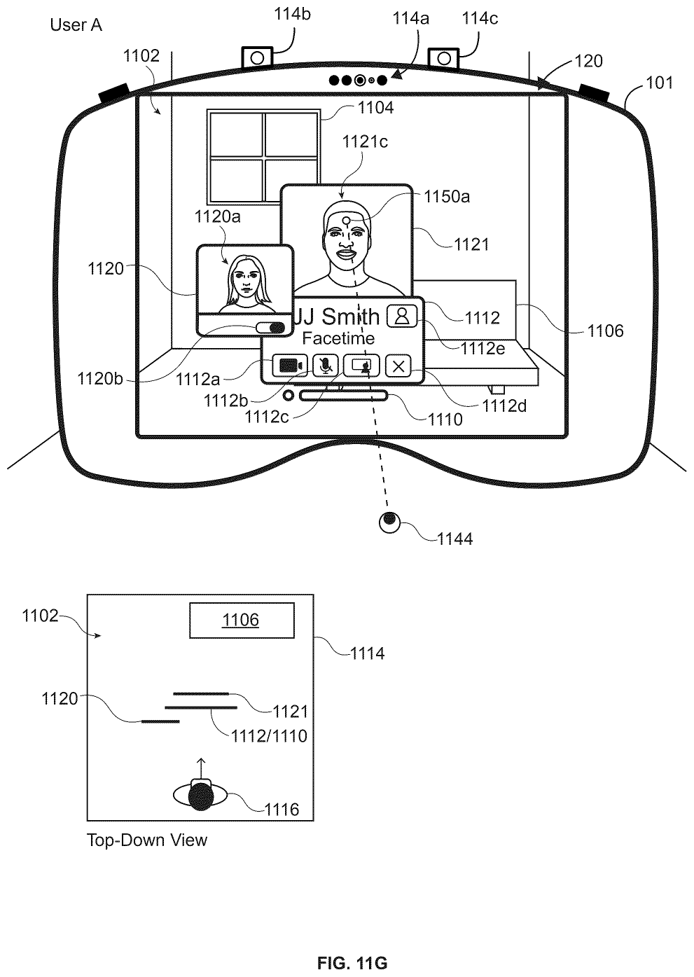

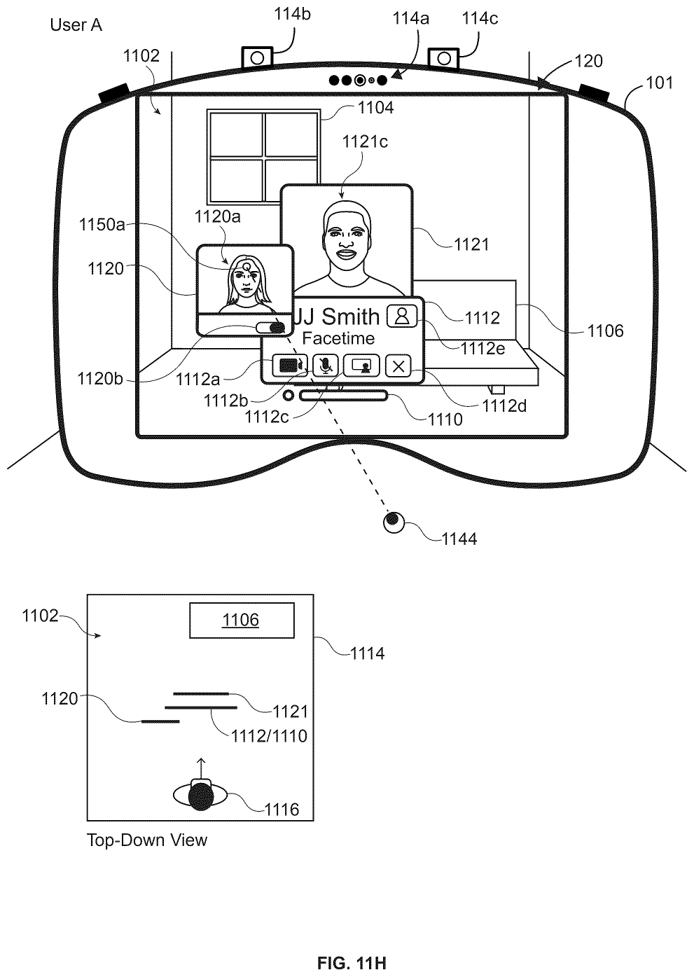

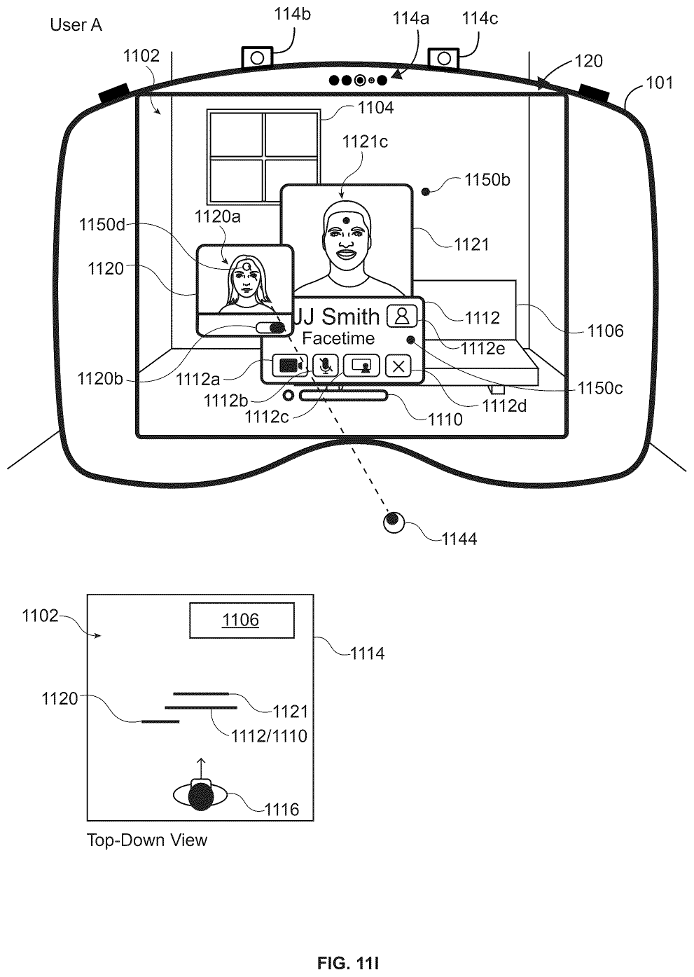

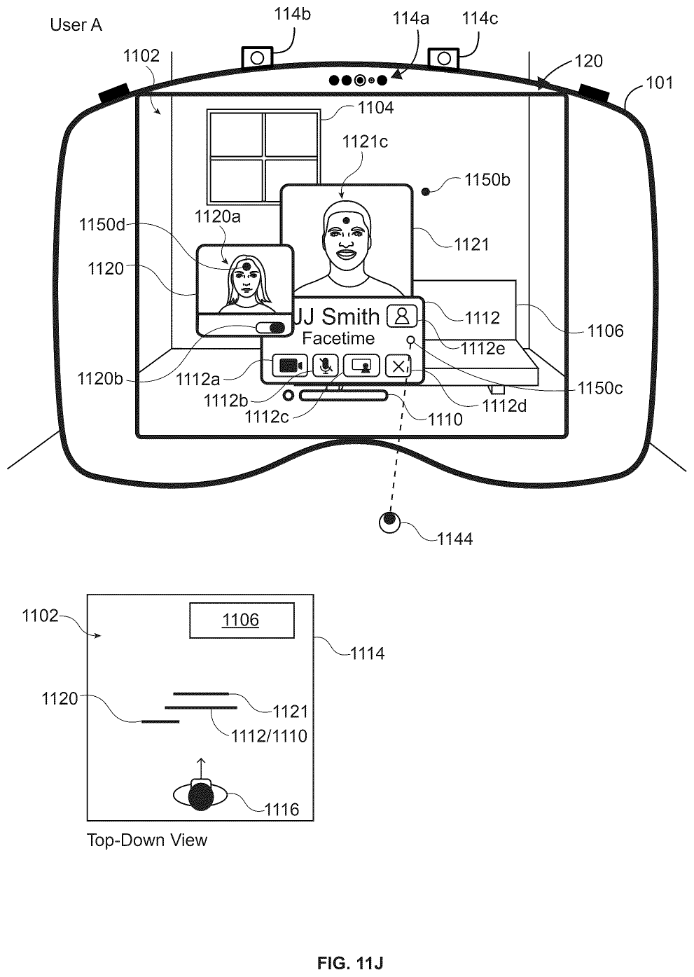

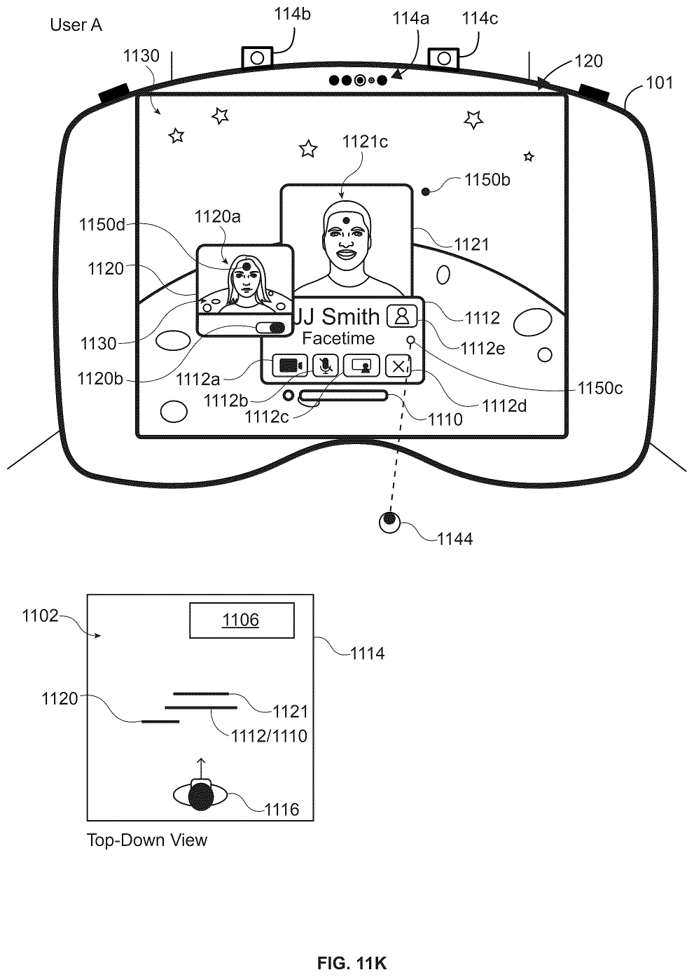

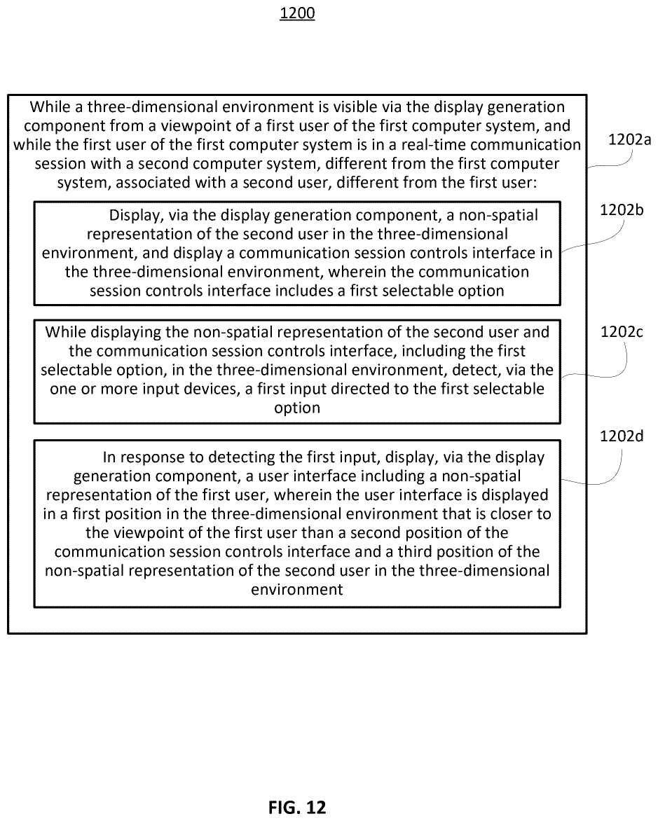

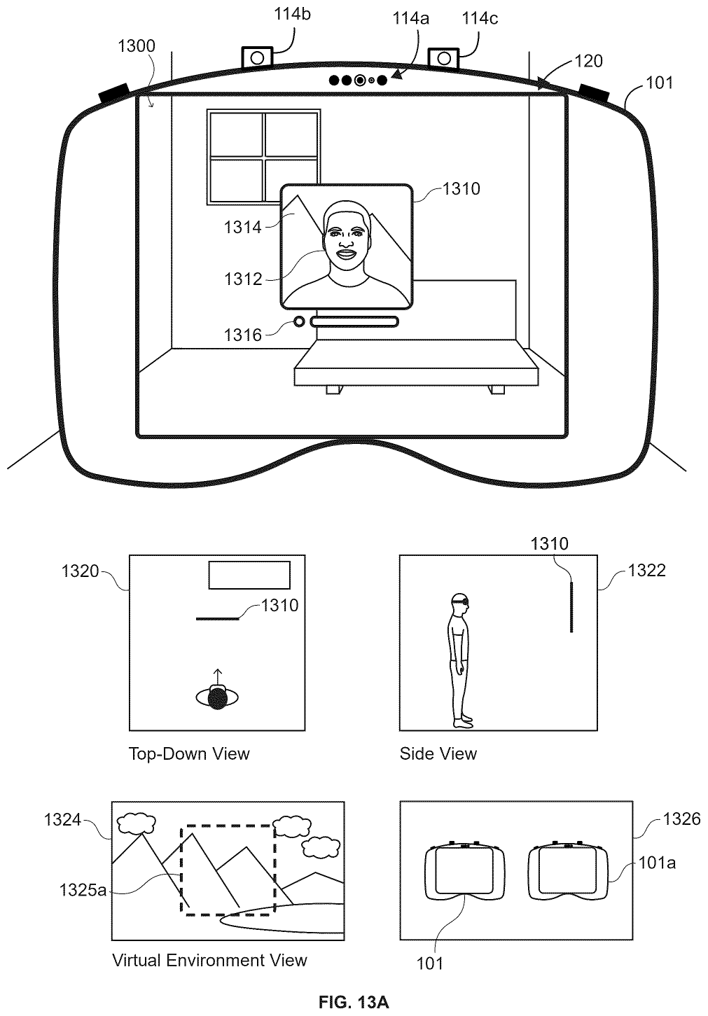

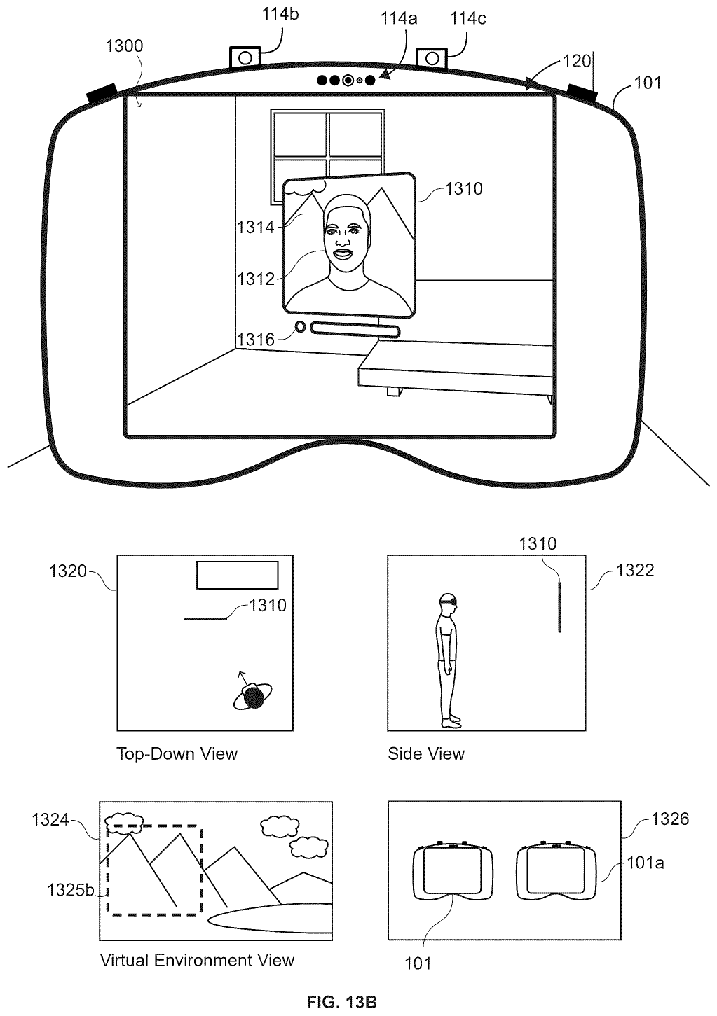

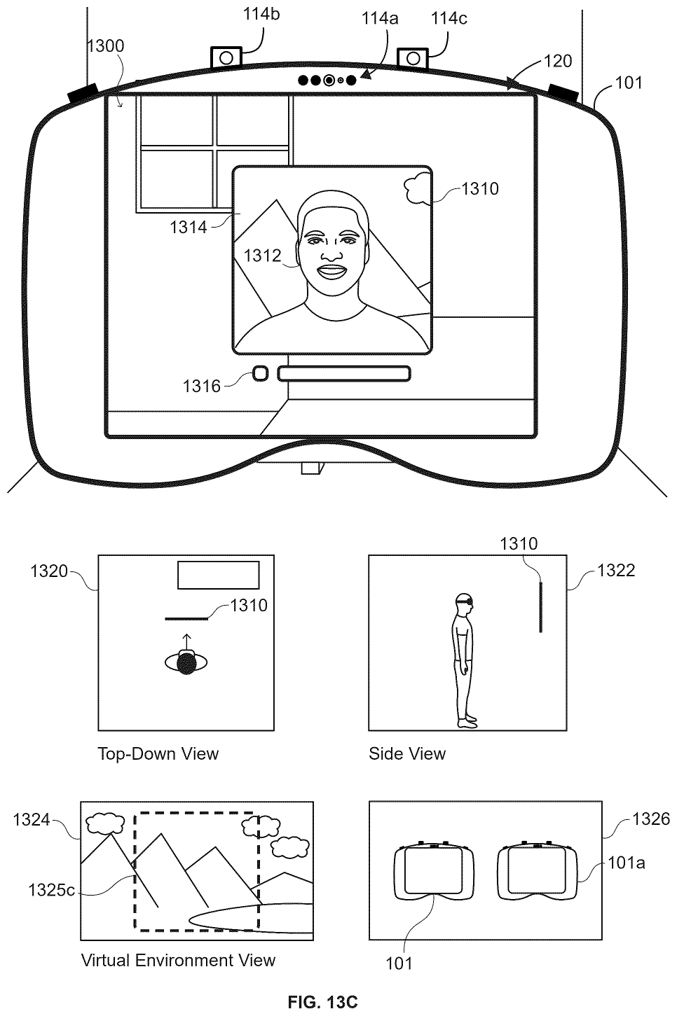

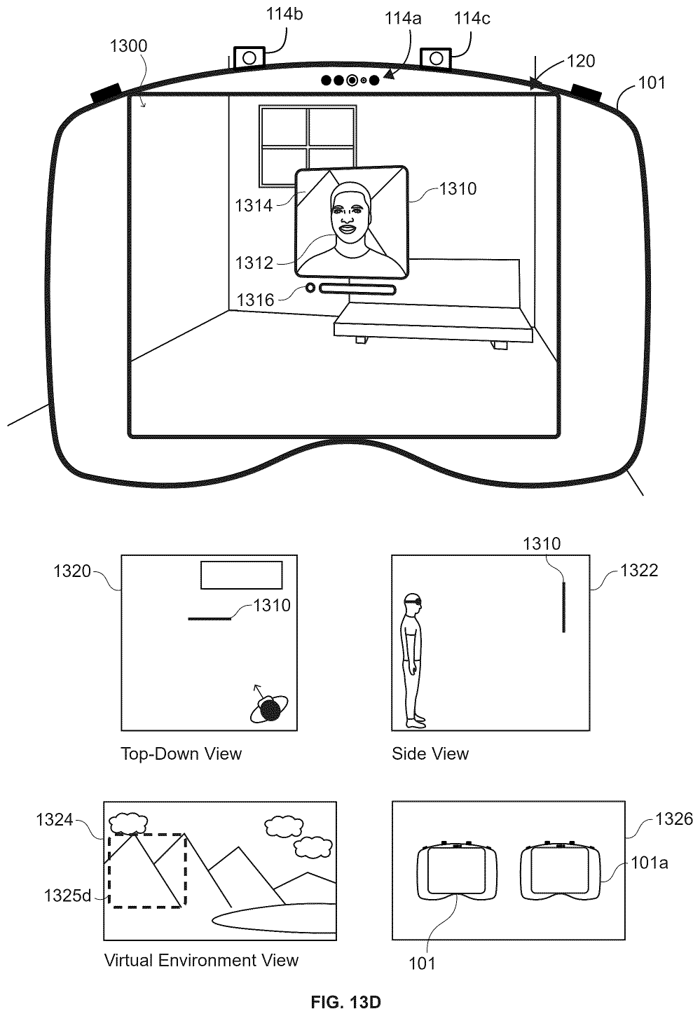

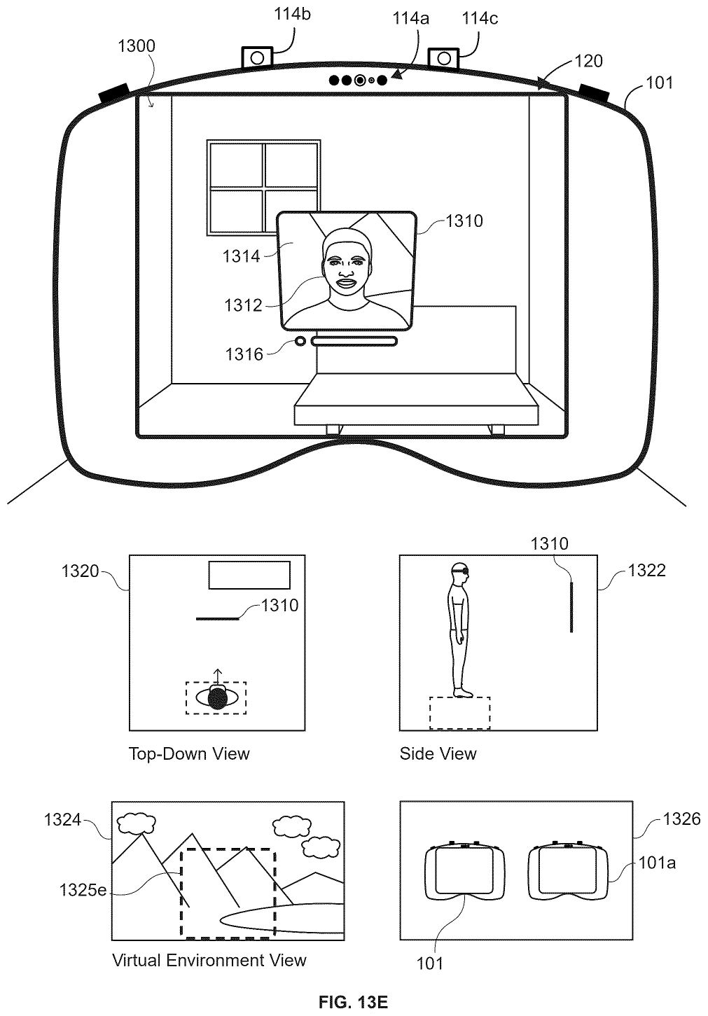

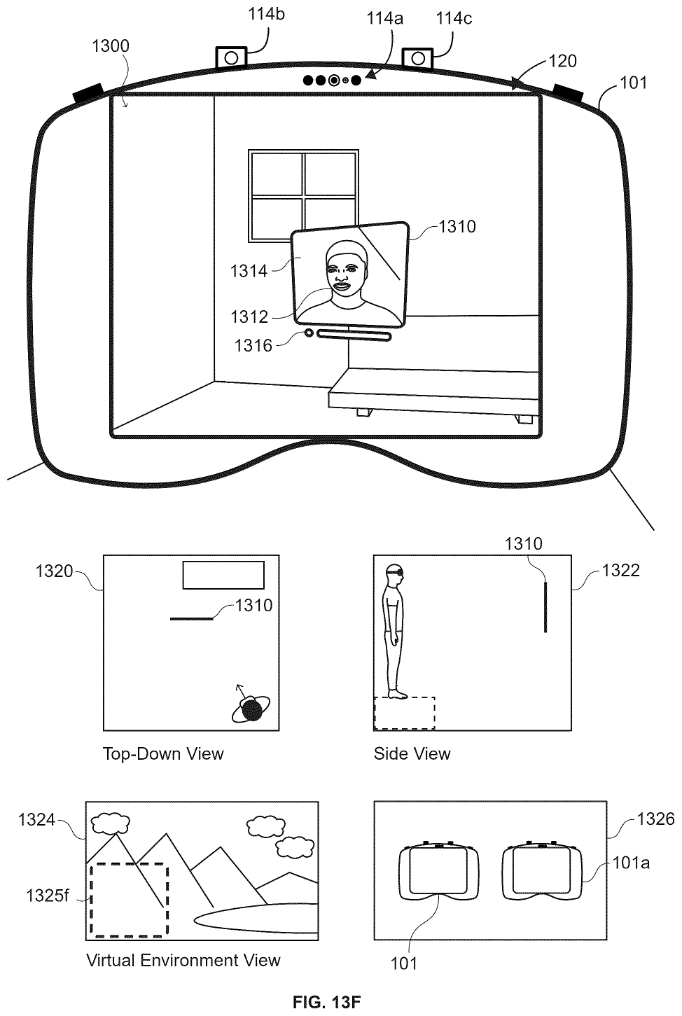

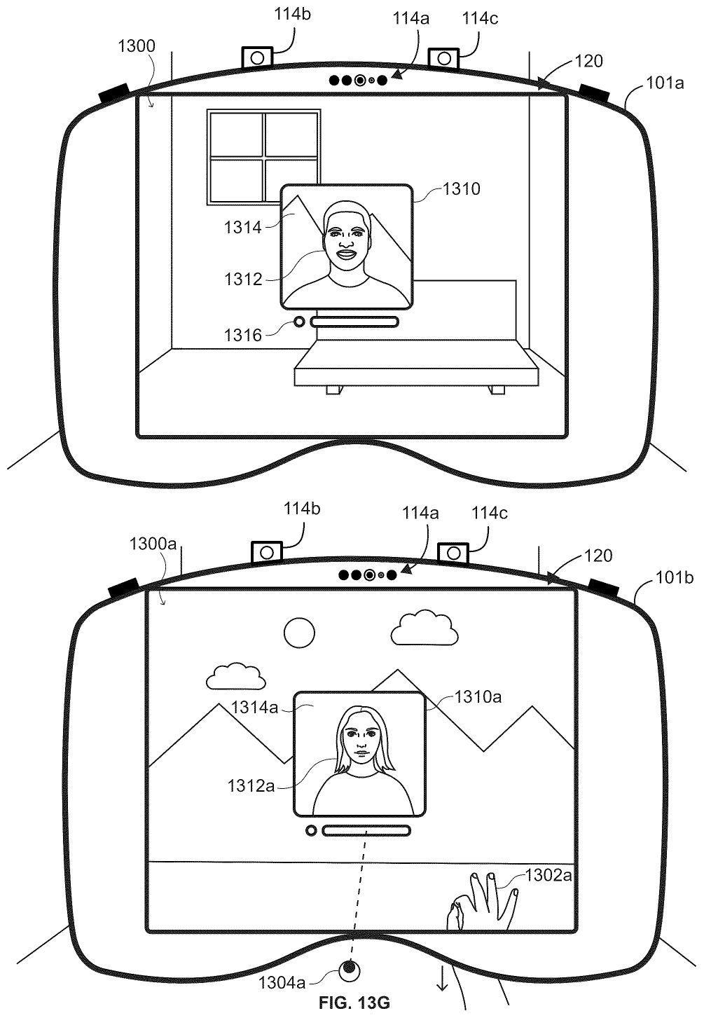

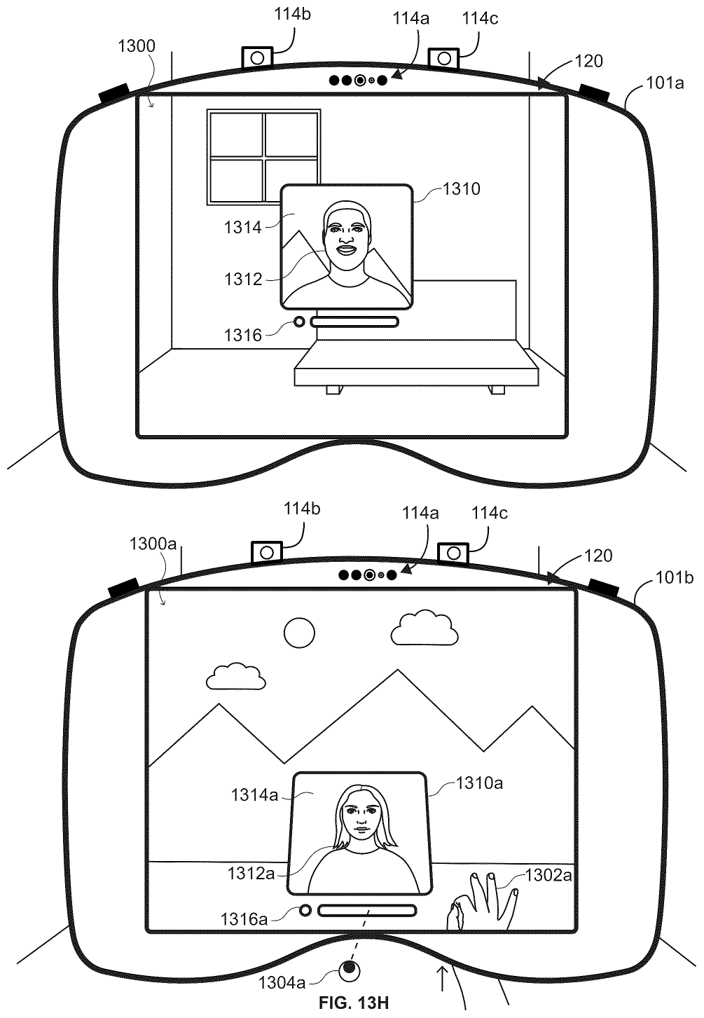

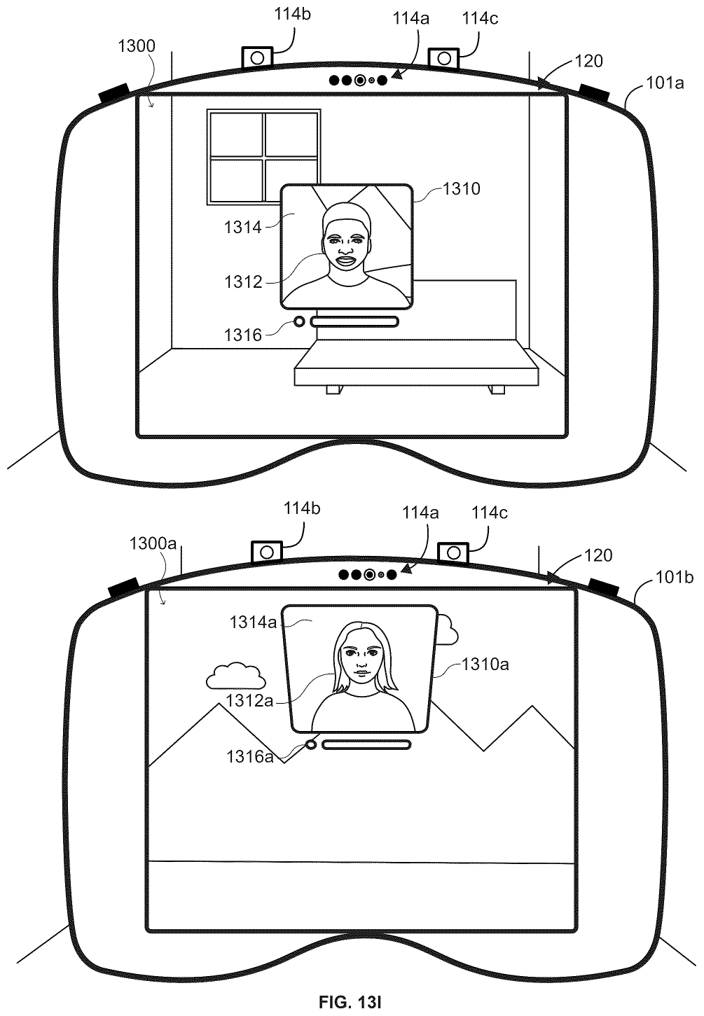

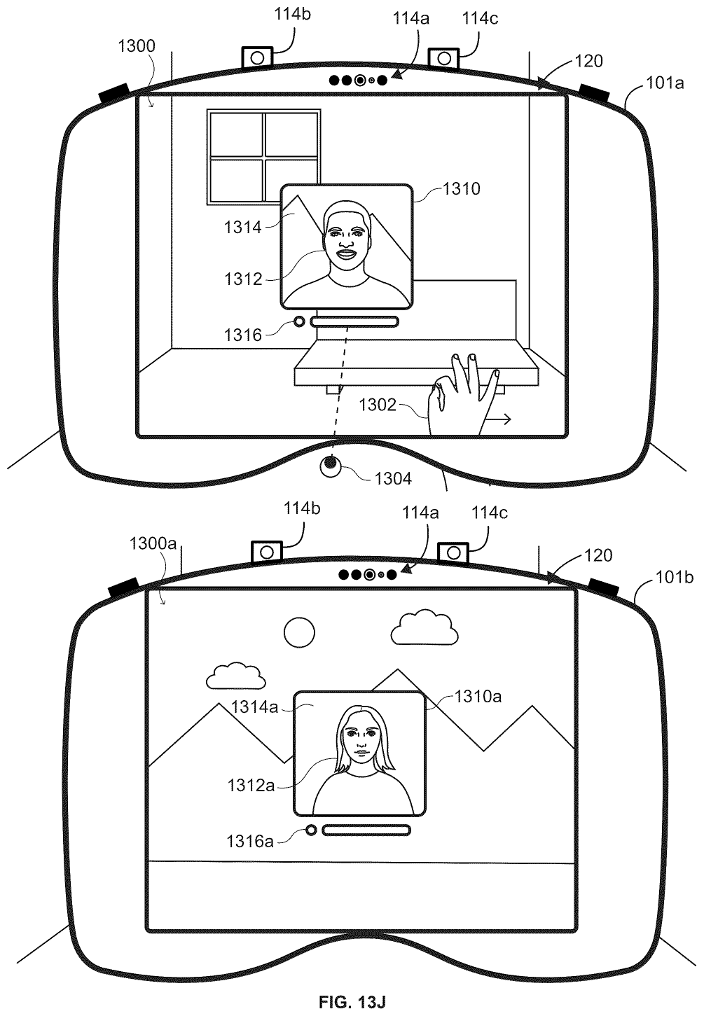

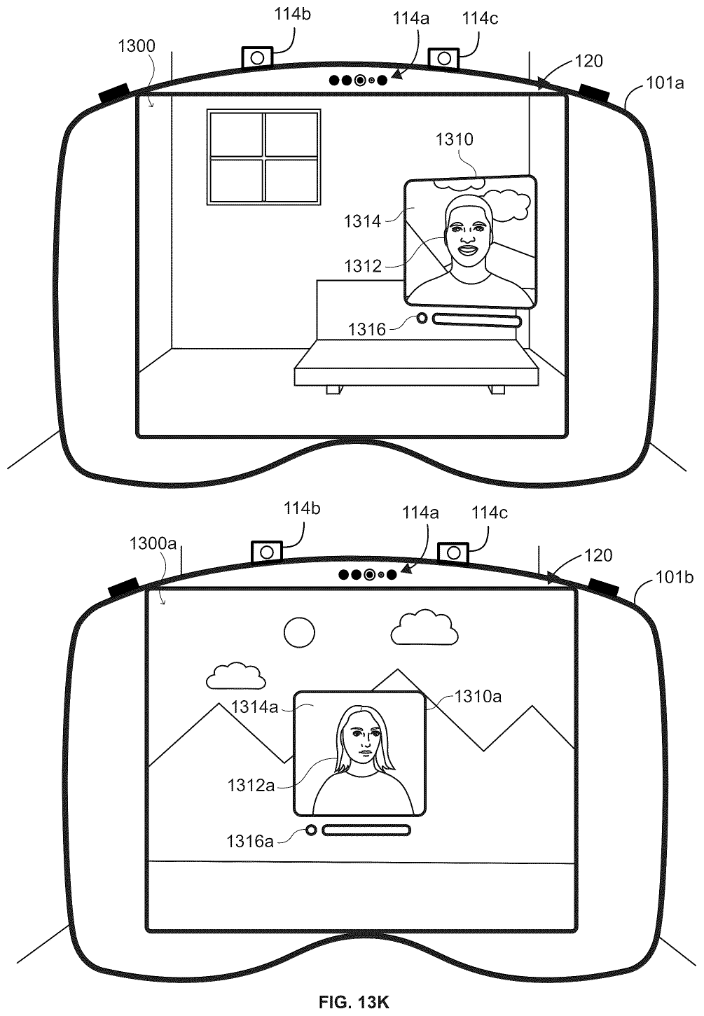

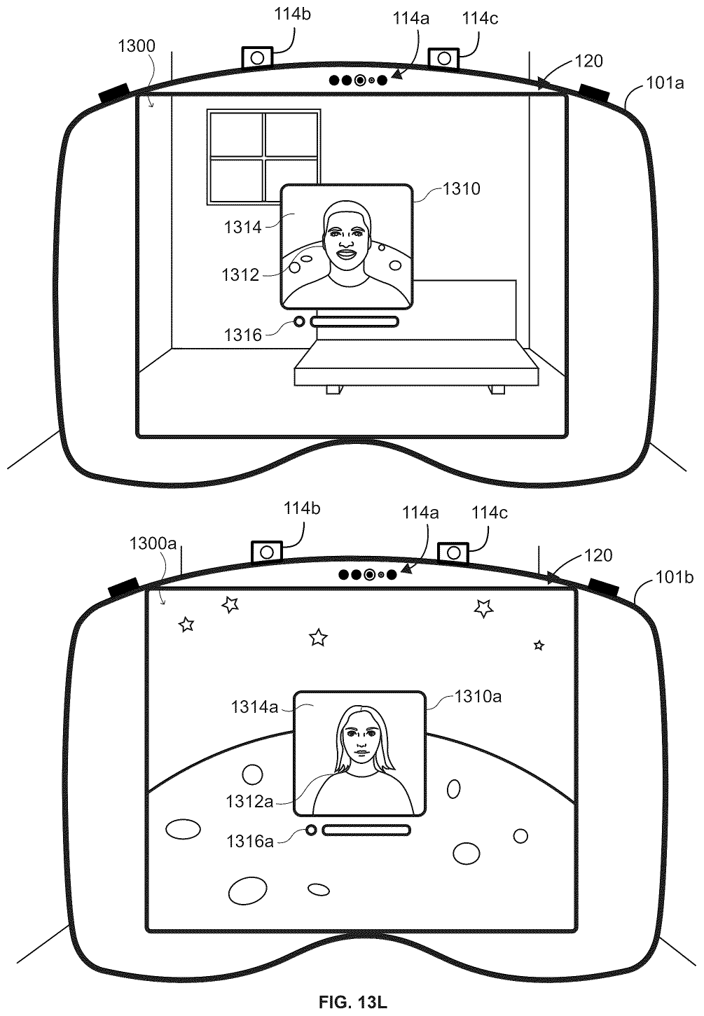

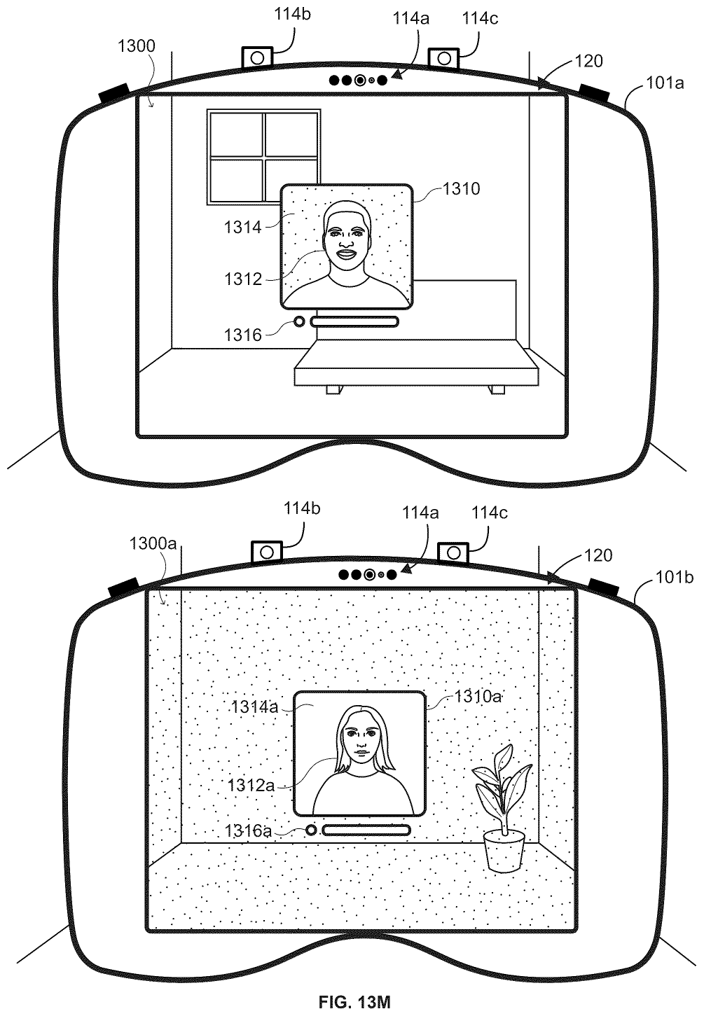

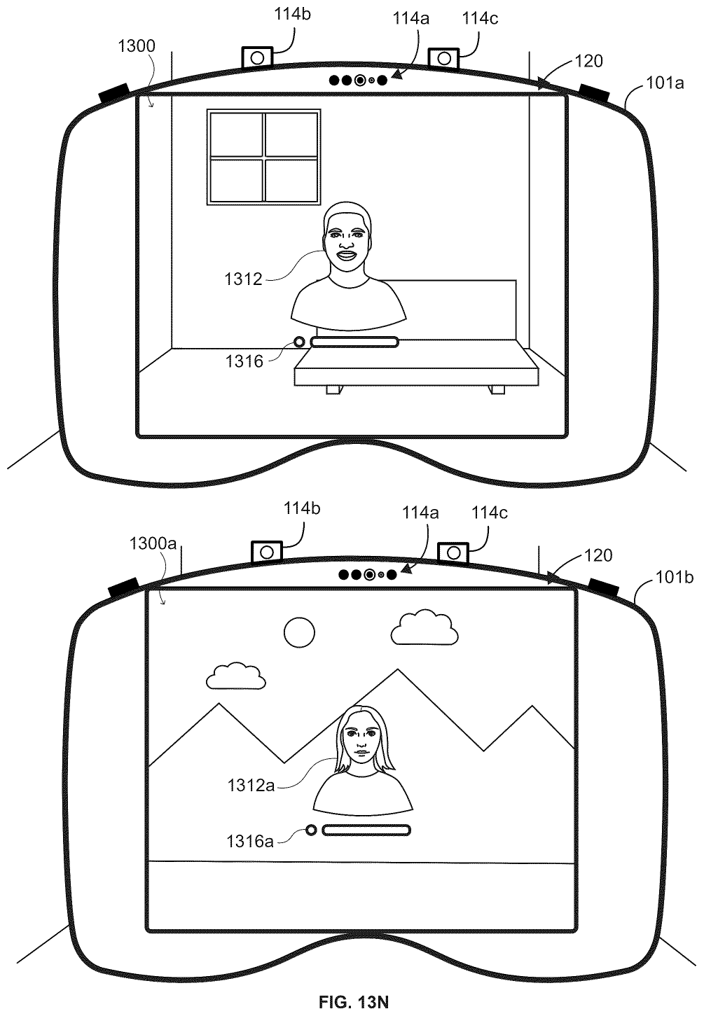

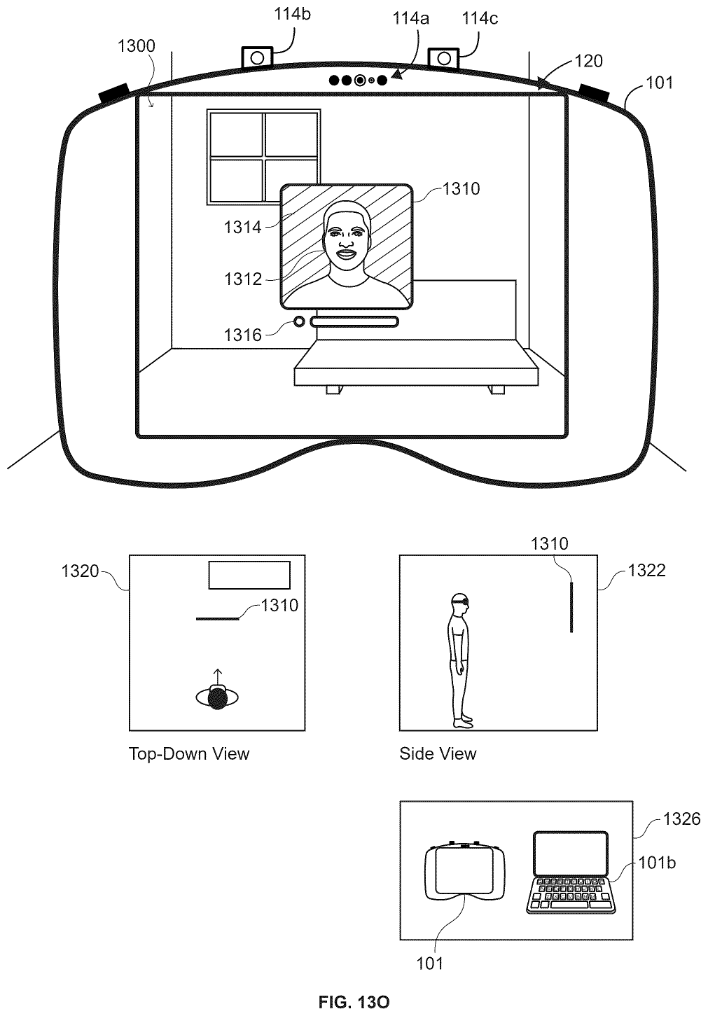

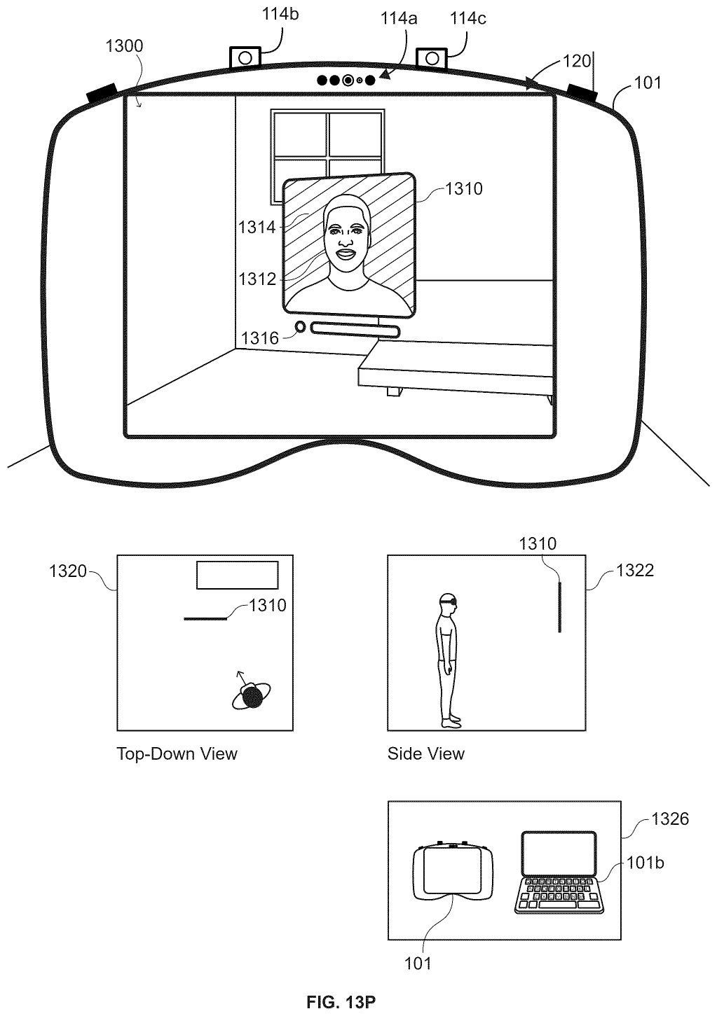

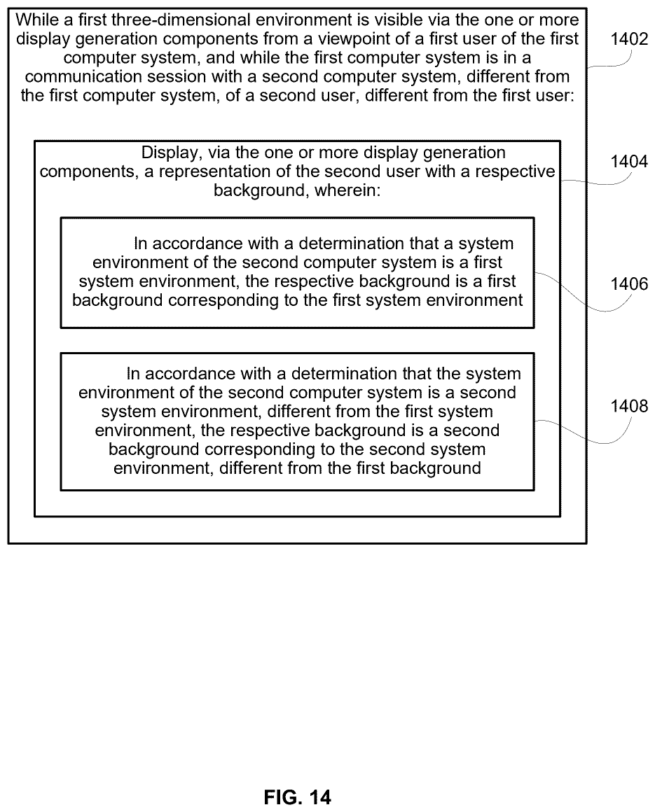

FIGS. 1A-6 provide a description of example computer systems for providing XR experiences to users (such as described below with respect to methods 800, 1000, 1200, and/or 1400). FIGS. 7A-7K illustrate examples of a computer system moving one or more virtual representations in a three-dimensional environment in response to changes of participation of one or more users in a communication session. FIG. 8 is a flowchart illustrating an exemplary method of moving one or more virtual representations in a three-dimensional environment in response to changes of participation of one or more users in a communication session. The user interfaces in FIGS. 7A-7K are used to illustrate the processes in FIG. 8. FIGS. 9A-9M illustrate examples of a computer system updating a spatial setting status of one or more representations of one or more users in a three-dimensional environment in response to detecting one or more spatial setting status requests from one or more users in a communication session. FIG. 10 is a flow diagram illustrating an exemplary method of updating a spatial setting status of one or more representations of one or more users in a three-dimensional environment in response to detecting one or more spatial setting status requests from one or more users in a communication session. The user interface in FIGS. 9A-9M are used to illustrate the processes in FIG. 10. FIGS. 11A-11K illustrate examples of a first computer system displaying a representation of a user of the first computer system in a three-dimensional environment while in a communication session. FIG. 12 is a flow diagram illustrating an example method of a first computer system displaying a representation of a user of the first computer system in a three-dimensional environment while in a communication session. The user interfaces in FIGS. 11A-11K are used to illustrate the processes in FIG. 12. FIGS. 13A-13P illustrate examples of a computer system displaying a representation of a second user of a second computer system within a three-dimensional environment during a communication session with the second computer system of the second user. FIG. 14 is a flowchart illustrating an example method of a computer system displaying a representation of a second user within a three-dimensional environment during a communication session with a second computer system of the second user. The user interfaces in FIGS. 13A-13P are used to illustrate the processes in FIG. 14.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a×R system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specfies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

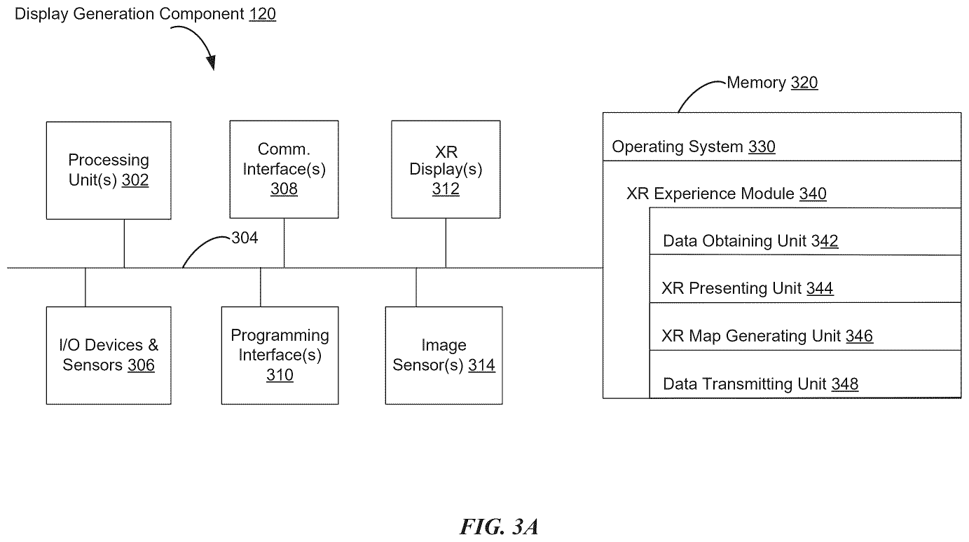

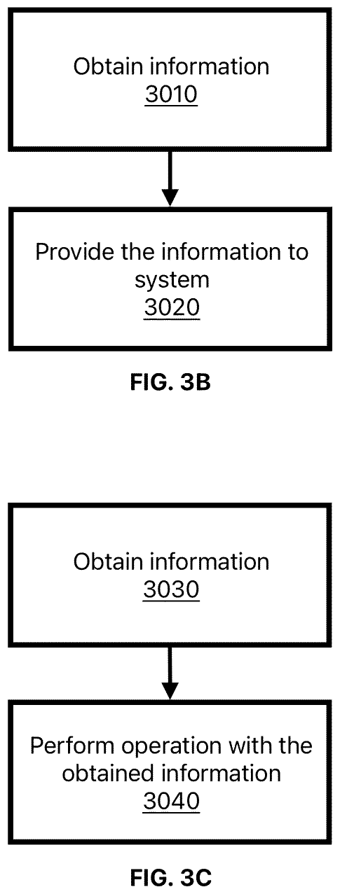

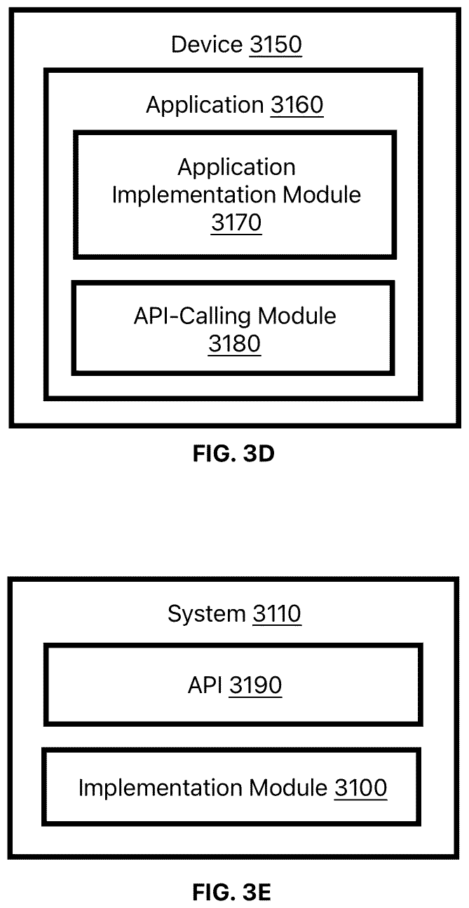

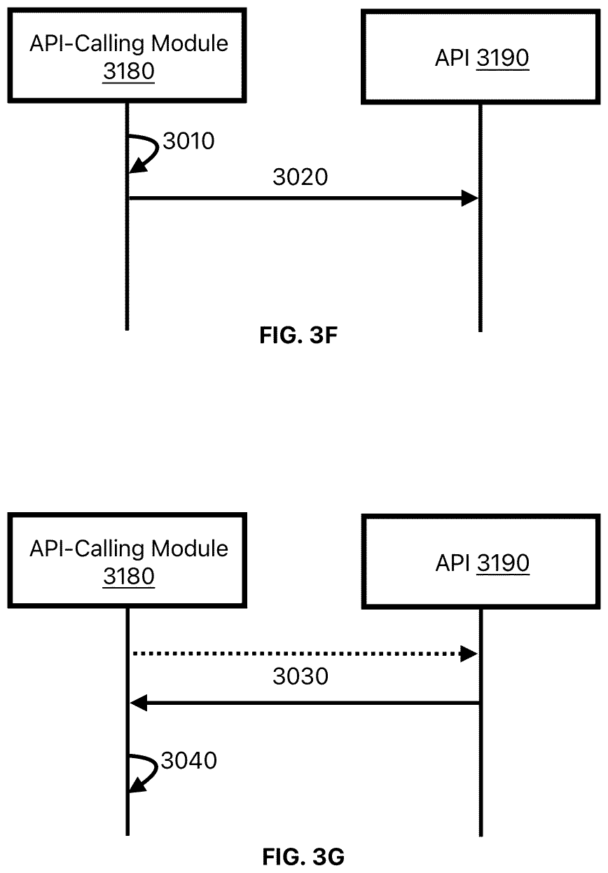

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 11 and 1K-1L and described herein. Likewise, any of the features, components, and/or parts, including the arrangements and configurations thereof shown and described with reference to FIGS. 11 and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

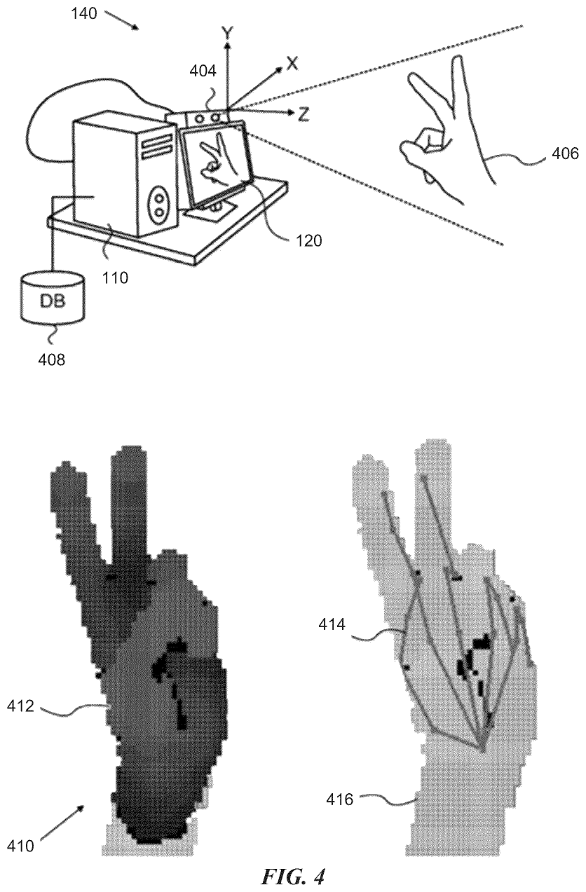

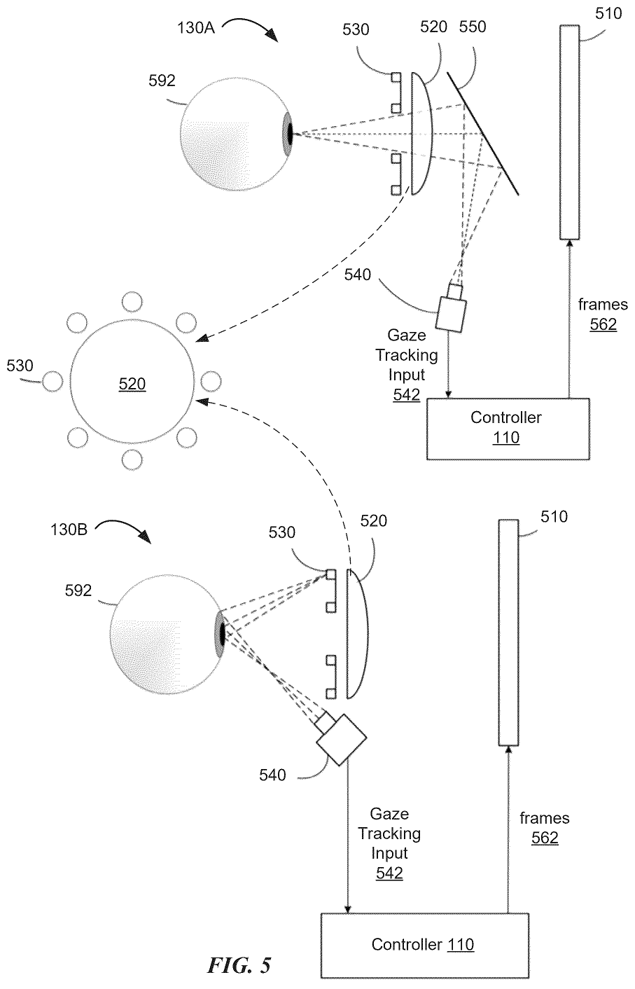

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 800 (FIG. 8), method 1000 (FIG. 10), method 1200 (FIG. 12), and/or method 1400 (FIG. 14) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application. FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

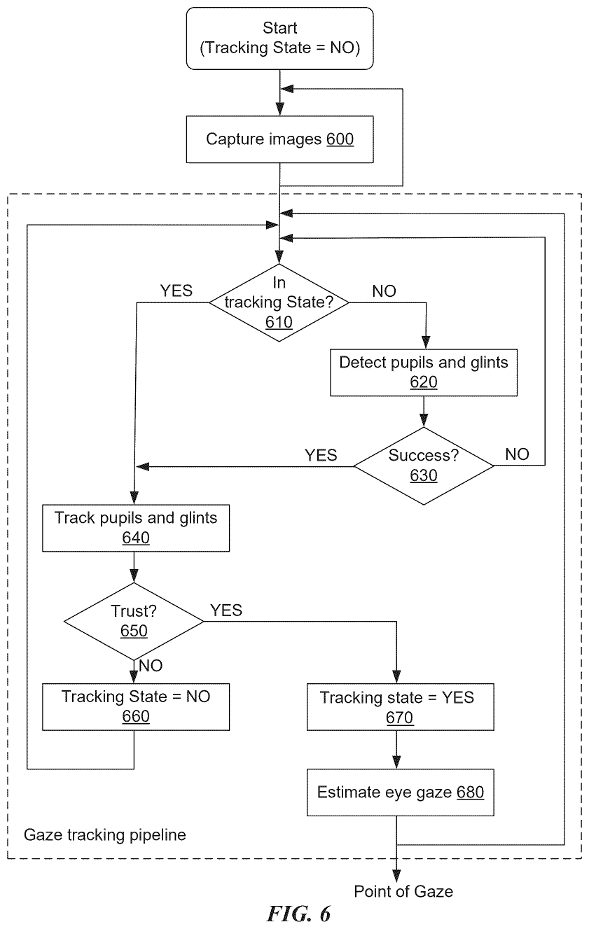

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

FIGS. 7A-7K illustrate examples of a computer system moving one or more virtual representations in a three-dimensional environment in response to changes of participation of one or more users in a communication session.

FIG. 7A illustrates a computer system 101 (e.g., an electronic device) displaying, via a display generation component 120, a plurality of virtual representations 708a through 708c in a three-dimensional environment 702. In some embodiments, computer system 101 is a head-mounted display device (e.g., a head-mounted display) worn by a respective user 716 (shown in top-down view 714) of computer system 101. In some embodiments, three-dimensional environment 702 is visible to the respective user 716 through display generation component 120 (e.g., optionally through a transparent and/or translucent display). For example, three-dimensional environment 702 is visible to respective user 716 while respective user 716 wears computer system 101. In some embodiments, computer system 101 includes a plurality of image sensors 114a through 114c (e.g., having one or more characteristics of image sensors 314 of FIG. 3A). The image sensors optionally include one or more of a visible light camera, an infrared camera, a depth sensor, or any other sensor computer system 101 would be able to use to capture one or more images of a user or a part of the user (e.g., one or more hands of the user) while the user interacts with computer system 101.

In some embodiments, display generation component 120 is configured to display one or more virtual objects (e.g., virtual content included in a virtual window or a user interface, such as virtual representations 708a through 708c) in three-dimensional environment 702. In some embodiments, as shown in FIG. 7A, computer system 101 displays one or more virtual objects within a representation of a physical environment of respective user 716. For example, one or more virtual objects (e.g., virtual representations 708a through 708c) and one or more physical objects (e.g., real-world window 704 and/or real-world couch 706) from a physical environment of respective user 716 are visible to respective user 716 in three-dimensional environment 702 (e.g., as optical passthrough through display generation component 120). Alternatively, or additionally, in some embodiments, computer system 101 displays one or more virtual objects within (e.g., superimposed on) a representation of a virtual environment (e.g., an at least partially immersive virtual environment, such as a representation of an outdoor environment (e.g., a beach, lake, mountain, or desert scene)). In some embodiments, three-dimensional environment 702 has one or more characteristics of the three-dimensional environment described with reference to method 800.

In some embodiments, computer system 101 is in a communication session with one or more computer systems (e.g., the one or more computer systems have one or more characteristics of the plurality of computer systems described with reference to method 800). In some embodiments, the communication session has one or more characteristics of the communication session described with reference to method 800. In some embodiments, the communication session is associated with a respective application (e.g., as described with reference to method 800). For example, the respective application facilitates the sharing of real-time video and/or audio (e.g., through the reception and transmission of video and/or audio signals). In some embodiments, the communication session includes simulated and/or computer-generated video (e.g., by changing one or more visual characteristics of an avatar and/or virtual persona included in a respective virtual representation).

FIGS. 7A-7K include a top-down view 714 of three-dimensional environment 702. In some embodiments, top-down view 714 corresponds to a schematic representation of the one or more objects (e.g., virtual and/or physical objects) included in three-dimensional environment 702. As shown in top-down view 714, three-dimensional environment 702 is viewed by respective user 716 from a current viewpoint (e.g., the direction of the current viewpoint of respective user 716 is represented by an arrow 724 extending from respective user 716). Top-down view 714 is updated in FIGS. 7A-7K to illustrate the current location of one or more respective virtual objects (e.g., virtual representations 708a through 708c) in three-dimensional environment 702 (and relative to the current viewpoint of respective user 716).

In FIG. 7A, computer system 101 displays a plurality of virtual representations 708a through 708c of respective users participating in the communication session using respective computer systems. 708a through 708c For example, virtual representation 708a represents a first user (different from respective user 716) associated with a second computer system in communication with computer system 101, virtual representation 708b represents a second user (different from the first user and respective user 716) associated with a third computer system in communication with computer system 101, and virtual representation 708c represents a third user (different from the first user, the first user, and respective user 716) associated with a fourth computer system in communication with computer system 101. In some embodiments, virtual representations 708a through 708c have one or more characteristics of the plurality of representations of the plurality of users described with reference to method 800 (e.g., and one or more characteristics of the virtual representations described with reference to methods 1000, 1200, and/or 1400).

In some embodiments, computer system 101 displays different types of virtual representations in three-dimensional environment 702. For example, in FIG. 7A, virtual representations 708a and 708c correspond to virtual representations of a first type. For example, the virtual representations of the first type include simulated and/or computer-generated video of the first user and the third user. As shown in FIG. 7A, virtual representations 708a and 708c include first portions 718a and 718c that include avatars of the first user and the third user (e.g., the avatars are computer-generated representations of one or more physical features of the first user and the third user, such as facial features). In some embodiments, computer system 101 displays virtual representations 708a and/or 708c as virtual representations of the first type in accordance with a determination that the second computer system and/or the fourth computer system are sharing computer-generated video of the first user and the third user in the communication session. In some embodiments, in accordance with a determination that a respective computer system is not sharing a computer-generated video (or optionally real-time video) of a respective user in the communication session, computer system 101 displays a respective virtual representation of a second type, different from the first type, of the respective user in three-dimensional environment 702. For example, as shown in FIG. 7A, computer system 101 displays virtual representation 708b as a virtual representation of a second type (different from the first type of virtual representation (e.g., different from virtual representations 708a and 708c)). For example, in FIG. 7A, the third computer system (associated with virtual representation 708b) is not sharing computer-generated video and/or real-time video of the second user in the communication session (e.g., the third computer system only shares audio in the communication session). As shown in FIG. 7A, displaying virtual representation 708b as the virtual representation of the second type includes displaying a first portion 718b that includes a virtual representation of a shape (e.g., having one or more characteristics of the virtual representation of the shape described with reference to method 800) (e.g., and optionally not displaying an avatar of the second user).

In FIG. 7A, the respective virtual representations of the first type (e.g., virtual representations 708a and 708c) and the respective virtual representations of the second type (e.g., virtual representation 708b) computer system 101 displays in three-dimensional environment 702 are non-spatial representations (e.g., having one or more characteristics of the non-spatial representations described with reference to method 1000).

In some embodiments, virtual representations 708a through 708c include second portions 730a through 730c, different from first portions 718a through 718c (e.g., first portions 718a through 718c correspond to the avatars and/or representations of shapes included in virtual representations 708a through 708c). As shown in FIG. 7A, second portions 730a through 730c include background features (e.g., displayed surrounding first portions 718a through 718c of virtual representations 708a through 708c). For example, second portions 730a and 730c include representations of a virtual environment (e.g., second portion 730a includes a virtual representation of a mountain environment, and second portion 730c includes a virtual representation of a space environment (e.g., on the moon)), as described in more detail with reference to method 1400. For example, the first user (associated with virtual representation 708a) and the third user (associated with virtual representation 708c) select respective virtual environments to show in the background of their avatars in the communication session. For example, second portion 730b corresponds to a different type of background than second portions 730a and 730c (e.g., second portion 730b includes an image or monochromatic background (e.g., a dark background, or a color that is selected by the second user)). In some examples, in accordance with a respective virtual representation including real-time video of a respective user, the second portion of the respective virtual representation includes features of the real-time video that are different from the physical features of the respective user (e.g., the real-world environment shown surrounding the respective user in the real-time video).

As shown in FIG. 7A, computer system 101 displays virtual representations 708a through 708c as (and/or within) virtual windows in three-dimensional environment 702 (e.g., first portions 718a through 718c (e.g., including the avatars and representation of a shape) and second portions 730a through 730c (e.g., including environmental and/or background features) are displayed within the virtual windows). In some embodiments, computer system 101 displays virtual representations 708a through 708c (e.g., the virtual windows associated with virtual representations 708a through 708c) within a virtual object 720a (represented with a dashed outline in top-down view 714) in the three-dimensional environment 702. For example, virtual object 720a is associated with the respective application associated with the communication session (e.g., virtual object 720a corresponds to a user interface for the respective application). Computer system 101 optionally displays virtual object 720a (including virtual representations 708a through 708c) without a boundary and/or perimeter surrounding virtual representations 708a through 708c. In some embodiments, affordance 710 is selectable to move virtual object 720a (and optionally virtual representations 708a through 708c) in three-dimensional environment 702 (e.g., as shown and described with reference to FIGS. 7J-7K). In some embodiments, virtual object 720a has one or more characteristics of the virtual object associated with the communication session described with reference to method 800. Alternatively, in some embodiments, computer system 101 displays virtual representations 708a through 708c as separate virtual objects (e.g., virtual windows) in three-dimensional environment 702 (e.g., virtual representations 708a through 708c are each selectable and/or movable in three-dimensional environment 702).

Although dashed representations of virtual objects (e.g., virtual object 720a shown in top-down view 714 in FIG. 7A) are not included in top-down view 714 in FIGS. 7B-7D and FIGS. 7F-7G (for simplicity), it should be appreciated that computer system 101 may display the virtual representations (e.g., virtual representations 708a through 708c) illustrated in these figures within a respective virtual object (e.g., having one or more characteristics of virtual object 720a shown and described with reference to FIG. 7A) in three-dimensional environment 702.

In some embodiments, from a view of the communication session of a respective user different from respective user 716 (e.g., the first user, second user, or third user), a respective computer system displays a virtual object (e.g., corresponding to virtual object 720a) and/or one or more virtual representations representing one or more users in the communication session (e.g., the one or more virtual representations have one or more characteristics of virtual representations 708a through 708c) in a three-dimensional environment (e.g., the three-dimensional environment has one or more characteristics of three-dimensional environment 702). For example, from a perspective of the first user (corresponding to virtual representation 708a), the second computer system displays virtual representations 708b and 708c and a virtual representation of respective user 716 (e.g., including an avatar representing respective user 716) in a three-dimensional environment (optionally within a virtual object associated with the communication session). For example, from a perspective of the second user (corresponding to virtual representation 708b), the second computer system displays virtual representation 708a, virtual representation 708c, and a virtual representation of respective user 716 in a three-dimensional environment (optionally within a virtual object associated with the communication session). For example, from a perspective of the third user (corresponding to virtual representation 708c), the second computer system displays virtual representations 708a and 708b and a virtual representation of respective user 716 in a three-dimensional environment (optionally within a virtual object associated with the communication session).

In some embodiments, computer system 101 changes a visual prominence of one or more of virtual representations 708a through 708c in response to detecting an indication corresponding to a change of participation of the first user, second user, and/or third user in the communication session (e.g., the change of participation of the first user, second user, and/or third user in the communication session has one or more characteristics of a change of participation of the second user in the communication session described with reference to method 800). For example, in response to receiving an indication (e.g., from a respective computer system in the communication session) that an amount of participation of a respective user in the communication session has increased (e.g., caused by the respective user speaking in the communication session and/or other forms of participation discussed herein), computer system 101 moves and/or changes a size of a respective virtual representation of the respective user in three-dimensional environment 702 (e.g., the indication has one or more characteristics of the indication of the change of participation of the second user in the communication session described with reference to method 800).

FIGS. 7A-7K include schematic glyphs of a current amount of participation of the respective users in the communication session. In FIG. 7A, glyph 712a corresponds to a current amount of participation of the first user (corresponding to virtual representation 708a) in the communication session, glyph 712b corresponds to a current amount of participation of the second user (corresponding to virtual representation 708b) in the communication session, and glyph 712c corresponds to a current amount of participation of the third user (corresponding to virtual representation 708c) in the communication session. In FIGS. 7A-7K, changes in an amount of participation of a respective user in the communication session is represented by changing the size of the shaded portion (the portion included a fill-pattern) of the glyph associated with the respective user (e.g., an increase in participation of the first user in the communication session includes increasing a size of the shaded portion of glyph 712a, such as shown and described with reference to FIG. 7B). In FIG. 7A, the current amount of participation of the first user, the second user, and the third user are the same (glyphs 712a through 712c include shaded portions (e.g., including a fill-pattern) of the same size). Thus, computer system 101 displays virtual representations 708a through 708c with the same visual prominence (e.g., size and/or distance from the current viewpoint of respective user 716) in three-dimensional environment 702.

In FIG. 7B, computer system 101 detects an indication (e.g., received from the second computer system) corresponding to an increase of participation of the first user in the communication session (represented by an increase in the size of shaded portion of glyph 712a compared to as shown in FIG. 7A). In response to detecting the indication corresponding to the increase of participation of the first user in the communication session, computer system 101 moves virtual representation 708a closer to a location in three-dimensional environment 702 corresponding to the location of the current viewpoint of respective user 716. In some embodiments, computer system 101 moves virtual representation 708a gradually in three-dimensional environment 702 in response to detecting the indication (e.g., over a period of time (e.g., 0.1, 0.2, 0.5, 1, 2, 5, or 10 seconds)). For example, in FIG. 7B, computer system 101 is in the process of moving virtual representation 708a in response to detecting the indication corresponding to the increase of participation of the first user (e.g., FIG. 7B is an intermediate figure showing the gradual movement of virtual representation 708a from the location of virtual representation 708a in FIG. 7A to the location of virtual representation 708a in FIG. 7C). In some embodiments, in FIG. 7B, computer system 101 moves virtual representation 708a in three-dimensional environment 702 in accordance with a determination that the amount of participation of the first user exceeded a threshold amount (e.g., having one or more characteristics of the criterion of the first one or more criterion that is satisfied when the change of participation of the second user exceeds the threshold amount of participation as described with reference to method 800).

In some embodiments, while moving virtual representation 708a in three-dimensional environment 702, in response to detecting the indication corresponding to the increase of participation of the first user in the communication session, computer system 101 increases a size of virtual representation 708a relative to three-dimensional environment 702. In FIG. 7B, computer system 101 displays virtual representation 708a in three-dimensional environment 702 with an increased size compared to the size of virtual representation 708a in FIG. 7A. In some embodiments, computer system 101 increases the size of virtual representation 708a relative to three-dimensional environment 702 gradually in response to detecting the indication (e.g., over a period of time (e.g., 0.1, 0.2, 0.5, 1, 2, 5, or 10 seconds)). For example, in FIG. 7B, computer system 101 is in the process of increasing the size of virtual representation 708a in response to detecting the indication corresponding to the increase of participation of the first user (e.g., FIG. 7B is an intermediate figure showing the gradual change of size of virtual representation 708a from the size of virtual representation 708a shown in FIG. 7A to the size of virtual representation 708a shown in FIG. 7C). In some embodiments, increasing the size of virtual representation 708a has one or more characteristics of displaying the first representation of the second user with the second size described with reference to method 800.

In some embodiments, computer system 101 increases the size of virtual representation 708a by increasing the size of second portion 730a (e.g., by revealing (e.g., displaying) an additional portion of the virtual environment included in virtual representation 708a) while maintaining the size of first portion 718a relative to three-dimensional environment 702 (e.g., increasing the size of virtual representation 708a includes maintaining the size of at least a portion of the avatar of the first user (e.g., including a representation of the head and/or face of the first user) while increasing the amount of the virtual environment included in virtual representation 708a). For example, in FIG. 7B, computer system 101 increases the size of virtual representation 708a by displaying the additional content included outside of the schematic dashed box illustrated within virtual representation 708a (e.g., the schematic dashed box corresponds to the size virtual representation 708a was displayed with in FIG. 7A prior to computer system 101 detecting the indication).

In some embodiments, while increasing the size of virtual representation 708a in FIG. 7B, computer system 101 displays (e.g., reveals) additional content that computer system 101 did not display virtual representation 708a with in FIG. 7A (e.g., prior to detecting the indication corresponding to the change of participation of the first user in the communication session). For example, the additional content corresponds to the content shown outside the schematic dashed box shown in FIG. 7B (e.g., including an additional portion of the virtual environment shown within virtual representation 708a and/or an additional portion of the avatar of the first user (e.g., a portion of a virtual representation of the shoulders and/or torso of the first user)). In some embodiments, while increasing the size of virtual representation 708a in FIG. 7B, computer system 101 maintains a size of the content computer system 101 previously displayed within virtual representation 708a in FIG. 7A (e.g., the content of virtual representation 708a shown within the schematic dashed box shown in FIG. 7B). For example, in FIG. 7B, computer system 101 maintains a size of at least a portion of the background included within virtual representation 708a relative to three-dimensional environment 702 (e.g., the portion of the virtual environment displayed surrounding the avatar within the schematic dashed box in FIG. 7B) when increasing the size of virtual representation 708a. For example, in FIG. 7B, computer system 101 maintains a size of at least a portion of the avatar of the first user included within virtual representation 708a relative to three-dimensional environment 702 (e.g., the portion of the avatar included within the schematic dashed box in FIG. 7B) when increasing the size of virtual representation 708a.

While increasing the size of virtual representation 708a in FIG. 7B, computer system 101 optionally increases a display size of first portion 718a and/or second portion 730a of virtual representation 708a (e.g., because computer system 101 moves virtual representation 708a to a location that is closer to the current viewpoint of respective user 716 while maintaining the true size (e.g., relative to three-dimensional environment 702) of first portion 718a and increasing the true size of second portion 730a). In some embodiments, increasing the size of second portion 730a while maintaining the size of first portion 718 has one or more characteristics of changing a respective size of the first portion of the first representation of the second user while maintaining the respective size of the second portion of the first representation of the second user described with reference to method 800.

It should be appreciated that the dashed boxes illustrated in FIGS. 7B-7D, and 7H-7K within the displayed virtual representations (e.g., virtual representation 708a in FIG. 7B) are included for schematic purposes (e.g., to show a change in size of a respective virtual representation in three-dimensional environment 702) and optionally do not correspond to elements that are displayed and/or are otherwise visible in three-dimensional environment 702.

In FIG. 7C, computer system 101 completes the movement and change in size of virtual representation 708a initiated in FIG. 7B in response to detecting the indication corresponding to the increase of participation of the first user in the communication session. As shown in FIG. 7C, computer system 101 displays virtual representation 708a at a closer distance to the location corresponding to the current viewpoint of respective user 716 in three-dimensional environment 702 (compared to the location of virtual representation 708a in FIG. 7B). Further, computer system 101 displays virtual representation 708a with an increased size relative to three-dimensional environment 702 compared to the size of virtual representation 708a displayed in FIG. 7B. For example, in FIG. 7B, computer system 101 increases the size of second portion 730a and maintains the size of first portion 718a relative to three-dimensional environment 702 (e.g., compared to the size of first portion 718a and second portion 730a in FIG. 7B).

Further, in FIG. 7C, computer system 101 detects an indication (e.g., received from the third computer system associated with the second user) corresponding to an increase of participation of the second user (corresponding to virtual representation 708b) in the communication session (e.g., the amount of participation illustrated by glyph 712b increases in FIG. 7C). In response to detecting the indication corresponding to the increase of participation of the second user in the communication session, computer system 101 increases a visual prominence of virtual representation 708b in three-dimensional environment 702. For example, as shown in FIG. 7C, computer system 101 moves virtual representation 708b to a closer distance to the location corresponding to the current viewpoint of respective user 716 in three-dimensional environment 702. Further, as shown in FIG. 7C, computer system 101 increases a size of virtual representation 708b relative to three-dimensional environment 702 (e.g., increasing the size of virtual representation 708b relative to three-dimensional environment 702 has one or more characteristics of increasing the size of virtual representation 708a described above).

In some embodiments, changing the visual prominence of virtual representation 708b includes changing a respective visual characteristic of virtual representation 708b in three-dimensional environment 702. For example, as shown in FIG. 7C, computer system 101 changes a visual appearance (e.g., represented by a changed fill-pattern) of first portion 718b of virtual representation 708b (e.g., computer system 101 changes a visual appearance of the virtual representation of the shape included within in virtual representation 708b). In some embodiments, changing the visual appearance of first portion 718b includes changing the color, brightness, and/or saturation of first portion 718b in three-dimensional environment 702. Alternatively, or additionally, in some embodiments, changing the respective visual characteristic of virtual representation 708b includes changing second portion 730b (e.g., changing the color, brightness, and/or saturation of second portion 730b). In some embodiments, computer system 101 changes the respective visual characteristic of virtual representation 708b while moving and/or changing the size of virtual representation 708b in three-dimensional environment 702. In some embodiments, computer system 101 changes the respective visual characteristic of virtual representation 708b in accordance with a determination that virtual representation 708b is a virtual representation of the second type described above (e.g., in response to detecting an indication corresponding to a change of participation of the first user and/or the third user in the communication session, computer system 101 forgoes changing the respective visual characteristic of virtual representation 708a and/or virtual representation 708c). In some embodiments, changing the respective visual characteristic of virtual representation 708b has one or more characteristics of changing the first visual characteristic of the first representation of the second user described with reference to method 800.

In some embodiments, computer system 101 changes the visual prominence of a respective virtual representation of a respective user by an amount that corresponds to an amount of change of participation of the respective user in the communication session. As shown in FIG. 7C, computer system 101 increases a visual prominence of virtual representation 708a by a greater amount in three-dimensional environment 702 than virtual representation 708b because the increase of participation of the first user in the communication session is greater than the increase of participation of the second user in the communication session (as shown by glyphs 712a and 712b). For example, in FIG. 7C, computer system 101 moves virtual representation 708a closer to the location corresponding to the current viewpoint of respective user 716 than virtual representation 708b. For example, in FIG. 7C, computer system 101 increases a size of virtual representation 708a by a greater amount relative to three-dimensional environment 702 than virtual representation 708b.

Alternatively, or additionally in some embodiments, a location and/or size of a respective virtual representation of a respective user in three-dimensional environment 702 corresponds to the current amount of participation of the respective user in the communication session. For example, as shown in FIG. 7C, the respective distances of virtual representations 708a through 708c from the location in three-dimensional environment 702 corresponding to the current viewpoint of respective user 716 corresponds to the amount of participation shown by glyphs 712a through 712c (e.g., computer system 101 displays virtual representation 708a closest to the current viewpoint of respective user 716 because the first user has the highest amount of participation in the communication session, and displays virtual representation 708c farthest from the current viewpoint of respective user 716 because the third user has the lowest amount of participation in the communication session). For example, as shown in FIG. 7C, the respective sizes of virtual representations 708a through 708c relative to three-dimensional environment 702 correspond to the amount of participation shown by glyphs 712a through 712c (e.g., computer system 101 displays virtual representation 708a with the largest size relative to three-dimensional environment 702 because the first user has the highest amount of participation in the communication session, and displays virtual representation 708c with the smallest size relative to three-dimensional environment 702 because the third user has the lowest amount of participation in the communication session).

In FIG. 7D, computer system 101 detects an indication (e.g., received from the second computer system) corresponding to a decrease of participation of the first user in the communication session (as shown by the decrease in the amount of participation shown by glyph 712a). For example, the participation of the first user in the communication session has decreased in frequency over a period of time (e.g., the first user has spoken in the communication session less than twice within a minute), and/or the first user has not spoken in the communication session within a threshold amount of time (e.g., 1, 2, 5, 10, 15, 20, 60, or 120 seconds). In response to detecting the indication corresponding to the decrease of participation of the first user in the communication session, computer system 101 reduces a visual prominence of virtual representation 708a. For example, as shown in FIG. 7D, computer system 101 moves virtual representation 708a farther from a location in three-dimensional environment 702 corresponding to the current viewpoint of respective user 716 (e.g., gradually (e.g., over a period of time, such as 0.1, 0.2, 0.5, 1, 2, 5, or 10 seconds)) than the location of representation 708a in FIG. 7C. For example, as shown in FIG. 7D, computer system 101 reduces the size of virtual representation 708a relative to three-dimensional environment 702 (e.g., gradually). In some embodiments, reducing the size of virtual representation 708a includes reducing the size of second portion 730a while maintaining the size of first portion 718a relative to three-dimensional environment 702 (e.g., and optionally reducing a display size of virtual representation 708a (e.g., because virtual representation 708a is moved to a location farther from the current viewpoint of respective user 716)).

Further, in FIG. 7D, computer system 101 detects an indication (e.g., received from the third computer system) corresponding to an increase of participation of the second user in the communication session (e.g., glyph 712b shows a greater amount of participation in FIG. 7D compared to FIG. 7C), and an indication (e.g., received from the fourth computer system) corresponding to an increase of participation of the third user in the communication session (e.g., glyph 712c shows a greater amount of participation in FIG. 7D compared to FIG. 7C). In response to detecting the indication corresponding to the increase of participation of the second user in the communication session, computer system 101 increases the visual prominence of virtual representation 708b in the three-dimensional environment 702 (e.g., by an amount corresponding to the amount of increase of participation of the second user in the communication session). In response to detecting the indication corresponding to the increase of participation of the third user in the communication session, computer system 101 increases the visual prominence of virtual representation 708c in the three-dimensional environment 702 (e.g., by an amount corresponding to the amount of increase of participation of the third user in the communication session). Alternatively, or additionally, in some embodiments, computer system 101 displays virtual representations 708a through 708c with an amount of visual prominence (e.g., distance from the current viewpoint of respective user 716 and/or size relative to three-dimensional environment 702) that correspond to the current amount of participation of the first, second, and third users in the communication session (e.g., computer system 101 displays virtual representation 708a with the least amount of visual prominence because the first user has the lowest amount of participation in the communication session, and displays virtual representation 708b with the greatest amount of visual prominence because the second user has the highest amount of participation in the communication session).

In some embodiments, a respective user in the communication session can select whether to be represented in the communication session by a spatial representation (e.g., having one or more characteristics of a spatial representation described with reference to method 1000) or a non-spatial representation (e.g., having one or more characteristics of a non-spatial representation described with reference to method 1000). In FIG. 7E, computer system 101 detects an indication (e.g., received by the fourth computer system) corresponding to a request from the third user to change from a non-spatial representation (e.g., virtual representation 708c shown in FIGS. 7A-7D) to a spatial representation. In response to detecting the indication corresponding to the request from the third user to change from the non-spatial representation to the spatial representation, computer system 101 ceases to display virtual representation 708c and displays spatial representation 722. For example, spatial representation 722 has one or more characteristics of the avatar of the third user included in virtual representation 708c.

In some embodiments, in response to displaying spatial representation 722, computer system 101 changes an arrangement of virtual representations 708a through 708b in three-dimensional environment 702. As shown in FIG. 7E, virtual representations 708a through 708b are displayed at a same height in three-dimensional environment 702 (e.g., as opposed to the varying heights of virtual representations 708a through 708c in the arrangement shown in FIGS. 7A-7D). In some embodiments, computer system 101 displays virtual representation 708a through 708b with the arrangement shown in FIG. 7E in accordance with a determination that the communication session does not include more than a threshold number of users represented by non-spatial representations (e.g., having one or more characteristics of the threshold number of users described below). In some embodiments, in FIG. 7E, virtual representations 708a through 708b are displayed within a virtual object 720b (e.g., virtual object 720b has one or more characteristics of virtual object 720a shown and described with reference to FIG. 7A). In some embodiments, displaying spatial representation 722 includes displaying spatial representation 722 outside of virtual object 720b. For example, computer system 101 displays spatial representation 722 such that there is a shared spatial truth between the current viewpoint of respective user 716 (represented by arrow 724 in top-down view 714) and the current viewpoint of the third user (represented by arrow 726 in top-down view 714) in the communication session (e.g., computer system 101 does not display virtual representations 708a through 708b in the three-dimensional environment 702 to be spatially true to a current viewpoint of the first user and second user in the communication session). Spatial representation 722 optionally has one or more of the characteristics of spatial representations described in more detail below with reference to method 1000.

In some embodiments, in accordance with a determination that a respective user of the communication session is represented by a spatial representation, computer system 101 forgoes changing a visual prominence (e.g., moving and/or changing the size) of the spatial representation in response to changes of participation of the respective user in the communication session. For example, in FIG. 7F, computer system 101 detects an indication (e.g., received from the fourth computer system) corresponding to an increase of participation of the third user in the communication session (e.g., the amount of participation shown by glyph 712c is increased in FIG. 7F compared to FIG. 7E). In response to detecting the indication corresponding to the increase of participation of the third user in the communication session, computer system 101 forgoes changing a visual prominence of spatial representation 722. For example, computer system 101 does not move spatial representation 722 in three-dimensional environment 702 (e.g., to maintain a spatial truth of the current viewpoint of the third user relative to the current viewpoint of respective user 716 in the communication session). For example, computer system 101 does not change a size of spatial representation 722 relative to three-dimensional environment 702. Optionally, in response to receiving the indication corresponding to the increase of participation of the third user in the communication session, computer system 101 changes one or more visual characteristics of spatial representation 722 different from re-locating and/or changing the size of spatial representation 722 (e.g., computer system 101 displays a visual indication, such as displaying visual indication 728 and/or changing one or more facial features of spatial representation 722 (e.g., such that the avatar of the third user appears to be speaking), to represent the participation of the third user in the communication session.

In some embodiments, in accordance with a determination that the communication session does not include more than a threshold number of users (e.g., 2, 3, 4, 5, or 10 users) represented in three-dimensional environment 702 by non-spatial representations, computer system 101 forgoes changing a visual prominence of a respective virtual representation based on a change of participation of the respective user in the communication session. In FIG. 7G, computer system 101 detects an indication (e.g., received from the second computer system) corresponding to an increase of participation of the first user in the communication session (e.g., the amount of participation shown by glyph 712a is greater in FIG. 7G than in FIG. 7F), and an indication corresponding to a decrease of participation of the third user in the communication session (e.g., the amount of participation shown by glyph 712c is smaller in FIG. 7G than in FIG. 7F). In response to detecting the indication corresponding to the increase of participation of the first user in the communication session, computer system 101 forgoes changing a visual prominence of virtual representation 708a in three-dimensional environment 702. For example, as shown in FIG. 7G, computer system 101 forgoes moving virtual representation 708a to a different distance from the location corresponding to the current viewpoint of respective user 716. For example, as shown in FIG. 7G, computer system 101 forgoes changing a size of virtual representation 708a relative to three-dimensional environment 702. In response to detecting the indication corresponding to the decrease of participation of the third user in the communication session, computer system 101 forgoes changing a visual prominence of spatial representation 722 (e.g., as described with reference to FIG. 7F).

In FIG. 7H, computer system 101 detects an indication (e.g., received by the fourth computer system) corresponding to a request from the third user to change from a spatial representation (e.g., spatial representation 722 shown in FIGS. 7E-7G) to a non-spatial representation (e.g., virtual representation 708c) in the communication session, optionally according to one or more characteristics of method 1000. In response to detecting the indication corresponding to the request from the third user to change from a spatial representation to a non-spatial representation in the communication session, computer system 101 ceases to display spatial representation 722 and displays virtual representation 708c in three-dimensional environment 702. In some embodiments, as shown in FIG. 7H, displaying virtual representation 708c includes displaying virtual representation 708c within a virtual object 720c (e.g., having one or more characteristics of virtual object 720a and/or 720b described above) with virtual representations 708a through 708b. In some embodiments, as shown in FIG. 7H, displaying virtual representation 708c includes changing an arrangement of virtual representations 708a through 708b in three-dimensional environment 702 (e.g., to correspond to the arrangement of virtual representations 708a through 708c shown in FIG. 7D (e.g., prior to computer system 101 detecting the indication corresponding to the request from the third user to change from the non-spatial representation to the spatial representation)). For example, computer system 101 displays virtual representations 708a through 708c with the arrangement shown in FIG. 7H in accordance with a determination that the communication session includes more than the threshold number of users represented in three-dimensional environment 702 by non-spatial representations.

In some embodiments, changing from a spatial representation to a non-spatial representation corresponds to an increase of participation in the communication session. For example, as shown in FIG. 7H, the amount of participation of the third user (represented by glyph 712c) increases in the communication session in response to computer system 101 displaying virtual representation 708c (and ceasing to display spatial representation 722) in three-dimensional environment 702. In response to displaying virtual representation 708c, and in accordance with a determination that more than the threshold number of users (e.g., three) are represented by non-spatial representations in three-dimensional environment 702, computer system 101 increases the visual prominence of virtual representation 708c (e.g., having one or more characteristics of increasing the visual prominence of virtual representation 708a, 708b, and/or 708c described above).

In some embodiments, in accordance with a determination that a total number of users in the communication session exceeds a threshold amount (e.g., 2, 3, 4, 5, or 10), computer system 101 displays the plurality of virtual representations of the users in the communication session in different regions of three-dimensional environment 702. In FIG. 7I, computer system 101 displays virtual representations 732a through 732d in a first region of three-dimensional environment 702, and a row of virtual representations 734 (including virtual representations 732e through 732g) in a second region of three-dimensional environment 702 (e.g., the second region of three-dimensional environment 702 is below the first region of three-dimensional environment 702 from the current viewpoint of respective user 716 of computer system 101).

In some embodiments, virtual representation 732a is associated with a first user of a second computer system (e.g., different from computer system 101) in the communication session, virtual representation 732b is associated with a second user of a third computer system in the communication session, virtual representation 732c is associated with a third user of a fourth computer system in the communication session, and virtual representation 732d is associated with a fourth user of a fifth computer system in the communication session. In some embodiments, virtual representation 732e is associated with a fifth user of a sixth computer system in the communication session, virtual representation 732f is associated with a sixth user of a seventh computer system in the communication session, and virtual representation 732g is associated with a seventh user of an eighth computer system in the communication session. In some embodiments, virtual representations 732a, 732c, and 732g have one or more characteristics of virtual representations 708a and 708c shown and described with reference to FIGS. 7A-7H. In some embodiments, virtual representations 732e and 732f have one or more characteristics of virtual representation 708b shown and described with reference to FIGS. 7A-7H. In some embodiments, virtual representation 732b includes real-time video of the second user, and virtual representation 732d includes real-time video of the fourth user. As shown in top-down view 714 of FIG. 7I, computer system 101 displays virtual representations 732a through 732g within a virtual object 720d (e.g., having one or more characteristics of virtual objects 720a, 720b, and/or 720c described above) in three-dimensional environment 702 (e.g., the first region of three-dimensional environment 702 (including virtual representations 732a through 732d) and the second region of three-dimensional environment 702 (including virtual representations 732e through 732g) are included within a volume of virtual object 720d).

In some embodiments, computer system 101 changes the visual prominence of virtual representations displayed in the first region, and not the second region, based on changes of participation of the users in the communication session. As shown in FIG. 7I, computer system 101 displays virtual representations 732a through 732d (corresponding to the virtual representations displayed within the first region of three-dimensional environment 702) with an amount of visual prominence corresponding to a current amount of participation of the users in the communication session (e.g., the amount of participation of the users in the communication session are represented by glyphs 736a through 736g). For example, computer system 101 displays virtual representation 732b with the most amount of visual prominence compared to the other virtual representations displayed in the first region of three-dimensional environment because the third user currently has the most amount of participation in the communication session (as shown by the size of the shaded portion of glyph 736b compared to glyphs 736a and 736c through 736g) (e.g., computer system 101 displays virtual representation 732b with the largest size relative to three-dimensional environment 702 and at the closest distance to the location corresponding to the current viewpoint of respective user 716 compared to other displayed virtual representations). For example, computer system 101 displays virtual representation 732a with the least amount of visual prominence compared to the other virtual representations displayed in the first region of three-dimensional environment 702 because the first user has the least amount of participation compared to the other users represented in the first region (as shown by the size of the shaded portion of glyph 736a compared to glyphs 736b through 736d) (e.g., computer system 101 displays virtual representation 732a with the smallest size relative to three-dimensional environment 702 and at the farthest distance from the location corresponding to the current viewpoint of respective user compared to virtual representations 732b through 732d).

In FIG. 7I, computer system 101 displays the row of virtual representations 734 with less visual prominence than virtual representations 732a through 732d. For example, as shown in FIG. 7I, virtual representations 732e through 732g are displayed with a smaller size relative to three-dimensional environment 702 compared to virtual representations 732a through 732d. For example, as shown in FIG. 7I, computer system 101 displays the row of virtual representations 734 at a farther distance from the location corresponding to the current viewpoint of respective user 716 in three-dimensional environment 702 than virtual representations 732a through 732d. In some embodiments, in response to detecting an indication corresponding to a change of participation of the fifth, sixth, or seventh user (represented in the row of virtual representations 734), computer system 101 forgoes changing a visual prominence of a respective virtual representation of the fifth, sixth, and/or seventh user (e.g., computer system 101 does not change the visual prominence of virtual representations 732e through 732g in response to changes of participation while virtual representations 732e through 732g are included in the row of virtual representations 734).

In some embodiments, in FIG. 7I, computer system 101 displays virtual representations 732a through 732d in the first region of three-dimensional environment 702 in accordance with a determination that the amount of participation of the first user, the second user, the third user, and the fourth user exceed a threshold 742a (illustrated as a dashed line overlaid on glyphs 736a through 736g). For example, computer system 101 displays virtual representations 732e through 732g in the row of virtual representations 734 because the participation of the fifth user, sixth user, and seventh user in the communication session does not exceed threshold 742a. In some embodiments, threshold amount 742 corresponds to an amount of participation relative to the participation of at least one of the plurality of users in the communication session (e.g., as described with reference to method 800). For example, threshold amount 742 corresponds to the amount of participation of the first user (shown by glyph 736a) because the first user has the lowest amount of participation in the communication session compared to the other users (the second user, third user, and fourth user) that are represented in the first region of three-dimensional environment 702.

In some embodiments, in FIG. 7J, computer system 101 detects one or more indications (e.g., received from the second computer system and/or sixth computer system) corresponding to a change of participation of the first user and the fifth user in the communication session. For example, as shown by glyphs 736a and 736e in FIG. 7J, the amount of participation of the first user has decreased (e.g., compared to as shown in FIG. 7I) and the amount of participation of the fifth user has increased (e.g., compared to as shown in FIG. 7I). In some embodiments, in FIG. 7J, in response to detecting the one or more indications, computer system 101 displays virtual representation 732e in the first region of three-dimensional environment 702 and virtual representation 732a in the row of virtual representations 734 (e.g., the second region of three-dimensional environment 702). In some embodiments, computer system 101 displays virtual representation 732e in the first region of three-dimensional environment 702 (e.g., and displays virtual representation 732a in the second region (e.g., the row of virtual representations 734)) in accordance with a determination that the amount of participation of the fifth user exceeded the amount of participation of the first user in the communication session (e.g., corresponding to threshold 742a shown and described with reference to FIG. 7I).

In FIG. 7J, computer system 101 changes the threshold amount of participation required to move a respective virtual representation from the row of virtual representations 734 to the first region of three-dimensional environment 702. For example, computer system 101 changes the threshold from threshold 742a (e.g., shown in FIG. 7I and corresponding to the amount of participation of the first user in FIG. 7I) to threshold 742b. For example, threshold 742b corresponds to the current amount of participation of the third user (shown by glyph 736c) in the communication session (e.g., the third user has the lowest amount of participation of the users of the communication session that are represented in the first region of three-dimensional environment 702).

As shown in FIG. 7J, computer system 101 displays virtual representations 732e and virtual representations 732b through 732d with a visual prominence corresponding to the amount of participation of the fifth user, second user, third user, and fourth user in the communication session (e.g., computer system 101 displays virtual representation 732e with the most visual prominence because the amount of participation of the fifth user in the communication session is greater than the amount of participation of the second user, third user, and the fourth user in the communication session).

In some embodiments, affordance 710, when selected, causes computer system 101 to move virtual object 720d in three-dimensional environment 702 (e.g., by a user input performed by respective user 716). In FIG. 7J, respective user 716 performs an input corresponding to a request to move virtual object 720d to a farther distance from the current viewpoint of respective user 716 in three-dimensional environment 702. As shown in FIG. 7J, the input includes attention 744 (e.g., including gaze) directed to affordance 710 and an air gesture, such as an air pinch, performed concurrently using hand 738. The air gesture includes movement of hand 738 (represented by arrow 740) toward the location respective user 716 desires to move virtual object 720d to in three-dimensional environment 702. In response to detecting the input performed by respective user 716 in FIG. 7K, computer system 101 moves virtual object 720d to a farther distance from the current viewpoint of respective user 716 in FIG. 7K (e.g., computer system 101 moves virtual object 720d in accordance with the movement of hand 738 during the input). As shown in FIG. 7K, moving virtual object 720d in response to the input includes moving virtual representations 732a through 732g in three-dimensional environment 702. For example, computer system 101 moves virtual representations 732a through 732g concurrently (e.g., in the same manner (e.g., in the same direction, at the same speed, and/or by the same amount (e.g., distance)) as respective user 716 performs the input to move virtual object 720d in three-dimensional environment 702. In some embodiments, as shown in FIG. 7K, computer system 101 continues to present virtual representations 732a through 732d at various distances from the viewpoint of the respective user 716 corresponding to the respective levels of participation of the users in the communication session.

FIG. 8 is a flowchart illustrating an example method 800 of moving one or more virtual representations in a three-dimensional environment in response to changes of participation of one or more users in a communication session. In some embodiments, the method 800 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 800 are, optionally, combined and/or the order of some operations is, optionally, changed.

In some embodiments, method 800 is performed at a first computer system (e.g., computer system 101) in communication with a display generation component (e.g., display generation component 120) and one or more input devices (e.g., image sensors 114a through 114c). In some embodiments, the first computer system is or includes an electronic device, such as a mobile device (e.g., a tablet, a smartphone, a media player, or a wearable device), or a computer. In some embodiments, the display generation component is a display integrated with the first computer system (optionally a touch screen display), external display such as a monitor, projector, television, or a hardware component (optionally integrated or external) for projecting a user interface or causing a user interface to be visible to one or more users. In some embodiments, the one or more input devices include an electronic device or component capable of receiving a user input (e.g., capturing a user input or detecting a user input) and transmitting information associated with the user input to the electronic device. Examples of input devices include an image sensor (e.g., a camera), location sensor, hand tracking sensor, eye-tracking sensor, motion sensor (e.g., hand motion sensor) orientation sensor, microphone (and/or other audio sensors), touch screen (optionally integrated or external), remote control device (e.g., external), another mobile device (e.g., separate from the electronic device), a handheld device (e.g., external), and/or a controller.

In some embodiments, while in a communication session with a plurality of computer systems other than the first computer system, wherein the first computer system is associated with a first user and the plurality of computer systems are associated with a plurality of users (802a), the first computer system displays (802b), via the display generation component, a plurality of representations of the plurality of users in a three-dimensional environment from a current viewpoint of the first user (e.g., virtual representations 708a through 708c displayed in three-dimensional environment 702 in FIG. 7A), the plurality of representations including a first representation of a second user of the plurality of users displayed at a first distance from the current viewpoint of the first user, such as virtual representation 708a shown in FIG. 7A. In some embodiments, the plurality of computer systems have one or more characteristics of the first computer system (e.g., the one or more communication systems are in communication with a display generation components and input devices having one or more characteristics of the display generation component and the one or more input devices described with reference to the first computer system). In some embodiments, the first computer system is a different type of computer system from and/or of a different architecture than at least a portion of the plurality of computer systems. For example, the first computer system is a wearable device (e.g., including a head-mounted display) and at least a portion of the plurality of computer systems are not head-mounted displays (e.g., a portion of the plurality of computer systems are tablets, laptops and/or smartphones). In some embodiments, the communication session has one or more characteristics of the communication session described with reference to methods 1000, 1200, and/or 1400. In some embodiments, the communication session is associated with a respective application that is accessible through the first computer system (e.g., by the first user) and the plurality of computer systems (e.g., by the plurality of users), such as an application for facilitating real-time video and/or audio calls (e.g., through the reception and transmission of audio and/or video signals). In some embodiments, the communication session is a real-time (e.g., or nearly real-time) communication session that includes audio (e.g., real-time voice audio from the first user and/or the plurality of users, and/or audio content from media shared between the first user and the plurality of users), video (e.g., real-time video of the first user and/or the plurality of users, and/or video content from media shared between the first user and the plurality of users) and/or other shared content (e.g., virtual representations (e.g., representations of virtual environments, avatars, and/or personas associated with the first user and/or the plurality of users), images, applications, and/or interactive media (e.g., video game media)). In some embodiments, the communication session includes simulated and/or computer-generated video (e.g., by changing one or more visual characteristics of an avatar) and/or real-time video of the plurality of users and/or real-world objects (e.g., captured by one or more cameras of the plurality of computer systems).

In some embodiments, the three-dimensional environment is generated, displayed, or otherwise caused to be viewable by the first computer system. For example, the three-dimensional environment is an extended reality (XR) environment, such as a virtual reality (VR) environment, a mixed reality (MR) environment, or an augmented reality (AR) environment. In some embodiments, the three-dimensional environment includes one or more virtual objects (e.g., including the plurality of representations) and/or representations of objects in a physical environment of a user of the computer system. In some embodiments, the three-dimensional environment has one or more characteristics of three-dimensional and/or virtual environments described with reference to methods 1000, 1200, and/or 1400. In some embodiments, at least a portion of the plurality of representations include an avatar and/or a virtual persona (e.g., an avatar and/or virtual persona is optionally created and/or customized by a respective user and/or corresponds to one or more visual characteristics of the respective user). In some embodiments, at least a portion of the plurality of representations include a virtual representation of a shape, such as a circle (e.g., a coin), oval, square, diamond, triangle, sphere, cylinder, cone, or cuboid. In some embodiments, at least a portion of the plurality of representations include an indication corresponding to a name of a respective user of the plurality of users. In some embodiments, the first computer system changes one or more visual features of a respective representation of the plurality of representations in response to receiving an indication (e.g., from a respective computer system of the plurality of computer systems) corresponding to participation of a respective user in the communication session (e.g., the first computer system changes one or more facial features of an avatar representing the respective user). In some embodiments, the plurality of representations are displayed within one or more virtual windows and/or containers. For example, the first representation of the second user is displayed within a first virtual window, and a second representation of a third user, different from the second user, is displayed within a second virtual window, different from the first virtual window. The plurality of representations are optionally displayed at different distances (e.g., at different depths) relative to the current viewpoint of the first user in the three-dimensional environment. For example, a second representation of a third user, different from the first representation of the second user, is displayed at a second distance, different from the first distance, from the current viewpoint of the first user. In some embodiments, the plurality of representations are two-dimensional virtual elements (e.g., the virtual windows and/or containers are two-dimensional). In some embodiments, the one or more virtual windows are arranged in a pattern in the three-dimensional environment (e.g., virtual windows are arranged linearly (e.g., aligned at the same height and/or distance relative to the current viewpoint of the first user), or non-linearly (e.g., arranged at different heights and/or distance (e.g., alternating heights and/or distances) relative to the current viewpoint of the first user)). In some embodiments, the plurality of representations are included within a virtual object associated with the communication session. For example, the virtual object includes the one or more virtual windows (e.g., the virtual object has a volume including one or more locations of the one or more virtual windows). The virtual object optionally does not include a virtual boundary and/or perimeter (e.g., a boundary is not displayed surrounding the plurality of representations). In some embodiments, the plurality of representations (e.g., and/or the virtual object the plurality of representations are included within) are selectable to move (e.g., collectively) in response to user input. For example, the virtual object and/or the plurality of representations are displayed with a selectable option (e.g., an affordance) that, when selected, causes the electronic device to move the plurality of representations (and/or the virtual object) in the three-dimensional environment. For example, in response to detecting a request to move the plurality of representations (e.g., through a selection input directed to an affordance that includes attention (e.g., by gaze, hand position, and/or cursor) and a hand gesture (e.g., including movement), such as an air pinch), the first computer system moves the plurality of representations (e.g., the virtual object) from a first region (e.g., including a first volume that includes a plurality of first locations of the plurality of representations) to a second region (e.g., including a second volume, different from the first volume, including a plurality of second locations of the plurality of representations), different from the first region, in the three-dimensional environment. In some embodiments, the plurality of representations have one or more characteristics of representations described with reference to methods 1000, 1200, and/or 1400.

In some embodiments, the first computer system detects (802c) an indication corresponding to a change of participation of the second user in the communication session, such as the indication detected by computer system 101 in FIG. 7B corresponding to the increase of participation of the first user of the second computer system in the communication session (e.g., as represented by glyph 712a in FIG. 7B). In some embodiments, the indication is received from a second computer system of the plurality of computer systems in the communication session (e.g., the second computer system is associated with the second user). In some embodiments, the indication is a signal received from the second computer system (e.g., through a network such as a personal, local, or wide area network), or from one or more servers in communication with the first computer system and the second computer system (e.g., and the plurality of computer systems in the communication session). In some embodiments, the change of participation corresponds to the second user speaking in the communication session (e.g., the indication includes an audio signal associated with an audio input that is detected by one or more input devices of the second computer system) or ceasing speaking. In some embodiments, the change of participation corresponds to the second user joining the communication session (e.g., the indication corresponds to the second computer system establishing communication with the first computer system and/or the plurality of computer systems in the communication session). In some embodiments, the change of participation corresponds to physical movement of the second user (e.g., the indication includes information regarding movement of one or more portions (e.g., a hand) of the second user (e.g., the second user is communicating in the communication session through sign language)) or cessation of movement. In some embodiments, the change of participation corresponds to an increase in the amount of participation of the second user (e.g., the user is speaking more than previously in the communication session). In some embodiments, the change of participation corresponds to a decrease in the amount of participation of the second user (e.g., a duration of time (e.g., 1, 2, 5, 10, 15, 30, 45, 60, or 120 seconds) has passed without participation of the second user). In some embodiments, the first computer system receives an indication from a third computer system, different from the second computer system, of the plurality of computer systems corresponding to an increase of participation of a third user, different from the second user, of the plurality of users, and the first computer system determines that the amount of participation of the second user has changed relative to the amount of participation of the third user in the communication session.

In some embodiments, in response to detecting the indication of the change of participation of the second user in the communication session (802d), in accordance with a determination that the change of the participation of the second user satisfies first one or more criteria, the first computer system moves (802e) the first representation of the second user to a second distance, different from the first distance, from the current viewpoint of the first user in the three-dimensional environment, such as computer system 101 moving virtual representation 708a closer to the location corresponding to the current viewpoint of respective user 716 from FIG. 7A to 7C. In some embodiments, the first representation of the second user is moved without input from the first user (e.g., the first representation of the second user is moved automatically by the first computer system in response to detecting the indication of the change of participation of the second user in the communication session). In some embodiments, the first criteria include a criterion that is satisfied when an absolute change in the participation of the second user exceeds a threshold amount. For example, the threshold amount corresponds to a proportion of an overall participation of the plurality of users in the communication (e.g., 10, 20, 25, or 50 percent). Alternatively, for example, the threshold amount of participation is independent of the participation of the plurality of users in the communication session (e.g., independent of the overall participation of the plurality of users and/or the amount of participation of one or more users of the plurality of users). In some embodiments, the first criteria include a criterion that is satisfied when the amount of participation of the second user exceeds an amount of participation of one or more users of the plurality of users in the communication session. In some embodiments, the magnitude and/or direction of the movement of the first representation corresponds to the amount of change in the participation of the second user (e.g., as described below). In some embodiments, in accordance with a determination that the indication received from the second computer system does not include a change of participation of the second user, the first computer system maintains the first representation of the second user at the first distance from the current viewpoint of the first user in the three-dimensional environment. In some embodiments, the first representation of the second user is moved independent of the other representations of the plurality of representations. For example, a second representation, different from the first representation, of a third user, different from the second user, of the plurality of representations is moved (e.g., to a different distance from the current viewpoint of the first user) by the first computer system based on the participation of the third user in the communication session (e.g., independent of the participation of the second user and/or the distance of the second representation in the three-dimensional environment from the current viewpoint of the first user). In some embodiments, moving the first representation of the second user to the second distance includes maintaining a location of the virtual object (e.g., and/or one or more of the plurality of representations included in the virtual object) in the three-dimensional environment. For example, movement of the first representation in the three-dimensional environment corresponds to movement of the first representation within the volume of the virtual object. In some embodiments, while moving the first representation of the second user to the second distance from the current viewpoint of the first user in the three-dimensional environment, the first computer system moves a second representation of a third user from a third distance to a fourth distance, different from the third distance, from the current viewpoint of the first user in the three-dimensional environment (e.g., the amount of participation of the third user changes concurrently with the amount of participation of the second user). A location corresponding to the current viewpoint of the first user in the three-dimensional environment is optionally maintained while the first computer system moves the first representation of the second user (e.g., the first user does not move relative to the three-dimensional environment while the first computer system receives the indication from the second computer system and/or moves the first representation of the second user in the three-dimensional environment). Moving a representation of a user of a communication session to a different distance in a three-dimensional environment relative to a current viewpoint of a respective user provides a guided and continuous user interface for the communication session by displaying visual guidance of where in the three-dimensional environment the respective user should direct their attention, thereby reducing errors in interaction and improving user device interaction.

In some embodiments, while displaying the first representation of the second user at the first distance from the current viewpoint of the first user, before detecting the indication of the change of participation of the second user, the first computer system displays the first representation of the second user with a first size relative to the three-dimensional environment, such as the size computer system 101 displays virtual representation 708a with relative to three-dimensional environment 702 in FIG. 7A. In some embodiments, in response to detecting the indication of the change of participation of the second user in the communication session, in accordance with the determination that the change of participation of the second user satisfies the first one or more criteria, the first computer system displays the first representation of the second user with a second size, different from the first size, relative to the three-dimensional environment, such as the size computer system 101 displays virtual representation 708a with relative to the three-dimensional environment 702 in FIG. 7C. In some embodiments, in accordance with a determination that the change of participation of the second user corresponds to an increase in participation of the second user in the communication session, the second size is larger than the first size. For example, in response to detecting an indication corresponding to an increase in participation of the second user, the first computer system increases the size of the first representation of the second user (e.g., while moving the first representation of the second user from the first distance to the second distance from the current viewpoint of the first user in the three-dimensional environment). In some embodiments, in accordance with a determination that the change of participation of the second user corresponds to a decrease in participation of the second user in the communication session, the second size is smaller than the first size. For example, in response to detecting an indication corresponding to a decrease in participation of the second user, the first computer system decreases the size of the first representation of the second user (e.g., while moving the first representation of the second user from the first distance to the second distance from the current viewpoint of the first user in the three-dimensional environment). In some embodiments, the first size and/or the second size correspond to a size of the first representation of the second user relative to the three-dimensional environment (e.g., the first size and/or the second size do not correspond to display sizes (e.g., a size of the first representation of the second user relative to the current viewpoint of the first user)). For example, additionally or alternatively to displaying the first representation of the second user with the second size relative to the three-dimensional environment, the first computer system changes a display size of the first representation of the second user from the current viewpoint of the first user (e.g., because the first computer system moves the first representation of the second user to a different distance (e.g., the second distance) from the current viewpoint of the first user in the three-dimensional environment). In some embodiments, the first size of the first representation of the second user corresponds to a first amount of participation of the second user in the communication session (e.g., an amount of participation of the second user in the communication session prior to detecting the indication of the change of participation of the second user), and the second size of the first representation of the second user corresponds to a second amount of participation of the second user, different from the first amount of participation of the second user, in the communication session (e.g., an amount of participation of the second user in the communication session included in the indication). Changing a size of a representation of a user of a communication session in a three-dimensional environment provides a guided and continuous user interface for the communication session by displaying visual guidance of where in the three-dimensional environment a respective user viewing the three-dimensional environment should direct their attention, thereby reducing errors in interaction and improving user device interaction.

In some embodiments, the first representation of the second user includes a first portion (e.g., second portion 730a of virtual representation 708a shown in FIG. 7A) and a second portion, different from the first portion (e.g., first portion 718a of virtual representation 708a shown in FIG. 7A). In some embodiments, the first representation of the second user includes a virtual window (e.g., as described above) comprising a representation of the second user. For example, the representation of the second user corresponds to real-time video of the second user (e.g., real-time video of a face of the second user), a virtual representation (e.g., of a shape), an avatar, and/or a virtual persona (e.g., as described above). In some embodiments, the second portion of the first representation of the second user corresponds to a portion of the virtual window that includes the representation of the second user (e.g., real-time video that includes a face of the second user, or a virtual representation of the second user, such as an avatar and/or virtual persona). In some embodiments, the first portion of the first representation of the second user corresponds to a portion of the virtual window that does not include the representation of the second user (e.g., does not include the real-time video that includes the face of the second user, or a virtual representation of the second user, such as an avatar and/or virtual persona). For example, the first portion of the first representation of the second user corresponds to a background that is presented behind the representation of the second user in the virtual window. For example, the virtual window includes real-time video of the second user, the first portion corresponds to the real-time video that does not include a face and/or body of the second user, and the second portion corresponds to the real-time video that includes the face and/or body of the second user. For example, the virtual window includes a virtual representation of the second user (e.g., as a shape, avatar, and/or virtual persona), the first portion corresponds to a background presented behind the virtual representation of the second user (e.g., not including the virtual representation of the second user), and the second portion corresponds to the virtual representation of the second user. In some embodiments, the background includes a representation of a virtual environment (e.g., as described above, and in reference to methods 1000, 1200, and/or 1400). In some embodiments, the background includes a representation of a physical environment of the second user (e.g., that is visible in real-time video).

In some embodiments, displaying the first representation of the second user with the second size includes changing a respective size of the first portion while maintaining a respective size of the second portion, such as changing the size of second portion 730a while maintaining the size of first portion 718a of virtual representation 708a in FIG. 7B. In some embodiments, displaying the first representation of the second user includes maintaining a size of the representation of the second user relative to the three-dimensional environment while changing a size of the background of the virtual window. In some embodiments, displaying the first representation of the second user with the second size includes displaying a representation of the second user (e.g., a real-time video of a face of the second user, or a virtual representation of the second user that includes a shape, avatar, and/or virtual persona) with the same size relative to the three-dimensional environment as displaying the first representation of the second user with the first size. Additionally, or alternatively, for example, displaying the first representation of the second user with the second size includes displaying the representation of the second user with a different display size (e.g., a different size relative to a current viewpoint of the first user) than displaying the first representation of the second user with the first size (e.g., because the first computer system maintains the size of the first representation of the second user relative to the three-dimensional environment while moving the first representation of the second user to a different distance from a location corresponding to the current viewpoint of the first user (e.g., as described below)). For example, in response to detecting the indication of the change of participation of the second user in the communication session, the first computer system displays the first representation of the second user with a larger display size because the first computer system moves to the first representation of the second user to closer to a location corresponding to the current viewpoint of the first user and/or increases the size of the first representation of the second user relative to the three-dimensional environment. For example, in response to detecting the indication of the change of participation of the second user in the communication session, the first computer system displays the first representation of the second user with a smaller display size because the first computer system moves the first representation of the second user farther from a location corresponding to the current viewpoint of the first user and/or decreases a size of the first representation of the second user relative to the three-dimensional environment. In some embodiments, displaying the first representation of the second user with the second size includes displaying a greater amount of background of the virtual window than displaying the first representation of the second user with the first size. For example, while displaying the first representation of the second user with the second size, the first computer system displays (e.g., reveals) a greater portion of the background while maintaining a size of the representation of the second user relative to the three-dimensional environment (e.g., maintaining a size of the face of the second user included in real-time video, or maintaining a size of a virtual representation of the second user, such as a shape, avatar, and/or virtual persona). Displaying the first representation of the second user with the second size optionally includes displaying more of the content of the first representation of the second user (e.g., more content of the background of the first representation of the second user and/or of an avatar of the second user). For example, displaying the first representation of the second user with the first size includes displaying a first cropped version of real-time video and/or a virtual representation of the second user, and displaying the first representation of the second user with the second size includes displaying a second cropped version, larger than the first cropped version, of the real-time video and/or virtual representation of the second user. In some embodiments, displaying the first representation of the second user with the second size includes displaying a smaller amount of background than displaying the first representation of the second user with the first size. For example, while displaying the first representation of the second user with the second size, the first computer system displays a smaller portion of the background while maintaining a size of the representation of the second user. Displaying the first representation of the second user with the second size optionally includes displaying less of the content of the first representation of the second user (e.g., less content of the background of the first representation of the second user and/or of an avatar of the second user). For example, displaying the first representation of the second user with the first size includes displaying a first cropped version of real-time video and/or a virtual representation of the second user, and displaying the first representation of the second user with the second size includes displaying a second cropped version, smaller than the first cropped version, of the real-time video and/or virtual representation of the second user. Changing a size of a first portion of a representation of a user of a communication session displayed in a three-dimensional environment while maintaining a size of a second portion, different from the first portion, of the representation of the user provides a guided and continuous user interface for the communication session by displaying visual guidance of where a respective user viewing the three-dimensional environment should direct their attention in a manner that prevents distraction from the respective user's participation in the communication session, thereby reducing errors in interaction and improving user device interaction.

In some embodiments, the first one or more criteria include a criterion that is satisfied when the change of participation of the second user exceeds a threshold amount of participation, such as threshold 742a shown in FIG. 7J. In some embodiments, the threshold amount has one or more characteristics of the threshold amount of participation described above. In some embodiments, in accordance with a determination that the change of participation of the second user increases by more than the threshold amount, the first computer system moves the first representation of the second user closer to the current viewpoint of the first user in the three-dimensional environment, and in accordance with a determination that the change of participation of the second user decreases by more than the threshold amount, the first computer system moves the first representation of the second user farther from the current viewpoint of the first user in the three-dimensional environment. In some embodiments, the threshold amount corresponds to an amount of participation of one or more users of the plurality of users in the communications session (e.g., as described above)—for example, the threshold amount changes depending on the level of participation of the different participants in the communication session. For example, in accordance with a determination that the amount of participation of the second user exceeds the amount of participation of a third user of the plurality of users, different from the second user, the first computer system moves the first representation of the second user closer to the current viewpoint of the first user in the three-dimensional environment (e.g., to a distance that is closer to the current viewpoint of the first user than the distance of a second representation of the third user in the three-dimensional environment). For example, in accordance with a determination that the amount of participation of the second user decreases to less than the amount of participation of the third user, the first computer system moves the first representation of the second user farther from the current viewpoint of the first user in the three-dimensional environment. In some embodiments, in accordance with a determination that the change of participation of the second user does not exceed the threshold amount, the first computer system forgoes moving the first representation of the second user to the second distance from the current viewpoint of the first user. Moving a representation of a user of a communication session to a different distance in a three-dimensional environment relative to a current viewpoint of a respective user when the user of the communication session exceeds a threshold amount of change of participation provides a guided and continuous user interface for participation in the communication session by displaying visual guidance of where in the three-dimensional environment the respective user should direct their attention, thereby reducing errors in interaction and improving user device interaction.

In some embodiments, moving the first representation of the second user to the second distance further comprises, in accordance with a determination that the change in participation of the second user corresponds to a first amount of change of participation, moving the first representation of the second user by a first amount of distance relative to the current viewpoint of the user (e.g., towards or away from the current viewpoint of the user) corresponding to the first amount of change in participation, such as the amount of movement of virtual representation 708a shown from FIG. 7A to FIG. 7C (e.g., corresponding to the change of participation (shown by glyph 712a) of the first user of the second computer system in the communication session from FIG. 7A to FIG. 7C). In some embodiments, moving the first representation of the second user to the second distance further comprises, in accordance with a determination that the change of participation of the second user corresponds to a second amount of change in participation different from the first amount of change in participation, moving the first representation of the second user by a second amount of distance relative to the current viewpoint of the user (e.g., towards or away from the current viewpoint of the user) corresponding to the second amount of change in participation, the second amount of distance different from the first amount of distance, such as the amount of movement of virtual representation 708b shown from FIG. 7B to FIG. 7C (e.g., corresponding to the change of participation (shown by glyph 712b) of the second user of the third computer system in the communication session from FIG. 7B to FIG. 7C). In some embodiments, the first amount of distance and the second amount of distance are relative to a location in the three-dimensional environment corresponding to the current viewpoint of the first user (e.g., the first amount of distance is a first distance from the current viewpoint of the first user and the second amount of distance is a second distance from the current viewpoint of the first user). For example, the first amount of distance and/or the second amount of distance are along an axis in the three-dimensional environment corresponding to depth from the current viewpoint of the first user. In some embodiments, in accordance with the first amount of change of participation being greater than the second amount of change of participation, the first amount of distance of movement of the first representation of the second user is greater than the second amount of distance of movement of the first representation of the second user. In some embodiments, in accordance with the first amount of change of participation being less than the second amount of change of participation, the first amount of distance of movement of the first representation of the second user is less than the second amount of distance of movement of the first representation of the second user. In some embodiments, the difference between the first amount of change and the second amount of change of the participation of the second user in the communication session corresponds to a difference in the amount of speaking (e.g., duration and/or frequency of speaking) and/or amount of movement of the second user. In some embodiments, in response to detecting the indication of the change of participation of the second user in the communication session, the first computer system changes the size of the first representation of the second user, additionally or alternatively to moving the first representation of the second user, by an amount that is based on the amount of change of participation of the second user in the communication session. In some embodiments, in accordance with the determination that the change of participation of the second user corresponds to the first amount of change of participation, the first computer system changes a size of the first representation of the second user by a first amount, and in accordance with a determination that the change of participation of the second user corresponds to the second amount of change of participation, the first computer system changes the size of the first representation of the second user by a second amount, different from the first amount (e.g., changing the size of the first representation of the second user by the first amount and/or the second amount has one or more characteristics of changing the size of the first representation of the second user described above). For example, in accordance with the first amount of change of participation being greater than the second amount of change of participation, the first amount of change in size is greater than the second amount of change in size (e.g., the first amount of change in size includes changing the size of the first portion of the first representation of the second by a greater amount than the second amount of change in size (e.g., as described above)). For example, in accordance with the first amount of change of participation being less than the second amount of change of participation, the first amount of change in size is less than the second amount of change in size (e.g., the first amount of change in size includes changing the size of the first portion of the first representation of the second user by a smaller amount than the second amount of change in size (e.g., the first portion of the first representation of the second user has one or more characteristics of the first portion of the first representation of the second user described above). Moving a representation of a user of a communication session by different amounts in a three-dimensional environment relative to a current viewpoint of a respective user provides a guided and continuous user interface for the communication session by displaying visual guidance to the respective user of where to direct their attention while limiting the animation to an appropriate amount based on the change of participation of the user, thereby improving user device interaction and conserving computing resources.

In some embodiments, moving the first representation of the second user to the second distance further comprises, in accordance with a determination that the change of participation of the second user corresponds to an increase of participation of the second user in the communication session, moving the first representation of the second user closer to a location corresponding to the current viewpoint of the first user in the three-dimensional environment, such as the movement of virtual representation 708b closer to the location corresponding to the current viewpoint of respective user 716 from FIG. 7C to FIG. 7D (e.g., corresponding to the increase of participation (shown by glyph 712b) of the second user of the third computer system in the communication session from FIG. 7C to FIG. 7D). In some embodiments, in accordance with a determination that the participation of the second user increases by a first amount, the first computer system moves the first representation of the second user from a first location in the three-dimensional environment to a second location in the three-dimensional environment that is closer to the location corresponding to the current viewpoint of the first user than the first location. In some embodiments, in accordance with a determination that the participation of the second user increases by a second amount, greater than the first amount, the first computer system moves the first representation of the second user from the first location in the three-dimensional environment to a third location in the three-dimensional environment that is closer to the location corresponding to the current viewpoint of the first user than the second location.

In some embodiments, moving the first representation of the second user to the second distance further comprises, in accordance with a determination that the change of participation of the second user corresponds to a decrease of participation of the second user in the communication session, moving the first representation of the second user farther from the location corresponding to the current viewpoint of the first user in the three-dimensional environment, such as the movement of virtual representation 708a farther from the location corresponding to the current viewpoint of respective user 716 from FIG. 7C to FIG. 7D (e.g., corresponding to the decrease of participation (shown by glyph 712a) of the first user of the second computer system in the communication session from FIG. 7C to FIG. 7D). In some embodiments, in accordance with a determination that the participation of the second user decreases by a first amount, the first computer system moves the first representation of the second user from a first location in the three-dimensional environment to a second location in the three-dimensional environment that is farther from the location corresponding to the current viewpoint of the first user than the first location. In some embodiments, in accordance with a determination that the participation of the second user decreases by a second amount, greater than the first amount, the first computer system moves the first representation of the second user from the first location to a third location in the three-dimensional environment that is farther from the location corresponding to the current viewpoint of the first user than the second location. In some embodiments, additionally or alternatively to moving the first representation of the second user, the first computer system changes the size of the first representation of the second user (e.g., having one or more characteristics of changing the size of the first representation of the second user described above). For example, in accordance with a determination that the change of participation of the second user corresponds to an increase in participation of the second user in the communication session, the first computer system increases the size of the first representation of the second user. For example, in accordance with a determination that the change of participation of the second user corresponds to a decrease in participation of the second user in the communication session, the first computer system decreases the size of the first representation of the second user. In some embodiments, a location of a respective representation of a respective user of the plurality of representations in the three-dimensional environment corresponds to a value of participation of the respective user in the communication session. For example, the first computer system defines (e.g., in information stored in a memory) a plurality of fixed locations in the three-dimensional environment that a respective representation of a respective user can be moved to based on the amount of participation of the respective user in the communication session. In some embodiments, the plurality of representations are included within a virtual object associated with the communication session (e.g., as described above), and the plurality of fixed locations correspond to locations within the volume of the virtual object. In some embodiments, each fixed location of the plurality of fixed locations corresponds to a threshold amount of participation (e.g., a level of participation). For example, the first computer system defines 2, 3, 4, 5, 10, 15, 16, 18, 20, or 25 fixed locations in the three-dimensional environment (e.g., within the virtual object the plurality of representations are included in) that correspond to different threshold amounts of participation. For example, the plurality of fixed locations include a first fixed location corresponding to a maximum level of participation in the communication session, and a second fixed location corresponding to a minimum level of participation in the communication session. The first fixed location is optionally located closest to the location corresponding to the current viewpoint of the first user of the plurality of fixed locations, and the second fixed location is optionally located farthest from the location corresponding to the current viewpoint of the first user of the plurality of fixed locations. The plurality of fixed locations optionally include one or more fixed locations corresponding to intermediate levels of participation between the first fixed location and the second fixed location (e.g., the one or more fixed locations are at one or more distances between the first fixed location and the second fixed location from the location corresponding to the current viewpoint of the first user). In some embodiments, in accordance with the determination that the change of participation of the second user corresponds to an increase of participation of the second user in the communication session, the first computer system moves the first representation of the second user from a first fixed location of the plurality of fixed locations to a second fixed location of the plurality of fixed locations that is closer to the location corresponding to the current viewpoint of the first user than the first fixed location. In some embodiments, in accordance with the determination that the change of participation of the second user corresponds to a decrease of participation of the second user in the communication session, the first computer system moves the first representation of the second user from a first fixed location of the plurality of fixed locations to a second fixed locations of the plurality of fixed locations that is farther from the current viewpoint of the first user than the first fixed location. Moving a representation of a user of a communication closer to or farther from a current viewpoint of a respective user in a three-dimensional environment based on the amount of participation of the user in the communication session provides a guided and continuous user interface for the communication session by displaying visual guidance of where in the three-dimensional environment the respective user should direct their attention, thereby reducing errors in interaction and improving user device interaction.

In some embodiments, moving the first representation of the second user to the second distance further comprises, in accordance with a determination that the change of participation of the second user corresponds to an increase of participation of the second user in the communication session, increasing a visual prominence of the first representation of the second user, such as the increase of visual prominence (e.g., increase of size) of virtual representation 708b from FIG. 7C to FIG. 7D (e.g., corresponding to the increase of participation (shown by glyph 712b) of the second user of the third computer system in the communication session from FIG. 7C to FIG. 7D). In some embodiments, increasing the visual prominence of the first representation of the second user includes increasing a size of the first representation of the second user relative to the three-dimensional environment (e.g., as described above). In some embodiments, increasing the visual prominence of the first representation of the second user includes moving the first representation of the second user closer to a location corresponding to the current viewpoint of the first user in the three-dimensional environment (e.g., as described above). In some embodiments, increasing the visual prominence of the first representation of the second user includes increasing a size of the first representation of the second user while concurrently moving the first representation of the second user to a location closer to the location corresponding to the current viewpoint of the first user in the three-dimensional environment. In some embodiments, increasing a visual prominence of the first representation of the second user includes increasing an amount of opacity, brightness, color, saturation, and/or sharpness of at least a portion of the first representation of the second user.

In some embodiments, moving the first representation of the second user to the second distance further comprises, in accordance with a determination that the change of participation of the second user corresponds to a decrease of participation of the second user in the communication session, decreasing a visual prominence of the first representation of the second user, such as the decrease of visual prominence (e.g., decrease of size) of virtual representation 708a from FIG. 7C to FIG. 7D (e.g., corresponding to the decrease of participation (shown by glyph 712a) of the first user of the second computer system in the communication session from FIG. 7C to FIG. 7D). In some embodiments, decreasing the visual prominence of the first representation of the second user includes decreasing a size of the first representation of the second user relative to the three-dimensional environment (e.g., as described above). In some embodiments, decreasing the visual prominence of the first representation of the second user includes moving the first representation of the second user farther from a location corresponding to the current viewpoint of the first user in the three-dimensional environment (e.g., as described above). In some embodiments, decreasing a visual prominence of the first representation of the second user includes decreasing a size of the first representation of the second user while concurrently moving the first representation of the second user to a location farther from the location corresponding to the current viewpoint of the first user in the three-dimensional environment. In some embodiments, decreasing a visual prominence of the first representation of the second user includes decreasing an amount of opacity, brightness, color, saturation, and/or sharpness of at least a portion of the first representation of the second user. Changing a visual prominence of a representation of a user of a communication session in a three-dimensional environment provides a guided and continuous user interface for the communication session by displaying visual guidance to a respective user viewing the three-dimensional environment of where the respective user should direct their attention, thereby reducing errors in interaction and improving user device interaction.

In some embodiments, while displaying the first representation of the second user at the second distance from the current viewpoint of the first user in the three-dimensional environment (e.g., virtual representation 708b shown in FIG. 7D), the first computer system displays a second representation of a third user of the plurality of users at a third distance, different from the second distance, from the current viewpoint of the first user in the three-dimensional environment (e.g., virtual representation 708c shown in FIG. 7D), wherein the second distance corresponds to a current amount of participation of the second user in the communication session (e.g., the distance of virtual representation 708b from the current viewpoint of respective user 716 in FIG. 7D corresponding to the amount of participation (shown by glyph 712b) of the second user of the third computer system in the communication session) and the third distance corresponds to a current amount of participation of the third user in the communication session (e.g., the distance of virtual representation 708c from the current viewpoint of respective user 716 in FIG. 7D corresponding to the amount of participation (shown by glyph 712c) of the third user of the fourth computer system in the communication session). In some embodiments, the current amount of participation of the second user in the communication session is different from the current amount of participation of the third user in the communication session (e.g., the second user spoke more recently and/or is speaking more frequently in the communication session compared to the third user). In some embodiments, the second representation of the third user has one or more characteristics of the second representation of the third user described above (e.g., the second representation of the third user is a representation of the plurality of representations of the plurality of users in the communication session). In some embodiments, the first computer system moves the first representation of the second user independent of the other representations of the plurality of representations (e.g., as described above). For example, the first computer system moves the second representation of the third user to the third distance from the current viewpoint of the first user in response to receiving an indication corresponding to a change of participation of the third user (e.g., the indication corresponding to the change of participation of the third user is different and/or independent from the indication corresponding to the change of participation of the second user). In some embodiments, the first computer system displays the first representation of the second user and the second representation of the third user at fixed locations of the plurality of fixed locations in the three-dimensional as described above. For example, the first computer system displays the first representation of the second user at a first fixed location of the plurality of fixed locations (e.g., the first fixed location corresponds to the second distance from the current viewpoint of the first user) and displays the third representation of the third user at a second fixed location of the plurality of fixed locations different from the first fixed location (e.g., the second fixed location corresponds to the third distance from the current viewpoint of the first user). In some embodiments, in accordance with the current amount of participation of the third user being greater than the current amount of participation of the second user, the third distance is less than the second distance. In some embodiments, in accordance with the current amount of participation of the third user being less than the current amount of participation of the second user, the third distance is greater than the second distance. Displaying multiple representations of users of a communication session at different locations in a three-dimensional environment based on the current amount of participation of the users in the communication session provides a guided and continuous user interface for the communication session by visually indicating to a respective user viewing the three-dimensional environment which users have most recently participated in the communication session, thereby reducing errors in interaction and improving user device interaction.

In some embodiments, the change of participation of the second user in the communication session corresponds to a change in the first representation of the second user from a respective representation of a first type to a respective representation of a second type, different from the respective representation of the first type, such as the change of the amount of participation (shown by glyph 712c) of the third user of the fourth computer system in the communication session from FIG. 7G to FIG. 7H in response to the change of the respective representation of the third user from spatial representation 722 (shown in FIG. 7G) to virtual representation 708c (shown in FIG. 7H). In some embodiments, the respective representation of the first type has one or more characteristics of the spatial representation of the second user described with reference to method 1000. In some embodiments, the respective representation of the second type has one or more characteristics of the non-spatial representation of the second user described with reference to method 1000. In some embodiments, the first computer system changes the first representation of the second user from the respective representation of the first type to the respective representation of the second type in response to receiving an indication corresponding to a request to include a spatial representation of the second user in the communication session (e.g., as described with reference to method 1000). In some embodiments, the respective representation of the first type corresponds to a respective representation that is not displayed within a virtual window in the three-dimensional environment (e.g., the virtual window having one or more characteristics of the one or more virtual windows described above). In some embodiments, the first computer system displays the respective representation of the second type corresponds to a respective representation that within a virtual window in the three-dimensional environment. In some embodiments, the first computer system displays at least a portion of the plurality of representations within a virtual object in the three-dimensional environment (e.g., having one or more characteristics of the virtual object including the plurality of representations described above). For example, a first portion of the plurality of representations that are displayed outside of the virtual object correspond to respective representations of the first type, and a second portion, different from the first portion, of the plurality of representations that are displayed within the virtual object correspond to respective representations of the second type. Moving a representation of a user of a communication session to a different distance in a three-dimensional environment relative to a current viewpoint of a respective user when the user changes from a representation of a first type to a representation of a second type, different from the first type, provides a visual indication to the respective user of the change in the type of representation of the user, thereby reducing errors in interaction.

In some embodiments, in response to detecting the indication of the change of participation of the second user in the communication session, in accordance with a determination that the first representation of the second user corresponds to a respective representation of a first type, the first computer system changes a first visual characteristic of the first representation of the second user, such as the change of color, brightness, and/or saturation of first portion 718b of virtual representation 708b shown in FIG. 7C. In some embodiments, the respective representation of the first type corresponds to a representation that includes a virtual representation of a shape (e.g., as described above). In some embodiments, the respective representation of the first type includes an indication corresponding to a name of a respective user (e.g., a name associated with a user profile of the respective user). In some embodiments, the respective representation of the first type does not include an avatar and/or a virtual persona. In some embodiments, the respective representation of the first type does not include real-time video of a respective user. In some embodiments, a respective user of the plurality of users in the communication session is represented by the respective representation of the first type when the respective user only shares audio in the communication session (e.g., and not real-time video, a virtual avatar and/or a virtual persona). In some embodiments, the first visual characteristic of the first representation of the second user corresponds to a color, brightness, and/or saturation of at least a portion of the first representation of the second user. For example, the at least the portion of the first representation of the second user includes a representation of a shape (e.g., a coin). For example, the at least the portion of the first representation of the second user includes a background portion (e.g., different from and/or presented behind the representation of the shape). In some embodiments, the first computer system changes the first visual characteristic of the first representation of the second user while moving the first representation of the second user to the second distance. In some embodiments, the first computer system changes the first visual characteristic while changing the size of the first representation of the second user relative to the three-dimensional environment (e.g., the size of the first representation of the second user is different from the first visual characteristic).

In some embodiments, in response to detecting the indication of the change of participation of the second user in the communication session, in accordance with a determination that the first representation of the second user corresponds to a respective representation of second type, different from the respective representation of the first type, the first computer system forgoes changing the first visual characteristic of the first representation of the second user, such as computer system 101 forgoing displaying a change of color, brightness, and/or saturation of first portion 718a of virtual representation 708a in FIG. 7C. In some embodiments, the respective representation of the second type corresponds to a representation that includes an avatar and/or a virtual persona of a respective user of the plurality of users in the communication session. In some embodiments, the respective representation of the second type corresponds to a representation that includes a real-time video of a respective user of the plurality of users in the communication session. In some embodiments, the respective representation of the second type does not include a virtual representation of a shape (e.g., as described above). In some embodiments, forgoing changing the first visual characteristic of the first representation of the second user includes forgoing changing a color, brightness, and/or saturation of at least a portion of the first representation of the second user. In some embodiments, the respective representation of the first type has one or more characteristics of the spatial representation of the second user and/or the non-spatial representation of the second user described with reference to method 1000. In some embodiments, the respective representation of the second type has one or more characteristics of the spatial representation of the second user and/or the non-spatial representation of the second user described with reference to method 1000. Changing a visual characteristic of a representation of a user of a communication session in response to a change in participation of the user in the communication session provides a guided and continuous user interface for the communication session by providing visual guidance of where in the three-dimensional environment a respective user viewing the three-dimensional environment should direct their attention, thereby reducing errors in interaction and improving user device interaction.

In some embodiments, the first one or more criteria includes a criterion that is satisfied when the first representation of the second user is displayed within a first region of the three-dimensional environment, such as the first region of three-dimensional environment 702 including virtual representations 732a through 732d in FIG. 7I, and is not satisfied when the first representation of the second user is displayed outside of the first region of the three-dimensional environment, such as the second region of three-dimensional environment 702 including the row of virtual representations 734 in FIG. 7I. In some embodiments, in accordance with a determination that the first representation of the second user is displayed outside of the first region of the three-dimensional environment, the first computer system forgoes moving and/or adjusting a size of the first representation of the second user to the second distance from the current viewpoint of the first user in the three-dimensional environment. In some embodiments, the first region of the three-dimensional environment is included within a virtual object associated with the communication session (e.g., having one or more characteristics of the virtual object associated with the communication session as described above). In some embodiments, the first region of the three-dimensional environment includes at least a first portion of the plurality of representations, the first portion including the first representation of the second user. In some embodiments, the first computer system displays a second portion, different from the first portion of the plurality of representations (the second portion not including the first representation of the second user) in a second region of the three-dimensional environment, different from the first region (e.g., having one or more characteristics of the second region of the three-dimensional environment described below). In some embodiments, the first computer system displays the second portion of the plurality of representations in the second region of the three-dimensional environment in accordance with a determination that the quantity of users in the communication session exceeds a threshold amount of users (e.g., having one or more characteristics of the threshold amount of users described below). For example, in accordance with a determination that the quantity of users in the communication session is less than the threshold amount of users, the first computer system forgoes displaying the second portion of the plurality of representations in the second region in the three-dimensional environment (e.g., and only displays the plurality of representations in the communication session in the first region of the three-dimensional environment). In some embodiments, the first computer system displays the first portion of the plurality of representations in a first arrangement (e.g., pattern) within the first region of the three-dimensional environment (e.g., having one or more characteristics of the arrangements and/or patterns of the plurality of representations as described above). For example, the first portion of the plurality of representations are arranged non-linearly (e.g., at alternating heights and/or distances relative to the current viewpoint of the first user). In some embodiments, the first portion of the plurality of representations correspond to a first portion of the plurality of users in the communication session that exceed a threshold amount of participation. In some embodiments, a second portion, different from the first portion, of the plurality of representations represent a second portion of the plurality of users in the communication session that do not exceed the threshold amount of participation. In some embodiments, the first computer system displays the second portion of the plurality of representations in the second region of the three-dimensional environment. In some embodiments, the first computer system displays the second portion of the plurality of representations in a second arrangement (e.g., pattern), different from the first arrangement, within the second region of the three-dimensional environment. For example, the second portion of the plurality of representations is arranged linearly (e.g., aligned at the same height and/or distance relative to the current viewpoint of the first user). In some embodiments, the second portion of the plurality of representations displayed in the second region of the three-dimensional environment having a smaller size than the first portion of the plurality of representations displayed in the first region of the three-dimensional environment. Moving a representation of a user of a communication session in a three-dimensional environment when the representation is displayed in a first region of the three-dimensional environment and not when the representation is displayed in a second region, different from the first region, of the three-dimensional environment conserves computing resources by displaying visual guidance to a respective user viewing the three-dimensional environment only when the representation is displayed in a region the respective user is likely to direct attention to.

In some embodiments, the first representation of the second user is displayed in a second region, different from the first region, of the three-dimensional environment, such as virtual representation 732e displayed in the row of virtual representations 734 in FIG. 7I, and the change of the participation of the second user does not satisfy the first one or more criteria. In some embodiments, in response to detecting the indication of the change of participation of the second user in the communication session, in accordance with a determination that the change of the participation of the second user satisfies second one or more criteria, the second one or more criteria including a first criterion that is satisfied when the first representation of the second user is displayed within the second region of the three-dimensional environment (e.g., within the second region of three-dimensional environment 702 in FIG. 7I including the row of virtual representations 734), and a second criterion that is satisfied when the change of the participation of the second user exceeds a threshold amount of participation (e.g., threshold 742a shown in FIG. 7I), the first computer system moves the first representation of the second user from the second region of the three-dimensional environment to the first region of the three-dimensional environment, such as the movement of virtual representation 732e from FIG. 7I to FIG. 7J. In some embodiments, in accordance with a determination that the first representation of the second user is displayed within the second region of the three-dimensional environment, and the change of the participation of the second user does not exceed the threshold amount of participation, the first computer system forgoes moving the first representation of the second user from the second region of the three-dimensional environment to the first region of the three-dimensional environment. In some embodiments, in accordance with a determination that the first computer system displays the first representation of the second user within the first region of the three-dimensional environment, and a current amount of participation of the second user does not exceed a threshold amount of participation, the first computer system moves the first representation of the second user from the first region of the three-dimensional environment to the second region of the three-dimensional environment. In some embodiments, moving the first representation of the second user from the second region of the three-dimensional environment to the first region of the three-dimensional environment includes moving a second representation of a third user, different from the first representation of the third user, from the first region of the three-dimensional environment to the second region of the three-dimensional environment. For example, the amount of participation of the third user in the communication session changes to less than the threshold amount of participation (e.g., and/or less than the current amount of participation of the second user in the communication session). In some embodiments, the first region and the second region of the three-dimensional environment are included within a virtual object associated with the communication session (e.g., having one or more characteristics of the virtual object associated with the communication session described above). For example, the first region of the three-dimensional environment corresponds to a first portion of (e.g., and/or volume within) the virtual object, and the second region of the three-dimensional environment corresponds to a second portion, different from the first portion, of the virtual object. For example, in response to detecting a user input corresponding to a request to move the virtual object in the three-dimensional environment, the first computer system moves the first region (e.g., including a first portion of the plurality of representations), and the second region (e.g., including a second portion of the plurality of representations, different from the first portion of the plurality of representations) in the three-dimensional environment in accordance with the user input. In some embodiments, the second region of the three-dimensional environment is below the first region of the three-dimensional environment from the current viewpoint of the first user (e.g., relative to an axis (e.g., y axis) in the three-dimensional environment corresponding to height from the current viewpoint of the first user). Moving a representation of a user of a communication session from a second region of a three-dimensional environment to a first region of the three-dimensional environment in response to an increase in participation of the user provides a guided and continuous user interface for the communication session by visually indicating to a respective user viewing the three-dimensional environment that the user has increased their participation in the communication session and guiding the respective user on where to direct their attention by making representations of more active participants in the communication session more dynamic and/or active, thereby reducing errors in interaction and improving user device interaction.

In some embodiments, the threshold amount of participation corresponds to an amount of participation relative to an amount of participation of at least one of the plurality of users in the communication session other than the first user and the second user, such as threshold 742a corresponding to the amount of participation (shown by glyph 736c) of the third user of the fourth computer system in FIG. 7J. In some embodiments, the threshold amount of participation corresponds to an amount of participation of a respective user represented within the first region of the three-dimensional environment. In some embodiments, the first computer system displays representations of users corresponding to the most active participants in the communication session in the first region of the three-dimensional environment. For example, a first portion of the plurality of representations of the plurality of users in the communication session are displayed in the first region of the three-dimensional environment. For example, the first portion corresponds 2, 3, 4, or 5 users of the plurality of users that have the highest current participation in the communication session (e.g., based on frequent and/or more recent speaking and/or movement). In some embodiments, the first computer system displays a second portion, different from the first portion, of the plurality of representations of the plurality of users in the communication session in the second region of the three-dimensional environment. For example, the second portion corresponds to the other users of the plurality of users of the communication session that are not the 2, 3, 4, or 5 users that have the highest current participation in the communication session. In some embodiments, the threshold amount of participation corresponds to the lowest current amount of participation out of the users corresponding to the first portion of representations (displayed in the first region). For example, the first computer system moves the first representation of the second user from the second region of the three-dimensional environment to the first region of the three-dimensional environment in accordance with a determination that the second user exceeds the current amount of participation of a respective user represented in the first region of the three-dimensional environment (e.g., and the first computer system moves a respective representation of the respective user from the first region of the three-dimensional environment to the second region of the three-dimensional environment). Moving a representation of a first user of a communication session from a second region to a first region of a three-dimensional environment in response to the participation of the first user in the communication exceeding the participation of a second user provides a guided and continuous user interface for the communication session by visually indicating to a respective user viewing the three-dimensional environment that the first user is actively participating in the communication session and guiding the respective user to direct their attention to the representation of the first user, thereby reducing errors in interaction and improving user device interaction.

In some embodiments, the first one or more criteria include a criterion that is satisfied when the first representation of the second user is a respective representation of a first type, such as virtual representation 708c shown in FIG. 7D. In some embodiments, the respective representation of the first type has one or more characteristics of the non-spatial representation of the second user described with reference to method 1000. In some embodiments, the respective representation of the first type is included within a virtual window (e.g., having one or more characteristics of the one or more virtual windows described above). In some embodiments, the respective representation of the first type is included within a virtual object associated with the communication session (e.g., having one or more characteristics of the virtual object associated with the communication session as described above).

In some embodiments, in response to detecting the indication of the change of participation of the second user in the communication session, in accordance with a determination that the first representation of a second user is a respective representation of a second type, different from the respective representation of the first type, such as spatial representation 722 shown in FIG. 7F, the first computer system forgoes moving the first representation of the second user to the second distance from the current viewpoint of the first user in the three-dimensional environment, such as computer system 101 forgoing moving spatial representation 722 in three-dimensional environment 702 in response to detecting the indication corresponding to the change of participation (shown by glyph 712c) of the third user of the fourth computer system in the communication session in FIG. 7F. In some embodiments, the respective representation of the second type has one or more characteristics of the spatial representation of the second user described with reference to method 1000. In some embodiments, the respective representation of the second type is not included within a virtual window (e.g., having one or more characteristics of the one or more virtual windows as described above). In some embodiments, the first computer system displays the respective representation of the second type outside of a virtual object associated with the communication session (e.g., having one or more characteristics of the virtual object associated with the communication session as described above). Additionally, or alternatively, in some embodiments, in accordance with the determination that the first representation of the second user is the respective representation of the second type, the first computer system forgoes changing a size of the first representation of the second user relative to the three-dimensional environment. Additionally, or alternatively, in some embodiments, in accordance with the determination that the first representation of the second user is the respective representation of the second type, the first computer system forgoes changing a visual prominence of the first representation of the second user (e.g., the visual prominence having one or more characteristics of the visual prominence described above). Additionally, or alternatively, in some embodiments, in accordance with the determination that the first representation of the second user is the respective representation of the second type, the first computer system forgoes changing the first visual characteristic of the first representation of the second user (e.g., the first visual characteristic having one or more characteristics of the first visual characteristic described above). Moving a representation of a user of a communication session to a different distance in a three-dimensional environment relative to a current viewpoint of a respective user in response to participation of the user in the communication session when the representation of the user is a representation of a first type but not when the representation of the user is a representation of a second type conserves computing resources by displaying visual guidance to the respective user of where in the three-dimensional environment to direct their attention only when it is necessary based on the type of representation of the user and maintains a shared spatial truth with the second user when presenting the representation of the second user of the second type.

In some embodiments, the first one or more criteria include a criterion that is satisfied when the communication session includes more than a threshold amount of users (and/or computer systems), such as the three users in the communication session represented by virtual representations 708a through 708c in FIGS. 7A-7D. For example, the criterion is satisfied when the communication session includes at least 2, 3, 4, 5, 6, 7, 8, 9, or 10 users (and/or computer systems). In some embodiments, in response to detecting the indication of the change of participation of the second user in the communication session, in accordance with a determination that the communication session includes less than the threshold amount of users (and/or computer systems), the first computer system forgoes moving the first representation of the second user to the second distance from the current viewpoint of the first user in the three-dimensional environment, such as computer system 101 forgoing moving virtual representation 708a in three-dimensional environment 702 in response to the change of participation (shown by glyph 712a) of the first user of the second computer system in the communication session in FIG. 7G. In some embodiments, in response to detecting the indication of the change of participation of the second user in the communication session, in accordance with the determination that the communication session includes less than the threshold amount of users (and/or computer systems), the first computer system forgoes changing the visual prominence of the first representation of the second user (e.g., by changing the size and/or moving the first representation of the second user). In some embodiments, in response to detecting the indication of the change of participation of the second user in the communication session, in accordance with the determination that the communication session includes less than the threshold amount of users (and/or computer systems), the first computer system forgoes changing the first visual characteristic of the first representation of the second user (e.g., having one or more characteristics of the first visual characteristic described above). In some embodiments, the first computer system displays the plurality of representations at different arrangements in the three-dimensional environment (e.g., within the virtual object associated with the communication session described above) in accordance with the quantity of users (and/or computer systems) in the communication session. For example, in accordance with a determination that the communication session includes more than a second threshold amount of users (e.g., more than 2, 3, 4, 5, 6, 7, 8, 9, or 10 users), the first computer system displays a first portion of the plurality of representations in a first region of the three-dimensional environment (e.g., having one or more characteristics of the first region described above) and a second portion, different from the first portion, of the plurality of representations in a second region of the three-dimensional environment (e.g., having one or more characteristics of the second region described above). For example, in accordance with a determination that the communication session includes less than the second threshold amount of users, the first computer system displays the plurality of representations (e.g., both the first portion and the second portion) in the first region of the three-dimensional environment (e.g., and not in the second region of the three-dimensional environment). In some embodiments, the first computer system displays a respective portion of the plurality of representations in different arrangements based on whether the first computer system displays them in the first region or the second region of the three-dimensional environment (e.g., as described above). Moving a representation of a user of a communication session in a three-dimensional environment when there is more than a threshold amount of users in the communication session and not when there is less than the threshold amount of users in the communication session conserves computing resources by displaying visual guidance to a respective user viewing the three-dimensional environment only when it is necessary based on the quantity of representations.

It should be understood that the particular order in which the operations in method 800 have been described is merely exemplary and is not intended to indicate that the described order is the only order in which the operations could be performed. One of ordinary skill in the art would recognize various ways to reorder the operations described herein.

FIGS. 9A-1 through 9M illustrate examples of one or more computer systems (e.g., first computer system 101a and second computer system 101b) displaying one or more users (e.g., first user 916 and second user 917) with spatial representations or non-spatial representations in respective three-dimensional environments (e.g., 902 and 903) while in a real-time communication session.

FIG. 9A-1 illustrates a computer system 101a (e.g., an electronic device) displaying, via a display generation component 120, a three-dimensional environment 902 from a viewpoint of a first user (e.g., user 916 in the top-down view 914a) of the computer system 101a.

FIG. 9A-1 depicts an example in which two users (e.g., the first user 916 and the second user 917 (shown in FIG. 9A-2)) are participating a real-time communication session. As mentioned above, the computer system 101a is configured to display content in the three-dimensional environment 902 using the display generation component 120a. In FIG. 9A-1, the three-dimensional environment 902 also includes a plurality of virtual objects described in further detail herein. For example, as shown in FIG. 9A-1, the three-dimensional environment 902 includes non-spatial representation of a second user 921a and a communication session user interface 912. In some embodiments, the first computer system 101 displays the communication session user interface 912 in the three-dimensional environment 902 with one or more characteristics of the communication session controls interface discussed in further detail below with reference to the method 1200. In some embodiments, the first computer system 101a displays the communication session user interface 912 with contact information (e.g., “JJ Smith” shown in FIG. 9A-1 corresponding to the second user 917) and a plurality of selectable options, including, but not limited to, the selectable option 912e configured to generate a request to include a spatial representation of the first user 921b in the communication session with the second user 917 (shown in FIG. 9A-2). In some embodiments, the first computer displays the selectable option 912e as a button configured to detect an input.

In some embodiments, as shown in FIG. 9A-1 the non-spatial representation of the second user 921a and the communication session user interface 912 are displayed in three-dimensional environment 902 overlaying a portion of real-world objects (e.g., chair 906 and window 904 as shown in FIG. 9A1) at respective locations relative to the viewpoint of the first user 916 (e.g., prior to receiving input interacting with the plurality of virtual objects, which will be described later, in three-dimensional environment 902). As shown in FIG. 9A-1, for example, the non-spatial representation of the second user 921a is optionally displayed at a first location in the three-dimensional environment 902 (e.g., at a location centrally ahead of the viewpoint of the first user 916, as indicated in the top-down view 914a in FIG. 9A-1). Additionally, in some embodiments, the communication session user interface 912 is located at a second location in the three-dimensional environment 700 (e.g., at a location closer to the viewpoint of the first user 916 compared to the location of the non-spatial representation of the second user 921a, as indicated in the overhead view 712 in FIG. 7A).

In FIG. 9A-1, the first computer system 101a detects, via the one or more input devices 114a through 114c, an input provided by the first user 916 directed at a selectable option 912e at the communication session user interface 912. As discussed herein, the first user 916 performs one or more air pinch gestures (e.g., with hand 909) to provide one or more inputs to the first computer system 101a to provide one or more user inputs directed to virtual objects displayed by computer system 101. As shown in FIG. 9A-1, the input further includes the attention 944 (including gaze) directed to selectable option 912e. Such depiction is intended to be exemplary rather than limiting; the first user 916 optionally provides user inputs using different air gestures and/or using other forms of input.

In some embodiments, as shown in FIG. 9A-1, both the first user 916 and the second user 917 (shown in FIG. 9A-2) have their corresponding spatial representation settings disabled, as indicated in legend 918 and the “x” indications for User A (corresponding to the first user 916) and User B (corresponding to the second user 917). In some embodiments, the first user 916 and the second user 917 have different combinations of enabled/disabled representation settings, as indicated by the legend 918 in figures below. In some embodiments, legend 918 indicates an enabled spatial representation setting with a “check” indication for the respective user as shown in further detail below.

FIG. 9A-2 illustrates a second computer system 101b in a communication session with the first computer system 101a described above with reference to FIG. 9A-1. For example, the second computer system 101b presents the content shown in FIG. 9A-2 at the same time the first computer system 101a presents the content shown in FIG. 9A-1. In some embodiments, the communication session has one or more of the characteristics of the communication session described with reference to method 1000. In FIG. 9A-2, a physical environment of a second user 917 (corresponding to the second computer system 101b) is visible via the display generation component 120b. The physical environment includes a potted plant 906b, which is visible via the display generation component 120b as shown in FIG. 9A-2.

Also, in FIG. 9A-2, the second computer system 101b displays a non-spatial representation of the first user 921b in the communication session because the first computer system 101a and the second computer system 101b are transmitting non-spatial representations, rather than spatial representations, of their respective users to the communication session, as indicated by legend 918. In some embodiments, the second computer system 101b includes a communication session user interface 913 including a plurality of selectable options 913a through 913e possessing one or more characteristics of the communication session user interface 912 discussed above with reference to FIG. 9A-1. In some embodiments, the second computer system 101b displays the above-mentioned virtual objects concurrently with the first computer system 101a displaying its respective virtual objects as shown in FIG. 9A-1. In some embodiments, the virtual objects and their placement relative to the viewpoint of the second user 917 are reflected in the top-down view 914b and in display generation component 120b. In some embodiments, the top-down view 914b includes one or more characteristics of the top-down view 914a discussed above with reference to FIG. 9A-1.

In some embodiments, as previously shown in FIG. 9A-1, computer system 101a detects an air pinch gesture from hand 909 while attention 944 (e.g., including gaze) of the first user is directed to the selectable option 912e. In response to the first computer system 101a detecting the input shown in FIG. 9A-1, as shown in FIGS. 9B-1 and 9B-2, the first computer system 101a and the second computer system 101b update the respective non-spatial representation of the respective users in their respective three-dimensional environments. For example, the first computer system 101a updates the nonspatial representation of the second user 921a shown in FIG. 9A-1 to a spatial representation of the second user 921a as shown in FIG. 9B-1. In some embodiments, the spatial representation of the second user 921a includes one or more characteristics of the virtual rendering of the second user as discussed in the method 1200. While the first computer system 101a displays the spatial representation of the second user 921a as shown in FIG. 9B-1, the second computer system 101b simultaneously displays a spatial representation of the first user 921b in the three-dimensional environment 903 shown in FIG. 9B-2. As shown in both FIG. 9B-1 and FIG. 9B-2, the respective spatial representation setting for the user 916 and the user 917 are indicated with the check indication at the legend 918. In some embodiments, the first computer system 101a and the second computer system 101b display the respective spatial representation of the respective users until a respective computer system detects an input requesting to stop sharing a spatial representation with the communication session, such as the input shown in FIG. 9C-2.

As shown in FIG. 9C-1, the first computer system 101a displays, via the display generation component 120a, the spatial representation of the second user 921a in the three-dimensional environment 903 while the second computer system 101b detects the input, as shown in FIG. 9C-2. For example, in FIG. 9C-2, the second computer system 101b detects the first input directed at selectable option 913e corresponding to a request to cease transmitting the spatial representation of the second user 921a to the first computer system 101a. As shown in FIG. 9C-2, the input includes the attention 944 (e.g., including gaze) directed to option 913e and an air gesture (e.g., performed by hand 909). In some embodiments, prior to detecting the input, the spatial representation settings of the first user 916 and the second user 917 are denoted as “on” by the checkmark indications in the legend 918. In some embodiments, as shown in FIG. C-2, in response to the second computer system 101b detecting the gaze 944 combined with the air pinch provided by hand 909, the first computer system 102a and the second computer system 101b cease presenting spatial representations of respective users and present non-spatial representations of respective users as part of the communication session as shown below with reference to FIG. 9D-1.

In some embodiments, as shown in FIG. 9D-1, in response to the second computer system 101b detecting the input in FIG. 9C-2, the first computer system 101a ceases displaying, via the display generation component 120a, the spatial representation of the second user 921a in the three-dimensional environment 902 as shown in FIG. 9C-1 and displays the non-spatial representation of the second user 921a shown in FIG. 9D-1. In some embodiments, while updating the spatial status of the user, the first computer system 101a maintains displaying the communication session user interface 912 at the same respective location in the three-dimensional environment 902 in FIG. 9D-1 as the location shown in FIG. 9C-1. As shown in the legend 918 in FIG. 9D-1, the spatial representation setting for user B (second user 917 shown in FIG. 9D-2) is denoted with the x indication, signaling the spatial representation setting is off, while the spatial representation setting for user A (first user 916) is denoted with the check indication, signaling that the spatial representation setting is on. In some embodiments, although the spatial setting for the first user 916 is on, because the spatial setting for the second user 917 (shown in FIG. 9D-2) is off, the first computer system 101a presents the non-spatial representation 921a of the second user as shown in FIGS. 9D-1 and 9D-2 and the second computer system 101b presents the non-spatial representation 921b of the first user as shown in FIG. 9D-3. In some embodiments, while the first computer system 101a displays the non-spatial representation of the second user 921a in the three-dimensional environment 902, the first computer system 101a detects an input directed to the selectable option 912e, indicating a request to display spatial representations of the respective users. In some embodiments, the input includes an air gesture (e.g., performed with hand 909) while attention 944 (e.g., including gaze) is directed to the option 912e.

As shown in FIG. 9D-3, the second computer system 101b displays, via the display generation component 120b, a visual indication 950 of the request generated by the first user 916 in the three-dimensional environment 903. As shown in FIG. 9D-3, the visual indication 950 includes a selectable option that, when selected, causes the second computer system 101b to include the spatial representation of the second user 917 in the communication session. For example, as shown in FIG. 9D-3, the second computer system 101b displays the visual indication 950 in an upper right corner of the display generation component 120b. In some embodiments, the visual indication 950 includes contextual text indicating respective users whose spatial settings are on (e.g., “JJ Smith went spatial” as shown in FIG. 9D-3). The visual indication 950 is optionally displayed as a two-dimensional window with rounded edges enclosing a list of users who are transmitting a spatial representation from their respective computer systems and a selectable option label “Join”. In some embodiments, the visual indication 950 includes a plurality of names discussed in further detail below. As shown in FIG. 9D-3, the legend 918 includes a checkmark indication corresponding to user A (e.g., the first user) in response to the first computer system 101 detecting the input shown in FIG. 9D-2. While the second computer system 101b displays the visual indication 950, the second computer system 101b optionally detects an input directed to the “Join” button of the visual indication 950, indicating the second user 917 agrees to transmit a spatial representation of the second user 921a to the first computer system 101a. As shown in FIG. 9D-3, the input includes attention 944 (e.g., including gaze) directed to the selectable option of the visual indication 950 and performance of an air gesture (e.g., with hand 909). In response to the second computer system 101b detecting the input in FIG. 9D-2, the second computer system 101b transmits the spatial representation of the second user 921a to the first computer system 101a as shown in FIG. 9E-1. It should be noted, that in these figures, the legend 918 denotes users A and B as having the spatial representation settings “on” by including the check indication by each respective user. In another embodiment, the communication includes a third computer system used by a third user described in further detail below. In some embodiments, a third computer system (not shown) joins the communication session, and in response, each respective computer system (101a, 101b, 101c (not shown)) displays a respective non-spatial representation (921a, 921b, 921c) in their respective three-dimensional environment (902, 903, 904 (not shown)).

FIG. 9F illustrates an example of the first computer system 101a in a real-time communication session with the second computer system 101b and a third computer system (not shown). For example, as shown in FIG. 9F, the first computer system 101a displays, via the display generation component 120a, the non-spatial representation of the second user 921a and a non-spatial representation of the third user 921c in the three-dimensional environment 902. In some embodiments, the first computer system 101a updates a location of the non-spatial representation of the second user 921a from a location in the three-dimensional environment 902 directly opposing the viewpoint of the first user 916 (as shown in the top-down view 914a in FIG. 9E-1), to a location to the left of the viewpoint of the first user 916 (as shown in the top-down view 914a in FIG. 9F) to accommodate the first computer system 101a displaying the non-spatial representation of the third user 921c in the three-dimensional environment 902. In some embodiments, while the first computer system 101a updates the location of the non-spatial representation of the second user 921a in the three-dimensional environment 902 to accommodate the non-spatial representation of the third user 921c, the communication session user interface 912 and the grabber bar 910 maintain their respective positions in the display generation component 120a relative to the viewpoint of the first user 916 as shown in FIG. 9E-1 through FIG. 9F. In some embodiments, while the communication session user interface 912 maintains its respective position in the display generation component 120a, the first computer system 101a updates the contextual information displayed at the communication session user interface 912 to include a contact name corresponding to the representation of the third user 921c (e.g., JJ & Sam). In some embodiments, the communication session user interface 912, as shown in the top-down view 914a, is positioned at a location between the non-spatial representation of the second user 921a and the non-spatial representation of the third user 921c and closer to the viewpoint of the first user 916. In some embodiments, the communication session as illustrated by FIG. 9F includes each respective user having their respective spatial status setting as “off” as shown by legend 919.

FIG. 9G-1 illustrates the first computer system 101a displaying, via the display generation component 120a, the non-spatial representations of the second user 921a and the third user 921c while the second and third users' (e.g., user B, user C) spatial status settings are “on” as illustrated by the legend 919. In some embodiments, although the spatial settings are “on” for the second user 917 (shown in FIG. 9G-2) and third user (not shown), the first computer system 101a displays the non-spatial representations 921a and 921c because the spatial setting is “off” for the first user (e.g., “User A” in legend 919). In some embodiments, as shown in FIG. 9G-1, the first computer system 101a displays the visual indication 951 in an upper right corner of the display generation component 120a that the other computer systems in the communication session are transmitting spatial representations of their respective users. In some embodiments, the visual indication 951 includes one or more characteristics of the visual indication 950 discussed above. In some embodiments, the visual indication 951 includes contextual text indicating respective users whose spatial settings are on (e.g., “JJ Smith and Sam went spatial” as shown in FIG. 9G-1). In some embodiments, the first computer system 101 receives an input directed to the visual indication 951, including attention 944 (e.g., including gaze) of the user directed to the visual indication 951 and an air gesture (e.g., performed with hand 909).

As shown in FIG. 9G-2, while the first computer system 101a is configured to transmit the non-spatial representation of the first user 921b to the communication session, the second computer system 101b displays a spatial representation of the third user 921c, a non-spatial representation of the first user 921b, the communication session user interface 913, and the grabber bar 911 in the three-dimensional environment 903. In some embodiments, the second computer system 101b displays the spatial representation of the third user 921c, the non-spatial representation of the first user 921b, the communication session user interface 913, and the grabber bar 911 with a respective spatial arrangement in the three-dimensional environment 903 that includes one or more characteristics of a spatial arrangement of the non-spatial representation of the second user 921a, the non-spatial representation of the third user 921c, the communication session user interface 912 and the grabber bar 910 as illustrated by the top down view 914a in FIG. 9G-1. In some embodiments, the second computer system 101b updates the location of the non-spatial representation of the second user 921a from a location directly opposing the viewpoint of the second user 917 (as shown in FIG. 9E-2) to a location to the left of the viewpoint of the second user 917 in the display generation component 120b, partially overlaying a portion of the potted plant 906b, as shown in FIG. 9G-2, to accommodate the spatial representation of the third user 921c. In FIG. 9G-2, the second computer system 101b presents the non-spatial representation of the first user 921b because the spatial setting for the first user is “off” (e.g., “user A” in legend 919) and presents the spatial representation of the third user 921c because the spatial settings for the second and third users are “on” (e.g., “user B” and “use C” in legend 919). In some embodiments, although not shown in the figures, the third computer system would present a spatial representation of the second user 917 and a non-spatial representation of the first user (first user 916 in FIG. 9G-1) for similar reasons.

FIG. 9H illustrates the first computer system 101a displaying the spatial representation of the second user 921a and the spatial representation of the third user 921c in the three-dimensional environment 902. In some embodiments, the first computer system 101a displays the content shown in FIG. 9H in response to detecting the input shown in FIG. 9G-1. In some embodiments, the first user 916, the second user 917, and the third user (corresponding to the spatial representation of the third user 921c (not shown)) have their respective spatial settings status set as “yes” as illustrated by the checkmark indications in the legend 919 in FIG. 9H. In some embodiments, the first computer system 101a maintains displaying the spatial representations of respective users in the communication session (as shown in FIG. 9H) until a respective user updates their respective spatial settings status as “no” as discussed in further detail below.

FIG. 9I-1 illustrates an example of the first computer system 101a displaying, via the display generation component 120a, the non-spatial representation of the third user 921c in response to receiving an indication from the third computer system that the third user set their respective spatial settings status as “no” (“user C” in legend 919). In some embodiments, the first computer system 101a ceases displaying the spatial representation of the third user 921c (shown in FIG. 9H) while maintaining the display of the spatial representation of the second user 921a, the communication session user interface 912, and the grabber bar 910 in their respective locations reflected in FIG. 9H. In some embodiments, response to receiving an indication from the third computer system that the third user set their respective spatial settings status as “no”, the second computer system 101b ceases displaying the spatial representation of the third user 921c and displays the non-spatial representation of the third user 921c in the three-dimensional environment 903 as discussed below with reference to FIG. 9I-2.

FIG. 9I-2 illustrates an example of the second computer system 101b displaying, via the display generation component 120b, the non-spatial representation of the third user 921c while maintaining displaying the spatial representation of the first user 921b, the communication session user interface 912 and the grabber bar 911 in the three-dimensional environment. In some embodiments, FIG. 9I-2 illustrates in the top-down view 914b that the above listed virtual objects will always be displayed parallel to the viewpoint of the second user independent of an orientation of the second user 917 in the three-dimensional environment 903. In some embodiments, the second user 917 shifts the second computer system 101b from a first orientation (as shown in FIG. 9G-2) to a second orientation (as shown in in FIG. 9I-2), facing a left corner of the three-dimensional environment 903.

In some embodiments, while the first computer system 101a presents the spatial representation of the second user 921a and the non-spatial representation of the third user 921c as shown in FIG. 9I-1 and the second computer system 101b presents the spatial representation of the first user 921b and the non-spatial representation of the third user 921c as shown in FIG. 9I-2, the third computer system presents non-spatial representations of the first and second users (not shown). The third computer system presents non-spatial representations of the first and second users despite these users having their spatial statuses set to “on” (see “user A” and “user B” in legend 919 in FIGS. 9I-1 and 9I-2) because the third user has their spatial status set to “off” (see “user C” in legend 919 in FIGS. 9I-1 and 9I-2).

FIG. 9J-1 illustrates an example of the first computer system 101a displaying, via the display generation component 120a, the non-spatial representation of the second user 921a and the non-spatial representation of the third user 921c. As shown in legend 919 of FIG. 9J-1, the second user (“user B”) and the third user (“user C”) have their respective spatial statuses set to “no.” In some embodiments, the first computer system 101a maintains the spatial setting status of the first user 916 as “yes” (see user A “check” indication at legend 919). In some embodiments, the first computer system 101a detects an input directed to option 912e, including the attention 944 (e.g., including gaze) directed to the option 912e and an air gesture (e.g., performed by hand 909). In response to detecting the input shown in FIG. 9J-1, the first computer system 101a updates the spatial status of the first user to “no,” as represented by legend 919 in FIG. 9J-2.

FIG. 9J-2 illustrates an example of the second computer system 101b displaying, via the display generation component 120b, the non-spatial representation of the third user 921c and the non-spatial representation of the first user 921b in the three-dimensional environment. It should be noted, as shown in the legend 919, all respective users (user A, user B, user C) have configured their respective spatial setting status as “no”. Optionally, the second computer system 101b would still display non-spatial representations 921b and 921c of the first and third users, respectively, even while the spatial status of the first user (e.g., “user A” in legend 919) was set to “on,” as shown in FIG. 9J-1, because the spatial status of the second user (e.g., “user B” in legend 919) is set to “off” in FIGS. 9J-1 and 9J-2.

In some embodiments, as shown in FIG. 9K, a respective user (e.g., first user, second user and/or third user not shown) sets their respective spatial setting status as “yes”, and in response, each respective user's computer system sets their respective spatial setting status as “yes”. Thus, although other examples illustrate users controlling their spatial statuses individually, in some embodiments, in response to one computer system receiving an input requesting a spatial mode of the communication session, the communication session includes spatial representations of all users. For example, as shown in FIG. 9K, the first computer system 101a displays, via the display generation component 120a, the spatial representation of the second user 921a and the spatial representation of the third user 921c in the three-dimensional environment 902.

In some embodiments in which the computer systems (e.g., first computer system 101a, second computer system 101b, and third computer system (not shown)) display spatial representations of multiple (e.g., all) users in the communication session in response to one computer system receiving an input requesting a spatial setting status as “on”, in response to one computer system receiving an input requesting to set the spatial setting status as “off”, that computer system changes that user's spatial setting status to off, while leaving the spatial setting status on for other users. For example, in FIG. 9L, the second user (e.g., “user B” in legend 919) has spatial setting status as “off” while the first user and the third user (e.g., “user A” and “user C” in legend 919) have spatial setting statuses “on,” optionally in response to the second computer system receiving an input (e.g., according to one or more examples described herein) requesting to turn off spatial mode. As shown in FIG. 9L, the first computer system 101a displays a spatial representation 921c of the third user because the first and third users have spatial setting status as “on” and a non-spatial representation of the second user 921a because the second user has spatial setting status set as “off.”

In some embodiments, the respective computer systems (such as the above discussed computer systems with reference to FIG. 9L) display spatial representations of the respective users of the above computer systems in the communication session in response to one (and optionally a plurality of) users generating a request to include spatial representations of the respective users in the communication session. In some embodiments, while the spatial representations of the respective users are displayed in the communication session, one (and optionally a plurality of) computer system receive an input requesting to set the spatial setting status for the respective users as “off”, and in response, that computer system sets the spatial setting status as “off” for every user in the communication session. For example, in FIG. 9M the first user, the second user, and the third user (e.g., “user A”, “user B”, and “user C” respectively in legend 919) have spatial mode off, while the first computer system 101a displays the non-spatial representation of the first user 921a and the non-spatial representation of the third user 921c in the three-dimensional environment 902. In some embodiments, as shown in FIG. 9M, the first computer system 101a displays the non-spatial representation of the first user 921a and the non-spatial representation of the third user 921c in the three-dimensional environment 902 in response to a computer system (such as the second computer system 101b (not shown)) generating the request to set the spatial setting status for the respective users as “off”.

FIG. 10 is a flow diagram illustrating an example method 1000 of updating a spatial setting status of one or more representations of one or more users in a three-dimensional environment in response to detecting one or more spatial setting status requests from one or more users in a communication session. In some embodiments, the method 1000 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1000 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1000 are, optionally, combined and/or the order of some operations is, optionally, changed.

In some embodiments, method 1000 is performed at a first computer system in communication with a display generation component and one or more input devices, such as computer system 101a in FIG. 9A-1. In some embodiments, the first computer system, display generation component, and/or one or more input devices have one or more characteristics of the computer system, display generation component, and/or one or more input devices described above with reference to method 800.

In some embodiments, method 1000 is performed while a three-dimensional environment is visible via the display generation component from a viewpoint of a first user of the first computer system, and while the first computer system is in a communication session with a second computer system, different from the first computer system, of a second user, different from the first user (1002a), such as a communication session including computer system 101a and computer system 101b in FIGS. 9A-1 and 9A-2. In some embodiments, the three-dimensional environment is, generated, displayed, or otherwise made viewable by the first computer system in a similar manner as discussed previously above with reference to the method 800 and discussed in further detail below with reference to the method 1200 and the method 1400. In some embodiments, the viewpoint of the first user has one or more characteristics as described above with reference to the method 800 and discussed in further detail below with reference to the method 1200 and the method 1400. In some embodiments, the communication session with the second computer system has one or more characteristics as described above with reference to the method 800 and discussed in further detail below with reference to the method 1200 and the method 1400. In some embodiments, the first computer system optionally initiates and/or receives a request to join the communication session with the second computer system. In some embodiments, the second computer system displays the communication session relative to the viewpoint of the second user and/or a third user of a third computer system (discussed further below) in a similar manner to how the first computer system displays the communication session relative to the viewpoint of the first user.

In some embodiments, the first computer system displays (1002b) a non-spatial representation of the second user in the three-dimensional environment relative to the viewpoint of the first user, such as representation 921a in FIG. 9A-1. In some embodiments, the non-spatial representation of the second user includes an image of a virtual avatar displayed in the three-dimensional environment as discussed previously above with reference to the method 800 and discussed in further detail below with reference to the method 1200 and the method 1400. In some embodiments, the non-spatial representation has one or more characteristics of the non-spatial representation as discussed above with reference to method 800 and discussed in further detail below with reference to the method 1200 and the method 1400. The representation of the user optionally has one of a plurality of possible forms (e.g., an avatar having a human-like form and/or appearance or an abstracted avatar including less human-like form (e.g., corresponding to a generic two-dimensional or three-dimensional object, such as a virtual coin or a virtual sphere)). In some embodiments, the non-spatial representation of the second user has one or more of the characteristics of the representations of users described with reference to methods 800, 1200 and/or 1400. In some embodiments, the three-dimensional environment includes the first visual representation at a location visible from the perspective of the first user (e.g., inside of the viewport of the first user) as discussed previously above with reference to the method 800 and discussed in further detail below with reference to the method 1200 and the method 1400. In some embodiments, the first visual representation is located outside the perspective of the first user as discussed previously above with reference to the method 800 and discussed in further detail below with reference to the method 1200 and the method 1400.

In some embodiments, the first computer system detects (1002c), via the one or more input devices, a first input (Described above in a similar manner with reference to the method 800) corresponding to a request to include a spatial representation of the first user in the communication session with the second user, such as the gaze 944 and the air pinch generated by hand 909 in FIG. 9A-1. In some embodiments, the communication session is a shared three-dimensional environment concurrently viewable by the first user and the second user. In some embodiments, the spatial representation of the first user corresponds to a computer-generated model of the non-spatial representation of the first user. In some embodiments, the viewpoint of the first user and the viewpoint of the second user share a spatial truth. In some embodiments, the shared spatial truth includes the second computer system updating the spatial arrangement of the representation of the second user relative to the viewpoint of the second user in response to the first user updating their respective spatial arrangement. In some embodiments, the shared spatial truth between the viewpoint of the first user and the viewpoint of the second user includes a communication of relative positions of the respective users between the first computer system and the second computer system. In some embodiments the communication of relative positions includes location data and orientation data of the respective user in their respective three-dimensional environment. In some embodiments, the orientation of a respective user is updated relative to the viewpoint of the other user in response to the respective user updating their orientation in their three-dimensional environment. In some embodiments, the first input is voice command, an air gesture (e.g., an air pinching of a plurality of fingers contacting one another, an air pointing of one or more fingers, and/or air closing of one or more fingers), selection of a physical button and/or selection of a virtual button (e.g., the first selectable option), and/or movement of the first user's viewpoint (e.g., the first user's position and/or orientation relative to the physical environment). In some embodiments, the computer system detects an air pinch gesture performed by a hand of the user of the computer system—such as the thumb and index finger of the hand of the user starting more than a threshold distance (e.g., 0.1, 0.2, 0.5, 1, 2, or 5 cm) apart and coming together and touching at the tips—that is detected by the one or more input devices (e.g., a hand tracking device) in communication with the first computer system. In some embodiments, the first input includes attention (e.g., including gaze) of the first user directed to the first visual representation in the three-dimensional environment. In some embodiments, the first computer system detects the selection of the first selectable option via a hardware input device (e.g., a controller operable with six degrees of freedom of movement, or a touchpad or mouse) in communication with the computer system. For example, the computer system detects a selection input (e.g., a tap, touch, or click) via the one or more input devices corresponding to an air gesture by the one or more fingers of the hand of the first user. In certain embodiments, the first input originates from the second computer system. For example, the second computer system uses a wireless communication infrastructure to direct the first input at a non-spatial representation of the first user in the three-dimensional environment of the second computer system. In some embodiments, the spatial representation of the first user corresponds to a three-dimensional avatar including one or more characteristics of the avatar corresponding to the non-spatial representation of the first user as discussed above. In some embodiments, the spatial representation of the first user is optionally represented by the three-dimensional avatar based on three-dimensional spatial data associated with the user and detected by the AR/VR application and/or AR/VR hardware discussed above with reference to the method 800. Non-spatial participants (such as the second user discussed in further detail below) optionally join the real-time communication session using a non-AR/VR application and/or non-AR/VR hardware, such using as a video messaging or video-calling application on a cell phone or tablet, and are optionally represented by two-dimensional avatars based on two-dimensional data (e.g., video data) associated with the participant and detected by the non-AR/VR application. In some embodiments, prior to the request, the second computer system displays the first user as the non-spatial representation from the viewpoint of the second user, and the first computer system displays the second user as the non-spatial representation from the viewpoint of the first user.

In some embodiments, in response detecting the first input (1002d), in accordance with a determination that one or more criteria are satisfied (1002e), the first computer system ceases display (1002f), via the display generation component, of the non-spatial representation of the second user, such as the non-spatial representation of the second user 921a in FIG. 9A-1 to the spatial representation of the second user 921a in FIG. 9B-1. In some embodiments, the first computer system transmits an indication of the spatial representation of the first user to the second computer system in response to detecting the first input. In this example, the indication of the spatial representation indicates to the second computer system that the first computer system is configured to transmit the spatial representation of the first user to the second computer system. The first computer system being configured to transmit the spatial representation of the first user to the second computer system optionally has one or more of the characteristics of the second computer system being configured to transmit the spatial representation of the second user, as described in more detail below. For example, if the second computer system is configured to transmit the spatial representation of the second user, the second computer system presents the spatial representation of the first user in response to receiving the indication, as described in more detail below. As another example, if the second computer system is not configured to transmit a spatial representation of the second user, the second computer system presents a notification in response to receiving the indication, as described in more detail below.

In some embodiments, the one or more criteria include a criterion that is satisfied when the second computer system is configured to transmit a spatial representation of the second user to the first computer system as part of the communication session. In some embodiments, the computer system ceases display of the first visual representation in the three-dimensional environment relative to the viewpoint of the first user. In some embodiments, the one or more criteria are satisfied when the communication session is configured by system settings of any of the participating computer systems to allow a single user in the communication session to cease the display of the non-spatial representations of the users within the communication session and generate spatial representations of a plurality of users in the three-dimensional environment (discussed in further detail below). In this example, the second computer system ceases the display of the non-spatial representation of the second user, a third computer system, different than the first computer system and the second computer system, ceases displaying a non-spatial representation of a third user, different than the first user and the second user relative to the viewpoint of the first user. In some embodiments, the computer system ceases display of the first visual representation instantaneously in response to receiving the first input. In some embodiments, the first computer system ceases the display of the first visual representation over a short period of time (e.g., 0.1 seconds, 0.3 seconds, 0.6 seconds, 1 seconds) via an animation in the three-dimensional environment relative to the viewpoint of the first user. For example, the first computer system ceases the display of the first visual representation via a fade-out animation. In some embodiments, the communication session includes a plurality of users of a plurality of computer systems, different than the first user of the first computer system and the second user of the second computer system. In some embodiments, the one or more criteria are satisfied by only a subsection of the plurality of users as described in further detail below. In some embodiments, the request to transmit is sent to the second computer system, but not the third computer system. In some embodiments, the three-dimensional environment includes a plurality of non-spatial representations corresponding to the plurality of users of a plurality of computer system viewable from the viewpoint of the first user.

In some embodiments, in response detecting the first input, and in accordance with a determination that one or more criteria are satisfied, the first computer system displays (1002g), via the display generation component, a spatial representation of the second user in the three-dimensional environment, such as the spatial representation of the second user 921a in FIG. 9B-1. (e.g., a spatial representation of an avatar corresponding to the second user). In some embodiments, the avatar corresponding to the second user includes one or more characteristics of the avatar discussed above with reference to the method 800 and discussed in further detail below with reference to the method 1200 and the method 1400. In some embodiments, the computer system displays the spatial representation of the second user in a location of the three-dimensional environment corresponding to the location of the previously displayed first visual representation of the second user. In some embodiments, the second computer system displays the spatial representation of the second user after the first computer system ceases displaying the spatial representation of the first user in the three-dimensional environment for a predetermined time-period. In some embodiments, the second user is displayed as the spatial representation in the three-dimensional environment relative to the viewpoint of the first user prior to the one or more criteria being satisfied by the first user. In this example, the one or more criteria are satisfied by the second user. In some embodiments, the second computer system concurrently displays the non-spatial representation of the first user in the second computer system's respective three-dimensional environment while the first computer system displays the non-spatial representation of the second user in the first computer system's three-dimensional environment. In some embodiments, in response to the one or more criteria being satisfied (e.g., at the first computer system), the second computer system updates the display of the non-spatial representation of the first user to display a spatial representation of the first user in the respective three-dimensional environment.

In some embodiments, in response detecting the first input, and in accordance with a determination that the one or more criteria are not satisfied (1002h) (e.g., no input is detected corresponding to an acceptance by the second user to transmit the spatial representation of the second user to the first user and the second computer system is not configured to transmit a spatial representation of the second user to the first computer system as part of the communication session), the first computer system maintains display (1002i), via the display generation component, of the non-spatial representation of the second user in the-three-dimensional environment, such as the spatial representation of the second user 921a in FIG. 9B-1. In some embodiments, the one or more criteria are not satisfied by the second user and are satisfied by the third user. In this example, the second computer system transmits the non-spatial representation of the second user to the first user and the third computer transmits the spatial representation of the third user to the first user. In some embodiments, the one or more criteria are satisfied by the second user and are not satisfied by the third user, resulting in the second computer system and the third computer system transmitting their respective non-spatial representations to the first user. The previous examples can be described in any variety of combinations and should not be limited to the above combinations of the one or more criteria being satisfied by a respective user of a respective computer system.

In enabling users to seamlessly switch between spatial and non-spatial representations (e.g., of their respective avatars) in the three-dimensional environment, a more immersive and interactive communication session is enabled between users in virtual environments. Furthermore, in introducing spatial and non-spatial modes for the communication session, the system provides greater flexibility and customization options, allowing users to tailor the communication session to their preferences and needs. By optimizing resource utilization and generating spatial representations only when necessary, the computer system additionally ensures efficient use of computational resources, which can lead to improved performance and scalability of the three-dimensional environment.

In some embodiments, while the first computer system is in the communication session with the second computer system, and while displaying the non-spatial representation of the second user in the three-dimensional environment, the first computer system receives an indication from the second computer system that corresponds to a request to include spatial representations of users in the communication session, such as selection of the selectable option 912e as shown in FIG. 9D-2. In some embodiments, the communication session includes an exchange of real-time data between the first computer system and the second computer system (e.g., audio data, visual data, user status information). In some embodiments, the second computer system transmits to the first computer system real-time data that includes a spatial status of the second user. In some embodiments, the spatial status is associated with the spatial representation of a respective user. For example, the second user optionally has a spatial status (e.g., a spatial representation) within the three-dimensional environment of the second computer system. In some embodiments, the first computer transmits a spatial status of the first user to the second computer system while concurrently receiving the spatial status of the second user from the second computer system. In some embodiments, the request satisfies a criterion of the one or more criteria. In some embodiments, the first computer system receives real-time data indicating that the second user requests to include the spatial representation of the second user in the communication session, which would cause the first computer system to display the spatial representation of the second user. In some embodiments, second computer system generates the request in response to the second user updating their spatial status from not including the spatial representation of the second user in the communication session to including the spatial representation of the second user in the communication session. In some embodiments, the computer system generates the request to include the spatial representation of the second user in the communication session in response to detecting one or more inputs from the second user. In some embodiments, the request to display the spatial representation of the second user includes a request to display a spatial representation of the first user in a three-dimensional environment viewable relative to the viewpoint of the second user. In some embodiments, the second computer system generates the request to display the spatial representations of the users in response to the second computer system detecting the second user selecting an option to display the spatial representations of the users in the three-dimensional environment of the second computer system.

In some embodiments, in response to receiving the indication from the second computer system, the first computer system displays, via the display generation component, an indication of the request to include spatial representations of the users in the communication session and a selectable option, such as the visual indication 950 in FIG. 9D-3. In some embodiments, the computer system displays a visual notification of the request to display spatial representations of the user in the communication in the three-dimensional environment of the first computer system. In some embodiments, the computer system displays the indication of the request with a first set of visual properties relative to the viewpoint of the first user. In some embodiments, the visual notification includes information describing a request to join the second user in a spatial communication session. In some embodiments, while the first computer system displays the indication of the request, the second computer system concurrently displays a second visual indication including information describing that the request to join the spatial communication session in response to the first computer system receiving the request. In some embodiments, the first computer system displays the indication of the request as a two-dimensional window parallel to the viewpoint of the first user. In some embodiments, the first computer system displays the indication of the request relative to the viewpoint of the first user is displayed with a selectable option (e.g., join button, slider). In some embodiments, the first computer system displays the indication of the request in the same location in the three-dimensional environment relative to the viewpoint of the first user as the second computer system displays the second visual indication of the transmission of the request relative to the viewpoint of the second user. In some embodiments, the second computer system displays the second visual indication of the transmission of the request at a location in the three-dimensional environment that does not obscure the representation of the first user relative to the viewpoint of the second user. In some embodiments, the first computer system displays the indication of the request in the three-dimensional environment partially occluding the two-dimensional representation of the second user relative to the viewpoint of the first user. In some embodiments, relative to the viewpoint of the first user, the first computer system displays the indication of the request with a list of users requesting to include spatial representations of the respective users in the communication session. In some embodiments, the first computer system and/or the second computer system generates a haptic and/or audio indication accompanying the display of the indication of the request and/or the indication of the transmission of the request, respectively. Displaying the indication of the request to include spatial representations of users in the communication session enhances user interactions with the computer system by reducing the number of inputs needed to include a spatial representation of the first user in the communication session while the second user requests to include a spatial representation of the second user in the communication session.

In some embodiments, detecting the first input includes detecting selection of the selectable option, such as the selection of the selectable option 912e in FIG. 9A-1. In some embodiments, in accordance with a determination that the first input does not include selection of the selectable option (e.g., the first computer system does not detect selection of the selectable option), the first computer system forgoes displaying the spatial representation of the second user in the three-dimensional environment. In some embodiments, the first input has one or more characteristics of the selection input described above and/or with reference to method 800. For example, the first input includes an air gesture (e.g., an air pinch) and attention (e.g., by gaze, hand position, and/or cursor) directed to the selectable option for a non-zero amount of time (e.g., 0.05, 0.1, 0.25, 0.5, 0.75, 1, 2, or 5 seconds). In some embodiments, detecting the first input includes detecting interaction with a hardware button (e.g., physical control or dial) of the first computer system, such as a press, click, and/or rotation of the hardware button of the first computer system. For example, in accordance with a determination that the first input does not include user interaction with the hardware button (e.g., the first computer system does not detect user interaction with the hardware button), the first computer system forgoes displaying the spatial representation of the second user in the three-dimensional environment. In some embodiments, the first computer system transmits an indication corresponding to the detection of the selection of the selectable option to the second computer system (e.g., in real-time). Requesting to share the spatial representations of the first in the communication session in response to detecting selection of the selectable option included in the indication enhances user interactions with the computer system by reducing the number of inputs needed to include a spatial representation of the first user in the communication session while the second user requests to include a spatial representation of the second user in the communication session.

In some embodiments, while the first computer system is in the communication session and while the three-dimensional environment is visible via the display generation component: (e.g., the real-time communication session discussed previously above) the first computer system displays, via the display generation component, a communication session user interface in the three-dimensional environment, wherein the communication session user interface includes a selectable option, wherein detecting the first input includes detecting selection of the selectable option, such as the communication session user interface 912 including the selectable option 912e in FIG. 9A-1. In some embodiments, the real-time communication session includes a communication session user interface displayed in the three-dimensional environment viewable relative to the viewpoint of the first user. In some embodiments, the communication session user interface includes one or more characteristics of the communication session user interface described with reference to methods 1200 and/or 1400. In some embodiments, the first computer system displays the communication session user interface as a two-dimensional window that optionally includes one or more virtual buttons such as a video conferencing button, a mute button that, when selected, causes the first computer system to mute the first user, an exit button, and a screenshare button that, when selected, causes the computer system to share media content from the first computer system to the communication session (e.g., with the second computer system (and any other additional computer systems) in the communication session). In some embodiments, the communication session user interface is displayed overlaid the representation of the second user or otherwise in front of the representation of the second user from the viewpoint of the first user (e.g., and along a depth axis intersecting a center of the three-dimensional environment corresponding to the viewpoint of the first user), and/or in proximity to (e.g., arranged adjacent to a border of) media content shared between the first computer system and the second computer system in the communication session. In some embodiments, a virtual button of the one or more virtual buttons correspond to the selectable option, that when selected, causes the first computer system to display the indication of the request to include spatial representations of the users. In some embodiments, the communication session user interface is displayed in the three-dimensional environment of the first computer system while the first computer system initiates a communication session with the second computer system. In some embodiments, the orientation of the communication session user interface is dependent on the viewpoint of the first user in the three-dimensional environment corresponding to the first computer system and the viewpoint of the second user in the three-dimensional environment corresponding to the second computer system. For example, the front face of the communication session user interface is visible relative to the viewpoint of the first user and relative to the viewpoint of the second user. For example, the first computer system orients the communication session user interface such that the front face (e.g., the two-dimensional window including the one or more virtual buttons) faces the viewpoint of the first user. In some embodiments, the selectable option included in the communication session user interface corresponds to the selectable option described above with reference to the selectable option displayed on the indication of the request to include spatial representations of the users. In some embodiments, the first computer system displays the selectable option in the three-dimensional environment concurrently with the indication of the request to include the spatial representations of the users. In this example, the indication of the request option includes the selectable option, different than the selectable option of the communication session user interface. In some embodiments, the first computer system displays the communication session user interface in the three-dimensional environment in response to the indication of the request to include the spatial representations of the users. In this example, the first user directs the first input at the selectable option of the communication session user interface detectable by the first computer system (e.g., and the first computer system transmits an indication corresponding to selection of the selectable option to the second computer system). Displaying the communication session user interface increases the options for user interactivity with the communication session and allows the user to respond to other user requests and/or inputs alongside other elements configured to modify the first user's experience of the communication session.

In some embodiments, while the three-dimensional environment is visible via the display generation component of the first computer system from the viewpoint of the first user and while the first computer system is in the communication session with the second computer system and a third computer system, different from the first and second computer systems, associated with a third user different from the first and second users, and while displaying the spatial representation of the second user in the three-dimensional environment, the first computer system determines the one or more criteria are satisfied, such as indicated in the legend 919 in FIG. 9H. In some embodiments, the communication session includes a plurality of users including the first user, the second user, and the third user. In some embodiments, the third user is a user of a third computer system. In some embodiments, the communication session is initialized including the first user, the second user, and the third user. In some embodiments, the third user joins the communication session at a point after the first user and the second user initialize the communication session. In some embodiments, the three-dimensional environment includes a non-spatial representation of the second user and a non-spatial representation of the third user relative to the viewpoint of the first user as discussed in further detail below. In some embodiments, the first computer system displays the spatial representation of the second user in response to one or more criteria being satisfied as discussed previously above. In some embodiments, the third computer system displays the representation of the first user and the spatial representation of the second user in the three-dimensional environment relative to the viewpoint of the third user, while the first computer system and the second computer system do not display a representation of the third user while the first computer system, the second computer system, and the third computer system are in the communication session relative to the viewpoint of the first user and/or relative to the viewpoint of the second user. In some embodiments, the first computer system and/or the second computer system do not display the non-spatial representation of the third user in the three-dimensional environment until the first computer system and/or the second computer system determines that one or more second criteria are satisfied as discussed in further detail below.

In some embodiments, in accordance with the first computer system determining that one or more second criteria are satisfied, the first computer system displays, via the display generation component, a spatial representation of the third user in the three-dimensional environment, such as the spatial representation of the second user 912c in FIG. 9H. In some embodiments, the one or more second criteria include characteristics of the one or more criteria as discussed previously above, but with respect to the spatial representation of the third user instead of with respect to the spatial representation of the second user. In some embodiments, the third computer system transmits an indication corresponding to the one or more second criteria to the first computer system and/or the second computer system and, in response, the third computer system includes the spatial representation of the third user in the communication session (e.g., after the third computer system includes the spatial representation of the third user in the communication session, the spatial representation of the third user is visible from the perspective of the first user and/or the second user in the communication session). In some embodiments, in accordance with a determination that the one or more second criteria are satisfied, the second computer system displays the spatial representation of the third user relative to the viewpoint of the second user in the three-dimensional environment corresponding to the second computer system concurrently with the first computer system displaying the spatial representation of the third user in the three-dimensional environment corresponding to the first computer system relative to the viewpoint of the first user. In some embodiments, the first computer system ceases displaying a non-spatial representation of the third user and displays the spatial representation of the third user in response to detecting the one or more second criteria being satisfied.

In some embodiments, in accordance with the first computer system determining that the one or more second criteria are not satisfied, the first computer system displays, via the display generation component, a non-spatial representation of the third user in the three-dimensional environment, such as the non-spatial representation of the second user 921c in FIG. 9I-1. In some embodiments, the one or more second criteria include characteristics of the one or more criteria as discussed previously above, but with respect to the non-spatial representation of the third user instead of with respect to the non-spatial representation of the second user. In some embodiments, the first computer system maintains the display of the non-spatial representation of the third user in the three-dimensional environment in response to the one or more second criteria not being satisfied. In some embodiments, the first computer system initiates displaying the non-spatial representation in the three-dimensional environment in response to determining the one or more second criteria are not being satisfied. Displaying the third user as a spatial representation or a non-spatial representation depending on criteria allows a multitude of users to seamlessly switch between spatial and non-spatial representations of their respective avatars in the three-dimensional environment, enabling a more immersive and interactive communication session between users in virtual environments.

In some embodiments, while the first computer system displays, via the display generation component, the spatial representation of the second user and the non-spatial representation of the third user in the three-dimensional environment relative to the viewpoint of the first user, the first computer system detects, via the one or more input devices, a second input (e.g., touch input, air gesture input, voice input, or input corresponding to user interaction with a hardware input device as described above) corresponding to a request to cease including a spatial representation of the first user in the communication session, such as gaze 944 combined with the air pinch provided by hand 909 in FIG. 9J-1. In some embodiments, the second input has one or more characteristics of the first input described above. In some embodiments, the second input includes a selection input (e.g., having one or more characteristics of the selection input described above) directed to a selectable option (e.g., the selectable option is selectable to cease including the spatial representation of the first user in the communication session). In some embodiments, the first computer system transmits the request to cease including the spatial representation of the first user to the second computer system and/or the third computer system. In some embodiments, the first computer system transmits the request to cease including to the second computer system and/or the third computer system after receiving a third input confirming the request to cease including the spatial representation of the first user. In some embodiments, the first computer system registers the detection of the second input after the second input exceeds a threshold amount of time (e.g., 0.1, 0.2, 0.5, 1, 2, 3, 5, or 10 seconds). For example, the first user optionally directs a finger press input and/or a selection input (e.g., the second input) at the selectable option of the communication session user interface, as discussed above, for a three-second interval. For example, in response to the first user directing the second input at the selectable option for the three-second interval, the first computer system optionally transmits the request to cease including the spatial representation of the first user in the communication session to the second computer system and/or the third computer system.

In some embodiments, in response to detecting the second input, the first computer system ceases displaying, via the display generation component, of the spatial representation of the second user in the three-dimensional environment relative to the viewpoint of the first user, such as the first computer system switching from displaying the spatial representation of the second user 921c in FIG. 9L to the first computer system displaying the non-spatial representation of the second user 921c in FIG. 9M. In some embodiments, the first computer system transmits an indication of the detection of the second input to the second computer system and/or the third computer system. For example, in response to detecting the indication received from the first computer system, the second computer system and/or the third computer system optionally cease displaying the spatial representation of the first user relative to the viewpoint of the second user and relative to the viewpoint of the third user in response to receiving the indication from the first computer system. In some embodiments, the first computer system ceases including the spatial representation of the first user to the second computer system and/or the third computer system and in response, the second computer system and/or the third computer system display (e.g., automatically) the non-spatial representation of the first user as discussed in further detail below. In some embodiments, the request to stop including the spatial representation of the first user includes an embedded request to the second computer system and/or the third computer system to cease displaying the spatial representations of the second user and/or the third user in the three-dimensional environment. In some embodiments, in response to detecting the second input, the first computer system ceases displaying (e.g., automatically) the spatial representations of the second user and the third user in the three-dimensional environment relative to the viewpoint of the first user. In some embodiments, the first computer system ceases displaying the spatial representations of the second user and the third user in the three-dimensional environment relative to the viewpoint of the first user concurrently. In some embodiments, the first computer ceases displaying the spatial representations of the second user and the third user over a period of time (e.g., 0.1, 0.2, 0.5, 1, 2, 5, or 10 seconds) via the animation described above. In some embodiments, the first computer system ceases displaying the spatial representation of the second user independent of (e.g., regardless of) the spatial status denoted by the second user.

In some embodiments, the first computer system displays, via the display generation component, the non-spatial representation of the second user and the non-spatial representation of the third user in the three-dimensional environment relative to the viewpoint of the first user, such as the non-spatial representation of the second user 921a and the spatial representation of the third user 921c in FIG. 9L. In some embodiments, the first computer system displays the non-spatial representations of the second user and the third user in the three-dimensional environment relative to the viewpoint of the first user immediately following the first computer system ceasing the display of spatial representations of the second user and the third user. In some embodiments, the second computer system includes the non-spatial representation of the second user in the communication session in response to the first computer system transmitting the request to cease including the spatial representation of the first user in the communication session. In some embodiments, the second computer system and the third computer system display the respective non-spatial representations of the respective users simultaneously. In some embodiments, the non-spatial representation of the second user and the non-spatial representation of the third user include one or more characteristics of the non-spatial representation of the first user as discussed above. In some embodiments, the non-spatial representation of the first user is visible relative to the viewpoint of the second user and/or the viewpoint of the third user. In some embodiments, the first computer system ceases displaying the spatial representation of the second user at a first location in the three-dimensional environment and displays the non-spatial representation of the second user at a second location, different than the first location, in the three-dimensional environment. In some embodiments, the communication session includes spatial representations and/or non-spatial representations of a respective user in the three-dimensional environment based on the respective user's requested spatial status. For example, the first computer system transmits the request to include the non-spatial representation of the first user in the communication session while the second computer system and the third computer system transmit the request to include the spatial representations of the second and third users in the communication session. In this example, from the viewpoint of the first user, the first computer system displays the non-spatial representations of the second user and the third user in the three-dimensional environment while, from the viewpoint of the second user, the second computer system displays the non-spatial representation of the first user and the spatial representation of the third user in the three-dimensional environment. Ceasing displaying the spatial representations of the users in the three-dimensional environment in response to a respective user requesting to cease including a spatial representation in the communication session ensures that the spatial status of all users in the three-dimensional environment relative to the viewpoint of a respective user remain consistent with their respective spatial status and, in keeping a consistent spatial status, increases the connectivity of the users within the three-dimensional environment.

In some embodiments, while the first computer system displays the non-spatial representation of the second user and the non-spatial representation of the third user in the three-dimensional environment relative to the viewpoint of the first user, (and optionally, the second and/or third computer system displays the non-spatial representation of the first user in the three-dimensional environment relative to the viewpoint of the second user and/or the viewpoint of the third user) the first computer system detects, via the one or more input devices, a third input corresponding to a request to include the spatial representation of the first user in the communication session, such as gaze 944 and the air pinch provided by the hand 909 in FIG. 9J-1. In some embodiments, the third input is directed to the communication session user interface as described above with reference to the second input. In some embodiments, the third input includes one or more characteristics of the first input and/or the second input as discussed above. In some embodiments, in response to detecting the third input, the first computer system transmits to the second computer system and the third computer system an indication corresponding to the request to include the spatial representation of the first user in the communication session. In some embodiments, in response to receiving the indication corresponding to the request to include the spatial representation of the first user in the communication session, the second computer system and/or the third computer system displays a visual indication in a three-dimensional environment relative to the viewpoint of the respective users (e.g., from the perspective of the respective users) of the second computer system and the third computer system (e.g., the visual indication has one or more characteristics of the one or more visual indications described above and/or below (e.g., the second visual indication)). For example, the visual indication includes one or more characteristics of the indication of the request to include spatial representations of the users in the communication session described above. In some embodiments, in response to receiving the third input, the first computer system determines whether the second user and/or the third user satisfy the one or more criteria described above.

In some embodiments, in response to the first computer system detecting the third input, in accordance with a determination that the one or more criteria are satisfied with respect to the second user and the one or more criteria second are not satisfied with respect to the third user, the first computer system displays, via the display generation component, the spatial representation of the second user and the non-spatial representation of the third user in the three-dimensional environment relative to the viewpoint of the first user, such as the spatial representation of the second user 921a and the non-spatial representation of the third user 921c in FIG. 9I-1. In some embodiments, the first computer system determines that the second user satisfies the one or more criteria and, in response, displays the spatial representation of the second user in the three-dimensional environment relative to the viewpoint of the first user. In some embodiments, the one or more criteria include a criterion that is satisfied by a respective user responding “yes” to the request to share spatial representations and/or making the request to share spatial representations as discussed above. For example, the first computer system optionally detects the third input and, in response, sends an indication corresponding to the request to include the spatial representation of the first user to the second computer system and/or the third computer system. In some embodiments, in response to detecting the indication corresponding to the request to include the spatial representation of the first user in the communication session, the third computer system displays the spatial representation of the first user and the spatial representation of the second user in the three-dimensional environment relative to the viewpoint of the third user (e.g., from the perspective of the third user). In some embodiments, the first computer system displays the spatial representation of the second user in the three-dimensional environment (e.g., immediately) in response to detecting the third input performed by the first user. In some embodiments, the first computer system maintains displaying the non-spatial representation of the third user relative to the first user in response to detecting the third input because the one or more criteria are not satisfied with respect to the third user. For example, the third computer system is not configured to include and/or present spatial representations of users in the communication session. In some embodiments, the third computer system is not configured to include and/or present spatial representations of users in the communication session because the third computer system has not detected an input requesting to include and/or present spatial representations, such as the inputs requesting to include and/or present spatial representations described herein. Selectively displaying spatial and/or non-spatial representations of the respective users in the communication session in accordance with the one or more criteria being satisfied or not satisfied with respect to the respective users prevents the erroneous display of spatial representations of user that do not want to engage in spatial communication while allowing the respective users to continue the communication session independent of respective spatial status in the three-dimensional environment.

In some embodiments, the one or more criteria includes a criterion that is satisfied when the first user requests to include a spatial representation of the first user in the communication session and/or the second user requests to include the spatial representation of the second user in the communication session, such as the visual request 951 in FIG. 9G-1. In some embodiments, the first computer detects an input by the first user to request to include the spatial representation of the first user to the second computer system. In some embodiments, the criterion that is satisfied is satisfied when the first computer detects the request. In some embodiments, the criterion is satisfied by an input detected by the first computer system prior to the first computer system detecting the request to include the spatial representation of the second user in the communication session. For example, the criterion is satisfied by the first computer detecting one or more inputs (e.g., the one or more inputs having one or more characteristics of the first input described above) at a first time during the communication session and remains satisfied upon detecting the request at a second time, later than the first time. In some embodiments, the criterion remains satisfied in response to (e.g., and/or after) the first computer system detecting the request to include the spatial representation of the second user in the communication session (e.g., the criterion maintains satisfied until the first computer system detects an additional request to cease including the spatial representation of the second user in the communication session). In some embodiments, the spatial representation of the first user includes real-time collected spatial data of the first user. In some embodiments, the criterion is satisfied in response to the second computer system transmitting a “yes” response to the request to include the spatial representation of the first user received from the first computer system. In some embodiments, the second computer system, and satisfies the criterion in response to receiving and responding “yes” to the request transmitted by the first computer system. In some embodiments, the criterion is satisfied when the second computer displays the representation of the first user as spatial in response to a request to include a spatial representation of the first user prior to the current request transmitted by the first computer system. In some embodiments, the criterion is satisfied by the first computer system initiating the request to include the spatial representation of the first user or the second computer system initiating the request to include the spatial representation of the second user in the communication session. In some embodiments, a respective computer system accepts the request to include the spatial representation of the other respective user of the other respective computer system. In some embodiments, the first computer system and/or the second computer system display respective communication session control user interfaces in the three-dimensional environment relative to the viewpoint of the first user and/or second user and, optionally, detect a respective user input directed at the selectable option of the respective communication session control user interface and, in response, transmitting a respective request to include a respective spatial representation of the respective user in the communication session. In some embodiments, the communication session includes a plurality of computer systems associated with a plurality of user (e.g., first computer system, second computer system, third computer system) where the criterion is satisfied (e.g., each computer system in the communication session displays spatial representations of the plurality of users in the three-dimensional environment) when: (i) the first computer system is requesting to include the spatial representation of the first user to the communication session, and (ii) at least one pair of computer systems of the plurality of computer systems are including spatial representations of their respective users to the communication session. In some embodiments, the criterion is not satisfied when the first user requests to include the spatial representation of the first user in the communication session and at least the second computer system has not requested to include the spatial representation of the second user in the communication session (e.g., resulting in the second computer system not displaying the spatial representation of the first user in the three-dimensional environment). Satisfying the criterion based on the request to include the respective representation of the first and/or second user to the communication session, prevents the first computer system and the second computer system from displaying the spatial representations of the respective users in the communication session without the respective user consenting to having their spatial representation being displayed in the communication session.

In some embodiments, while the first computer system displays the spatial representation of the second user in the three-dimensional environment and while the communication session includes a third computer system, different from the first computer system and the second computer system, of a third user, different from the second user and the third user, the first computer system receives an indication of a request to stop presenting the spatial representation of the second user in the communication session, such as an input to generate the indication of the request analogous to the input that generates the visual request 951 in FIG. 9G-1. In some embodiments, the communication session includes a third computer system that includes one or more characteristics of the first computer system and/or the second computer system as previously discussed above. In some embodiments, the third computer system is controlled by the third user as previously discussed above. In some embodiments, the third computer system has one or more of the characteristics previously discussed above. In some embodiments, the third computer system transmits an indication to the first computer system and/or second computer system corresponding to a request to include a spatial representation of the third user in the communication session. In some embodiments the third computer system transmits a non-spatial representation of the third user to the first computer system and the second computer system in the communication session. In some embodiments, the communication session includes the spatial representation of the first user, the spatial representation of the second user, and the spatial representation of the third user in the three-dimensional environment. In some embodiments, the communication session includes the spatial representation of the first user, the spatial representation of the second user, and a non-spatial representation of the third user within the three-dimensional environment. In some embodiments, the second computer system, third computer system and/or a computer system, server, or database not included in (e.g., different from) the first computer system generates the request to stop presenting the spatial representation of the second user in the communication session (e.g., in accordance with a determination that the second user fails to satisfy a criterion of the one or more criteria). In some embodiments, the first computer system displays a visual indication of the request to stop presenting in the three-dimensional environment relative to the viewpoint of the first user. In some embodiments, the second computer system transmits the request to stop presenting to the first computer system and the third computer system. In some embodiments, the respective computer system displays the visual indication of the request to stop presenting and/or the visual indication of the request to stop presenting combined with a non-visual indication of the request to stop presenting. In some embodiments, in response to receiving the request from the second computer system, the first computer system presents a haptic indication of the request. In some embodiments, the one or more criteria for displaying the spatial representation of the second user are not satisfied in response to the first computer system receiving the request to stop presenting the spatial representation of the second user from the second computer system.

In some embodiments, in response to the first computer system receiving the request from the second computer system, the first computer system ceases displaying, via the display generation component, of the spatial representation of the second user in the three-dimensional environment, such as the gaze 944 and air pinch provided by the hand 909 in FIG. 9C-2. In some embodiments, the first computer system and the third computer system ceases the display of the spatial representation of the second user relative to the viewpoint of the respective user in response to receiving the request to stop presenting the spatial representation of the second user in the communication session. In some embodiments, the first computer system and the third computer system cease the display of the spatial representation of the second user relative to viewpoint of the respective user concurrently. In some embodiments, the ceasing displaying the spatial representation of the second user occurs over a period of time (e.g., 1 second, 2 seconds, three seconds). In one example, the first computer ceases the display of the spatial representation of the second user over the period of time via an animation (e.g., dissolve animation, fade-out animation, shrinking animation). In some embodiments, the ceasing displaying the spatial representation of the second user occurs instantaneously.

In some embodiments, the first computer system displays, via the display generation component, the non-spatial representation of the second user in the three-dimensional environment, such as the non-spatial representation of the first user 921b in FIG. G-2. In some embodiments, the non-spatial representation of the second user comprises a two-dimensional window including a representation of the second user including one or more characteristics of the representation of the second user as discussed above with reference to the method 800. In one example, the first computer system displays the two-dimensional window in the three-dimensional environment orientated to face the viewpoint of the first user. In some embodiments, the first computer system optionally detects a movement input from the first user directed at the non-spatial representation of the second user, and updates the orientation of the non-spatial representation according to the method 800 discussed above. For example, the first computer system updates the orientation of the second non-spatial representation from an orientation directly facing the viewpoint of the first user to an orientation perpendicular to the viewpoint of the first user in the three-dimensional environment. In some embodiments, the first computer system displays the non-spatial representation of the second user in the three-dimensional environment immediately after the first computer system ceases displaying the spatial representation of the second user. In some embodiments, the first computer system, the second computer system, and the third computer system concurrently display the spatial representation of the second user in the three-dimensional environment. In some embodiments, in response to not satisfying the one or more criteria, the first computer system displays the non-spatial representation of the second user.

In some embodiments, in accordance with a determination that the communication session includes a non-spatial representation of the third user, the first computer system maintains displaying, via the display generation component, of the non-spatial representation of the third user in the three-dimensional environment relative to the viewpoint of the first user, such as the non-spatial representation of the third user 921c in FIG. 9I-1. In some embodiments, the third computer system receives a transmission from the second computer system to cease the display of the spatial representation of the second user in the three-dimensional environment, and in response, the third computer system continues to include the non-spatial representation of the third user in the communication session. In some embodiments, the second computer system maintains displaying the non-spatial representation of the third user in the three-dimensional environment relative to the viewpoint of the second user while concurrently transmitting an indication corresponding to the request to cease the display of the spatial representation of the second user.

In some embodiments, in accordance with a determination that the communication session includes a spatial representation of the third user, the first computer system maintains displaying, via the display generation component, of the spatial representation of the third user in the three-dimensional environment relative to the viewpoint of the first user, such as the spatial representation of the third user 921c in FIG. 9H. In some embodiments, the first computer system and/or the third computer system includes one or more behaviors of the first computer system and/or the third computer described above with reference to maintaining the display of the non-spatial representation of the third user. For example, the third computer system maintains display of a spatial representation of the first user in response to receiving the request from the second computer system. Displaying the updated spatial representation of the second user (spatial or non-spatial) while maintaining the current spatial status of the third user relative to the viewpoint of the first user allows each user in the communication session to use their preferred spatial status in the communication session independent of the spatial status of other users in the communication session.

In some embodiments, the communication session further includes a third computer system, different from the first computer system and the second computer system (e.g., third computer system as discussed above previously), of a third user, different from the first user and second user.

In some embodiments, the first computer system displays, via the display generation component, a non-spatial representation of the third user, such as the non-spatial representation of the third user 921c in FIG. 9F. In some embodiments, the first computer system displays the non-spatial representation of the third user prior to detecting the first input, the second input, and/or the third input as discussed above. In some embodiments, the non-spatial representation of the third user includes one or more characteristics of the non-spatial representation of the first user and/or the non-spatial representation of the second user as discussed above.

In some embodiments, while displaying the non-spatial representation of the second user and the non-spatial representation of the third user in the three-dimensional environment relative to the viewpoint of the first user, the first computer system displays, via the display generation component, a spatial option proximate to the non-spatial representation of the second user and/or the non-spatial representation of the third user in the three-dimensional environment relative to the viewpoint of the first user, such as the visual request 951 in FIG. 9G-1. In some embodiments, the first input includes selection of the spatial option proximate to the non-spatial representation of the second user and/or the non-spatial representation of the third user (e.g., selection of the spatial option corresponds to a selection input (e.g., having one or more characteristics of the selection input described above) directed to the spatial option). In some embodiments, the first computer system displays the spatial option in a two-dimensional panel orientated towards the viewpoint of the first user configured to denote the spatial status of respective users in the communication session and/or an interactable component to which the first computer system receives one or more inputs initiating or ceasing sharing the spatial representation of the first user in the communication session. In some embodiments, the first computer system displays the spatial option in response to detecting the one or more first inputs. In some embodiments, the first computer system displays the spatial option at a location (e.g., intersecting the non-spatial representations of the second user and the third user) relative to the viewpoint of the first user. In some embodiments, the first computer system displays the spatial option in the three-dimensional environment when establishing the communication session. In some embodiments, the first computer system forgoes displaying the spatial option in accordance with a determination that the spatial status of the second user transmitted by the second computer system and the spatial status of the third user transmitted by the third computer system match the spatial status of the first user in the communication session. For example, the first computer system includes the spatial representation of the first user in the communication session, the second computer system includes the spatial representation of the second user in the communication session, and the third computer system includes the spatial representation of the third user in the communication session. For example, the first computer system determines the spatial statuses of the respective users in the communication session are the same, and in response, the first computer system does not display the spatial option in the three-dimensional environment relative to the viewpoint of the first user. In some embodiments, the first computer system displays the spatial option at a location in the three-dimensional environment that overlays at least a portion of the non-spatial representation of the second user and/or the non-spatial representation of the third user relative to the viewpoint of the first user. In some embodiments, the first computer system displays the spatial option with a predetermined spatial arrangement relative to the non-spatial representation of the second user and/or the non-spatial representation of the third user relative to the viewpoint of the first user. In some embodiments, the first computer system updates the position of the non-spatial representation of the second user and/or the non-spatial representation of the first user while maintaining the predetermined spatial arrangement of the spatial option relative to the viewpoint of the first user. In some embodiments, the spatial option includes contextual information corresponding to the spatial status of each respective user in the communication session. In some embodiments, the spatial option is not displayed in the three-dimensional environment until the second user and/or the third user satisfies the one or more criteria. In some embodiments, first computer system displays the spatial option in the three-dimensional environment prior to detecting the request to include a respective spatial representation of a respective user in the communication session. In some embodiments, the spatial option is distinct from the request to transmit the respective spatial representation of the respective user. In some embodiments, in response to receiving an input selecting the spatial option the first computer system, toggles between sharing and not sharing the spatial representation of the first user with the communication session. Displaying the spatial option enhances user interactions with the computer system by enabling the respective user to toggle the spatial status of their respective avatar independent from the spatial status of other users in the communication session.

In some embodiments, the one or more criteria include a criterion that is satisfied when the first computer system generates a request to include a spatial representation of the first user in the communication session or the second computer system generates a request to include a spatial representation of the second user in the communication session, such as the gaze 944 and the air pinch provided by the hand 909 in FIG. 9A-1, and the gaze 944 and the air pinch provided by the hand 909 in FIG. 9C-2. In some embodiments, the one or more criteria include a criterion that is satisfied when the first computer system receives the request to include the spatial representation of the second user from the second computer. In some embodiments, the communication session includes a third computer system of a third user (e.g., third user as discussed above) and the one or more criteria include a criterion that is satisfied when the third computer system transmits a request to include the spatial representation of the third user in the communication session. In this example, the first computer system automatically displays the spatial representation of the third user (and/or the second user depending on the number of users in the communication session) in response to generating the request to include the spatial representation of the first user in the communication session, without requiring that the second computer system and/or third computer system transmits a request to include spatial representations of the second and/or third user(s), respectively, in the communication session. In some embodiments, the first user, the second user, and (optionally) the third user automatically satisfy the criterion of the one or more criteria in response to a respective user generating a request to include a spatial representation of the respective user in the communication session. In some embodiments, the spatial representations of the first user and/or the second user includes one or more characteristics of the spatial representations of the first user and/or the second user as discussed above.

Automatically displaying spatial representations of the users in the communication as spatial in response to a respective user requesting to include a spatial representation of the respective user in the communication ensures that all users in the communication hold the same spatial status, and through automating the change of the user representations changing from non-spatial to spatial, reduces the number of inputs needed be other users in the communication session, increasing the immersive effect of the three-dimensional environment.

In some embodiments, the communication session further includes a third computer system, different from the first computer system and the second computer system, of a third user, different from the first user and second user. In some embodiments, the first computer system displays, via the display generation component, a spatial representation of the third user (e.g., the spatial representation as discussed above), such as the spatial representation of the third user in FIG. 9G-2.

In some embodiments, while the first computer system displays the spatial representation of the second user and the spatial representation of the third user (optionally only the second user or the third user) the first computer system receives a request to cease including a respective spatial representation of a respective user in the communication session, such as a request analogous to the request that generates the visual request 951 in FIG. 9G-1. In some embodiments, the first computer system receives a request to cease including the spatial representation of the second user in the communication session from the second computer system. In some embodiments, the request is displayed as a two-dimensional window orientated towards the viewpoint of the first user in the three-dimensional environment. In some embodiments, the first computer system receives a request to cease including the spatial representation of the third user in the communication from the third computer system. In some embodiments, the first computer system receives a request to cease including the spatial representation of a respective user from the second computer system and the third computer system simultaneously. In some embodiments, the first computer system transmits the request (e.g., the request to cease including the spatial representation of the first user in the communication session) to the second computer system and/or the first computer system. In some embodiments, the request includes contextual information associated with the respective computer system that generated the request. For example, the first computer system optionally receives a request that includes contextual information indicating that the request was generated by the second computer system. In some embodiments, the first computer system displays the request in response to receiving, from the second computer system and/or the third computer system, a request to cease including the respective spatial representation of the respective user. In some embodiments, the request includes an interactable component, when selected, confirms that the respective spatial representation will be ceased to be displayed by the first computer system as discussed in further detail below. In some embodiments, in response to receiving the request, the first computer system automatically ceases displaying the spatial representation of the respective user as discussed in further detail below.

In some embodiments, in response to the first computer system receiving (e.g., received at the first computer system, the second computer system, and/or the third computer system or any combination thereof) the request and in accordance with a determination that the request is a request from the second computer system (e.g., the respective computer system as discussed above) to cease including the spatial representation of the second user (e.g., the respective user as discussed above) in the communication session, the first computer system ceases displaying, via the display generation component, of the spatial representation of the second user, such as the gaze 944 and air pinch provided by the hand 909 directed at the selectable option 913e in FIG. 9C-2 detected by the first computer system in FIG. 9D-1 resulting in the first computer system displaying the non-spatial representation of the second user 921a. In some embodiments, the first computer system and the third computer system cease displaying the spatial representation of the second user in the three-dimensional environment relative to the viewpoints of the first user and the third user. In some embodiments, the first computer system ceases displaying the spatial representation of the second user relative to the viewpoint of the first user via an animation that includes one or more characteristics of the animation as discussed above. In some embodiments, the first computer system ceases displaying the spatial representation of the second user relative to the viewpoint of the first user, while the second computer system does not cease the display of the spatial representation of the third user relative to the viewpoint of the third user and vice versa. In some embodiments, in response to the second computer system transmitting the request, the second computer system ceases displaying the spatial representation of the first user and the spatial representation of the third user in the communication session (e.g., from the viewpoint (e.g., perspective) of the second user).

In some embodiments, the first computer system displays, via the display generation component, the non-spatial representation of the second user, such as the non-spatial representation of the second user 921a in FIG. 9L. In some embodiments, the first computer system displays the non-spatial representation of the second user in the same location as the spatial representation of the second in the three-dimensional environment relative to the viewpoint of the first user. In some embodiments, the first computer system ceases displaying the spatial representation of the second user at a first location in the three-dimensional environment, and subsequently displays the non-spatial representation of the second user at a second location, different than the first location, in the three-dimensional environment. In this example, the spatial representation of the second user at the first location includes a predefined spatial representation to the communication session control user interface, and the non-spatial representation of the second user at the second location includes a predefined spatial representation to the communication session control user interface. In some embodiments, the first computer system displays the non-spatial representation of the second user while the first computer system is ceasing the display of the spatial representation of the second user via the animation as discussed above. In some embodiments, the first computer system ceases displaying the spatial representation of the second user via the animation as discussed above, resulting in the computer system displaying the non-spatial representation of the second user in the three-dimensional environment. In this example, the first computer system optionally displays the non-spatial representation of the second user in a different location in the three-dimensional environment than the location of the spatial representation of the second user relative to the viewpoint of the first user. In some embodiments, the third computer system displays the non-spatial representation of the second user in the three-dimensional environment in response to receiving the request from the second computer system.

In some embodiments, the first computer system maintains, via the display generation component, displaying of the spatial representation of the third user, such as the first computer system displaying the spatial representation of the second user 921a in FIG. 9K and FIG. 9L. In some embodiments, the first computer system displays the spatial representation of the third user in the three-dimensional environment independent of a determination of the spatial status of the second user in the communication session. In some embodiments, the first computer system maintains displaying the spatial representation of the third user in the three-dimensional environment in the absence of detecting the request generated by the second computer system and/or the first computer system continues to receive the transmission of the spatial representation of the third user from the third computer system. In some embodiments, the second computer system maintains inclusion of the spatial representation of the third user in the communication session (e.g., from the viewpoint of the second user) in response to transmitting the request. In some embodiments, the second computer ceases displaying the spatial representations of the respective users in the communication and displays the non-spatial representations of the respective users in response to transmitting the request. In some embodiments, the first computer system updates a location of the spatial representation of the third user in the three-dimensional environment in response to displaying the non-spatial representation of the second user in the three-dimensional environment while maintaining displaying the spatial representation of the third user in the three-dimensional environment. For example, as discussed above, the first computer system ceases displaying the spatial representation of the second user at a first location in the three-dimensional environment and displays the non-spatial representation of the second user at a second location in the three-dimensional environment. In this example the second location in the three-dimensional environment corresponds to the location of the spatial representation of the third user. In this example, in response to the first computer ceasing displaying the spatial representation of the second user, the first computer system updates the location of the spatial representation of the third user from the second location to a third location in the three-dimensional environment.

In some embodiments, in accordance with the first computer system determining that the request is a request from the third computer system (e.g., the respective computer system as discussed above) to cease including the spatial representation of the third user (e.g., the respective user as discussed above) in the communication session, the first computer system ceases displaying, via the display generation component, of the spatial representation of the third user, such as a request analogous to the request received by the first computer system to display the non-spatial representation of the third user 921c in FIG. 9M. In some embodiments, the first computer ceasing displaying the spatial representation of the third user includes one or more characteristics of the first computer ceasing displaying the spatial representation of the second user as discussed previously.

In some embodiments, the first computer system displays, via the display generation component, a non-spatial representation of the third user, such as the non-spatial representation of the third user 921c in FIG. 9M. In some embodiments, the first computer initiating displaying the non-spatial representation of the third user includes one or more characteristics of the first computer initiating displaying the non-spatial representation of the second user as discussed previously.

In some embodiments, the first computer system maintains, via the display generation component, displaying of the spatial representation of the second user, such as the spatial representation of the second user 921a in FIG. 9I-1. In some embodiments, the first computer maintaining displaying the spatial representation of the second user includes one or more characteristics of the first computer ceasing displaying the spatial representation of the third user as discussed previously.

Allowing a respective computer system to stop sharing a spatial representation in the communication session and continue in the communication session with non-spatial representations allows for respective users to engage in their preferred method of communicating in the communication session without disrupting the preferences of the other respective users in the communication session.

In some embodiments, the communication session further includes a third computer system, different from the first computer system and the second computer system, of a third user, different from the first user and second user, optionally as described above. In some embodiments, the first computer system displays, via the display generation component, a spatial representation of the third user (e.g., the spatial representation of the third user as discussed above), such as the spatial representation of the third user 921c in FIG. 9H.

In some embodiments, while the first computer system displays the spatial representation of the second user (e.g., the spatial representation of the second user as discussed above) and the spatial representation of the third user (e.g., the spatial representation of the third user as discussed above), such as the spatial representation of the second user 921a and the spatial representation of the third user 921c in FIG. 9H.

In some embodiments, the first computer system receives the request, such as the input analogous to generating the visual request 951 in FIG. 9G-1. In some embodiments, the request includes one or more characteristics of the request to cease including the respective spatial representation of the respective user as described above with reference to receiving the request to cease including the respective non-spatial representation of the respective user.

In some embodiments, in response to the first computer system receiving (e.g., detecting with the one or more input devices of the first computer system, the second computer system, and/or the third computer system) the request, the first computer system ceases displaying, via the display generation component, of the spatial representation of the second user and the spatial representation of the third user, such as the request that causes the first computer to cease displaying the spatial representation of the second user 921a and the spatial representation of the third user 921c in FIG. 9L, and display the non-spatial representation of the second user 921a and the non-spatial representation of the third user 921c in FIG. 9M. In some embodiments, the first computer system ceases displaying the spatial representation of the second user and the spatial representation of the third user in the three-dimensional environment simultaneously relative to the viewpoint of the first user. In some embodiments, the cessation of the spatial representation of the second user and the spatial representation of the third user includes one or more characteristics of the cessation of the spatial representations of the second user and the third user as discussed above. In some embodiment, prior to the first computer system ceasing displaying the spatial representation of the second user and the spatial representation of the third user in the three-dimensional environment, the first computer system receives and displays the request as an indication. In some embodiments, the first computer system ceases displaying the spatial representations of the second user and the third user after displaying the request for a period of time. In some embodiments, the first computer system ceases displaying the spatial representations of the second user and the third user while displaying the request for a period of time (e.g., the same period of time previously discussed). In some embodiments, the second computer system and/or third computer system cease displaying a spatial representation of the first user in response to the request.

In some embodiments, the first computer system displays, via the display generation component, the non-spatial representation of the second user and a non-spatial representation of the third user, such as the non-spatial representation of the second user 921a and the non-spatial representation of the third user 921c in FIG. 9M. In some embodiments, the first computer system displays the non-spatial representations of the second user and the third user in the three-dimensional environment while the first computer system ceases displaying the spatial representations of the second user and the third user in the three-dimensional environment. In some embodiments, the first computer system displays the non-spatial representations of the second user and the third user in a similar manner as discussed above. Requiring the respective users in the communication session leave the spatial communication session for a non-spatial communication session creates a consistent communication environment for all respective users in the communication session.

In some embodiments, while the first computer system displays the spatial representation of the second user in the three-dimensional environment relative to the viewpoint of the first user (and optionally the spatial representation of the third user), the first computer system determines that the one or more criteria are no longer satisfied, such as the legend 918 in FIG. 9D-1.

In some embodiments, in response to the first computer system determining (e.g., a spatial status of a respective user transmitted from a respective computer system to other computer systems in the communication session) that the one or more criteria are no longer satisfied, the first computer system ceases displaying, via the display generation component, the spatial representation of the second user in the three-dimensional environment relative to the viewpoint of the first user, such as the first computer displaying the non-spatial representation of the second user 921a in response to the one or more criteria not being satisfied as indicated by the legend 918 in FIG. 9D-1. In some embodiments, the one or more criteria are no longer satisfied according to the above-described limitations. In some embodiments, the first computer system ceases including the spatial representation of the first user in the communication session in response to the determining the one or more criteria are no longer satisfied. In some embodiments, the first computer system ceases displaying the spatial representation of the second user simultaneously with ceasing including the spatial representation of the first user in the communication session. In some embodiments, the first computer system displays the spatial representation of the second user in the three-dimensional environment while the second computer system displays the spatial representation of the first user in the three-dimensional environment, and in accordance with a determination that the first user no longer satisfies the one or more criteria, the first computer system displays the non-spatial representation of the second user in the three-dimensional environment while the second computer system displays the non-spatial representation of the first user in the three-dimensional environment. In some embodiments, the third computer system ceases displaying the spatial representations of the first user and the second user in response to determining that the first computer system has ceased including the spatial representation of the first user. In some embodiments, the second computer system has generated the request to cease including the spatial representation of the second user; however, the first computer system maintains displaying the spatial representation of the second user until the first computer system receives a transmission from the third computer system corresponding to the request to cease including the spatial representation of the third user in the communication session.

In some embodiments, the first computer system displays, via the display generation component, the non-spatial representation of the second user in the three-dimensional environment relative to the viewpoint of the first user, such as the non-spatial representation of the second user 921a in FIG. 9D-1. In some embodiments, the first computer system and/or the second computer system ceases including the spatial representation of the first user and the spatial representation of the second user in the communication session (e.g., and displays the non-spatial representations of the first user and/or the second user) in accordance with a determination that the first user and/or the second user no longer satisfy the one or more criteria. In some embodiments, the first user no longer satisfies the one or more criteria when the first computer system detects an input (e.g., performed by the first user) corresponding to a request to cease including the spatial representation of the first user in the communication session. For example, in response to the request to cease including the spatial representation of the first user in the communication session, the first computer system ceases to display the spatial representation of the second user in the communication session (e.g., and displays the non-spatial representation of the second user) (e.g., the first computer system ceases to display the spatial representation of the second user independent of (e.g., without detecting) an indication received from the second computer system corresponding to a request by the second user to cease including the spatial representation of the second user in the communication session). Additionally, for example, in response to detecting an indication (e.g., received from the first computer system) corresponding to the request to cease including the spatial representation of the first user in the communication session, the second computer system ceases to include the spatial representation of the first user in the communication session from the viewpoint (e.g., the perspective) of the second user (e.g., and includes the non-spatial representation of the first user n the communication session from the viewpoint of the second user). In some embodiments, the second user no longer satisfies the one or more criteria when the second computer system detects an input (e.g., performed by the second user) corresponding to a request to cease including the spatial representation of the second user in the communication session. For example, in response to the request to cease including the spatial representation of the second user in the communication session, the second computer system ceases to include the spatial representation of the first user in the communication session from the perspective of the second user (e.g., the second computer system ceases to include the spatial representation of the first user in the communication session from the perspective of the second user independent of (e.g., without detecting) an indication received from the first computer system corresponding to a request by the first user to cease including the spatial representation of the first user in the communication session) (e.g., and includes the non-spatial representation of the first user in the communication session from the viewpoint of the second user). Additionally, for example, in response to detecting an indication (e.g., received from the second computer system) corresponding to the request to cease including the spatial representation of the second user in the communication session, the first computer system ceases display of the spatial representation of the second user in the three-dimensional environment (e.g., and displays the non-spatial representation of the second user in the three-dimensional environment). In some embodiments, the third computer system displays the non-spatial representations of the first user and the second user in accordance with the determination that the one or more criteria are no longer satisfied. In some embodiments, the third computer system displays the non-spatial representation of the second user relative to the viewpoint of the first user in a similar manner as discussed above. Requiring at least two users in the communication session to satisfy the one or more criteria results in a conservation of the computational power of the respective computer systems in the communication session, and further allows the majority spatial status to dictate the overall spatial status of the respective users in the communication session.

It should be understood that the particular order in which the operations in method 1000 have been described is merely exemplary and is not intended to indicate that the described order is the only order in which the operations could be performed. One of ordinary skill in the art would recognize various ways to reorder the operations described herein.

FIGS. 11A through 11I illustrate examples of a first computer system in a communication session with a second computer system while displaying a representation of a second user of the second computer system and a representation of a first user of the first computer system in a three-dimensional environment. In some embodiments, the first computer system and/or the second computer system include the components and/or implement the methodologies described above with reference to method 800. In some embodiments, the communication session has one or more characteristics of the communication session described with reference to method 1200.

FIG. 11A illustrates an example of the first computer system 101 (e.g., an electronic device) displaying, via the display generation component 120, a three-dimensional environment 1102 including a home interface 1108 including a plurality of selectable options 1108a through 1108h corresponding to respective contacts of the first computer system 101. For example, as shown in FIG. 11A, the first computer system 101 displays the home interface 1108 at a location opposing the viewpoint of the first user 1116 overlaying a representation of a real-world environment of the first computer system 101. In some embodiments, the plurality of selectable options 1108a through 1108h includes a first selectable option 1108a corresponding to a first contact of the first computer system 101. When selected, option 1108a causes the first computer system 101 to initiate a communication session with the first contact, discussed in further detail below. In some embodiments, as shown in FIG. 11A, the first computer system 101 displays the plurality of selectable options 1108a through 1108h in a four by two array in the three-dimensional environment 1102. Alternative arrangements and/or numbers of options for the computer system 101 to concurrently display are possible in some embodiments. For example, the first computer system 101 optionally displays the plurality of selectable options 1108a through 1108h as two-dimensional circles, wherein each respective selectable option includes an indication of a respective contact name of the respective contact.

In some embodiments, as shown in FIG. 11A, the three-dimensional environment 1102 includes the above listed virtual objects overlaying a representation of the real-world environment. For example, the real-world environment optionally includes, as shown in FIG. 11A, the interior space of a room including a window 1104 and a chair 1106 opposite the viewpoint of the first user 1116. In some embodiments, the first computer system 101 displays the home interface 1108 including the plurality of selectable options overlaying a portion of the window 1104 and the chair 1106.

FIGS. 11A-11H include a top-down view 1114 of the three-dimensional environment 1102. In some embodiments, the top-down view 1114 corresponds to a schematic representation of one or more virtual objects (e.g., the virtual objects as shown in FIGS. 11A)-11H and (optionally) physical objects included in the three-dimensional environment 1102. As shown in top-down view 1114, the three-dimensional environment 1102 is viewed by the first user 1116 from a current viewpoint (e.g., the direction of the current viewpoint of respective user 1116 is represented by an arrow extending from respective user 1116). Top-down view 1114 is updated in FIGS. 11A-11H to illustrate the respective statuses of the one or more virtual objects (e.g., the home interface 1108 and the selectable contacts 1108a though 1108h displayed in FIG. 11A) in three-dimensional environment 1102 (and relative to the current viewpoint of respective user 1116).

In some embodiments, the first computer system 101 detects, via the one or input devices 114a through 114c, attention 1144 of the user directed to first selectable option 1108a (represented by the dashed line shown in FIG. 11A) and/or air gesture input (represented by hand 1109 shown in FIG. 11A). Detecting the attention 1144 of the user optionally includes detecting the gaze of the user as described further herein. Detecting an air gesture input optionally includes detecting a gesture performed by a portion of the user, such as the hand 1109 of the user.

In response to detecting the input illustrated in FIG. 11A, the first computer system 101 ceases displaying the home interface 1108 in the three-dimensional environment 1102, displays a plurality of virtual objects shown in FIG. 11B, and establishes a communication session with the second computer system associated with the second user.

FIG. 11B illustrates the first computer system 101 displaying, via a display generation component 120, a non-spatial representation of the second user 1121, a communication session controls interface 1112 (including a grabber 1110 associated with the communication session controls interface), and a user interface 1120 that includes a virtual rendering of the first user 1120a and an interactive component 1120b while establishing the communication session with the second computer system 101b (not shown). In some embodiments, the first computer system 101 displays the non-spatial representation of the second user 1121 including an image (e.g., image 1121b) corresponding to the second user (e.g., the second user 1117 shown below with reference to FIG. 11E) and a connection indication 1121a while establishing the communication session, as shown in FIG. 11B. For example, the image 1121b corresponding to the second user includes a contact photo of the second user prior to the first computer system establishing the communication session with the second computer system 101b (see FIG. 11E). In this example, the contact photo is represented as a silhouette of a person's head and shoulders against a plain background enclosed within a circular border. In some embodiments, described in further detail below, the image 1121b includes a number and/or name associated with the second user. In some embodiments, while establishing the communication session, the first computer system 101 includes the connection indication 1121a at an upper right corner of the non-spatial representation of the second user 1121, serving as a visual indication of an attempt to establish the communication session.

In some embodiments, the communication session controls interface 1112 includes a plurality of interactable controls (e.g., 1123a through 112e) configured to modify various aspects of the communication session. For example, as shown in FIG. 11B, the name displayed by the communication session user interface (e.g., JJ Smith) corresponds to the second user of the second computer system 101b (not shown). In some embodiments, interactive element 1112a is an option that, when selected, causes the computer system 101 to display a video-conferencing interface in the three-dimensional environment. In some embodiments, interactive element 1112b is an option that, when selected, mutes the audio for the first user 1116. In some embodiments, interactive element 1112c is an option that, when selected, initiates the sharing of content within the communication session (e.g., which will subsequently be displayed (or, optionally, is already displayed) in the three-dimensional environment 1102). In some embodiments, interactive element 1112d is an option that, when selected, ends the communication session with the second user (and optionally a third user described below with reference to the method 1200). In this embodiment, selection of interactive element 1112d causes the computer system 101 to cease display of the non-spatial representation of the second user 1121 in the three-dimensional environment 1102. In some embodiments, the virtual rendering of the first user 1120a includes one or more characteristics of the computer-generated image of a respective user discussed above with reference to the method 800. In some embodiments, the first computer system 101 displays the user interface 1120 including a virtual window enclosing the virtual rendering of the first user 1120a in an upper portion of the user interface 1120. In some embodiments, as shown in FIG. 11B, the virtual rendering of the first user 1120a includes one or more characteristics of the computer-generated image of the respective user discussed above with reference to the method 800. In some embodiments, the user interface 1120 includes an upper portion corresponding to the virtual rendering of the first user 1120a and a lower portion corresponding to the interactive component 1120b. In some embodiments, the interactive component 1120b is a toggle configured to slide between an “on” position and an “off” position discussed in further detail below. For example, the first computer system 101 optionally displays the interactive component 1120b as a toggle switch where one side represents “on”, and the other side represents “off.” When the button is in the “on” position, a small slider or indicator is visibly positioned on the “on” side as shown in FIG. 11B.

In some embodiments, the non-spatial representation of the second user 1121, the communication session user interface 1112, and the movement element 1110 overlay a left portion of the chair 1106 in the three-dimensional environment relative to the viewpoint of the first user 1116. In some embodiments, the first computer system 101 displays the above referenced virtual objects at predetermined distances from the viewpoint of the first user 1117. As shown in the top-down view 1114, the first computer system 101 displays the user interface 1120 at a position closest to the viewpoint of the first user 1116 as compared to the other virtual objects, the communication session controls interface 1112 between the user interface 1120 and the non-spatial representation of the second user 1121, at a location farthest from the viewpoint of the first user 1116 as compared to the other virtual objects. In some embodiments, the aforementioned arrangement of the positions of the virtual objects are configurable by the first user 1117 and/or additional predetermined configurations by the first computer system 101.

FIG. 11C illustrates an example communication session established between the first computer system 101 and the second computer system 101b (not shown) as a result of a communication request generated by the attention of the first user 1144 directed at the first selectable contact 1108a (shown in FIG. 11B). In some embodiments, in response to establishing the communication session between the first computer system 101 and the second computer system 101b (not shown), the first computer system updates the non-spatial representation of the second user 1121 from the image 1121b (shown in FIG. 11B) to a computer-generated representation of the second user 1121c. For example, as shown in FIG. 11C, the first computer system 101 displays the non-spatial representation of the second user 1121 as a virtual window enclosing a computer-generated representation of the second user 1121c. In some embodiments, during the communication session, the second computer system 101b (not shown) transmits a live-feed of computer generated graphics encapsulating the current facial/spatial/posture status of the second user to the first computer system 101 (and any additional computer systems participating in the communication session).

In some embodiments, in FIG. 11C, the first computer system 101 displays the interactive component 1120b in the “on” position (discussed above with reference to FIG. 11B) with a slider positioned on the left side of the banner, relative to the viewpoint of the first user. As shown in FIG. 11C, while the interactive component 1120b is in the “on” position, the first computer system 101 detects the attention 1144 of the user directed to the interactive component 1120b concurrently with a gesture performed by the user 1117 (e.g., with hand 1109). In response to receiving the input shown in FIG. 11C, the computer system 101 ceases providing the virtual rendering of the first user 1120a to the communication session and instead provides an image of the first user not including the virtual rendering of the first user 1120a, as described in more detail with reference to method 1200. Additionally, in some embodiments, in response to detecting the input shown in FIG. 11C, the first computer system 101 updates the user interface 1120 to replace the virtual rendering of the first user 1120a with the image of the first user not including the virtual rendering of the first user, as shown in FIG. 11D.

In FIG. 11D, the first computer system 101 updates user interface 1120 to include an image 1120c corresponding to the first user 1117 while maintaining the display of the plurality of virtual objects in the three-dimensional environment 1102. The first computer system 101 optionally displays the three-dimensional environment 1102 as shown in FIG. 11D in response to detecting the input described above with reference to FIG. 11C. In some embodiments, the image 1120c displayed within the user interface 1120 includes one or more visual characteristics of the image of the second user 1121b described above. For example, as shown in FIG. 11D, the first computer system 101 displays a coin including the initials “SG” corresponding to a name of the first user 1117. In some embodiments, the first computer system 101 toggles the first selectable option to an “off” position in response to detecting the input described above with reference to FIG. 11C. For example, as shown in FIG. 11D, the first computer system 101 displays the interactive component 1120b as the above-described button moved to the left within the banner described above. In some embodiments (not shown) the first computer system 101 displays a sliding animation of the interactive component 1120b from the “on” position to the “off” position in response to detecting the input described above with reference to FIG. 11C. In this example, the slider will appear to move horizontally across the toggle's track, transitioning from the “on” side to the “off” side. Once the animation finishes, the slider will come to a rest on the “off” side of the toggle, visually indicating the new state of the interactive component 1120b.

In some embodiments, as shown by the top-down view 1114, the first computer system 101 maintains the respective spatial arrangements of the plurality of virtual objects while updating the user interface 1120 to include the image described above.

FIG. 11E illustrates an example second computer system 101b displaying, via display generation component 120b, a three-dimensional environment 1103 relative to the viewpoint of the second user 1117 while participating in a communication session with the first computer system 101, and a non-spatial representation of the first user 1120c. In some embodiments, the second computer system 101b includes one or more characteristics of the first computer system 101 including, but not limited to, the display generation component 120 and one or more input devices 114a through 114c (e.g., corresponding to 114aa through 114cc shown in FIG. 11E). In some embodiments, the second computer system 101b displays the non-spatial representation of the first user 1120c (e.g., the image) suspended in space, a communication session controls interface 1113 (analogous to the communication session controls interface 1112), and a grabber bar 1111 associated with the communication session controls interface 1113 at a location opposing the viewpoint of the second user 1117 within a real-world environment described below. In some embodiments, as shown in FIG. 11E, the three-dimensional environment 1103 includes the above listed virtual objects overlaying a representation of the real-world environment in a similar fashion as described above with reference to FIG. 11B. For example, the real-world optionally includes, as shown in FIG. 11E, the interior space of a room including a potted plant 1106b opposite the viewpoint of the second user 1117.

As shown in FIG. 11E, the second computer system 101b displays the non-spatial representation of the first user 1120c as the coin described above with reference to FIG. 11D in response to the first computer 101 detecting the attention of the first user 1144 directed to the interactive component 1120b (illustrated by FIG. 11C) in real-time. In some embodiments, as shown in the top-down view 1115, the second computer system 101b displays the communication session controls interface 1113, the grabber bar 1111, and the non-spatial representation of the first user 1120c at predetermined locations in the three-dimensional environment 1103 relative to the viewpoint of the second user in a similar manner to the manner in which the first computer system 101 displays the virtual elements in FIG. 11C. For example, as shown in FIG. 11E, the second computer system 101b displays the communication session controls interface 1113 and the grabber bar 1111 at a location closest to the viewpoint of the second user 1117 as compared to the other virtual objects displayed in the three-dimensional environment 1103. In addition, the second computer system 101b displays the non-spatial representation of the first user 1120c at a location farthest from the viewpoint of the second user 1117 as compared to the other objects displayed in the three-dimensional environment 1103.

As described at least with reference to method 1000, in some embodiments, the communication session includes spatial representations of the users (e.g., 1120a, 1121). For example, the second user 1117 optionally updates their respective spatial status to transmit a spatial representation of the second user 1117 to the first computer system 101 described in further detail with reference to the method 1000. Other inputs for including spatial representations in the communication session, including a different electronic device initiating the use of spatial representations in the communication session, are possible as described with reference to method 1000. In this example, as shown in FIG. 11F, the computer system 101 displays the one or more virtual objects discussed above with reference to FIG. 11B in the same respective locations in the three-dimensional environment 1102 including a spatial representation of the second user 1121. In some embodiments, as shown in FIG. 11F, the first computer system 101 displays the non-spatial representation of the second user 1121 at the same location in the three-dimensional environment 1102 as shown above with reference to FIG. 11B. In some embodiments, the second computer system 101b optionally, in response to a user input, transmits a non-spatial representation of the second user 1117 to the first computer system as shown below in FIG. 11G.

FIG. 11G illustrates an example of the first computer system 101 displaying the one or more virtual objects discussed above with reference to FIG. 11B including a virtual camera 1150a configured to detect and record visual data discussed in further detail with reference to the method 1200. In some embodiments, the first computer system 101 positions the virtual camera 1150a at a location proximate to or at the location shown in FIG. 11G in response to detecting the attention 1144 of the user directed to the spatial representation of the second user 1121. For example, as shown in FIG. 11G, the first computer system 101 includes the virtual camera 1150a disposed centered in an upper portion of the non-spatial representation of the second user 1121. In some embodiments, the virtual camera 1150a is activated in response to the one or more input devices 114a through 114c detecting the attention of the first user 944 directed within a boundary of the area corresponding to the non-spatial representation of the second user 1121. In some embodiments, the virtual camera 1150a is one camera of a plurality of virtual cameras (1150a through 1150d) discussed in further detail below with reference to FIG. 11I. In some embodiments, the virtual camera 1150a is not displayed by the computer system 101 but represents the point of view (POV) from which the second computer system displays the representation of the first user. For example, as shown in FIG. 11G, the attention of the first user 1144 is detected by the first computer system 101 as directed at an area corresponding to the non-spatial representation of the second user 1121. In this example, as shown in FIG. 11G, the virtual camera 1150a is represented as an unfilled circle, indicating that the attention of the first user 1144 is directed at a vicinity of the virtual camera 1150 (e.g., the user interface 1120). In some embodiments, the location of the virtual camera 1150a in the three-dimensional environment 1102 is dynamic and corresponds to a direction of the attention of the first user 1144 as discussed in further detail below with reference to 11H.

FIG. 11H illustrates an example of the first computer system 101 updating a respective position in the three-dimensional environment 1102 of the virtual camera 1150a in accordance with the direction of the attention of the first user 1144. For example, as shown in FIG. 11H, the first computer system 101 detects the attention of the first user 1144 directed at the virtual rendering of the first user 1120a. In response to detecting the attention of the first user 1144 directed to the virtual rendering of the first user 1120a, the computer system 101 positions the virtual camera 1150a at the location shown in FIG. 11H. Alternative arrangements and/or numbers of respective locations of the virtual camera 1150a detected by computer system 101 are possible in some embodiments.

In some embodiments, the virtual camera 1150a is one of the plurality of virtual cameras disposed in the three-dimensional environment 1102 as shown in FIG. 11I. For example, as shown in FIG. 11I, the three-dimensional environment 1102 includes virtual cameras 1150a through 1150d disposed in unique positions. In some embodiments, the plurality of virtual cameras 1150a through 1150d are inactive (not recording visual data) until the first computer system 101 detects the attention of the first user 1144 directed at an area of the three-dimensional environment 1102 corresponding to a respective location of a respective virtual camera of the plurality of virtual cameras 1150a through 1150d. For example, the first computer system 101 optionally detects the attention of the first user 1144 directed at the user interface 1120 (and the virtual camera 1150d (denoted by an unfilled circle in FIG. 11I) disposed in an area of the user interface 1120) of the plurality of virtual cameras 1150a through 1150d. In some embodiments, the respective positions of the plurality of virtual cameras 1150a through 1150d are disposed at predetermined positions in the three-dimensional environment 1102 by the first computer system 101. For example, the virtual camera 1150a is optionally disposed at a location in the three-dimensional environment 1102 corresponding to the location of the non-spatial representation of the second user 1121b. In some embodiments, the first computer system 101 detects the direction of the attention of the first user 1144 shift from the virtual camera 1150d to another respective virtual camera of the plurality of virtual cameras 1150a-1150d as discussed further below.

FIG. 11J illustrates an example of the first computer system 101 detecting the attention of the first user 1144 directed to the communication session controls interface 1112. In response to detecting the attention of the first user 1144 directed to the communication session controls interface 1112, the computer system 101 activates the virtual camera 1150c disposed in an area corresponding to the communication session controls interface 1112 in the three-dimensional environment 1102. In some embodiments, in response to detecting the attention of the first user 1144 is no longer directed at the virtual camera 1150d, as it was in FIG. 11I, the first computer system 101 deactivates the virtual camera 1150d (denoted by the filled in circle shown in FIG. 11J) and activates the virtual camera 1150c (denoted by the unfilled circle shown in FIG. 11J). In some embodiments, the first computer system 101 activates/deactivates any of the plurality of virtual cameras 1150a through 1150d according to the method 1200. In some embodiments, the first computer system 101 arranges the plurality of virtual cameras 1150a through 1150d in the predetermined respective locations in the three-dimensional environment, independent of the immersion level of a system environment discussed in reference to the method 1400.

In some embodiments, as shown in FIG. 11K, the first computer system 101 maintains displaying the plurality of virtual objects (e.g., non-spatial representation of the second user 1121, the user interface 1120, the communication session controls interface 1112, and the grabber bar 1111) while updating the three-dimensional environment 1102 (shown in FIG. 11J) to the three-dimensional environment 1130. In some embodiments, the first computer system 101 updates the display of the three-dimensional environment, shown by the display generation component 120, in response to an update of the system environment discussed in further detail with reference to the method 1400. For example, the first computer system 101 optionally displays the three-dimensional environment 1130 as a moon enclosing a lower half of the display generation component 120. In some embodiments, the first computer system 101 displays the three-dimensional environment 1130 (e.g., moon) behind the aforementioned plurality of virtual objects discussed above. In some embodiments, the first computer system 101 simultaneously updates the virtual rendering of the first user 1120a to include a background (e.g., the respective background discussed with reference to the method 1400) associated with the three-dimensional environment 1130, because the representation of the first user 1120a that the second computer system device will display in the communication session will include a background corresponding to the system environment 1130, as described in more detail below with reference to method 1400. In some embodiments, the background of the virtual rendering of the first user 1120a is a scaled-down representation of the three-dimensional environment 1130.

FIG. 12 is a flow diagram illustrating an example method 1200 of a first computer system displaying a representation of a user of the first computer system in a three-dimensional environment while in a communication session. In some embodiments, the method 1200 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1200 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1200 are, optionally, combined and/or the order of some operations is, optionally, changed.

In some embodiments, a method 1200 is performed at a first computer system in communication with a display generation component and one or more input devices, such as the first computer system 101 in communication with display generation component 120 as shown in FIG. 11B. In some embodiments, the first computer system, display generation component, and/or one or more input devices have one or more characteristics of the computer system, display generation component, and/or one or more input devices described above with reference to method 800.

In some embodiments, while a three-dimensional environment is visible via the display generation component from a viewpoint of a first user of the first computer system, and while the first user of the first computer system is in a real-time communication session with a second computer system, different from the first computer system, associated with a second user, different from the first user (1202a), the first computer system displays (1202b), via the display generation component, a non-spatial representation of the second user in the three-dimensional environment, and displays a communication session controls interface in the three-dimensional environment, wherein the communication session controls interface includes a first selectable option, such as the non-spatial representation of the second user 1121 and the communication session controls interface 1112 as shown in FIG. 11B. In certain embodiments, the three-dimensional environment is generated, displayed, or otherwise made viewable by the first computer system in a similar manner as discussed previously above with reference to the method 800. In some embodiments, the three-dimensional environment has one or more characteristics of the three-dimensional environments of the method 800, the method 1000, and discussed below with reference to the method 1400. In some embodiments, the viewpoint of the first user has one or more characteristics as described above with reference to the method 800, the method 1000, and described below with reference to the method 1400. In some embodiments, the communication session with the second computer system has one or more characteristics as described above with reference to the method 800, the method 1000, and described below with reference to the method 1400. In some embodiments, the first computer system optionally initiates and/or receives a request to join the communication session with the second computer system. In some embodiments, the non-spatial representation of the second user corresponds to a virtual avatar displayed in the three-dimensional environment as discussed previously above with reference to the method 800, the method 1000, and discussed below with reference to the method 1400. In some embodiments, the non-spatial representation has one or more characteristics of the non-spatial representation as discussed above with reference to method 800, the method 1000, and described below with reference to the method 1400. In some embodiments, the computer system displays the representation of the second user in a similar manner as described above with reference to the method 800, the method 1000, and described below with reference to the method 1400. In some embodiments, the three-dimensional environment includes the first visual representation at a location visible from the perspective of the first user (e.g., inside of the viewport of the first user). In some embodiments, the first visual representation is located outside of the portion of the three-dimensional environment visible from the viewpoint of the first user as discussed previously above with reference to the method 800. In some embodiments, the communication session controls interface is displayed at a location closer to the viewpoint of the first user relative to the displayed location of the non-spatial representation of the second user within the three-dimensional environment. In some embodiments, the computer system displays the non-spatial representation of the second user at a time after the first computer system displays the communication session controls interface in the three-dimensional environment. For example, while the first computer system initiates the communication session with the second computer system, the first computer system will display the communication session controls interface in the three-dimensional environment. In this example, once the communication session is established with the second computer system, the first computer system displays the non-spatial representation of the second user in the three-dimensional environment. In some embodiments, the communication session controls interface includes a first selectable option to display a self-preview of the first user, the mechanics of initiating the aforementioned self-preview discussed in further detail below. In some embodiments, the communication session controls interface is displayed as a two-dimensional platter orientated to face the viewpoint of the first user in the three-dimensional environment. In some embodiments, the communication controls interface includes a plurality of selectable options that, when selected, cause the computer system to alter and/or control one or more aspects of the communication session. For example, a selectable option, different than the first selectable option, when selected, causes the computer system cease the communication session with the second user in the three-dimensional environment. In some embodiments, a selectable option of the plurality of selectable options, different than the first electable option, is configured to cease the display of the non-spatial representation of the second user and initiate display of a spatial representation of the second user as described above with reference to the method 800 and the method 1000. In some embodiments, the first computer system displays the first selectable option as a virtual button that is selectable to initiate one or more operations (e.g., initiating the display of the self-preview discussed in further detail below). In some embodiments, the first computer system displays the first selectable option at a respective location within the first three-dimensional environment that corresponds to the non-spatial representation of the second user. For example, the first computer system optionally displays the first selectable option above, below, and/or otherwise nearby the non-spatial representation of the second user. In some embodiments, the displayed position of the first selectable option corresponds to a position, posture, and/or orientation of the non-spatial representation of the second user in the three-dimensional environment, and/or the viewpoint of the first user. For example, the first computer system optionally displays the first selectable option below a representation of the second user's head within the non-spatial representation of the second user, and/or optionally overlaying the torso of the non-spatial representation of the second user. In response to detecting a change in the position of the non-spatial representation of the second user relative to the viewpoint of the first user (e.g., in response to input for moving the representation from the first user), the first computer system optionally moves the first selectable option in a direction and/or by a distance in accordance with movement of the non-spatial representation of the second user (e.g., in a same and/or similar distance and/or direction).

In some embodiments, while the first computer system displays the non-spatial representation of the second user and the communication session controls interface, including the first selectable option, in the three-dimensional environment, the first computer system detects (1202c), via the one or more input devices, a first input (e.g., an air gesture (further described below), voice input, touch input, or interaction with a hardware input device) directed to the first selectable option, such as the gaze 1144 combined with the input provided by hand 1109 directed to the first selectable option 912e in FIG. 11C. In some embodiments, the first input includes one or more characteristics of the first input discussed above with reference to method 800. In some embodiments, the first input includes one or more characteristics of the first input discussed above with reference to method 1000.

In some embodiments, in response to the first computer system detecting the first input, the first computer system displays (1202d), via the display generation component, a user interface including a non-spatial representation of the first user, wherein the user interface is displayed in a first position in the three-dimensional environment that is closer to the viewpoint of the first user than a second position of the communication session controls interface and a third position of the non-spatial representation of the second user in the three-dimensional environment, such as the user interface 1121 in FIG. 11C. (wherein the user interface optionally partially overlays at least a portion of the non-spatial representation of the second user from the viewpoint of the first user). In some embodiments, the first computer system continues to maintain the display of the communication session controls interface and the non-spatial representation of the second user in the three-dimensional environment when displaying the user interface in the three-dimensional environment. In some embodiments, the user interface displays a static representation of the first user at a time when the first computer system initiated the communication session and prior to a time corresponding to the selection by the first user the first selectable option. In some embodiments, the user interface displays a dynamic representation of the first user during the communication session. For example, the dynamic representation of the first user is a video feed (and/or is generated based on a video feed) corresponding to the first user in the communication session, such that expressions, movements and/or other characteristics of the representation of the first user mimic expressions, movements and/or other characteristics of the first user (e.g., the face of the first user). In some embodiments, the user interface includes a representation of the first user overlaying a background corresponding to a simulated background environment of the three-dimensional environment, as described further below with reference to method 1400. In these embodiments, the background and representation include one or more characteristics of the method 1400 as discussed in further detail below with reference to method 1400. In some embodiments, the non-spatial representation of the first user includes one or more characteristics of the non-spatial representation of the second user as previously discussed above and with reference to the method 800. In some embodiments, the first computer system displays the user interface in a position closer to the viewpoint of the first user as compared to the communication session controls interface and the non-spatial representation of the second user in the three-dimensional environment. In some embodiments, independent of their respective distances from the viewpoint of the user, a bottom edge of the user interface, a bottom edge of the communication session controls interface, and a bottom edge of the non-spatial representation of the second user are at an equal height from a floor of the three-dimensional environment relative to the viewpoint of the first user. In some embodiments, the first computer system displays the combination of the user interface, the communication session controls interface, and the non-spatial representation of the second user within a range of heights relative to the floor of the three-dimensional environment, relative to the viewpoint of the first user. In a certain embodiment, this range of heights is between 1 meter and 60 meters. In some embodiments, the first computer system displays the user interface at a first height within the range, the communication session controls interface at a second height within the range, different than the first height, and the non-spatial representation of the second user at a third height within the range, different than the first height and the second height. In some embodiments, the first computer system displays the user interface, the communication session control interface, and the non-spatial representation at a height proportional to the distance any of the aforementioned objects is displayed by the first computer system from the viewpoint of the first user in the three-dimensional environment. In some embodiments, the user interface, the communication session controls interface, and the non-spatial representation of the second user each include a virtual camera discussed in further detail below. In some embodiments, the first position, the second position, and the third position are all at least a minimum distance away from the viewpoint of first user in the three-dimensional environment. In some embodiments, the first position, the second position, and the third position have different positions along an axis extending from the viewpoint of the first user outwards into the three-dimensional space. In some embodiments, the axis corresponds to a simulated depth (e.g., a depth dimension), measured relative to the viewpoint of the first user. For example, the first computer system displays the user interface at the first position, the first position within a range of positions over 3 meters from the viewpoint of the first user (e.g., 3.25 meters, 3.5 meters, 3.75, meters, 4 meters). In this example, the first computer system displays the communication session controls interface at the second position, the second position being a position in between and/or beyond the range of positions of the first position such as between 3.25 meters through 4.5 meters. In this example, the computer system displays the non-spatial representation of the second user at a third position, the third positing being a position in a range of positions in between and/or beyond the range of positions of the second position such as between 3.25 meters through 5 meters. In some embodiments, the first position, the second position, and the third position are distinct positions along the axis in the depth dimension. For example, the user interface at the first position is spaced apart by a range of distances (e.g., 1 cm through 20 cm) from the communication session controls interface at the second position along the axis. In some embodiments, the display generation component displays the user interface at a position in the three-dimensional environment that is dependent on a position of the display of the communication session controls interface in the three-dimensional environment. For example, the electronic device displays the communication session controls interface at a first position in the three-dimensional environment and displays the user interface at a second position in the three-dimensional environment that is based on the first position of the communication session controls user interface. In this example, the first position and the second position have a spatial relationship in the three-dimensional environment. As another example, the electronic device displays the communication session controls interface at a third position in the three-dimensional environment and displays the user interface at a fourth position in the three-dimensional environment that is based on the third position of the communication session controls user interface. In some embodiments, the electronic device moves the communication session controls interface from the first position to a third position and automatically moves the user interface from the second position to a fourth position in the three-dimensional environment, the respective positions different than the first and second position previously described. In this example, the third position and the second position have the same spatial relationship and the first position and the second position in the three-dimensional environment. In some embodiments, the user interface, the communication session controls interface, and the non-spatial representation of the second user possess the same orientation relative to the viewpoint of the first user in the three-dimensional environment. In some embodiments, the user interface overlays a portion of the communication session controls interface and does not overlay the non-spatial representation of the second user relative to the viewpoint of the first user. In some embodiments, the user interface overlays a portion of the non-spatial representation of the second user that is at least 50% of the non-spatial representation from the viewpoint of the first user. In some embodiments, the user interface overlays a portion of the non-spatial representation but does not overlay a portion of the communication session controls interface from the viewpoint of the first user. Displaying a preview of the first user while in communication with a second user enhances user interactions with the computer system by providing real-time feedback to the first user, displaying visual cues for the first user, reducing user error, and reducing user inputs.

In some embodiments, the non-spatial representation of the first user includes simulated video of a rendering of the first user based on a virtual camera in the three-dimensional environment relative to the viewpoint of the first user, such as the non-spatial representation of the first user 1120a and the virtual camera 1150a in FIG. 11G. In some embodiments, the simulated video of the rendering of the first user has one or more characteristics of an avatar and/or virtual persona described with reference to method 800. In some embodiments, the virtual camera includes characteristics of a real-world camera (e.g., mimics) but operates within a digital space (e.g., the three-dimensional environment). In some embodiments, displaying the user interface including the non-spatial representation of the first user in the first position in the three-dimensional environment includes setting a position (e.g., location and/or orientation) of the virtual camera to correspond to the first position in the three-dimensional environment (e.g., the virtual camera is set to the first position in the three-dimensional environment (e.g., the location of the virtual camera is set to correspond to the position of the user interface including the non-spatial representation of the first user)). In some embodiments, the first computer system generates the simulated video of the rendering of the first user based on a viewpoint of the first user relative to a location of the virtual camera in the three-dimensional environment. In some embodiments, a pose of one or more portions of the simulated video of the rendering of the first user (e.g., an orientation of one or more representations of one or more portions of the rendering of the first user (e.g., position of a representation the head and/or eyes of the rendering of the first user included within the non-spatial representation)) corresponds to the location of the virtual camera in three-dimensional environment. For example, in accordance with a determination that the viewpoint of the first user relative to the location of the virtual camera in the three-dimensional environment, is a first viewpoint (e.g., having a first location and/or orientation relative to the location of the virtual camera), the one or more portions of the simulated video of the rendering of the first user have a first pose within the non-spatial representation (e.g., corresponding to a first position of the representation of the head and/or eyes of the rendering of the first user included within the non-spatial representation). For example, in accordance with a determination that the viewpoint of the first user relative to the location of the virtual camera is a second viewpoint, different from the first viewpoint (e.g., having a second location and/or orientation, different from the first location and/or orientation, relative to the location of the virtual camera), the one or more portions of the simulated video of the rendering of the first user have a second pose, different from the first pose, within the non-spatial representation (e.g., corresponding to a second position, different from the first position, of the representation of the head and/or eyes of the rendering of the first user included within the non-spatial representation). In some embodiments, the location of the virtual camera in the three-dimensional environment is a predetermined location in the three-dimensional environment set by the first computer system. In some embodiments, the first computer system detects the attention of the first user (e.g., the gaze of the first user)) directed towards the location of the virtual camera in the three-dimensional environment, and in response, updates the one or more portions of the simulated video of the rendering of the first user (e.g., such that, from the perspective of the first user (and/or optionally from the perspective of the second user viewing a respective representation of the first user in the communication session) the gaze of the first user (e.g., corresponding to eye and/or head position of the rendering of the first user) is directed to a forward location (e.g., from the viewpoint of the first user and/or from the perspective of the second user viewing the communication session)). In some embodiments, the virtual camera is one of the plurality of virtual cameras disposed in the three-dimensional environment as discussed below. In some embodiments, the first computer system sources data to construct the simulated video of the rendering of the first user from real-time video of the first user while in the communication session. Generating the rendering of the first user with a virtual camera results in, from the viewpoint of the second user, the attention of the first user is always focused on the second user while the users are engaging in the communication session, fostering an increased conversational connection between users participating in the communication session.

In some embodiments, the third position of the non-spatial representation of the second user is farther from the viewpoint of the first user than (i) the second position of the communication session controls interface and (ii) the first position of the user interface in the three-dimensional environment, such as the positions of the aforementioned objects displayed by the top-down view 1114 in FIG. 11B In some embodiments, the first position, the second position, and the third position are positioned along the axis extending from the viewpoint of the first user discussed above with reference to the method 1200. In some embodiments, from the viewpoint of the first user, the third position of the non-spatial representation of the second user overlays at least a portion of the communication session controls interface at the second position and/or the user interface at the first position along the axis extending from the viewpoint of the first user. In some embodiments, the first position, the second position, and the third position are respective positions along the axis extending from the viewpoint of the first user such that the respective virtual objects corresponding to the respective positions do not overlay one another from the viewpoint of the first user.

In some embodiments, the second position of the communication session controls interface is farther from the viewpoint of the first user than the first position of the user interface in the three-dimensional environment, such as the communication session controls 1112 as compared to the user interface 1120 in FIG. 11B. In some embodiments, the first computer detects one or more inputs (e.g., the first input), and in response, determines the respective positions of the non-spatial representation of the second user, the communication session controls interface, and the user interface in the three-dimensional environment relative to the viewpoint of the first user. In some embodiments, the first computer system displays the user interface no closer than a threshold distance (e.g., 0.05, 0.1, 0.2, 0.5, 1, 2, or 5 meters) from the viewpoint of the first user in the three-dimensional environment. In some embodiments, the first position, the second position, and the third position in the three-dimensional environment are equally spaced apart from one another by a predetermined minimum distance. In some embodiments, the first position, second position, and/or third position in the three-dimensional environment are relative to a cartesian coordinate system (e.g., X-Y-Z coordinates) including a height (e.g., relative to a distance from a ground of the three-dimensional environment), a depth (e.g., relative to a distance from the viewpoint of the first user), and a tangential position (e.g., relative to the viewpoint of the first user). In some embodiments, the first computer system restricts the respective positions in the three-dimensional environment to positions wherein the virtual objects (e.g., including the non-spatial representation of the second user, communication session controls interface, and/or the user interface including the non-spatial representation of the first user) are easily viewable (e.g., unobstructed and/or displayed at a position close enough to the viewpoint of the first user in the three-dimensional environment such that, from the perspective of the first user, details of the virtual objects are distinguishable) by the first user. In some embodiments, the first position, the second position, and the third position are individually set by the first user. In some embodiments, the respective positions of the virtual objects are static in the three-dimensional environment during the communication session. In some embodiments, the respective positions of the virtual objects are configured to move within the three-dimensional environment according to the user input detected by the first computer system as discussed above. For example, the first computer system displays the respective virtual objects at the corresponding respective positions in the three-dimensional environment and, in response to detecting the user input, the first computer system updates the first location of the user interface from an initial position to a final position, closer to the viewpoint of the first user as compared to the initial position. Stacking the displayed non-spatial representation of the second user, the communication session controls interface, and the user interface aids in creating a three-dimensional environment with depth relative to the viewpoint of a user in the communication session and ensures that virtual objects displayed in the three-dimensional environment do not phase (e.g., clipping) through one another relative to the viewpoint of the user.

In some embodiments, a display size of the user interface in the three-dimensional environment is smaller than a display size of the non-spatial representation of the second user in the three-dimensional environment relative to the viewpoint of the first user, such as the user interface 1120 as compared to the non-spatial representation of the second user 1121 in FIG. 11B. In some embodiments, the first computer system displays the non-spatial representation of the second user with a first predetermined height and a first predetermined width in the three-dimensional environment. In some embodiments, the first computer system displays the user interface with a second predetermined height and a second predetermined width, different from the first predetermined height and the first predetermined width, in the three-dimensional environment. For example, the second predetermined height and the second predetermined width are smaller than the first predetermined height and the first predetermined width. In some embodiments, the first computer system limits the display size of the user interface to be less than or equal to the display size of the non-spatial representation of the second user in the three-dimensional environment. In some embodiments, the display size of the non-spatial representation of the second user and the display size of the user interface are different sizes according to a predetermined ratio. For example, the first computer system displays the user interface element at a size four times smaller than the displayed size of the non-spatial representation of the second user, relative to the viewpoint of the first user. In some embodiments, the first computer system detects a user input, such as the one or more inputs, and in response, adjusts the respective display size of the non-spatial representation of the second user or the user interface in the three-dimensional environment while maintaining the predetermined ratio. For example, in response to receiving an input requesting to increase the size of the user interface element and/or the non-spatial representation of the second user, the first computer system increases the display size of the user interface and the spatial representation of the second user by two times simultaneously. In some embodiments, the first computer system displays the display size of the user interface with a first length and a first width in the three-dimensional environment and displays the display size of the non-spatial representation of the second user with a second length and a second width, greater than the first length and the first width independent of the viewpoint of the first user, in the three-dimensional environment. In some embodiments, the display size of the user interface is a (e.g., predetermined perceived) display size relative to the viewpoint of the first user, and the display size of the non-spatial representation of the second user is a (e.g., predetermined perceived) display size relative to the viewpoint of the first user, larger than the display size of the user interface relative to the viewpoint of the first user. In some embodiments the first computer system determines the display size of the user interface and/or the non-spatial representation of the second user based on the area of the three-dimensional environment occupied relative to the viewpoint of the first user.

Displaying the user interface with a smaller size as compared to the displayed size of the non-spatial representation of the second user ensures that the first user is able to easily view a preview of themselves in the three-dimensional environment without obscuring the non-spatial representation of the second user while in the communication session, resulting in a seamless communication session while still allowing for the first user to observe real-time feedback of the representation of the first user viewable by the second user in the communication session.

In some embodiments, the user interface includes an interactive component (e.g., adjacent and/or partially overlaying the non-spatial representation of the first user), such as the interactive component 1120b in FIG. 11B.

In some embodiments, while displaying the user interface including the non-spatial representation of the first user (e.g., and optionally a plurality of other virtual objects in the three-dimensional environment including, but not limited to, a third user in the communication session) and the interactive component, the first computer system detects, via the one or more input devices, a second input directed to the interactive component, such as the gaze 1144 combined with an air pinch provided by the hand 909 in FIG. 11C. In some embodiments, the interactive component includes an icon or button. For example, the icon/button optionally resembles a camera or a lens. In some embodiments, in response to detecting the second input (discussed in further detail below), the electronic device modifies display of the icon. For example, the electronic device modifies display (e.g., a visual appearance and/or prominence) of the icon to indicate that the first computer system is transmitting the non-spatial representation of the first user (e.g., by displaying a filled-in camera icon or a green indicator light). In some embodiments, the first computer system reduces a visual prominence of the icon (e.g., by reducing opacity, color, brightness, and/or saturation of the icon) or displays a visual indication (e.g., a cross-out symbol) optionally overlaid on the icon (e.g., indicating that the camera is not transmitting the non-spatial representation of the first user to the second computer system during the communication session). In some embodiments, the second input includes one or more characteristics of the first input described above.

In some embodiments, in response to the first computer system detecting (e.g., via the one or more input devices) the second input, and in accordance with a determination that, when the second input is received, the non-spatial representation of the first user includes a virtual rendering of the first user, the first computer system updates, via the display generation component, the display of the non-spatial representation of the first user to include an image representing the first user that does not include the virtual rendering of the first user, such as the image 1120c in FIG. 11C. In some embodiments, the image representing the first user has one or more characteristics of the virtual representation of the shape described with reference to method 800. In some embodiments, the first computer system updates the non-spatial representation of the user instantaneously in response to detecting the second input. In some embodiments, the first computer system updates the non-spatial representation of the first user to the image over a time period (e.g., 0.1, 0.2, 0.5, 1, 2, 5, or 10 seconds) via an animation. In some embodiments, the virtual rendering includes one or more characteristics of the plurality of representations of the plurality of users described above with reference to the method 800. In some embodiments, the first computer system displays the virtual rendering centered within the non-spatial representation of the first user, relative to the viewpoint of the first user. In some embodiments, in response to detecting the second input, the first computer system ceases displaying the non-spatial representation of the first user including the virtual rendering in the three-dimensional environment and re-displays the non-spatial representation of the first user including the image, not the virtual rendering, in the three-dimensional environment. In some embodiments, the image includes one or more characteristics of the virtual coin, or the virtual sphere as described above with reference to the method 1000. In some embodiments, the image representing the first user is the virtual coin including identifying information related to the respective user (e.g., name, phone number, other account name). In some embodiments, the virtual rendering includes one or more characteristics of the avatar discussed with reference to the method 800, the method 1000, and the method 1400. In some embodiments, the first computer system requires a confirmation input after detecting the second input before updating the virtual rendering to the image representing the first user. In some embodiments, while the first computer system displays the non-spatial representation of the first user including the virtual rendering of the first user, the first computer system transmits the virtual rendering to one or more respective computer systems (different from the first computer system) in the communication session (e.g., the second computer system), and in response to the second input, the first computer system displays the image representation of the first user that does not include the virtual rendering, ceases transmitting the virtual rendering to the one or more respective computer systems in the communication session, and displays the image while transmitting the image to the one or more respective computer systems in the communication session. For example, after the first computer system detects the second input (e.g., in response to the first computer system detecting the first input), the one or more respective computer systems of the communication session display, from the perspectives of the one or more respective users of the one or more respective computer systems, the non-spatial representation of the first user including the image representing the first user and not including the virtual rendering of the first user.

In some embodiments, in accordance with a determination that, when the second input is received, the non-spatial representation of the first user includes the image representing the first user that does not include the virtual rendering of the first user, the first computer updates, via the display generation component, the display of the non-spatial representation of the first user to include the virtual rendering of the first user, such as an input analogous to the gaze 944 combined with the air pinch provided by the hand 909 in FIG. 11C. In some embodiments, the first computer system updates the non-spatial representation from not including the virtual rendering of the first user to including the virtual rendering of the first user in the three-dimensional environment according to one or more methods as described above with reference to updating the non-spatial representation of the first user from including the virtual rendering to including the image. In some embodiments, the first computer system updates the non-spatial representation of the first user from including the image to including the virtual rendering of the first user. In some embodiments, while the first computer system is displaying the image not including the virtual rendering of the first user and transmitting the image to the one or more respective computer systems (different from the first computer system), in response to the second input, the first computer system ceases transmitting the image to the one or more respective computer systems in the communication session and ceases displaying the image, and displays non-spatial representation of the first user including the virtual rendering of the first user, and simultaneously transmits the virtual rendering to the one or more respective computer systems. For example, after the first computer system detects the second input (e.g., in response to the first computer system detecting the first input), the one or more respective computer systems of the communication session (different from the first computer system) display, from the perspectives of the respective users of the one or more respective computer systems, the non-spatial representation of the first user including the virtual rendering of the first user. Displaying the non-spatial representation of the first user within the user interface as either the avatar corresponding to the first user or the coin corresponding to the first user allows the first user to preview how the second user will perceive the first user during the communication session, this allowing for real-time feedback for the first user during the communication session.

In some embodiments, in response to detecting the second input and in accordance with a determination that the communication session includes a spatial representation of the first user, the first computer system continues to include the spatial representation of the first user in the communication session, such as the analogous non-spatial representation of the second user in FIG. 11C and FIG. 11D. In some embodiments, the spatial representation of the first user has one or more characteristics of the spatial representations described with reference to methods 800 and/or 1000. In some embodiments, in response to detecting the second input, in accordance with the determination that the communication session includes the spatial representation of the first user, and the spatial representation of the first user includes a virtual rendering of the first user (e.g., having one or more characteristics of an avatar and/or virtual persona of the first user described with reference to method 800), the first computer system changes the visual appearance of the spatial representation of the first user in the communication session to include an image representing the first user (e.g., having one or more characteristics of the virtual representation of the shape described with reference to method 800 (e.g., a coin)). For example, changing the visual appearance of the spatial representation of the first user in the communication session to include the image representing the first user includes ceasing to include the virtual rendering of the first user in the spatial representation of the first user in the communication session. In some embodiments, in response to detecting the second input, in accordance with the determination that the communication session includes the spatial representation of the first user, and the spatial representation of the first user includes an image representing the first user, the first computer system changes the visual appearance of the spatial representation of the first user in the communication session to include a virtual rendering of the first user. For example, changing the visual appearance of the spatial representation of the first user to include the virtual rendering of the first user in the communication session includes ceasing to include the image representing the first user in the spatial representation of the first user in the communication session. In some embodiments, while including the spatial representation of the first user in the communication session with a virtual rendering of the first user, the first computer system detects an input corresponding to a request to cease including the spatial representation of the first user in the communication session (e.g., as described with reference to the second input in method 1000). In some embodiments, in response to detecting the input corresponding to the request to cease including the spatial representation of the first user in the communication session, the first computer system ceases to include the spatial representation of the first user in the communication session and includes a non-spatial representation (e.g., having one or more characteristics of a non-spatial representation described below) of the first user in the communication session including the virtual rendering of the first user. In some embodiments, while including the spatial representation of the first user in the communication session with an image representing the first user, the first computer system detects an input corresponding to a request to cease including the spatial representation of the first user in the communication session (e.g., as described with reference to the second input in method 1000). In some embodiments, in response to detecting the input corresponding to the request to cease including the spatial representation of the first user in the communication session, the first computer system ceases to include the spatial representation of the first user in the communication session and includes a non-spatial representation (e.g., having one or more characteristics of a non-spatial representation described below) of the first user in the communication session including the image representing the first user.

In some embodiments, in accordance with a determination that the communication session includes the non-spatial representation of the first user, the first computer system continues to include the non-spatial representation of the first user in the communication session, such as the non-spatial representation of the second user in FIG. 11C and FIG. 11D. In some embodiments, the non-spatial representation of the first user in the communication session has one or more characteristics of the non-spatial representations described with reference to methods 800 and/or 1000. In some embodiments, in response to detecting the second input, in accordance with the determination that the communication session includes the non-spatial representation of the first user, and the non-spatial representation of the first user includes a virtual rendering of the first user, the first computer system changes the visual appearance of the non-spatial representation of the first user in the communication session to include an image representing the first user. For example, changing the visual appearance of the non-spatial representation of the first user in the communication session to include the image representing the first user includes ceasing to include the virtual rendering of the first user in the non-spatial representation of the first user in the communication session. In some embodiments, in response to detecting the second input, in accordance with the determination that the communication session includes the non-spatial representation of the first user, and the non-spatial representation of the first user includes an image representing the first user, the first computer system changes the visual appearance of the non-spatial representation of the first user in the communication session to include a virtual rendering of the first user. For example, changing the visual appearance of the non-spatial representation of the first user to include the virtual rendering of the first user includes ceasing to include the image representing the first user in the non-spatial representation of the first user in the communication session. In some embodiments, while including the non-spatial representation of the first user in the communication session with a virtual rendering of the first user, the first computer system detects an input corresponding to a request to include a spatial representation of the first user in the communication session (e.g., as described with reference to the first input in method 1000). In some embodiments, in response to detecting the input corresponding to the request to include the spatial representation of the first user in the communication session (e.g., and in accordance with a determination that one or more criteria are satisfied, as described with reference to method 1000), the first computer system ceases to include the non-spatial representation of the first user in the communication session and includes a spatial representation of the first user in the communication session including the virtual rendering of the first user. In some embodiments, while including the non-spatial representation of the first user in the communication session with an image representing the first user, the first computer system detects an input corresponding to a request to including a spatial representation of the first user in the communication session (e.g., as described with reference to the first input in method 1000). In some embodiments, in response to detecting the input corresponding to the request to include the spatial representation of the first user in the communication session, the first computer system ceases to include the non-spatial representation of the first user in the communication session and includes a spatial representation of the first user in the communication session including the image representing the first user. Maintaining a spatial status of a representation of a participant in a communication session when the participant changes a visual appearance of a preview (e.g., between an avatar and a virtual representation of a shape (e.g., a coin)) enables the participant to customize their visual appearance in the communication session while preventing unexpected changes in spatial status in the communication session, thereby reducing errors in interaction and conserving computing resources associated with inputs to correct unexpected changes in spatial status.

In some embodiment, while displaying the non-spatial representation of the second user in the three-dimensional environment and while the non-spatial representation of the second user includes an image representing the second user without including a virtual rendering of the second user, the first computer system receives, from the second computer system, an indication of a request to include the virtual rendering of the second user in the non-spatial representation of the second user, such as an indication of a request analogous to the request generated by the first computer system 101 causing the second computer system 101b to display the image 1120c in FIG. 11E. In some embodiments, the virtual rendering of the second user includes one or more characteristics of the virtual rendering of the first user as discussed above. In some embodiments, the indication of the request to include the virtual rendering of the second user includes one or more characteristics of the request to display the spatial representation of the second user as discussed with reference to the method 1000. In some embodiments, the virtual rendering of the second user is generated by the second computer system using a collection of (e.g., real-time) data of the second user. In some embodiments, while the second computer is in the communication session and displaying a non-spatial representation of the first second user, the second computer system detects an input with one or more characteristics of the second input described above directed at the non-spatial representation of the second user including a virtual rendering of the second user, and in response, the second computer system ceases displaying the virtual rendering of the second user and displays an image representing the second user (e.g., without including the virtual rendering of the second user as described below). In some embodiments, the first computer system displays the image representing the second user with the respective background of the second computer system as described with reference to method 1400. In some embodiments, the first computer system displays the image representing the second user with an animation including one or more characteristics of the animation described above.

In some embodiments, in response to receiving the indication from the second computer system, the first computer system updates, via the display generation component, the non-spatial representation of the second user to include the virtual rendering of the second user without including the image representing the second user, such as the first computer system updating the display of non-spatial representation of the second user 1121 in FIG. 11B to FIG. 11C. In some embodiments, the first computer system ceases displaying the image representing the second user before displaying the virtual rendering of the second user. In some embodiments, the first computer system displays the virtual rendering overlaying the image representing the second user (e.g., a location closer to the viewpoint than the first position discussed above). In some embodiments, while the first computer system displays the non-spatial representation of the second user including the image representing the second user at a first size (e.g., a first display size and/or a first size relative to the three-dimensional environment), receiving the indication from the second computer system. In some embodiments, in response to receiving the indication from the second computer system, updating the non-spatial representation of the second user to include the virtual rendering of the second user while maintaining the first size of the non-spatial representation. In some embodiments, the first computer system displays the non-spatial representation of the second user including the image representing the second user without the respective simulated background environment of the second computer system (e.g., having one or more characteristics of the one or more simulated background environments described with reference to method 1400), and displays the non-spatial representation of the second user including the virtual rendering of the second user with the respective simulated background environment of the second computer system. In some embodiments, the first computer system displays the non-spatial representation of the second user including the image representing the second user and the non-spatial representation of the second user including the virtual rendering of the second user with the respective simulated background environment of the second computer system. In some embodiments, while displaying the non-spatial representation of the second user in the three-dimensional environment, the first computer system detects an indication (e.g., received from the second computer system) corresponding to participation of the second user in the communication session (e.g., having one or more characteristics of participation in the communication session described with reference to method 800). In some embodiments, in response to detecting the indication, in accordance with a determination that the non-spatial representation of the second user includes the image representing the second user without including the virtual rendering of the second user, the first computer system displays the non-spatial representation with a first animation in the three-dimensional environment. For example, the first animation includes movement of the non-spatial representation (e.g., to a different distance relative to a location corresponding to a current viewpoint of the first user, as described with reference to method 800, and/or oscillation of the image representing the second user), a change in visual prominence (e.g., having one or more characteristics of changing visual prominence as described with reference to method 800), and/or a change in visual appearance (e.g., changing brightness, color, and/or saturation)). For example, displaying the first animation includes displaying a pulsating or fluctuating ring and/or outline around the image representing the second user. In some embodiments, the pulsing or fluctuating ring discussed above visually indicates that the second user is speaking in the communication session. In some embodiments, in response to detecting the indication, in accordance with a determination that the non-spatial representation of the second user includes the virtual rendering of the second user without including the image representing the second user, the first computer system forgoes displaying the non-spatial representation with the first animation in the three-dimensional environment. In some embodiments, the first computer system displays the virtual rendering of the second user in response to detecting a confirmation input by the first user accepting the second computer's transmission of the virtual rendering of the second user to the three-dimensional environment.

Updating the representation of the second user included in the non-spatial representation of the second user relative to the viewpoint of the first user in accordance with the preferences of the second user facilitates an ability for respective users to alter the appearance of their representation (e.g., camera on/off) in the communication session without disruption the communication session, ensuring customization of the communication session without the need to pause and/or end the communication session in order to achieve this.

In some embodiments, the first computer system displays, via the display generation component, the non-spatial representation of the first user, the non-spatial representation of the second user, and the communication session controls user interface in a respective system environment (e.g., and optionally a plurality of other virtual objects in the three-dimensional environment), such as the non-spatial representation of the first user 1120a, the non-spatial representation of the second user 1121c, and the communication session controls user interface 1112 in FIG. 11C. In some embodiments, displaying the non-spatial representation of the first user includes, in accordance with a determination that the respective system environment is a first system environment, displaying the non-spatial representation of the first user with a first background that corresponds to the first system environment, such as the non-spatial representation of the first user 1120b in FIG. 11K. In some embodiments, the respective system environment includes one or more characteristics of the respective system environment discussed in further detail below with reference to the method 1400. In some embodiments, the first computer system sets the respective system environment (e.g., in response to an input (e.g., performed by the first user) corresponding to a request to set the respective system environment) prior to the communication session. In some embodiments, the respective system environment is a predetermined environment of the first computer system. In some embodiments, the respective background includes one or more visual characteristics of the respective system environment. In some embodiments, the first computer system displays the communication session user interface (and optionally any other displayed virtual content) in the respective system environment while displaying the non-spatial representation of the first user in respective system environment. In some embodiments, the first computer system displays the first system environment prior to displaying the non-spatial representation of the first user with the first background in the three-dimensional environment. In some embodiments, the first computer system detects an input corresponding to selection of the first system environment at the communication session controls user interface (e.g., performed by the first user). In some embodiments, in response to detecting the input corresponding to selection of the first system environment, the first computer system updates (e.g., at a first time), the three-dimensional environment to include the first system environment. In some embodiments, in response to detecting the input corresponding to selection of the first system environment, the first computer system updates the non-spatial representation (e.g., at a second time, after the first time) to include the first background. In some embodiments, displaying the non-spatial representation of the first user includes displaying the virtual rendering of the first user (or optionally an image representing the first user) at least partially overlaid on the first background. In some embodiments, the second computer system detects (e.g., receives from the first computer system) an indication corresponding to a request to include the first background in the non-spatial representation of the first user in the communication session. In some embodiments, in response to detecting the indication, the second computer system displays, from the perspective of the second user, the non-spatial representation in the communication session with the first background.

In some embodiments, displaying the non-spatial representation of the first user includes, in accordance with a determination that the respective system environment is a second system environment different from the first system environment, displaying the non-spatial representation of the first user with a second background that corresponds to the second system environment, different from the first background, such as a system environment analogous to the three-dimensional environment 1130 in FIG. 11K. In some embodiments, the respective system environment is a system environment of a plurality of system environments that include the first system environment and the second system environment. In some embodiments, the second system environment includes one or more characteristics of the second system environment discussed in further detail below with reference to the method 1400. In some embodiments, the first computer system displays the three-dimensional environment with the second system environment prior and/or during the communication session. In some embodiments, the second background includes one or more characteristics of the second background discussed in further detail below with reference to the method 1400. In some embodiments, the behavior of the second system environment and the second background includes one or more characteristics of the first system environment and the first background previously discussed. Displaying a respective background corresponding to a respective system environment of the first computer behind the rendering of the user in the non-spatial representation of the first user increases the immersivity of the three-dimensional environment while the first user is participating in the communication session by matching the three-dimensional environment viewable by the first user with the projected image transmitted to the second computer system.

In some embodiments, the three-dimensional environment includes a plurality of virtual cameras (e.g., a software-based camera that simulates a physical camera, as described above) used to generate the non-spatial representation (e.g., and optionally display a (e.g., real-time) representation of the first user based on collected visual data by the plurality of virtual cameras) of the first user, such as the virtual cameras 1150a-1150d in FIG. 11I. In some embodiments, a position (e.g., location and/or orientation) in the three-dimensional environment of a respective virtual camera of the plurality of virtual cameras corresponds to a viewing angle of a virtual rendering of the first user included in the non-spatial representation (e.g., corresponding to a pose of one or more portions of the rendering of the first user described above).

In some embodiments, in accordance with a determination that one or more first criteria are satisfied and one or more second criteria different from the one or more first criteria are not satisfied, the first computer system generates the non-spatial representation of the first user (e.g., 1120a) using a virtual camera at a position corresponding to the third position in the three-dimensional environment of the non-spatial representation of the second user, such as the virtual camera 1150d in FIG. 11I. In some embodiments, the one or more first criteria include a criterion that is satisfied when the attention (e.g., including gaze, cursor, and/or hand position) of the first user is directed to the position corresponding to the third position in the three-dimensional environment (e.g., the criterion is not satisfied when the attention of the first user is directed to a position corresponding to a respective position different from the third position in the three-dimensional environment). In some embodiments, the one or more second criteria are not satisfied when the attention of the first user is directed to the position corresponding to the third position in the three-dimensional environment. In some embodiments, a first virtual camera of the plurality of virtual cameras corresponds to a first position of the plurality of positions in the three-dimensional environment, and a second virtual camera, different from the first virtual camera, of the plurality of virtual cameras corresponds to a second position, different from the first position, of the plurality of positions in the three-dimensional environment. In some embodiments, respective positions of respective virtual cameras included in the plurality of virtual cameras in the three-dimensional environment correspond to respective positions of virtual objects in the three-dimensional environment. For example, a respective virtual camera optionally corresponds to the second position associated with the communication session controls interface in the three-dimensional environment. In some embodiments, the first computer system determines (e.g., predetermines) the relative positions of the plurality of cameras in the three-dimensional environment. In some embodiments, the virtual camera at the position corresponding to the third position in the three-dimensional environment includes one or more characteristics of the virtual camera described in further detail with reference to the method 1400. In some embodiments, the one or more criteria being satisfied includes one or more characteristics of the one or more criteria being satisfied according to the method 1400. In some embodiments, the first computer system configures the plurality of virtual cameras to simultaneously record real-time data corresponding to the first user to generate the virtual rendering of the first user in the three-dimensional environment. In some embodiments, the first computer system determines the one or more first criteria are satisfied via the one or more input devices (e.g., one or more cameras configured to track a user's gaze). In some embodiments, the one or more first criteria are satisfied at a time different from a time when the one or more second criteria are satisfied. For example, the first computer system optionally determines that the one or more second criteria are satisfied and the one or more first criteria are not satisfied (discussed in further detail below) during a first time period of the communication session, and the first computer system optionally determines the one or more first criteria are satisfied and the one or more second criteria are not satisfied during a second time period, different from the first time period, during the communication session. In some embodiments, the one or more second criteria are not satisfied during the communication session.

In some embodiments, in accordance with a determination that the one or more second criteria are satisfied and the one or more first criteria are not satisfied, the first computer system generates the non-spatial representation of the first user using a virtual camera at a position corresponding to a fourth position different from the third position in the three-dimensional environment of the non-spatial representation of the second user, such as the virtual camera 1150b in FIG. 11I. In some embodiments, the one or more second criteria includes a criterion that is satisfied when the attention (e.g., including gaze, cursor, and/or hand position) of the first user is directed to a position corresponding to the fourth position in the three-dimensional environment (e.g., the criterion is not satisfied when the attention of the first user is directed to a position corresponding to a respective position different from the fourth position in the three-dimensional environment). In some embodiments, the one or more first criteria are not satisfied when the attention of the first user is directed to a position corresponding to the fourth position in the three-dimensional environment. In some embodiments, in accordance with a determination that a position (e.g., location and/or orientation) of a respective virtual camera of the plurality of virtual cameras in the three-dimensional environment is a first respective position, the first computer system generates the virtual rendering of the first user (included in the non-spatial representation of the first user) having a first pose (e.g., having one or more characteristics a pose of one or more portions of the virtual rendering of the first user described above). For example, the first pose corresponds to a current spatial relationship between a location corresponding to the current viewpoint of the first user and the first respective position of the respective virtual camera in the three-dimensional environment. In some embodiments, in accordance with a determination that a position (e.g., location and/or orientation) of the respective virtual camera in the three-dimensional environment is a second respective position, different from the first respective position, the first computer system generates the virtual rendering of the first user (included in the non-spatial representation of the first user) having a second pose, different from the first pose (e.g., having one or more characteristics of a pose of one or more portions of the virtual rendering of the first user described above). For example, the second pose corresponds to a current spatial relationship between a location corresponding to the current viewpoint of the first user and the second respective position of the respective virtual camera in the three-dimensional environment. Setting the location of the respective virtual camera of the plurality of virtual cameras based on where in the three-dimensional environment the first user directs their attention ensures that the second computer system displays the gaze of the non-spatial representation of the first user relative to the viewpoint of the second user as always being directed to the viewpoint of the second user, thereby reducing errors in interaction in the communication session and improving user device interaction.

In some embodiments, the one or more first criteria include a criterion that is satisfied when attention of the first user is directed to the third position in the three-dimensional environment of the non-spatial representation of the second user, and the one or more second criteria include a criterion that is satisfied when the attention of the user is directed to the fourth position in the three-dimensional environment, such as the gaze 1144 directed to a region associated with the virtual camera 1150d in FIG. 11I and the gaze 1144 directed to a region associated with the virtual camera 1150c in FIG. 11J. In some embodiments, the criterion of the one or more first criteria is not satisfied when attention of the first user is directed to a respective position in the three-dimensional environment different from the third position of the non-spatial representation of the second user. In some embodiments, the criterion of the one or more second criteria is not satisfied when attention of the user is directed a respective position in the three-dimensional environment different from the fourth position in the three-dimensional environment. In some embodiments, the criterion for the one or more first criteria is satisfied when gaze of the first user is directed toward a position in the three-dimensional environment corresponding to the third position (e.g., for a threshold amount of time (e.g., 0.1, 0.2, 0.5, 1, 2, 5, or 10 seconds). In some embodiments, the criterion for the one or more second criteria is satisfied when the attention of the first user is directed toward a position in the three-dimensional environment corresponding to the fourth position for the threshold amount of time. In some embodiments, the first computer system detects an input corresponding to a change in attention (e.g., a change in the location of gaze relative to the three-dimensional environment) of the first user from a position corresponding to the third position in the three-dimensional environment to a position corresponding to the fourth position in the three-dimensional environment. In some embodiments, in response to detecting the input corresponding to the change in attention, the first computer system displays the non-spatial representation of the first user using the virtual camera at a position corresponding to the fourth position (e.g., as described above). For example, displaying the non-spatial representation of the first user using the virtual camera at the position corresponding to the fourth position includes displaying the non-spatial representation of the first user with an animation (e.g., a visual effect, such as fading one or more portions of the non-spatial representation and/or changing the opacity, color, brightness, and/or color of one or more portions of the non-spatial representation) (e.g., while changing from displaying the non-spatial representation of the first user using the virtual camera at the position corresponding to the third position to displaying the non-spatial representation of the first user using the virtual camera at the position corresponding to the fourth position). In some embodiments, the first computer system detects an input corresponding to a change in attention of the first user from a position corresponding to the fourth position in the three-dimensional environment to a position corresponding to third position in the three-dimensional environment. In some embodiments, in response to detecting the input corresponding to the change in attention, the first computer system displays the non-spatial representation of the first user using the virtual camera at the position corresponding to the third position (e.g., as described above). Generating a virtual representation of a user using a virtual camera based on the attention of the user being direct toward a location of the virtual camera ensures that the representation of the user accurately represents the user while in a communication session with a second user (e.g., such that the attention of the virtual representation is displayed to be directed toward the second user), thereby reducing errors in interaction during the communication session and improving user device interaction.

In some embodiments while the first computer system displays the non-spatial representation of the second user, and the communication session controls interface, including the first selectable option, in the three-dimensional environment, without displaying the user interface including the non-spatial representation of the first user, the first computer system generates the non-spatial representation of the first user using a virtual camera at a respective position in the three-dimensional environment, such as analogous to second computer system 101b displaying the non-spatial representation of the first user 1120c and the communication session controls interface 1113. In some embodiments, the first computer system generates the non-spatial representation of the first user prior to detecting the first input described above with reference to the method 1200. In some embodiments, the first computer system displays the non-spatial representation of the first user after detecting an input requesting to cease displaying the user interface including the non-spatial representation of the first user. In some embodiments, the respective position of the virtual camera corresponds to a predetermined location in the three-dimensional environment. For example, the respective position of the virtual camera corresponds to the second position of the communication session controls interface in the three-dimensional environment. For example, the respective position of the virtual camera corresponds to the third position of the non-spatial representation of the second user in the three-dimensional environment. For example, the respective position of the virtual camera corresponds to a position in three-dimensional environment different from the second position and third position (e.g., the fourth position described above, a position in the three-dimensional environment associated with a respective object (e.g., shared in the communication session) different from the non-spatial representation of the second user and/or the communication session controls interface, and/or a position adjacent to the non-spatial representation of the second user and/or the communications session controls interface in the three-dimensional environment). In some embodiments, in response to detecting an indication (e.g., received from the first computer system) corresponding to the generation of the non-spatial representation of the first user using the virtual camera at the respective position in the three-dimensional environment, the second computer system includes the non-spatial representation of the first user using the virtual camera at the respective position in the three-dimensional environment in the communication session from the perspective of the second user (e.g., the second user views the non-spatial representation of the first user in a three-dimensional environment through a display generation component of the second computer system).

In some embodiments, in response to the first computer system detecting the first input, the first computer system ceases generating the non-spatial representation of the first user using the virtual camera at the respective position in the three-dimensional environment, such as the non-spatial representation of the first user 1120c in FIG. 11D utilizing the virtual camera 1150a in FIG. 11H.

In some embodiments, in response to the first computer system detecting the first input, the first computer system generates the non-spatial representation of the first user using the virtual camera at the second position in the three-dimensional environment of the user interface including the non-spatial representation of the first user, such as the virtual camera 1150a in FIG. 11H. In some embodiments, in response to detecting the first input, the first computer system displays the user interface including the non-spatial representation of the first user (as described above) using the virtual camera at the second position in the three-dimensional environment. For example, the non-spatial representation of the first user includes a virtual rendering of the first user (e.g., as described above). In some embodiments, after displaying the user interface including the non-spatial representation of the first user using the virtual camera at the second position in the three-dimensional environment, the first computer system detects an input corresponding to attention (e.g., gaze) of the first user directed toward the second position in the three-dimensional environment. In some embodiments, in response to detecting the input, the first computer system displays the virtual rendering of the first user with a representation of attention toward the virtual camera (e.g., the first computer system displays representations of the head and/or eyes of the virtual rendering of the first user to be looking forward to a location of the virtual camera (e.g., from a perspective of the second user viewing the non-spatial representation of the first user in the communication session, the virtual rendering of the first user in the communication session appears to be looking at the second user)). In some embodiments, the first computer system displays an animation while ceasing to generate the non-spatial representation of the first user using the virtual camera at the respective position in the three-dimensional environment and/or while generating the non-spatial representation of the first user using the virtual camera at the second position in the three-dimensional environment (e.g., the animation has one or more characteristics of the animation displayed while displaying the non-spatial representation of the first user using the virtual camera at the position corresponding to the fourth position described above). In some embodiments, the second computer system displays the animation from a perspective of the second user (e.g., in a three-dimensional environment viewed by the second user) while generating the non-spatial representation of the first user using the virtual camera at the second position. Displaying a preview of the first user while in a communication session with a second user using a virtual camera corresponding to the position of the preview enhances user interactions with the first computer system by providing real-time feedback to the first user that includes an accurate view of the current representation of the user in the communication session, thereby reducing errors in interaction during the communication session and improving user device interaction.

In some embodiments, while the three-dimensional environment is visible via the display generation component of the first computer system from the viewpoint of the first user, and while the first computer system is establishing (e.g., a time prior to the second computer system and/or the third computer system accepting a transmission generated by the first computer system and/or prior to the first computer system receiving a transmission generated by the second and/or third computer system) the real-time communication session with the second computer system, and in accordance with a determination the first computer system has not established the real-time communication session, the first computer system displays, via the display generation component, a user interface element including the non-spatial representation of the second user in the three-dimensional environment, such as the non-spatial representation of the second user 1121 in FIG. 11B. In some embodiments, while the first computer system is establishing the real-time communication session with the second computer system (e.g., and/or prior to the first computer system establishing the real-time communication session with the second computer system, the first computer system forgoes displaying one or more respective representations (e.g., spatial representations and/or non-spatial representations) of respective users of the real-time communication session (e.g., a respective representation of the second user of the second computer system). In some embodiments, the user interface element includes an interactive component for including a virtual rendering of the first user and/or an image representing the first user in the communication session (e.g., the interactive component has one or more characteristics of the interactive component described above). In some embodiments, prior to establishing the real-time communication session, the first computer system displays the three-dimensional environment including a plurality of virtual objects corresponding to a private three-dimensional environment including the user interface element. In some embodiments, the user interface element including the non-spatial representation of the second user includes a virtual rendering of the second user (e.g., having one or more characteristics of the simulated video of the rendering of the first user described above). For example, the first computer system displays the virtual rendering of the second user in the user interface element based on a position of a respective virtual camera of the plurality of virtual cameras described above. In some embodiments, the user interface element including the non-spatial representation of the second user includes an image representing the second user (e.g., having one or more characteristics of the image representing the first user described above and/or a virtual representation of a shape described with reference to method 800). For example, the first computer system displays the image representing the second user in the user interface element with one or more of the animations described above. In some embodiments, the first computer system establishes the real-time communication session with the second computer system and the third computer system. In some embodiments, when establishing the real-time communication session with the second computer system and the third computer system, the first computer system displays a user interface element including the non-spatial representation of the second user and a non-spatial representation of the third user in the three-dimensional environment. In some embodiments, a location of the non-spatial representation of the second user is associated with a location. Displaying the non-spatial representation of the second user in the three-dimensional environment prior to connecting with another computer system enables the user to see what their representation will look like to the other users in the communication session prior to establishing the communication session, thereby reducing user error.

It should be understood that the particular order in which the operations in method 1200 have been described is merely exemplary and is not intended to indicate that the described order is the only order in which the operations could be performed. One of ordinary skill in the art would recognize various ways to reorder the operations described herein.

FIGS. 13A-13P illustrate examples of a computer system displaying a representation of a second user within a three-dimensional environment during a communication session with a second computer system of the second user, in accordance with some embodiments.

FIG. 13A illustrates a computer system 101 displaying, via a display generation component 120, a three-dimensional environment 1300 (e.g., a three-dimensional user interface). It should be understood that, in some embodiments, computer system 101 utilizes one or more techniques described with reference to FIGS. 13A-13P in a two-dimensional environment without departing from the scope of the disclosure. As described above with reference to FIGS. 1-6, computer system 101 optionally includes a display generation component 120 (e.g., a head-mounted display) and a plurality of image sensors 114a-114c (e.g., image sensors 314 of FIG. 3). Image sensors 114a-114c optionally include one or more of a visible light camera, an infrared camera, a depth sensor, or any other sensor computer system 101 would be able to use to capture one or more images of a first user or a part of the first user (e.g., one or more hands of the first user, such as a hand of the first user) while the first user interacts with computer system 101. In some embodiments, computer system 101 displays the first user interface or three-dimensional environment 1300 to the first user (and/or the three-dimensional environment 1300 is visible via display generation component 120, such as via passive and/or active passthrough), and uses sensors to detect the physical environment and/or movements of the first user's hands (e.g., external sensors facing outwards from the first user) such as movements that are interpreted by computer system 101 as gestures such as air gestures, and/or gaze of the first user (e.g., internal sensors facing inwards towards the face of the first user).

As shown in FIG. 13A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 1300. For example, three-dimensional environment 1300 includes a representation of a window, which is optionally a representation of a physical window in the physical environment.

As discussed in more detail below, in FIG. 13A, display generation component 120 is illustrated as displaying content in the three-dimensional environment 1300. In some embodiments, the content is displayed by a single display (e.g., display 510 of FIG. 5) included in display generation component 120. In some embodiments, display generation component 120 includes two or more displays (e.g., left and right display panels for the left and right eyes of the first user, respectively, as described with reference to FIG. 5) having displayed outputs that are merged (e.g., by the first user's brain) to create the view of the content shown in FIGS. 13A-13P.

Display generation component 120 has a field of view (e.g., a field of view captured by external image sensors 114b and 114c and/or visible to the first user via display generation component 120) that corresponds to the content shown in FIG. 13A. Because display generation component 120 is optionally a head-mounted display, the field of view of display generation component 120 is optionally the same as or similar to the field of view of the first user.

As discussed herein, the first user performs one or more air pinch gestures (e.g., with hand 1302 in FIG. 13J) to provide one or more inputs to computer system 101. Such depiction is intended to be exemplary rather than limiting; the first user optionally provides user inputs using different air gestures and/or using other forms of input as described with reference to method 1400.

As shown in FIG. 13A, computer system 101 displays a three-dimensional environment 1300 that includes a user interface element 1310 including a representation of a second user 1312 of a second computer system 101a and a background 1314, and a grabber bar 1316. User interface element 1310 is a defined area or segment within three-dimensional environment 1300 (e.g., similar to a virtual window) where representation of the second user 1312 and background 1314 are displayed. Representation of the second user 1312 is a digital or virtual depiction of the second user of second computer system 101a that is generated and displayed via display generation component 120 within three-dimensional environment 1300, as described in greater detail with respect to step 1404 of method 1400. Background 1314 is a virtual setting or backdrop that is displayed behind representation of the second user 1312 within three-dimensional environment 1300, as described in greater detail with respect to step 1404 of method 1400. In some embodiments, background 1314 is based on a system environment associated with second computer system 101a. For example, as illustrated in FIG. 13A, the system environment of second computer system 101a is a virtual environment, as described in greater detail with respect to method 1400. Grabber bar 1316 is an affordance that allows the first user to adjust or manipulate the position of user interface element 1310 within three-dimensional environment 1300. In addition, for ease of discussion, FIG. 13A illustrates a top-down view 1320, a side view 1322, a virtual environment view 1324, and communication session participants 1326. Top-down view 1320 and side view 1322 are two-dimensional perspectives of the physical environment around computer system 101. Virtual environment view 1324 is a supplemental window (not shown to the first user) that displays a broader or complete background of the system environment of second computer system 101a of the second user, highlighting a section 1325a being shown to the first user as background 1314 of user interface element 1310 within three-dimensional environment 1300 as the first user moves within their physical environment, with section 1325a dynamically shifting within the larger background to correspond with the first user's movements.

In some embodiments, computer system 101 detects movement of the viewpoint of the first user (e.g., in accordance with movement of the first user within their physical environment), as illustrated in top-down view 1320 of FIG. 13B, indicating to computer system 101 that the first user is gazing at user interface element 1310 from a different direction and/or distance, as described in further detail with respect to method 1400. In some embodiments, in response to detecting the movement of the viewpoint of the first user, computer system 101 displays a section 1325b of virtual environment view 1324 as background 1314 of user interface element 1310 corresponding to a leftwards portion of virtual environment view 1324 with respect to section 1325a, given that the new viewpoint of the user suggests that the first user is gazing at user interface element 1310 from the right within three-dimensional environment 1300 (and/or that the first user has moved towards the right within three-dimensional environment 1300, as shown in top-down view 1320). In some embodiments, in response to detecting the movement of the viewpoint of the user is towards the right within three-dimensional environment 1300, computer system 101 modifies representation of the second user 1312 so that representation of the second user 1312 appears to be viewed from the right (e.g., by showing a portion of a left side of representation of the second user 1312). In some embodiments, user interface element 1310 appears to be tilted towards the left in three-dimensional environment 1300, given that user interface element 1310 remains fixed in place within three-dimensional environment 1300 and the first user is gazing at user interface element 1310 from a side of user interface element 1310.

In some embodiments, computer system 101 detects movement of the viewpoint of the first user towards user interface element 1310 within three-dimensional environment 1300, as illustrated in the top-down view of FIG. 13C, indicating to computer system 101 that the first user is gazing at user interface element 1310 from a closer distance than the distance of FIG. 13A. In some embodiments, in response to detecting the movement of the viewpoint of the first user towards user interface element 1310, computer system 101 displays a section 1325c of virtual environment view 1324 as background 1314 of user interface element 1310 corresponding to a broader portion of virtual environment view 1324 with respect to section 1325a. In some embodiments, in response to detecting the movement of the viewpoint of the user towards user interface element 1310 within three-dimensional environment 1300, computer system 101 modifies representation of the second user 1312 to appear larger to give the impression to the first user of coming nearer to the second user. In some embodiments, user interface element 1310 appears to be larger, given that user interface element 1310 remains fixed in place within three-dimensional environment 1300 and the first user is gazing at user interface element 1310 from a closer distance than in FIG. 13A.

In some embodiments, computer system 101 detects movement of the viewpoint of the first user away from and to the right of user interface element 1310 within three-dimensional environment 1300, as illustrated in top-down view 1320 of FIG. 13D, indicating to computer system 101 that the first user is gazing at user interface element 1310 from a further distance than the distance of FIG. 13A and to the right of the viewpoint of FIG. 13A. In some embodiments, in response to detecting the movement of the viewpoint of the first user away from and to the right of user interface element 1310, computer system 101 displays a section 1325d of virtual environment view 1324 as background 1314 of user interface element 1310 corresponding to a narrower and to the left portion of virtual environment view 1324, with respect to section 1325a. In some embodiments, in response to detecting the movement of the viewpoint of the user away from and to the right of user interface element 1310 within three-dimensional environment 1300, computer system 101 modifies representation of the second user 1312 to appear smaller and to be viewed from the right (e.g., by showing a portion of a left side of representation of the second user 1312) to give the impression to the first user of getting farther and to the right of the second user. In some embodiments, user interface element 1310 appears to be smaller and tilted to the left, given that user interface element 1310 remains fixed in place within three-dimensional environment 1300 and the first user is gazing at user interface element 1310 from a farther distance than in FIG. 13A and from a side of user interface element 1310.

In some embodiments, computer system 101 detects movement of the viewpoint of the first user upwards with respect to user interface element 1310 within three-dimensional environment 1300, as illustrated in side view 1322 of FIG. 13E, indicating to computer system 101 that the first user is gazing at user interface element 1310 from a higher perspective than in FIG. 13A. In some embodiments, in response to detecting the movement of the viewpoint of the first user upwards with respect to user interface element 1310, computer system 101 displays a section 1325e of virtual environment view 1324 as background 1314 of user interface element 1310 corresponding to a lower portion of virtual environment view 1324 with respect to section 1325a. In some embodiments, in response to detecting the movement of the viewpoint of the user upwards with respect to user interface element 1310 within three-dimensional environment 1300, computer system 101 modifies representation of the second user 1312 to appear to be viewed from above (e.g., by showing a portion of a top side of representation of the second user 1312). In some embodiments, user interface element 1310 appears to be tilted downwards in three-dimensional environment 1300, given that user interface element 1310 remains fixed in place within three-dimensional environment 1300 and the first user is gazing at user interface element 1310 from a higher perspective than in FIG. 13A.

In some embodiments, computer system 101 detects movement of the viewpoint of the first user away from, to the right of, and upwards with respect to user interface element 1310 within three-dimensional environment 1300, as illustrated in the top-down view 1320 and side view 1322 of FIG. 13F, indicating to computer system 101 that the first user is gazing at user interface element 1310 from a further distance than the distance of FIG. 13A, to the right of the viewpoint of FIG. 13A, and from a higher perspective than in FIG. 13A. In some embodiments, in response to detecting the movement of the viewpoint of the first user away from, to the right of, and upwards with respect to user interface element 1310, computer system 101 displays a section 1325f of virtual environment view 1324 as background 1314 of user interface element 1310 corresponding to a narrower, to the left, and lower portion of virtual environment view 1324, with respect to section 1325a. In some embodiments, in response to detecting the movement of the viewpoint of the user away from, to the right of, and upwards with respect to user interface element 1310 within three-dimensional environment 1300, computer system 101 modifies representation of the second user 1312 to appear smaller and to be viewed from the right (e.g., by showing a portion of a left side of representation of the second user 1312) and from a higher perspective to give the impression to the first user of getting farther, to the right of, and higher than the second user. In some embodiments, user interface element 1310 appears to be smaller and tilted to the left and downwards, given that user interface element 1310 remains fixed in place within three-dimensional environment 1300 and the first user is gazing at user interface element 1310 from a farther distance than in FIG. 13A and from a corner of user interface element 1310.

FIG. 13G illustrates a second computer system 101a displaying, via a display generation component 120a, a three-dimensional environment 1300a (e.g., a three-dimensional user interface). In some embodiments, second computer system 101a has one or more characteristics of computer system 101, including display generation component 120a (e.g., a head-mounted display) and a plurality of image sensors 114aa through 114ac (e.g., image sensors 314 of FIG. 3). In some embodiments, display generation component 120a has one or more characteristics of display generation component 120. In some embodiments, image sensors 114aa through 114ac have one or more characteristics of image sensors 114a through 114c.

In some embodiments, computer system 101 displays three-dimensional environment 1300, including user interface element 1310, representation of the second user 1312 of second computer system 101a, background 1314, and grabber bar 1316, and second computer system 101a displays a three-dimensional environment 1300a, including a user interface element 1310a, a representation of the first user 1312a of computer system 101, a background 1314a, and a grabber bar 1316a.

In some embodiments, the computer system 101 displays background 1314 of user interface element 1310 based on a system environment associated with environment 1300a of second computer system 101a, as described in greater detail with respect to method 1400. In some embodiments, the second computer system 101a displays background 1314a of user interface element 1310a based on a system environment associated with environment 1300, as described in greater detail with respect to method 1400. For example, because environment 1300 is a representation of the physical environment of computer system 101 (not a virtual environment or atmosphere), background 1314a is a default background, as described in greater detail with respect to method 1400. In some embodiments, virtual environment view 1324 of FIGS. 13A-13F corresponds to environment 1300a, a view opposite of environment 1300a (e.g., the view behind the viewpoint of the second user), or a default view of the system environment corresponding to environment 1300a. In some embodiments, second computer system 101a detects hand 1302a of the second user perform a gesture (e.g., an air pinch) while an attention 1304a (e.g., including gaze or a gaze proxy) of the second user is directed to grabber bar 1316a, as illustrated in FIG. 13G, indicating to second computer system 101a that the second user wishes to interact with grabber bar 1316a.

In some embodiments, upon detecting hand 1302a of the second user perform the gesture while attention 1304a was directed to grabber bar 1316a, second computer system 101a detects hand 1302a perform an air drag gesture, as illustrated in FIG. 13H, by maintaining the gesture (e.g., the air pinch) and moving in a downwards direction, relative to three-dimensional environment 1300a. In some embodiments, in response to detecting the air drag gesture, second computer system 101a moves user interface element 1310a downwards in accordance with the air drag gesture. In some embodiments, in response to receiving an indication from second computer system 101a that the second user moved user interface element 1310a downwards with respect to three-dimensional environment 1300a, as illustrated in FIG. 13H, computer system 101 displays a section of virtual environment view 1324, as illustrated in FIGS. 13A, as background 1314 of user interface element 1310 corresponding to a higher portion of virtual environment view 1324 with respect to section 1325a. In some embodiments, in response to receiving the indication from second computer system 101a that the second user moved user interface element 1310a downwards with respect to three-dimensional environment 1300a, as illustrated in FIG. 13H, computer system 101 modifies representation of the second user 1312 to appear to be viewed from below (e.g., by showing a portion of a bottom side of representation of the second user 1312). In some embodiments, second computer system 101a adjusts an orientation of user interface element 1310a automatically so that it remains perpendicular to the viewpoint of the second user.

In some embodiments, upon detecting hand 1302a of the second user perform the downwards air drag gesture, second computer system 101a detects hand 1302a perform an upwards air drag gesture, as illustrated in FIG. 13I, by maintaining the gesture (e.g., the air pinch) and moving in an upwards direction, relative to three-dimensional environment 1300a. In some embodiments, in response to detecting the air drag gesture, second computer system 101a moves user interface element 1310a upwards in accordance with the air drag gesture. In some embodiments, in response to receiving an indication from second computer system 101a that the second user moved user interface element 1310a upwards with respect to three-dimensional environment 1300a, as illustrated in FIG. 13I, computer system 101 displays a section of virtual environment view 1324, as illustrated in FIG. 13A, as background 1314 of user interface element 1310 corresponding to a lower portion of virtual environment view 1324 with respect to section 1325a (e.g., section 1325e of FIG. 13E). In some embodiments, in response to receiving the indication from second computer system 101a that the second user moved user interface element 1310a upwards with respect to three-dimensional environment 1300a, as illustrated in FIG. 13I, computer system 101 modifies representation of the second user 1312 to appear to be viewed from above (e.g., by showing a portion of a top side of representation of the second user 1312). In some embodiments, second computer system 101a adjusts an orientation of user interface element 1310a automatically so that it remains perpendicular to the viewpoint of the second user.

In some embodiments, computer system 101 detects hand 1302 of the first user perform a gesture (e.g., an air pinch) while a attention 1304 of the first user is directed to grabber bar 1316, as illustrated in FIG. 13J, indicating to computer system 101 that the first user wishes to interact with grabber bar 1316. In some embodiments, upon detecting hand 1302 of the second user perform the gesture while attention 1304 was directed to grabber bar 1316, computer system 101 detects hand 1302 perform an air drag gesture, as illustrated in FIG. 13K, by maintaining the gesture (e.g., the air pinch) and moving in a rightwards direction, relative to three-dimensional environment 1300a. In some embodiments, in response to detecting the air drag gesture, computer system 101 moves user interface element 1310 rightwards in accordance with the air drag gesture, indicating that the second user is gazing at the first user from a rightwards perspective in three-dimensional environment 1300. In some embodiments, in response to receiving an indication from computer system 101 that the first user moved user interface element 1310 rightwards with respect to three-dimensional environment 1300, second computer system 101a maintains the same background 1314a of user interface element 1310a, given that background 1314a is a default background, despite the movement of user interface element 1310 in three-dimensional environment 1300. In some embodiments, in response to receiving the indication from computer system 101 that the first user moved user interface element 1310 rightwards with respect to three-dimensional environment 1300, second computer system 101a modifies representation of the first user 1312a to appear to be viewed from the right (e.g., by showing a portion of a right side of representation of the first user 1312a). In some embodiments, computer system 101 adjusts an orientation of user interface element 1310 automatically so that it remains perpendicular to the viewpoint of the second user.

In some embodiments, second computer system 101a updates its system environment to be a different virtual environment to the virtual environment illustrated in FIGS. 13A-13K (e.g., in response to detecting an input from the second user), as illustrated in FIG. 13L, and updates three-dimensional environment 1300a based on the updated system environment. In some embodiments, upon second computer system 101a updating its system environment, computer system 101 receives an indication from second computer system 101a regarding the updated system environment. In response to receiving the indication from second computer system 101a, the computer system 101 updates background 1314 of user interface element 1310 based on the updated system environment.

In some embodiments, second computer system 101a updates its system environment to be an atmosphere environment, as illustrated in FIG. 13M, and updates three-dimensional environment 1300a based on the updated system environment, as described in greater detail with respect to method 1400. In some embodiments, the atmosphere environment involves second computer system 101a displaying, via display generation component 120a, the physical environment around second computer system 101a overlaid by the atmosphere environment. In some embodiments, upon second computer system 101a updating its system environment, computer system 101 receives an indication from second computer system 101a regarding the updated system environment. In response to receiving the indication from second computer system 101a, the computer system 101 updates background 1314 of user interface element 1310 based on the updated system environment to show the atmosphere environment, but not the physical environment around second computer system 101a.

In FIG. 13N, the communication session includes spatial representations of the users instead of non-spatial representations included in FIGS. 13A-13M, as described further with reference to methods 1000 and 1400. For example, computer system 101 displays a spatial representation of the second user 1312 and second computer system 101a displays a spatial representation of the first user 1312a. The spatial representation of the second user 1312 does not include a background 1314 and spatial representation of the first user 1312a does not include a background 1314a, as described in greater detail with respect to method 1400.

In some embodiments, computer system 101 is in communication with a computer system 101b that does not include a three-dimensional environment (e.g., a laptop), as illustrated in FIG. 13O. In some embodiments, when computer system 101 is in communication with computer system 101b, representation of the second user 1312 is a static image or avatar of the second user or video footage captured by the computer system 101b and background 1314 is a default background, as described in greater detail with respect to method 1400. In some embodiments, computer system 101 detects movement of the viewpoint of the first user towards the right within three-dimensional environment 1300, as illustrated in FIG. 13P, indicating to computer system 101 that the first user is gazing at user interface element 1310 from the right of the viewpoint of FIG. 13O. In some embodiments, in response to detecting the movement of the viewpoint of the user away from and to the right of user interface element 1310 within three-dimensional environment 1300, computer system 101 maintains the same background 1314 of user interface element 1310, given that background 1314 is a default background, despite the movement of the first user within three-dimensional environment 1300. In some embodiments, in response to detecting the movement of the viewpoint of the user to the right of user interface element 1310 within three-dimensional environment 1300, computer system 101 does not modify representation of the second user 1312 to be viewed from the right because computer system 101b does not include a three-dimensional environment. In some embodiments, user interface element 1310 appears to be tilted to the left, given that user interface element 1310 remains fixed in place within three-dimensional environment 1300 and the first user is gazing at user interface element 1310 from a side of user interface element 1310.

FIG. 14 is a flowchart illustrating an example method 1400 of a computer system displaying a representation of a second user of a second computer system within a three-dimensional environment during a communication session with the second computer system. In some embodiments, the method 1400 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1400 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1400 are, optionally, combined and/or the order of some operations is, optionally, changed.

In some embodiments, a method 1400 is performed at a first computer system in communication with one or more display generation components and one or more input devices, such as computer system 101 in communication with display generation component 120 as shown in FIG. 13A. In some embodiments, the first computer system, one or more display generation components, and/or one or more input devices have one or more characteristics of the computer system, one or more display generation components, and/or one or more input devices described above with reference to method(s) 800, 1000, and/or 1200.

In some embodiments, while a first three-dimensional environment is visible via the one or more display generation components from a viewpoint of a first user of the first computer system, such as three-dimensional environment 1300, and while the first computer system is in a communication session with a second computer system, different from the first computer system, of a second user, different from the first user (1402), the first computer system displays (1404), via the one or more display generation components, a representation of the second user with a respective background, such as computer system 101, in a communication session with second computer system 101a, displaying representation of the second user 1312 with background 1314 within user interface element 1310, as shown in FIG. 13A. In some embodiments, the first three-dimensional environment has one or more characteristics of the three-dimensional environments described above with reference to method(s) 800, 1000, and/or 1200. In some embodiments, the first three-dimensional environment refers to a three-dimensional environment that is visible to the first user of the first computer system but is not visible to the second user of the second computer system (e.g., is not displayed or otherwise visible via the one or more display generation components of the second computer system). In some embodiments, the second computer system has one or more characteristics of the first computer system. In some embodiments, the first computer system and the second computer system are the same type of computer system and/or have a similar architecture. For example, the first computer system and the second computer system may both be wearable devices, such as a head-mounted display and/or device. In some embodiments, the first computer system is a different type of computer system from and/or of a different architecture than the second computer system. For example, the first computer system may be a wearable device, such as a head-mounted display/device, and the second computer system may be a non-wearable device, such as a laptop. In some embodiments, the communication session has one or more characteristics of the communication sessions described with reference to method(s) 800, 1000, and/or 1200. In some embodiments, the first computer system being in a communication session with the second computer system refers to the establishment and maintenance of a data exchange pathway between two distinct computer systems. In some embodiments, the communication session facilitates the transfer of various types of data, such as audio, video, user commands, and environmental data. In some embodiments, the communication session enables a first user and a second user to interact with and perceive each other's actions within respective three-dimensional environments. In some embodiments, the first computer system utilizes data from the communication session to dynamically update the visual and auditory environment as the first user and/or the second user move within their respective physical spaces, as described in greater detail herein.

In some embodiments, the representation of the second user has one or more characteristics of the representations of one or more users described above with reference to method(s) 800, 1000, and/or 1200. In some embodiments, the representation of the second user refers to a digital or virtual depiction of the second user that is generated and displayed within the first three-dimensional environment. In some embodiments, the representation of the second user includes an avatar, a model, or any form of visual surrogate that stands in for the actual physical presence of the second user. For example, the representation of the second user may be an avatar that mimics the appearance and/or movements of the second user and is displayed within a 2D tile and/or window within the first three-dimensional environment. In some embodiments, the respective background refers to a virtual setting or backdrop that is displayed behind the representation of the second user in the first three-dimensional environment (e.g., further from the viewpoint of the first user than the representation of the second user). For example, the respective background may be a virtual scene (e.g., a portion of an immersive environment) that is displayed behind an avatar representation of the second user in a 2D tile within the first three-dimensional environment. In some embodiments, the respective background is contextually relevant to the current situation of the second user and/or a system environment of the second computer system, as described in greater detail herein. In some embodiments, the respective background is configured by the first computer system to reflect movements by the first user within the first three-dimensional environment, as described in greater detail herein. For example, as the first user moves from one location to another, the respective background displayed adjusts accordingly, such as with a parallax effect and/or to simulate looking through a portal into the environment of the second user, as described in greater detail herein. In some embodiments, the adjustment of the respective background includes one or more of changes in perspective, depth, and/or orientation, as described in greater detail herein.

In some embodiments, in accordance with a determination that a system environment of the second computer system is a first system environment, the respective background is a first background corresponding to the first system environment (1406), such as background as 1314 shown in FIG. 13A. In some embodiments, the system environment refers to a virtual or simulated scene configured within a computer system for a three-dimensional environment. For example, the system environment may include a range of virtual landscapes, interior settings, or abstract spaces that may be generated by a computer system to provide a contextual backdrop for a three-dimensional environment. In some embodiments, the determination of the system environment of the second computer system involves identifying which of a predefined list of available system environments is currently active for the second user. In some embodiments, the predefined list of available system environments includes at least a first system environment and a second system environment. In some embodiments, the system environment of the second computer system corresponds to a second three-dimensional environment where the second computer system is displaying a representation of the first user of the first computer system during the communication session. In some embodiments, the first computer system has a system environment that corresponds to the first three-dimensional environment where the first computer system is displaying the representation of the second user, via the one or more display generation components. In some embodiments, the determination of the system environment of the second computer system involves automated software processes that analyze various inputs and settings on the second computer system (e.g., user preferences, environmental settings, system configurations, or sensor data collected from the second user's physical surroundings). In some embodiments, the first background refers to a specific portion of the first system environment that is displayed to the first user (e.g., through the window and/or tile in which the representation of the second user is displayed) as the respective background behind the representation of the second user. In some embodiments, the first background is a selected segment of the entire first system environment of the second user, tailored to fit within the viewing constraints and context of the viewpoint of the first user, as described in greater detail herein. In some embodiments, the portion of the first system environment represented as the first background is determined based on factors such as an orientation and/or a position of the first user within the first three-dimensional environment. In some embodiments, the portion of the first system environment represented as the first background is determined based on an orientation and/or a position of a representation of the first user in a second three-dimensional environment displayed and/or otherwise visible to the second user of the second computer system, as described in greater detail herein. In some embodiments, the first system environment is not displayed by the second computer system to the second user during the communication session. In some embodiments, the first system environment is selectable and can be displayed to the second user via one or more display generation components of the second computer system upon receiving an input from the second user requesting the display of the first system environment at the second computer system. In some embodiments, a background corresponding to a specific portion of a system environment of the first computer system is displayed to the second user (e.g., through a window and/or tile in which the representation of the first user is displayed) as a respective background behind the representation of the first user. In some embodiments, the background corresponding to the specific portion of the system environment of the first computer system has one or more characteristics of the first background corresponding to the first system environment, as described above.

In some embodiments, in accordance with a determination that the system environment of the second computer system is a second system environment, different from the first system environment, the respective background is a second background corresponding to the second system environment, different from the first background (1408) such as background 1314 as shown in FIG. 13L. In some embodiments, the second background corresponding to the second system environment has one or more characteristics of the first background corresponding to the first system environment, as described above. Automating the adjustment of the displayed background in response to detected changes in the environment of the second computer system significantly enhances the computational efficiency of the first computer system by minimizing computational load and bandwidth usage, as updates to the display are only made when actual environmental changes occur, thereby conserving resources and reducing unnecessary data processing. Additionally, the disclosed method ensures reduced latency and improved system responsiveness, enabling the computer system to manage its workload more effectively and maintain a seamless user experience.

In some embodiments, while the first computer system is in the communication session with the second computer system, while the viewpoint of the user is a first viewpoint, the first computer system displays the representation of the second user with a first portion of the respective background, such as computer system 101 displaying section 1325a of virtual environment view 1324 as background 1314, as shown in FIG. 13A. In some embodiments, the first viewpoint refers to a specific perspective from which the first user observes the three-dimensional environment via the one or more display generation components. In some embodiments, the first viewpoint is the viewpoint of the first user before one or more specific inputs or movements by the user are detected. In some embodiments, the first portion refers to a specific segment or area of the respective background that is displayed to the first user in conjunction with the representation of the second user. In some embodiments, the first portion is a visible backdrop behind the representation of the second user when the first computer system presents the three-dimensional environment while the first user has the first viewpoint. In some embodiments, the first portion is equivalent to the entire respective background. In some embodiments, the first portion is a smaller subset of the respective background, based on the first viewpoint.

In some embodiments, while the first computer system is in the communication session with the second computer system, while the viewpoint of the user is a first viewpoint, the first computer system detects movement of the viewpoint of the first user, such as movement of the viewpoint of the user as shown from FIG. 13A to any of FIGS. 13B-13F. In some embodiments, movement of the first user refers to physical or virtual motion performed by the first user within the three-dimensional environment. Some examples of movements include, but are not limited to, positional shifts, orientation changes, or interactions that imply motion such as walking, leaning, or gesturing. In some embodiments, movement involves virtual navigation commands entered via a controller, keyboard, or other input device, allowing the user to move within the three-dimensional environment without physical displacement. In some embodiments, detecting movement of the first user involves the user of one or more technologies described herein to sense and interpret the movements of the user as described above.

In some embodiments, in response to detecting the movement of the viewpoint of the first user the first computer system displays the representation of the second user with a respective portion of the respective background different from the first portion of the respective background in accordance with the movement of the first user, such as computer system 101 displaying representation of the second user 1312 with section 1325b of virtual environment view 1324 as shown in FIG. 13B. In some embodiments, the respective portion of the respective background different from the first portion of the respective background refers to a segment of the respective background that is different from the first portion previously displayed when the viewpoint of the user is the first viewpoint. In some embodiments, the first computer system displays the respective portion of the respective background in response detecting the movement of the first user, providing a new perspective or area of the respective background that aligns with a new viewpoint or position of the user. In some embodiments, the respective portion is determined by a direction and extent of the first user's movement, as described in further detail below. In some embodiments, the transition between the first portion and the respective portion is seamless, and the first computer system calculates the overlap and ensures a smooth visual flow. In some embodiments, the transition between the first portion and the respective portion includes an animated transition that the first computer system updates in real-time while the first user is moving, in accordance with the movement of the first user. In some embodiments, despite changes in the viewed portion, the respective background maintains environmental consistency, ensuring that one or more elements (e.g., lighting, shadows, and/or other visual effects) are coherent across the transition from the first portion to the respective portion. In some embodiments, the first portion and the respective portion are distinct sections of the same background image. In some embodiments, first portion and the respective portion overlap, meaning that part of the first portion is equal to part of the respective portion. In some embodiments, the first portion and the respective portion do not overlap, meaning that no part of the first portion is equal to any part of the respective portion. In some embodiments, the first portion and the respective portion are contiguous, meaning that they are adjacent and/or connect directly at their edges within the same background image. In some embodiments, in response to detecting the movement of the viewpoint of the first user, the first computer system displays a respective portion of the representation of the second user, different from a portion of the representation of the second user displayed prior to the second indication, in accordance with the movement of the first user. In some embodiments, displaying the respective portion of the representation of the second user has one or more characteristics of displaying the respective portion of the respective background. For example, when the first user moves towards their right within the first three-dimensional environment, the respective portion of the representation of the second user represents a leftwards portion of the representation of the second user, simulating the first user looking from a position on the right of the representation of the second user within the three-dimensional environment Dynamically adjusting the background displayed behind the representation of the second user based on first user movement optimizes the use of graphical processing resources, ensuring efficient rendering only when necessary, which conserves energy and extends system performance.

In some embodiments, displaying the representation of the second user with the respective portion of the respective background includes, in accordance with a determination that the movement of the viewpoint of the first user is in a first direction, the respective portion is a second portion, such as section 1325b of virtual environment view 1324, as shown in FIG. 13B. In some embodiments, displaying the representation of the second user with the respective portion of the respective background includes in accordance with a determination that the movement of the viewpoint of the first user is in a second direction, different from the first direction, the respective portion is a third portion, different from the second portion, such as section 1325c of virtual environment view 1324, as shown in FIG. 13C. In some embodiments, the direction refers to the orientation or path along which the viewpoint of the first user moves within the three-dimensional environment. In some embodiments, the direction is related to physical movement in space or virtual navigation commands that simulate such movements. In some embodiments, the direction is interpreted as the cardinal direction (e.g., north, south, east, west) or as left, right, up, down, forward, and backward relative to the user's orientation in the physical space or with respect to a virtual frame of reference for virtual navigation. In some embodiments, the direction is considered relative to the user's initial position or viewpoint within the three-dimensional environment, regardless of their current orientation. In some embodiments, the direction includes virtual movements such as zooming in or out. In some embodiments, the second portion and the third portion refer to specific segments of the respective background that are displayed following the movement of the first user in different directions. In some embodiments, the first computer system displays the second portion in response to detecting the first user move in the first direction by a first amount and the first computer system displays the third portion in response to detecting the first user move in the second direction by a second amount. In some embodiments, the first amount and the second amount are equal. In some embodiments, the first amount and the second amount are not equal. In some embodiments, the first direction and the second direction are equal, and the second portion and the third portion are different due to the first amount and the second amount not being equal. In some embodiments, the first portion of the respective background corresponds to a middle portion of the respective background, and the second portion and the third portion correspond to side portions of the respective background. In some embodiments, the first portion of the respective background corresponds to any portion of the respective background, and the second portion and the third portion correspond to portions of the respective background at different sides of the first portion of the respective background. In some embodiments, the second portion and the third portion extend beyond the initial visible bounds of the first portion, revealing additional areas of the first or second system environments that were not previously visible to the first user. For example, when the first user moves to the right within the three-dimensional environment, the respective portion of the respective background may include new areas of the first or second system environments to the left of the first portion of the respective background, simulating a realistic change in perspective akin to moving one's viewpoint to see beyond the edges of a window. In some embodiments, when the direction of movement of the first user is to the left of the first user's location corresponding to the first viewpoint in the three-dimensional environment, the respective portion corresponds to a portion of the respective background to the right of the first portion. In some embodiments, when the direction of movement of the first user is to the right of the first user's location corresponding to the first viewpoint in the three-dimensional environment, the respective portion corresponds to a portion of the respective background to the left of the first portion. In some embodiments, when the direction of movement of the first user is towards the representation of the second user from the first user's location corresponding to the first viewpoint in the three-dimensional environment, the respective portion corresponds to a broader view that encompasses a wider area of the background surrounding the second user, revealing more of the environment of the second computer system than shown by the first portion of the respective background. In some embodiments, when the direction of movement of the first user is away from the representation of the second user from the first user's location corresponding to the first viewpoint in the three-dimensional environment, the respective portion corresponds to a more limited view, narrowing the visible area of the background surrounding the second user (e.g., a portion smaller than the first portion of the respective background). In some embodiments, when the direction of movement of the first user is upward from the first user's location corresponding to the first viewpoint within the three-dimensional environment, the respective portion corresponds to a portion of the respective background lower than the first portion. In some embodiments, when the direction of movement of the first user is downward from the first user's location corresponding to the first viewpoint within the three-dimensional environment, the respective portion corresponds to a portion of the respective background higher than the first portion. Adjusting the displayed background to show different portions based on the specific direction of the movement of the first user enhances the spatial awareness of the first computer system, allowing for a more nuanced and context-sensitive rendering that improves user immersion and interaction accuracy, thus leading to fewer erroneous user inputs and the conservation of power and computational resources.

In some embodiments, while the first computer system is in the communication session with the second computer system the first computer system receives a first indication (optionally from the second computer system), via the one or more input devices, corresponding to a representation of the first user being displayed within a second three-dimensional environment at a first position, such as an indication corresponding to the position of user interface element 1310a and/or representation of the second user 1312a, as shown in FIG. 13G. In some embodiments, the indication refers to a signal, message, or notification received from the second computer system via the one or more input devices. In some embodiments, the indication communicates a specific change or update, such as a modification in the system environment of the second computer system, to the first computer system. In some embodiments, the representation of the first user has one or more characteristics of the representations of one or more users described above with reference to method(s) 800, 1000, and/or 1200. In some embodiments, the representation of the first user refers to a digital or virtual depiction of the first user that is generated and displayed within the second three-dimensional environment corresponding to the first three-dimensional environment. For example, the representation of the first user is a non-spatial representation of the first user according to method 1000 described above. In some embodiments, the first position refers to a location or point within the second three-dimensional environment where the representation of the first user is placed or appears before a second user interaction. In some embodiments, receiving the first indication from the second computer system involves the first computer system obtaining a signal or data (e.g., via the one or more input devices) informing the first computer system that the second computer system is displaying the representation of the first user within the second three-dimensional environment at the first position. In some embodiments, the first indication includes data such as the coordinates, orientation, or any other data that indicates the position of the representation of the first user within the second three-dimensional environment.

In some embodiments, while the first computer system is in the communication session with the second computer system, in response to receiving the first indication, the first computer system displays the representation of the second user with a first portion of the respective background, such as computer system 101 displaying section 1325a of virtual environment view 1324 of FIG. 13A as background 1314, as shown in FIG. 13G. In some embodiments, the first portion of the respective background has one or more characteristics of one or more portions of the respective background described herein. In some embodiments, displaying the representation of the second user with the first portion of the respective background in response to receiving the first indication involves the first computer system updating its visual output to align the displayed representation of the second user with a specific part of the virtual background corresponding to the system environment of the second computer system in accordance with the data of the first indication. In some embodiments, the movement of the representation of the first user within the second three-dimensional environment refers to a change in the position and/or orientation of the representation of the first user within the three-dimensional environment of the second computer system. In some embodiments, the second user manipulates the position and/or orientation of the representation of the first user through one or more input devices in communication with the second computer system.

In some embodiments, the first computer system receives a second indication (optionally from the second computer system), via the one or more input devices, corresponding to movement of the representation of the first user within the second three-dimensional environment, such as movement of representation 1314a as shown from FIG. 13G to FIG. 13H. In some embodiments, the second indication includes data such as the coordinates and/or the orientation of the representation of the first user and/or changes in the coordinates and/or the orientation of the representation of the first user within the second three-dimensional environment.

In some embodiments, in response to receiving the second indication, the computer system displays the representation of the second user with a respective portion of the respective background different from the first portion of the respective background in accordance with the movement of the representation of the first user within the second three-dimensional environment, such as computer system 101 displaying representation of the second user 1312 with a higher portion of virtual environment view 1324 with respect to section 1325a of FIG. 13A as background 1314, as shown in FIG. 13H. In some embodiments, the respective portion of the respective background refers to an updated segment or area of the background displayed behind the representation of the second user, which changes in response to the movement of the representation of the first user within the second three-dimensional environment. In some embodiments, the respective portion is distinct from the first portion and is adjusted to reflect the new position and/or orientation of the representation of the first user as manipulated or moved by the second user. For example, when the second user moves the representation of the first user within the second environment, it is akin to repositioning a virtual camera within the second environment. In this example, as the virtual camera's point of view shifts in response to the movement of the representation of the first user, the first user sees the representation of the second user from this new angle, and consequently, the respective background displayed to the first user changes to reflect the new perspective, showing a portion of the background that corresponds to the direction from which the virtual camera is now viewing the second user. In some embodiments, the respective portion dynamically updates to align with the directional changes of the representation of the first user within the second three-dimensional environment. For example, when the representation of the first user is moved by the second user in an upwards motion within the second three-dimensional environment, the respective portion of the respective background represents a lower portion of the respective background, simulating the representation of the first user looking down from a higher position within the three-dimensional environment. In some embodiments, in response to receiving the second indication, the first computer system displays a respective portion of the representation of the second user, different from a portion of the representation of the second user displayed prior to the second indication, in accordance with the movement of the representation of the first user within the second three-dimensional environment. In some embodiments, displaying the respective portion of the representation of the second user has one or more characteristics of displaying the respective portion of the respective background. For example, when the representation of the first user is moved by the second user in an upwards motion within the second three-dimensional environment, the respective portion of the representation of the second user represents a higher portion of the representation of the second user, simulating the representation of the first user looking down on the representation of the second user from a higher position within the three-dimensional environment. In some embodiments, displaying the representation of the second user with the respective portion of the respective background in accordance with the movement of the representation of the first user has one or more characteristics of displaying the representation of the second user with the respective portion of the respective background different from the first portion of the respective background in accordance with the movement of the first user. In some embodiments, the first computer system updates the displayed portion of the respective background in response to a combination of movement of the first user in the first environment and movement of the representation of the first user within the second three-dimensional environment. Automatically updating the respective portion of the respective background in response to movements of the representation of the first user within the second three-dimensional environment optimizes the visual rendering process of the first computer system, enhancing its ability to provide timely and contextually appropriate visual feedback, which conservatively utilizes computational resources and improves user experience by maintaining visual coherence.

In some embodiments, displaying the representation of the second user with the respective portion of the respective background includes, in accordance with a determination that the movement of the representation of the first user within the second three-dimensional environment is in a first direction, the respective portion is a second portion, such as movement of representation 1314a from FIG. 13G to FIG. 13H corresponding to computer system 101 displaying representation of the second user 1312 with a higher portion of virtual environment view 1324 with respect to section 1325a of FIG. 13A as background 1314, as shown in FIG. 13H. In some embodiments, in accordance with a determination that the movement of the representation of the first user within the second three-dimensional environment is in a second direction, different from the first direction, the respective portion is a third portion, different from the second portion, such as movement of representation 1314a from FIG. 13G or FIG. 13H to FIG. 131 corresponding to computer system 101 displaying representation of the second user 1312 with a lower portion of virtual environment view 1324 with respect to section 1325a of FIG. 13A (e.g., section 1325e of FIG. 13E) as background 1314, as shown in FIG. 131. In some embodiments, the direction refers to the orientation or path along which the second user moves the representation of the first user within the second three-dimensional environment. In some embodiments, the first computer system displays the second portion when the second user moves the representation of the first user in the first direction by a first amount and displays the third portion when the second user moves the representation of the first user in the second direction by a second amount. In some embodiments, the first amount and the second amount are equal. In some embodiments, the first amount and the second amount are different. In some embodiments, the first direction and the second direction are equal, and the second portion and the third portion are different due to the first amount and the second amount not being equal. In some embodiments, the first portion of the respective background corresponds to a middle portion of the respective background, and the second portion and the third portion correspond to side portions of the respective background. In some embodiments, the first portion of the respective background corresponds to any portion of the respective background, and the second portion and the third portion correspond to portions of the respective background at different sides of the first portion of the respective background. In some embodiments, the second portion and the third portion extend beyond the visible bounds of the first portion, revealing additional areas of the first or second system environments that were not previously visible to the first user. For example, when the second user moves the representation of the first user to the right within the second three-dimensional environment, the respective portion of the respective background may include new areas of the first or second system environments to the right of the first portion of the respective background. In some embodiments, when the direction of the movement of the representation of the first user is to the left of the first position in the second three-dimensional environment, the respective portion corresponds to a portion of the respective background to the left of the first portion. In some embodiments, when the direction of the movement of the representation of the first user is to the right of the first position in the second three-dimensional environment, the respective portion corresponds to a portion of the respective background to the right of the first portion. In some embodiments, when the direction of the movement of the representation of the first user is towards the second user from the first position in the second three-dimensional environment, the respective portion corresponds to a broader view that encompasses a wider area of the background surrounding the second user, revealing more of the environment of the second computer system than shown by the first portion respective background. In some embodiments, when the direction of the movement of the representation of the first user is away from the second user from the first position in the second three-dimensional environment, the respective portion corresponds to a more limited view, narrowing the visible area of the background surrounding the second user (e.g., a portion smaller than the first portion of the respective background). In some embodiments, when the direction of the movement of the representation of the first user is upward from the first position within the three-dimensional environment, the respective portion corresponds to a portion of the respective background lower than the first portion. In some embodiments, when the direction of the movement of the representation of the first user is downward from the first position within the second three-dimensional environment, the respective portion corresponds to a portion of the respective background higher than the first portion. Dynamically adjusting the displayed background based on the specific directions of movement of the representation of the first user within the second three-dimensional environment enhances the computational efficiency of the first computer system by allowing the first computer system to render only relevant visual sections, optimizing resource allocation and reducing processing overhead, thereby improving system responsiveness and reducing power consumption.

In some embodiments, displaying the representation of the second user with the respective background includes in accordance with a determination that the second computer system does not include a system environment, the respective background is a third background, different from the first background and the second background, such as the default background of background 1314, as shown in FIG. 13O. In some embodiments, the second computer system not including a system environment refers to scenarios where the second computer system lacks a defined virtual or simulated environment that can be displayed or interacted with. In some embodiments, when the second computer system does not include a system environment, the second computer system is in a default or standby mode where no specific virtual environment is loaded or available. In some embodiments, when the second computer system is a type of device that does not support the creation or display of virtual environments (e.g., smartphones, personal computing devices, tablet computing devices, or Internet of Things (IoT) devices), the second computer system does not include a system environment. In some embodiments, the third background refers to a default background that is displayed when the second computer system does not include or cannot display a system environment. In some embodiments, determining that the second computer system does not include a system environment includes one or more of a system configuration check (e.g., checking the configuration settings of the second computer system), a query (e.g., querying the second computer system for its system environment), and/or a failure to receive data from the second computer system. In some embodiments, the third background is not based on (and/or not selected based on) an input from the second user and/or the second computer system. Automatically switching to a third background when the second computer system lacks a system environment ensures system robustness and maintains user engagement by providing a consistent visual experience, obviating the need for first user input to correct the background of the second user, thus conserving power and computational resources.

In some embodiments, while the first computer system is in the communication session with the second computer system, while the viewpoint of the user is a first viewpoint, the first computer system displays the representation of the second user with a respective portion of the third background, such as the default background of background 1314, as shown in FIG. 13O. In some embodiments, the respective portion of the third background refers to a segment or section of the default background corresponding to the third background that the first computer system displays behind the representation of the second user. In some embodiments, the respective portion of the third background encompasses the entire third background itself.

In some embodiments, while the first computer system is in the communication session with the second computer system, while the viewpoint of the user is a first viewpoint, detecting movement of the viewpoint of the first user, such as movement of the viewpoint of the first user from FIG. 13O to FIG. 13P, and in response to detecting the movement of the viewpoint of the first user, the first computer system displays the representation of the second user with the respective portion of the third background, such as the default background of background 1314, as shown in FIG. 13P. In some embodiments, displaying the representation of the second user with the respective portion of the third background in response to detecting the movement of the first user signifies that the background behind the representation of the second user does not change or shift in response to the first user's movements. For example, this may indicate that the third background is static, providing a consistent visual backdrop that does not react to changes in the first user's viewpoint or position. Maintaining the same display of the third background while detecting movement of the third user enhances the efficiency of the first computer system by minimizing changes in the visual output for actions which previously required changes when the respective background is the third background, thus conserving power and computational resources.

In some embodiments, while the first computer system is in the communication session with the second computer system and the one or more display generation components are displaying the representation of the second user with the respective background, the first computer system receives an indication (optionally from the second computer system), via the one or more input devices, corresponding to a modification of the system environment of the second computer system, such as computer system 101a modifying its system environment from the system environment corresponding to environment 1300a as shown in FIG. 13G to the system environment corresponding to environment 1300a as shown in FIG. 13L. In some embodiments, the indication refers to a signal, message, or notification received from the second computer system via the one or more input devices, as described in greater detail herein. In some embodiments, the indication communicates a specific change or update, such as a modification in the system environment of the second computer system, to the first computer system. In some embodiments, the modification of the system environment of the second computer system refers to any change or update made to the virtual or simulated environment within which the second computer system operates. In some embodiments, the modification of the system environment of the second computer involves a change from one system environment to a different system environment. In some embodiments, the modification of the system environment of the second computer involves one or more of changes to graphical themes (e.g., switching from one landscape to another), changes to a configuration or system settings (e.g., enhancing resolution, changing controls, modifying a layout), and/or adding or removing elements within the second environment (e.g., adding or removing objects from the system environment).

In some embodiments, in response to receiving the indication corresponding to the modification of the system environment of the second computer system, in accordance with a determination that the system environment of the second computer system is a third system environment, different from a respective system environment associated with the respective background, the first computer system displays, via the one or more display generation components, the representation of the second user with a third background corresponding to the third system environment, different from the first background and the second background, such as computer system 101 displaying representation of the second user 1312 with a background 1314 corresponding to the system environment of computer system 101a associated with environment 1300a, as shown in FIG. 13L. In some embodiments, the respective environment associated with the respective background refers to the specific system environment that corresponds to the background that the first computer system displays behind the representation of the second user. In some embodiments, the respective environment is either the first system environment or the second system environment, depending on which is active or relevant at the time of reference in the context of the communication session. In some embodiments, the third system environment refers to a distinct system environment within the second computer system that is different from the previously identified first and second system environments. In some embodiments, the third system environment represents an additional or alternative setting that is not being displayed as the respective background but can be activated based on user interactions or system changes. In some embodiments, the third background refers to the visual or graphical representation that corresponds to the third system environment within the second computer system. In some embodiments, the third background is distinct and separate from the first background and the second background previously displayed and associated with the first system environment and the second system environment, respectively. Automatically updating the display to show the third background corresponding to the third system environment in response to changes in the system environment of the second computer system enhances the adaptability and responsiveness of the first computer system, ensuring the visual output remains relevant and synchronized with the conditions of the second computer system.

In some embodiments, while the first computer system is in the communication session with the second computer system and the one or more display generation components are displaying the representation of the second user with the respective background, wherein the representation of the second user is a non-spatial representation (e.g., a non-spatial representation of the second user according to method 1000 described above), the first computer system receives an indication (optionally from the second computer system), via the one or more input devices, corresponding to the second user switching to a spatial representation of the second user, such as an indication associated with causing display of the spatial representation of representation of the second user 1312, as shown in FIG. 13N.

In some embodiments, in response to receiving the indication corresponding to the second user switching to the spatial representation of the second user, the first computer system displays, via the one or more display generation components, the spatial representation of the second user without a background, such as representation of the second user 1312, as shown in FIG. 13N. In some embodiments, the spatial representation of the second user refers to an avatar or model that is designed to mimic the appearance, movements, and/or interactions of the second user in a three-dimensional form. In some embodiments, the spatial representation of the second user has one or more of the characteristics of the spatial representations of users described above with reference to method 1000. In some embodiments, receiving an indication corresponding to the second user switching to the spatial representation of the second user involves the first computer system receiving data or signals that detail the parameters, characteristics, and/or changes in the spatial avatar of the second user. In some embodiments, the spatial representation of the second user is integrated into the first three-dimensional environment. In some embodiments, displaying the spatial representation of the second user without a background refers to the visual presentation of the spatial representation of the second user within the first three-dimensional environment, unaccompanied by any virtual background, regardless of the system environment of the second computer system. In some embodiments, the indication from the second computer system triggers a shift into a spatial mode corresponding to a communication session in which the representation of the second user is an avatar or model that appears directly within the first three-dimensional environment, without displaying a background for the representation. In some embodiments, a location and/or orientation of the spatial representation of the second user within the first environment corresponds to the location and/or orientation of the viewpoint of the second user within the second environment. In some embodiments, the viewpoint of the first user and the viewpoint of the second user share a spatial truth when the communication session includes spatial representations of the first user and/or the second user, as described above with reference to method 1000. Displaying the three-dimensional representation of the second user without the respective background upon receiving the indication from the second computer system reduces the computational resources required for rendering the respective background, thereby conserving power and enhancing the efficiency of the system.

In some embodiments, the system environment of the second computer system is a virtual environment, such as environment 1300a, as shown in FIG. 13G or 13L. In some embodiments, the virtual environment has one or more characteristics of the virtual environments described above with reference to method(s) 800, 1000, and/or 1200. In some embodiments, the virtual environment refers to a digitally created or simulated physical space that is designed to mimic, augment, or create new surroundings that a user may interact with. In some embodiments, the virtual environment is immersive, providing sensory feedback to a user such as visual, auditory, and/or haptic responses. Automating the adjustment of the displayed background in response to detected changes in the virtual environment of the second computer system enhances the computational efficiency of the first computer system by forgoing updating the display when changes in the virtual environment do not occur, minimizing computational load and bandwidth usage, conserving resources, and reducing unnecessary data processing.

In some embodiments, the system environment of the second computer system is a virtual atmosphere such as environment 1300a, as shown in FIG. 13M. In some embodiments, the virtual atmosphere refers to a minimalistic or abstract setting within a virtual space, characterized by simplistic visual elements that create a specific ambient condition without the complexity of detailed environments. In some embodiments, the virtual atmosphere is represented by one or more effects, such as single-color wash, subtle gradients, soft textural backgrounds (e.g., wisps or clouds), soft lighting, muted colors, and/or gentle movements within the atmosphere (e.g., drifting shapes or a play of light and shadows). In some embodiments, when the system environment is the virtual atmosphere, the respective background includes one or more of the visual elements associated with the virtual atmosphere. For example, the respective background may include one or more of the color, gradients, texture, lighting, movements and/or any other elements or effects of the virtual atmosphere. In some embodiments, when the system environment of the second computer system is the virtual atmosphere, the second computer system displays the aforementioned one or more effects overlaid on a representation of the physical environment surrounding the second computer system (e.g., instead of replacing the display of the representation of the physical environment with a virtual environment). In some embodiments, when the system environment of the second computer system is the virtual atmosphere, the respective background of the representation of the second user displayed by the first computer system is based on the one or more effects corresponding to the virtual atmosphere and is not based on the physical environment surrounding the second computer system. Automating the adjustment of the displayed background in response to detected changes in the virtual atmosphere environment of the second computer system enhances the computational efficiency of the first computer system by forgoing updating the display when changes in the virtual atmosphere environment do not occur, minimizing computational load and bandwidth usage, conserving resources, and reducing unnecessary data processing.

It should be understood that the particular order in which the operations in method 1400 have been described is merely exemplary and is not intended to indicate that the described order is the only order in which the operations could be performed. One of ordinary skill in the art would recognize various ways to reorder the operations described herein.

In some embodiments, aspects/operations of methods 800, 1000, 1200, and/or 1400 may be interchanged, substituted, and/or added between these methods. For example, the three-dimensional environments of methods 800, 1000, 1200, and/or 1400, the virtual representations (e.g., spatial and/or non-spatial representations) of methods 800, 1000, 1200, and/or 1400, the communication sessions of methods 800, 1000, 1200, and/or 1400, the selection inputs of methods 800, 1000, 1200, and/or 1400, virtual environments of methods 800, 1000, 1200, and/or 1400, avatars (e.g., virtual renderings) of methods 800, 1000, 1200, and/or 1400 and/or backgrounds (e.g., environments and/or system environments) of methods 800, 1000, 1200, and/or 1400 are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, social media IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1-47. (canceled)

48. A method comprising:
at a first computer system in communication with one or more display generation components and one or more input devices:
while a first three-dimensional environment is visible via the one or more display generation components from a viewpoint of a first user of the first computer system, and while the first computer system is in a communication session with a second computer system, different from the first computer system, of a second user, different from the first user:
displaying, via the one or more display generation components, a representation of the second user with a respective background, wherein:
in accordance with a determination that a system environment of the second computer system is a first system environment, the respective background is a first background corresponding to the first system environment; and
in accordance with a determination that the system environment of the second computer system is a second system environment, different from the first system environment, the respective background is a second background corresponding to the second system environment, different from the first background.

49. The method of claim 48, further comprising:
while the first computer system is in the communication session with the second computer system:
while the viewpoint of the first user is a first viewpoint, displaying the representation of the second user with a first portion of the respective background;
detecting movement of the viewpoint of the first user; and
in response to detecting the movement of the viewpoint of the first user:
displaying the representation of the second user with a respective portion of the respective background different from the first portion of the respective background in accordance with the movement of the first user.

50. The method of claim 49, wherein displaying the representation of the second user with the respective portion of the respective background includes:
in accordance with a determination that the movement of the viewpoint of the first user is in a first direction, the respective portion is a second portion; and
in accordance with a determination that the movement of the viewpoint of the first user is in a second direction, different from the first direction, the respective portion is a third portion, different from the second portion.

51. The method of claim 48, further comprising:
while the first computer system is in the communication session with the second computer system:
receiving a first indication, via the one or more input devices, corresponding to a representation of the first user being displayed within a second three-dimensional environment at a first position;
in response to receiving the first indication, displaying the representation of the second user with a first portion of the respective background;
receiving a second indication, via the one or more input devices, corresponding to movement of the representation of the first user within the second three-dimensional environment; and
in response to receiving the second indication:
displaying the representation of the second user with a respective portion of the respective background different from the first portion of the respective background in accordance with the movement of the representation of the first user within the second three-dimensional environment.

52. The method of claim 51, wherein displaying the representation of the second user with the respective portion of the respective background includes:
in accordance with a determination that the movement of the representation of the first user within the second three-dimensional environment is in a first direction, the respective portion is a second portion; and
in accordance with a determination that the movement of the representation of the first user within the second three-dimensional environment is in a second direction, different from the first direction, the respective portion is a third portion, different from the second portion.

53. The method of claim 48, wherein displaying the representation of the second user with the respective background includes:
in accordance with a determination that the second computer system does not include a system environment, the respective background is a third background, different from the first background and the second background.

54. The method of claim 53, further comprising:
while the first computer system is in the communication session with the second computer system:
while the viewpoint of the first user is a first viewpoint, displaying the representation of the second user with a respective portion of the third background;
detecting movement of the viewpoint of the first user; and
in response to detecting the movement of the viewpoint of the first user:
displaying the representation of the second user with the respective portion of the third background.

55. The method of claim 48, further comprising:
while the first computer system is in the communication session with the second computer system and the one or more display generation components are displaying the representation of the second user with the respective background, receiving an indication, via the one or more input devices, corresponding to a modification of the system environment of the second computer system; and
in response to receiving the indication corresponding to the modification of the system environment of the second computer system:
in accordance with a determination that the system environment of the second computer system is a third system environment, different from a respective system environment associated with the respective background, displaying, via the one or more display generation components, the representation of the second user with a third background corresponding to the third system environment, different from the first background and the second background.

56. The method of claim 48, further comprising:
while the first computer system is in the communication session with the second computer system and the one or more display generation components are displaying the representation of the second user with the respective background, wherein the representation of the second user is a non-spatial representation, receiving an indication, via the one or more input devices, corresponding to the second user switching to a spatial representation of the second user; and
in response to receiving the indication corresponding to the second user switching to the spatial representation of the second user:
displaying, via the one or more display generation components, the spatial representation of the second user without a background.

57. The method of claim 48, wherein the system environment of the second computer system is a virtual environment.

58. The method of claim 48, wherein the system environment of the second computer system is a virtual atmosphere.

59. A first computer system that is in communication with a display generation component and one or more input devices, the first computer system comprising:
one or more processors;
memory; and
one or more programs, wherein the one or more programs are stored in the memory and configured to be executed by the one or more processors, the one or more programs including instructions for:
while a first three-dimensional environment is visible via the one or more display generation components from a viewpoint of a first user of the first computer system, and while the first computer system is in a communication session with a second computer system, different from the first computer system, of a second user, different from the first user:
displaying, via the one or more display generation components, a representation of the second user with a respective background, wherein:
in accordance with a determination that a system environment of the second computer system is a first system environment, the respective background is a first background corresponding to the first system environment; and
in accordance with a determination that the system environment of the second computer system is a second system environment, different from the first system environment, the respective background is a second background corresponding to the second system environment, different from the first background.

60. A non-transitory computer readable storage medium storing one or more programs, the one or more programs comprising instructions, which when executed by one or more processors of a first computer system that is in communication with a display generation component and one or more input devices, cause the first computer system to perform a method comprising:
while a first three-dimensional environment is visible via the one or more display generation components from a viewpoint of a first user of the first computer system, and while the first computer system is in a communication session with a second computer system, different from the first computer system, of a second user, different from the first user:
displaying, via the one or more display generation components, a representation of the second user with a respective background, wherein:
in accordance with a determination that a system environment of the second computer system is a first system environment, the respective background is a first background corresponding to the first system environment; and
in accordance with a determination that the system environment of the second computer system is a second system environment, different from the first system environment, the respective background is a second background corresponding to the second system environment, different from the first background.
